(19) United States
(12) Patent Application Publication
(10) Pub. No.: US 2026/0159538 A1
(43) Pub. Date: Jun. 11, 2026

(54) SOLID FORMS OF 1-(4-(4-((3-(3,6-DIFLUOROPYRIDIN-2-YL)-1-((1R,4R)-4-ETHOXYCYCLOHEXYL)-1H-PYRAZOL-4-YL)CARBAMOYL)THIAZOL-2-YL)-1H-PYRAZOL-1-YL)ETHYL PHOSPHATE AND SALTS THEREOF, AND THEIR PHARMACEUTICAL COMPOSITIONS AND USES

(71) Applicant: Rigel Pharmaceuticals, Inc., South San Francisco, CA (US)

(72) Inventors: Lu Chou, Millbrae, CA (US); Nandan Oza, Sunnyvale, CA (US)

(73) Assignee: Rigel Pharmaceuticals, Inc., South San Francisco, CA (US)

(21) Appl. No.: 19/411,088

(22) Filed: Dec. 5, 2025

Related U.S. Application Data
(60) Provisional application No. 63/729,262, filed on Dec. 6, 2024.

(51) Int. Cl. C07F 9/6558

(52) U.S. Cl. CPC C07F 9/65583; C07B 2200/13

(57) ABSTRACT

Solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate, solid forms of salts thereof, including solid forms comprising 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt, compositions comprising the solid forms, methods of making the solid forms and methods of their uses are disclosed.

### 1. RELATED APPLICATIONS

This application claims the benefit of U.S. Provisional Application No. 63/729,262, filed Dec. 6, 2024, the disclosure of which is incorporated herein by reference in its entirety.

### 2. FIELD

Provided herein are solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate, solid forms of salts thereof, including solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt, pharmaceutical compositions thereof, and methods of their uses for the treatment of diseases or disorders.

### 3. BACKGROUND OF THE DISCLOSURE

Interleukin-1 receptor-associated kinases (IRAKs) are important mediators of signaling processes, such as toll-like receptors (TLR) and interleukin-1 receptor (IL-1R) signaling processes. IRAKs have been implicated in modulating signaling networks that control inflammation, apoptosis, and cellular differentiation. Four IRAK genes have been identified in the human genome (IRAK1, IRAK2, IRAK3 and IRAK4), and studies have revealed distinct, non-redundant biological roles. IRAK1 and IRAK4 have been shown to exhibit kinase activity. Compound 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate (Compound 1I) and salts thereof, including 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt (Compound 1) have been reported as IRAK inhibitors and/or useful for delivering an IRAK inhibitor having a therapeutic use in treatment of diseases where IRAKs are implicated. There is a continuing need to develop therapeutically efficacious forms of Compound 1I and salts thereof, including solid forms of Compound 1.

The preparation and selection of a solid form of a pharmaceutical compound is complex, given that a change in solid form may affect a variety of physical and chemical properties, which may provide benefits or drawbacks in processing, formulation, stability and bioavailability, among other important pharmaceutical characteristics. Potential pharmaceutical solids include crystalline solids and amorphous solids. Amorphous solids are characterized by a lack of long-range structural order, whereas crystalline solids are characterized by structural periodicity. The desired class of pharmaceutical solid depends upon the specific application; amorphous solids are sometimes selected on the basis of, e.g., an enhanced dissolution profile, while crystalline solids may be desirable for properties such as, e.g., physical or chemical stability (see, e.g., S. R. Vippagunta et al., Adv. Drug. Deliv. Rev., (2001) 48:3-26; L. Yu, Adv. Drug. Deliv. Rev., (2001) 48:27-42).

Notably, it is not possible to predict apriori if crystalline forms of a compound even exist, let alone how to successfully prepare them (see, e.g., Braga and Grepioni, 2005, “Making crystals from crystals: a green route to crystal engineering and polymorphism,” Chem. Commun.: 3635-3645 (with respect to crystal engineering, if instructions are not very precise and/or if other external factors affect the process, the result can be unpredictable); Jones et al., 2006, Pharmaceutical Cocrystals: An Emerging Approach to Physical Property Enhancement,” MRS Bulletin 31:875-879 (At present it is not generally possible to computationally predict the number of observable polymorphs of even the simplest molecules); Price, 2004, “The computational prediction of pharmaceutical crystal structures and polymorphism,” Advanced Drug Delivery Reviews 56:301-319 (“Price”); and Bernstein, 2004, “Crystal Structure Prediction and Polymorphism,” ACA Transactions 39:14-23 (a great deal still needs to be learned and done before one can state with any degree of confidence the ability to predict a crystal structure, much less polymorphic forms)).

The variety of possible solid forms creates potential diversity in physical and chemical properties for a given pharmaceutical compound. The discovery and selection of solid forms are of great importance in the development of an effective, stable and marketable pharmaceutical product.

### 4. SUMMARY

Provided herein are solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate (Compound 1I) and solid forms of various salts of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate.

In one embodiment, provided herein are solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt

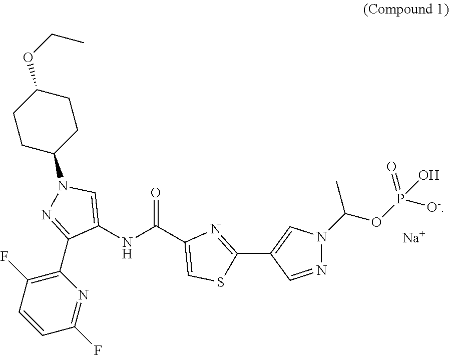

In one embodiment, the solid form of Compound 1 is Form D. In another embodiment, the solid form of Compound 1 is Form E. In yet another embodiment, the solid form of Compound 1 is Form J. In yet another embodiment, the solid form of Compound 1 is Form L. In yet another embodiment, the solid form of Compound 1 is Form U. In one embodiment, the solid form is a hydrate.

In one embodiment, the solid form of Compound 1 is Form O. In another embodiment, the solid form of Compound 1 is Form Q. In yet another embodiment, the solid form of Compound 1 is Form R. In yet another embodiment, the solid form of Compound 1 is Form T. In yet another embodiment, the solid form of Compound 1 is Form W. In one embodiment, the solid form is an anhydrate.

In one embodiment, the solid form of Compound 1 is Form H. In another embodiment, the solid form of Compound 1 is Form N. In yet another embodiment, the solid form of Compound 1 is Form X. In one embodiment, the solid form is a solvate.

In one embodiment, the solid form of Compound 1 is Form F. In another embodiment, the solid form of Compound 1 is Form G. In yet another embodiment, the solid form of Compound 1 is Form I. In yet another embodiment, the solid form of Compound 1 is Form K. In yet another embodiment, the solid form of Compound 1 is Form M. In yet another embodiment, the solid form of Compound 1 is Form P. In yet another embodiment, the solid form of Compound 1 is Form S. In yet another embodiment, the solid form of Compound 1 is Form V. In yet another embodiment, the solid form of Compound 1 is Form Y. In one embodiment, the solid form is an amorphous form.

In one embodiment, the solid form of Compound 1 is Form A. In another embodiment, the solid form of Compound 1 is Form B. In yet another embodiment, the solid form of Compound 1 is Form C.

In one embodiment, provided herein are solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate potassium salt (Compound 1A). In one embodiment, the solid form of Compound 1A is Form A. In another embodiment, the solid form of Compound 1A is Form B. In yet another embodiment, the solid form of Compound 1A is Form C. In yet another embodiment, the solid form of Compound 1A is Form D. In yet another embodiment, the solid form of Compound 1A is Form E.

In one embodiment, provided herein are solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate magnesium salt (Compound 1B). In one embodiment, the solid form of Compound 1B is Form A.

In one embodiment, provided herein are solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate calcium salt (Compound 1C). In one embodiment, the solid form of Compound 1C is Form A.

In one embodiment, provided herein are solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate ammonium salt (Compound 1D). In one embodiment, the solid form of Compound 1D is Form A.

In one embodiment, provided herein are solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate arginine salt (Compound 1E). In one embodiment, the solid form of Compound 1E is Form A. In one embodiment, the solid form of Compound 1E is Form B. In one embodiment, the solid form of Compound 1E is Form C.

In one embodiment, provided herein are solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate lysine salt (Compound 1F). In one embodiment, the solid form of Compound 1F is Form A.

In one embodiment, provided herein are solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate choline salt (Compound 1G). In one embodiment, the solid form of Compound 1G is Form A. In one embodiment, the solid form of Compound 1G is Form B.

In one embodiment, provided herein are solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate tris salt (Compound 1H). In one embodiment, the solid form of Compound 1H is Form A. In one embodiment, the solid form of Compound 1H is Form B.

In one embodiment, provided herein are solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate (Compound 1I) (freeform). In one embodiment, the solid form of Compound 1I is Form A. In one embodiment, the solid form of Compound 1I is Form B.

In certain embodiments, the solid forms are single-component crystal forms. In certain embodiments, the solid forms are multiple-component crystal forms.

In certain embodiments, the solid forms are single-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt. In certain embodiments, the solid forms are multiple-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt.

In certain embodiments, the solid forms are single-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate potassium salt. In certain embodiments, the solid forms are multiple-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate potassium salt.

In certain embodiments, the solid forms are single-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate magnesium salt. In certain embodiments, the solid forms are multiple-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate magnesium salt.

In certain embodiments, the solid forms are single-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate calcium salt. In certain embodiments, the solid forms are multiple-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate calcium salt.

In certain embodiments, the solid forms are single-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate ammonium salt. In certain embodiments, the solid forms are multiple-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate ammonium salt.

In certain embodiments, the solid forms are single-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate arginine salt. In certain embodiments, the solid forms are multiple-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate arginine salt.

In certain embodiments, the solid forms are single-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate lysine salt. In certain embodiments, the solid forms are multiple-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate lysine salt.

In certain embodiments, the solid forms are single-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate choline salt. In certain embodiments, the solid forms are multiple-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate choline salt.

In certain embodiments, the solid forms are single-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate tris salt. In certain embodiments, the solid forms are multiple-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate tris salt.

In certain embodiments, the solid forms are single-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate. In certain embodiments, the solid forms are multiple-component crystal forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate.

Without intending to be limited by any particular theory, certain solid forms provided herein have particular advantageous physical and/or chemical properties making them useful, e.g., for manufacturing, processing, formulation and/or storage, while also possessing particularly advantageous biological properties, such as, e.g., bioavailability and/or biological activity.

In certain embodiments, solid forms provided herein include solid forms comprising 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt, including, but not limited to, single-component and multiple-component solid forms comprising 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt. Certain embodiments herein provide methods of making, isolating and/or characterizing the solid forms provided herein.

Also provided are pharmaceutical compositions formulated for administration by an appropriate route and means containing effective concentrations of a solid form of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt, and optionally comprising at least one pharmaceutical carrier.

In one embodiment, the pharmaceutical compositions deliver amounts effective for the treatment, prevention and/or amelioration of auto-immune diseases, inflammatory disorders, cardiovascular diseases, nerve disorders, neurodegenerative disorders, allergic disorders, asthma, pancreatitis, multi-organ failure, kidney diseases, platelet aggregation, cancer, transplantation, sperm motility, erythrocyte deficiency, graft rejection, lung injuries, respiratory diseases, ischemic conditions, and bacterial and viral infections.

Also provided herein are combination therapies using a solid form of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate or salts thereof in combination with a therapy e.g., another pharmaceutical agent effective for treatment of the disease to be treated.

In one embodiment, provided herein are combination therapies using a solid form of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt in combination with a therapy e.g., another pharmaceutical agent effective for treatment of the disease to be treated.

The solid forms provided herein, including the solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt provided herein may be administered simultaneously with, prior to, or after administration of one or more of the combination therapies.

Pharmaceutical compositions containing the solid forms provided herein, including a solid form of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt and one or more of the above agents are also provided.

In one embodiment, provided herein are methods of treatment by administration of a composition comprising a solid form provided herein, including a solid forms of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt.

In practicing the methods, effective amounts of a solid form provided herein, including a solid form of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt or compositions containing therapeutically effective amounts of the solid form provided herein, including the solid form of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt are administered to an individual exhibiting the symptoms of the disease or disorder to be treated. The amounts are effective to ameliorate or eliminate one or more symptoms of the disease or disorder.

Further provided is a pharmaceutical pack or kit comprising one or more containers filled with one or more of the ingredients of the pharmaceutical compositions. Optionally associated with such container(s) can be a notice in the form prescribed by a governmental agency regulating the manufacture, use or sale of pharmaceuticals or biological products, which notice reflects approval by the agency of manufacture, use of sale for human administration. The pack or kit can be labeled with information regarding mode of administration, sequence of drug administration (e.g., separately, sequentially or concurrently), or the like.

These and other aspects of the subject matter described herein will become evident upon reference to the following detailed description.

### 5. BRIEF DESCRIPTION OF THE FIGURES

FIG. 1 depicts an overlay of X-ray powder diffractograms for Forms D, E, F, G and H of Compound 1.

FIG. 2 depicts a thermogravimetrical analysis (TGA) and a differential scanning calorimetry (DSC) thermogram plots of Form D of Compound 1.

FIG. 3 depicts a ¹H NMR spectrum of Form D of Compound 1.

FIG. 4 depicts an X-ray powder diffractogram for Form D of Compound 1 before and after heating to 150° C.

FIG. 5 depicts a thermogravimetrical analysis (TGA) and a differential scanning calorimetry (DSC) thermogram plots of Form D of Compound 1 before and after heating to 150° C.

FIG. 6 depicts an overlay of variable temperature X-ray powder diffractograms for Form D of Compound 1.

FIG. 7 provides a PLM image of Form D of Compound 1.

FIG. 8 depicts a FTIR spectrum of Form D of Compound 1.

FIG. 9 depicts an X-ray powder diffractogram for Form E of Compound 1.

FIG. 10 depicts a thermogravimetrical analysis (TGA) and a differential scanning calorimetry (DSC) thermogram plots of Form E of Compound 1.

FIG. 11 depicts a ¹H NMR spectrum of Form E of Compound 1.

FIG. 12 depicts an overlay of variable temperature X-ray powder diffractogram for Form E of Compound 1.

FIG. 13 depicts an overlay of X-ray powder diffractogram for re-prepared Form E of Compound 1.

FIG. 14 depicts a thermogravimetrical analysis (TGA) and a differential scanning calorimetry (DSC) thermogram plots of re-prepared Form E of Compound 1.

FIG. 15 provides a PLM image of re-prepared Form E of Compound 1.

FIG. 16 depicts a FTIR spectrum of Form E of Compound 1.

FIG. 17 depicts an X-ray powder diffractogram for form J of Compound 1.

FIG. 18 depicts a thermogravimetrical analysis (TGA) and a differential scanning calorimetry (DSC) thermogram plots of Form J of Compound 1.

FIG. 19 depicts a ¹H NMR spectrum of Form J of Compound 1.

FIG. 20 depicts a variable temperature XRPD overlay of Form J of Compound 1.

FIG. 21 depicts an overlay of X-ray powder diffractograms for re-prepared Form J of Compound 1.

FIG. 22 depicts an X-ray powder diffractogram for form L of Compound 1.

FIG. 23 depicts a thermogravimetrical analysis (TGA) and a differential scanning calorimetry (DSC) thermogram plots of Form L of Compound 1.

FIG. 24 depicts a ¹H NMR spectrum of Form L of Compound 1.

FIG. 25 depicts an overlay of variable temperature X-ray powder diffractograms for Form L of Compound 1.

FIG. 26 depicts an X-ray powder diffractogram for Form U of Compound 1.

FIG. 27 depicts a thermogravimetrical analysis (TGA) and a differential scanning calorimetry (DSC) thermogram plots of Form U of Compound 1.

FIG. 28 depicts an X-ray powder diffractogram for Form O of Compound 1.

FIG. 29 depicts an X-ray powder diffractogram for Form Q of Compound 1.

FIG. 30 depicts an X-ray powder diffractogram for Form R of Compound 1.

FIG. 31 depicts an X-ray powder diffractogram for Form T of Compound 1.

FIG. 32 depicts an X-ray powder diffractogram for Form W of Compound 1.

FIG. 33 depicts a thermogravimetrical analysis (TGA) and a differential scanning calorimetry (DSC) thermogram plots of Form W Compound 1.

FIG. 34 depicts an X-ray powder diffractogram for form H of Compound 1.

FIG. 35 depicts a thermogravimetrical analysis (TGA) and a differential scanning calorimetry (DSC) thermogram plots of Form H of Compound 1.

FIG. 36 depicts a ¹H NMR spectrum of Form H of Compound 1.

FIG. 37 depicts an X-ray powder diffractogram for form N of Compound 1.

FIG. 38 depicts a thermogravimetrical analysis (TGA) and a differential scanning calorimetry (DSC) thermogram plots of Form N of Compound 1.

FIG. 39 depicts a ¹H NMR spectrum of Form N of Compound 1.

FIG. 40 depicts an overlay of variable temperature X-ray powder diffractograms for Form N of Compound 1.

FIG. 41 depicts an X-ray powder diffractogram for Form X of Compound 1.

FIG. 42 depicts an X-ray powder diffractogram for Form F of Compound 1.

FIG. 43 depicts a thermogravimetrical analysis (TGA) and a differential scanning calorimetry (DSC) thermogram plots of Form F of Compound 1.

FIG. 44 depicts a ¹H NMR spectrum of Form F of Compound 1.

FIG. 45 depicts an X-ray powder diffractogram for Form G of Compound 1.

FIG. 46 depicts a thermogravimetrical analysis (TGA) and a differential scanning calorimetry (DSC) thermogram plots of Form G of Compound 1.

FIG. 47 depicts a ¹H NMR spectrum of Form G of Compound 1.

FIG. 48 depicts an overlay of X-ray powder diffractograms for Form G of Compound 1 after storage.

FIG. 49 depicts an X-ray powder diffractogram for Form I of Compound 1.

FIG. 50 depicts a thermogravimetrical analysis (TGA) and a differential scanning calorimetry (DSC) thermogram plots of Form I of Compound 1.

FIG. 51 depicts a ¹H NMR spectrum of Form I of Compound 1.

FIG. 52 depicts an overlay of X-ray powder diffractograms for Form K, Form D obtained after storing Form K, and reference Form D of Compound 1.

FIG. 53 depicts an X-ray powder diffractogram for Form M of Compound 1.

FIG. 54 depicts a thermogravimetrical analysis (TGA) and a differential scanning calorimetry (DSC) thermogram plots of Form M of Compound 1.

FIG. 55 depicts a ¹H NMR spectrum of Form M of Compound 1.

FIG. 56 depicts an X-ray powder diffractogram for Form P of Compound 1.

FIG. 57 depicts an X-ray powder diffractogram for Form S of Compound 1.

FIG. 58 depicts an X-ray powder diffractogram for Form V of Compound 1.

FIG. 59 depicts an X-ray powder diffractogram for Form Y of Compound 1.

FIG. 60 depicts an overlay of X-ray powder diffractograms for Form Y of Compound 1 before and after drying and reference Form J.

FIG. 61 depicts an overlay of X-ray powder diffractograms for residual solids after slurry competition in aw (water activity)=0˜0.4 (wet sample).

FIG. 62 depicts an overlay X-ray powder diffractograms for residual solids after slurry competition in aw=0˜0.4 (dry sample).

FIG. 63 depicts an overlay of X-ray powder diffractograms for residual solids after slurry competition in aw=0.6 (wet sample).

FIG. 64 depicts an overlay of X-ray powder diffractograms for residual solids after slurry competition in aw=0.6 (dry sample).

FIG. 65 depicts an overlay of X-ray powder diffractograms for residual solids after slurry competition in aw=0.8 (wet sample).

FIG. 66 depicts an overlay of X-ray powder diffractograms for residual solids after slurry competition in aw=0.8 (dry sample).

FIG. 67 depicts an overlay of X-ray powder diffractograms for residual solids after slurry competition in aw=1.0 (dry sample).

FIG. 68 depicts an X-ray powder diffractogram for residual solids after slurry competition in aw=0 (wet sample).

FIG. 69 depicts an overlay of X-ray powder diffractograms for residual solids after slurry competition in aw=0 (dry sample).

FIG. 70 depicts an overlay of X-ray powder diffractograms for residual solids after slurry competition in aw=0.2˜0.6 (wet sample).

FIG. 71 depicts an overlay of X-ray powder diffractograms for residual solids after slurry competition in aw=0.2˜0.6 (dry sample).

FIG. 72 depicts an overlay of X-ray powder diffractograms for residual solids after slurry competition in aw=0.8˜1.0 (dry sample).

FIG. 73 depicts an overlay of X-ray powder diffractograms for Form D of Compound 1 after solubility test in H₂O.

FIG. 74 depicts an overlay of X-ray powder diffractograms for Form D of Compound 1 after solubility test in SGF.

FIG. 75 depicts an overlay of X-ray powder diffractograms for Form D of Compound 1 after solubility test in FaSSIF.

FIG. 76 depicts an overlay of X-ray powder diffractograms for Form D of Compound 1 after solubility test in FeSSIF.

FIG. 77 depicts an overlay of X-ray powder diffractograms for Form E of Compound 1 after solubility test in H₂O.

FIG. 78 depicts an overlay of X-ray powder diffractograms for Form E after solubility test in SGF.

FIG. 79 depicts an overlay of X-ray powder diffractograms for Form E of Compound 1 after solubility test in FaSSIF.

FIG. 80 depicts an overlay of X-ray powder diffractograms for Form E of Compound 1 after solubility test in FeSSIF.

FIG. 81 depicts a dynamic vapor sorption (DVS) plot for Form D of Compound 1.

FIG. 82 depicts an overlay of X-ray powder diffractograms for Form D of Compound 1 after DVS test.

FIG. 83 depicts a DVS plot of Form E of Compound 1.

FIG. 84 depicts an overlay of X-ray powder diffractograms for Form E of Compound 1 after DVS test.

FIG. 85 depicts an overlay of X-ray powder diffractograms for Form D of Compound 1 after stability test.

FIG. 86 depicts an overlay of X-ray powder diffractograms for Form E of Compound 1 after stability test.

FIG. 87 provides an inter-conversion diagram of Compound 1 solid forms.

FIG. 88 provides a PLM image of Forms D+E of Compound 1.

FIG. 89 provides a PLM image of Form NP1 of Compound 1.

FIG. 90 depicts an X-ray powder diffractogram for Form NP1 of Compound 1.

FIG. 91 depicts thermogravimetrical analysis (TGA) and differential scanning calorimetry (DSC) thermogram plots of Form NP1 of Compound 1.

FIG. 92 provides a PLM image of Form NP3 of Compound 1.

FIG. 93 depicts an X-ray powder diffractogram for Form NP3 of Compound 1.

FIG. 94 depicts thermogravimetrical analysis (TGA) and differential scanning calorimetry (DSC) thermogram plots of Form NP3 of Compound 1.

FIG. 95 depicts an X-ray powder diffractogram for Form NP4 of Compound 1.

FIG. 96 depicts an X-ray powder diffractogram for Form A of Compound 1.

FIG. 97 depicts thermogravimetrical analysis (TGA) and differential scanning calorimetry (DSC) thermogram plots of Form A of Compound 1.

FIG. 98 depicts a ¹H NMR spectrum of Form A of Compound 1.

FIG. 99 depicts an X-ray powder diffractogram for Form B of Compound 1.

FIG. 100 depicts thermogravimetrical analysis (TGA) and differential scanning calorimetry (DSC) thermogram plots of Form B of Compound 1.

FIG. 101 depicts a ¹H NMR spectrum of Form B of Compound 1.

FIG. 102 depicts an X-ray powder diffractogram for Form C of Compound 1.

FIG. 103 depicts thermogravimetrical analysis (TGA) and differential scanning calorimetry (DSC) thermogram plots of Form C of Compound 1.

FIG. 104 depicts a ¹H NMR spectrum of Form C of Compound 1.

FIG. 105 depicts an X-ray powder diffractogram for Form A of Compound 1A.

FIG. 106 depicts thermogravimetrical analysis (TGA) and differential scanning calorimetry (DSC) thermogram plots of Form A of Compound 1A.

FIG. 107 depicts a ¹H NMR spectrum of Form A of Compound 1A.

FIG. 108 depicts an X-ray powder diffractogram for Form B of Compound 1A.

FIG. 109 depicts thermogravimetrical analysis (TGA) and differential scanning calorimetry (DSC) thermogram plots of Form B of Compound 1A.

FIG. 110 depicts a ¹H NMR spectrum of Form B of Compound 1A.

FIG. 111 depicts an X-ray powder diffractogram overlay of Form B of Compound 1A before and after heating.

FIG. 112 depicts thermogravimetrical analysis (TGA) and differential scanning calorimetry (DSC) thermogram plots of Form B of Compound 1A after heating.

FIG. 113 depicts a VT-XRPD overlay of Form B of Compound 1A.

FIG. 114 depicts an X-ray powder diffractogram for Form C of Compound 1A.

FIG. 115 depicts thermogravimetrical analysis (TGA) and a differential scanning calorimetry (DSC) thermogram plots of Form C of Compound 1A.

FIG. 116 depicts a ¹H NMR spectrum of Form C of Compound 1A.

FIG. 117 depicts XRPD overlay of Form C of Compound 1A before and after heating.

FIG. 118 depicts thermogravimetrical analysis (TGA) and differential scanning calorimetry (DSC) thermogram plots of Form C of Compound 1A after heating.

FIG. 119 depicts a VT-XRPD overlay of Form C of Compound 1A.

FIG. 120 depicts an X-ray powder diffractogram for Form D of Compound 1A.

FIG. 121 depicts thermogravimetrical analysis (TGA) and differential scanning calorimetry (DSC) thermogram plots of Form D of Compound 1A.

FIG. 122 depicts a ¹H NMR spectrum of Form D of Compound 1A.

FIG. 123 depicts XRPD overlay of K salt Form D before and after heating.

FIG. 124 depicts TGA/DSC curves of K salt Form D after heating.

FIG. 125 depicts an X-ray powder diffractogram for Form A of Compound 1B.

FIG. 126 depicts thermogravimetrical analysis (TGA) and differential scanning calorimetry (DSC) thermogram plots of Form A of Compound 1B.

FIG. 127 depicts a ¹H NMR spectrum of Form A of Compound 1B.

FIG. 128 depicts an X-ray powder diffractogram for Form A of Compound 1C.

FIG. 129 depicts thermogravimetrical analysis (TGA) and differential scanning calorimetry (DSC) thermogram plots of Form A of Compound 1C.

FIG. 130 depicts a ¹H NMR spectrum of Form A of Compound 1C.

FIG. 131 depicts an X-ray powder diffractogram for Form A of Compound 1D.

FIG. 132 depicts thermogravimetrical analysis (TGA) and differential scanning calorimetry (DSC) thermogram plots of Form A of Compound 1D.

FIG. 133 depicts a ¹H NMR spectrum of Form A of Compound 1D.

FIG. 134 depicts an X-ray powder diffractogram for Form A of Compound 1E.

FIG. 135 depicts thermogravimetrical analysis (TGA) and differential scanning calorimetry (DSC) thermogram plots of Form A of Compound 1E.

FIG. 136 depicts a H NMR spectrum of Form A of Compound 1E.

FIG. 137 depicts XRPD overlay of Form A of Compound 1E before and after heating.

FIG. 138 depicts TGA/DSC curves of Form A of Compound 1E after heating.

FIG. 139 depicts VT-XRPD overlay of Form A of Compound 1E.

FIG. 140 depicts an X-ray powder diffractogram for Form B of Compound 1E.

FIG. 141 depicts thermogravimetrical analysis (TGA) and differential scanning calorimetry (DSC) thermogram plots of Form B of Compound 1E.

FIG. 142 depicts a ¹H NMR spectrum of Form B of Compound 1E.

FIG. 143 depicts an X-ray powder diffractogram for Form C of Compound 1E.

FIG. 144 depicts an X-ray powder diffractogram for Form A of Compound 1F.

FIG. 145 depicts thermogravimetrical analysis (TGA) and differential scanning calorimetry (DSC) thermogram plots of Form A of Compound 1F.

FIG. 146 depicts a ¹H NMR spectrum of Form A of Compound 1F.

FIG. 147 depicts an X-ray powder diffractogram for Form A of Compound 1G.

FIG. 148 depicts thermogravimetrical analysis (TGA) and differential scanning calorimetry (DSC) thermogram plots of Form A of Compound 1G.

FIG. 149 depicts a ¹H NMR spectrum of Form A of Compound 1G.

FIG. 150 depicts XRPD overlay of choline salt Form A of Compound 1G (before and after heating).

FIG. 151 depicts an X-ray powder diffractogram for Form B of Compound 1G.

FIG. 152 depicts thermogravimetrical analysis (TGA) and differential scanning calorimetry (DSC) thermogram plots of Form B of Compound 1G.

FIG. 153 depicts VT-XRPD overlay of choline salt Form B of Compound 1G.

FIG. 154 depicts an X-ray powder diffractogram for Form A of Compound 1H.

FIG. 155 depicts thermogravimetrical analysis (TGA) and differential scanning calorimetry (DSC) thermogram plots of Form A of Compound 1H.

FIG. 156 depicts a ¹H NMR spectrum of Form A of Compound 1H.

FIG. 157 depicts VT-XRPD overlay of Form B of Compound 1H.

FIG. 158 depicts an X-ray powder diffractogram for Form B of Compound 1H.

FIG. 159 depicts thermogravimetrical analysis (TGA) and differential scanning calorimetry (DSC) thermogram plots of Form B of Compound 1H.

FIG. 160 depicts a ¹H NMR spectrum of Form B of Compound 1H.

FIG. 161 depicts an X-ray powder diffractogram for freeform of Compound 1I.

FIG. 162 depicts thermogravimetrical analysis (TGA) and differential scanning calorimetry (DSC) thermogram plots of freeform of Compound 1I.

FIG. 163 provides an HPLC chromatogram showing impurities in isolation of freeform of Compound 1I.

FIG. 164 depicts an X-ray powder diffractogram for Form A of Compound 1I.

FIG. 165 depicts thermogravimetrical analysis (TGA) and differential scanning calorimetry (DSC) thermogram plots of Form A of Compound 1I.

FIG. 166 depicts a ¹H NMR spectrum of Form A of Compound 1I.

FIG. 167 depicts an X-ray powder diffractogram for Form B of Compound 1I.

FIG. 168 depicts thermogravimetrical analysis (TGA) and differential scanning calorimetry (DSC) thermogram plots of Form B of Compound 1I.

FIG. 169 depicts a ¹H NMR spectrum of Form B of Compound 1I.

FIG. 170 depicts an X-ray powder diffractogram for Form C of Compound 1I.

FIG. 171 depicts thermogravimetrical analysis (TGA) and differential scanning calorimetry (DSC) thermogram plots of Form C of Compound 1I.

FIG. 172 depicts a ¹H NMR spectrum of Form C of Compound 1I.

FIG. 173 depicts an X-ray powder diffractogram for Form D of Compound 1I.

FIG. 174 depicts thermogravimetrical analysis (TGA) and differential scanning calorimetry (DSC) thermogram plots of Form D of Compound 1I.

FIG. 175 depicts a ¹H NMR spectrum of Form D of Compound 1I.

FIG. 176 depicts an X-ray powder diffractogram for the starting material 1-(4-(4-((3-(3,6-Difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt for the freeform of the salt.

FIG. 177 depicts thermogravimetrical analysis (TGA) and differential scanning calorimetry (DSC) thermogram plots for the starting material 1-(4-(4-((3-(3,6-Difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt for the freeform of the salt.

FIG. 178 depicts a ¹H NMR spectrum using DMSO-d₆ for the starting material 1-(4-(4-((3-(3,6-Difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt for the freeform of the salt.

FIG. 179 depicts a ¹H NMR spectrum using D₂O for the starting material 1-(4-(4-((3-(3,6-Difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt for the freeform of the salt.

FIG. 180 depicts X-ray powder diffractogram of scaled-up Form E of Compound 1A.

FIG. 181 depicts thermogravimetrical analysis (TGA) and differential scanning calorimetry (DSC) thermogram plots of scaled-up Form E of Compound 1A.

FIG. 182 depicts a ¹H NMR spectrum of scaled-up Form E of Compound 1A.

FIG. 183 depicts X-ray powder diffractogram of scaled-up Form A of Compound 1E.

FIG. 184 depicts thermogravimetrical analysis (TGA) and differential scanning calorimetry (DSC) thermogram plots of scaled-up Form A of Compound 1E.

FIG. 185 depicts a ¹H NMR spectrum of scaled-up Form A of Compound 1E.

FIG. 186 depicts X-ray powder diffractogram of scaled-up Form A of Compound 1G.

FIG. 187 depicts thermogravimetrical analysis (TGA) and differential scanning calorimetry (DSC) thermogram plots of scaled-up Form A of Compound 1G.

FIG. 188 depicts a ¹H NMR spectrum of scaled-up Form A of Compound 1G.

FIG. 189 depicts X-ray powder diffractogram of scaled-up Form C of Compound 1H.

FIG. 190 depicts thermogravimetrical analysis (TGA) and differential scanning calorimetry (DSC) thermogram plots of scaled-up Form C of Compound 1H.

FIG. 191 depicts a ¹H NMR spectrum of scaled-up Form C of Compound 1H.

FIG. 192 depicts differential scanning calorimetry (DSC) thermogram plots collected at 25° C. between 0 and 95% RH for Form E of Compound 1A.

FIG. 193 depicts X-ray powder diffractogram comparison before and after DVS test for Form E of Compound 1A.

FIG. 194 depicts differential scanning calorimetry (DSC) thermogram plots collected at 25° C. between 0 and 95% RH for Form A of Compound 1E.

FIG. 195 depicts X-ray powder diffractogram comparison before and after DVS test for Form A of Compound 1E.

FIG. 196 depicts differential scanning calorimetry (DSC) thermogram plots collected at 25° C. between 0 and 95% RH for Form A of Compound 1G.

FIG. 197 depicts X-ray powder diffractogram comparison before and after DVS test for Form A of Compound 1G.

FIG. 198 depicts differential scanning calorimetry (DSC) thermogram plots collected at 25° C. between 0 and 95% RH for Form C of Compound 1H.

FIG. 199 depicts X-ray powder diffractogram comparison before and after DVS test for Form C of Compound 1H.

FIG. 200 depicts X-ray powder diffractograms after storage for 1 week at 25° C./60% RH and 40° C./75% RH for Form E of Compound 1A.

FIG. 201 depicts X-ray powder diffractograms after storage for 1 week at 25° C./60% RH and 40° C./75% RH for Form A of Compound 1E.

FIG. 202 depicts X-ray powder diffractograms after storage for 1 week at 25° C./60% RH and 40° C./75% RH for Form A of Compound 1G.

FIG. 203 depicts X-ray powder diffractograms after storage for 1 week at 25° C./60% RH and 40° C./75% RH for Form C of Compound 1H.

### 6. DETAILED DESCRIPTION

### 6.1. Definitions

As used herein, the term “Compound 1” refers to 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt, which has the following structure:

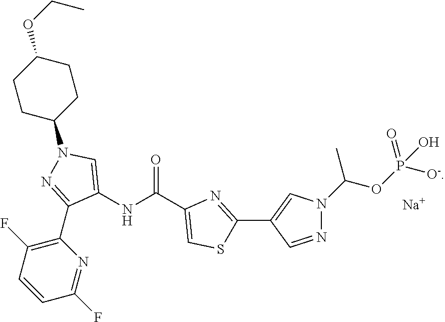

As used herein, the term “Compound 1A” refers to a potassium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate or 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate potassium salt.

As used herein, the term “Compound 1B” refers to a magnesium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate or 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate magnesium salt.

As used herein, the term “Compound 1C” refers to a calcium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate or 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate calcium salt.

As used herein, the term “Compound 1D” refers to an ammonium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate or 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate ammonium salt.

As used herein, the term “Compound 1E” refers to an arginine salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate or 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate arginine salt.

As used herein, the term “Compound 1F” refers to a lysine salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate or 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate lysine salt.

As used herein, the term “Compound 1G” refers to a choline salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate or 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate choline salt.

As used herein, the term “Compound 1H” refers to a tris salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate or 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate tris salt.

As used herein, the term “Compound 1I” refers to 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate (freeform).

As used herein and unless otherwise specified, the terms “solid form” and related terms refer to a physical form which is not predominantly in a liquid or a gaseous state. For example, as used herein and unless otherwise specified, the term “solid form” and related terms, when used in reference to Compound 1, refer to a physical form comprising Compound 1 which is not predominantly in a liquid or a gaseous state. The solid forms may be crystalline, amorphous, or mixtures thereof. In particular embodiments, solid forms may be liquid crystals. A “single-component” solid form comprising Compound 1 consists essentially of Compound 1. A “multiple-component” solid form comprising Compound 1 comprises a significant quantity of one or more additional species, such as ions and/or molecules, within the solid form. Multiple-component solid forms comprising Compound 1 include co-crystals, solvates (e.g., hydrates), and clathrates of Compound 1. In particular embodiments, the term “solid form comprising Compound 1” and related terms include single-component and multiple-component solid forms comprising Compound 1. In particular embodiments, “solid forms comprising Compound 1” and related terms include crystal forms comprising Compound 1, amorphous forms comprising Compound 1, and mixtures thereof.

As used herein and unless otherwise specified, the term “crystalline” and related terms used herein, when used to describe a compound, substance, modification, material, component or product, unless otherwise specified, mean that the compound, substance, modification, material, component or product is substantially crystalline as determined by X-ray diffraction. See, e.g., Remington: The Science and Practice of Pharmacy, 21^{st} edition, Lippincott, Williams and Wilkins, Baltimore, MD (2005); The United States Pharmacopeia, 23^{rd} ed., 1843-1844 (1995).

As used herein and unless otherwise specified, the term “crystal forms,” “crystalline forms” and related terms herein refer to solid forms that are crystalline. Crystal forms include single-component crystal forms and multiple-component crystal forms, and include polymorphs, solvates, hydrates, and/or other molecular complexes. In certain embodiments, a crystal form of a substance may be substantially free of amorphous forms and/or other crystal forms. In certain embodiments, a crystal form of a substance may contain less than about 1%, 2%, 3%, 4%, 5%, 6%, 7%, 8%, 9%, 10%, 15%, 20%, 25%, 30%, 35%, 40%, 45% or 50% of one or more amorphous forms and/or other crystal forms on a weight basis. In certain embodiments, a crystal form of a substance may be physically and/or chemically pure. In certain embodiments, a crystal form of a substance may be about 99%, 98%, 97%, 96%, 95%, 94%, 93%, 92%, 91% or 90% physically and/or chemically pure.

As used herein and unless otherwise specified, the terms “polymorphs,” “polymorphic forms” and related terms herein, refer to two or more crystal forms that consist essentially of the same molecule, molecules, and/or ions. Like different crystal forms, different polymorphs may have different physical properties such as, e.g., melting temperature, heat of fusion, solubility, dissolution properties and/or vibrational spectra, as a result of the arrangement or conformation of the molecules and/or ions in the crystal lattice. The differences in physical properties may affect pharmaceutical parameters such as storage stability, compressibility and density (important in formulation and product manufacturing), and dissolution rate (an important factor in bioavailability). Differences in stability can result from changes in chemical reactivity (e.g., differential oxidation, such that a dosage form discolors more rapidly when comprised of one polymorph than when comprised of another polymorph) or mechanical changes (e.g., tablets crumble on storage as a kinetically favored polymorph converts to thermodynamically more stable polymorph) or both (e.g., tablets of one polymorph are more susceptible to breakdown at high humidity). As a result of solubility/dissolution differences, in the extreme case, some solid-state transitions may result in lack of potency or, at the other extreme, toxicity. In addition, the physical properties may be important in processing (e.g., one polymorph might be more likely to form solvates or might be difficult to filter and wash free of impurities, and particle shape and size distribution might be different between polymorphs).

As used herein and unless otherwise specified, the terms “solvate” and “solvated,” refer to a crystal form of a substance which contains solvent. The terms “hydrate” and “hydrated” refer to a solvate wherein the solvent comprises water. “Polymorphs of solvates” refers to the existence of more than one crystal form for a particular solvate composition. Similarly, “polymorphs of hydrates” refers to the existence of more than one crystal form for a particular hydrate composition. The term “desolvated solvate,” as used herein, refers to a crystal form of a substance which may be prepared by removing the solvent from a solvate.

As used herein and unless otherwise specified, the term “amorphous,” “amorphous form,” and related terms used herein, mean that the substance, component or product in question is not substantially crystalline as determined by X-ray diffraction. In particular, the term “amorphous form” describes a disordered solid form, i.e., a solid form lacking long range crystalline order. In certain embodiments, an amorphous form of a substance may be substantially free of other amorphous forms and/or crystal forms. In other embodiments, an amorphous form of a substance may contain less than about 1%, 2%, 3%, 4%, 5%, 10%, 15%, 20%, 25%, 30%, 35%, 40%, 45% or 50% of one or more other amorphous forms and/or crystal forms on a weight basis. In certain embodiments, an amorphous form of a substance may be physically and/or chemically pure. In certain embodiments, an amorphous form of a substance be about 99%, 98%, 97%, 96%, 95%, 94%, 93%, 92%, 91% or 90% physically and/or chemically pure.

Techniques for characterizing crystal forms and amorphous forms include, but are not limited to, thermal gravimetric analysis (TGA), differential scanning calorimetry (DSC), X-ray powder diffractometry (XRPD), single-crystal X-ray diffractometry, vibrational spectroscopy, e.g., infrared (IR) and Raman spectroscopy, solid-state and solution nuclear magnetic resonance (NMR) spectroscopy, optical microscopy, hot stage optical microscopy, scanning electron microscopy (SEM), electron crystallography and quantitative analysis, particle size analysis (PSA), surface area analysis, solubility measurements, dissolution measurements, elemental analysis, and Karl Fischer analysis. Characteristic unit cell parameters may be determined using one or more techniques such as, but not limited to, X-ray diffraction and neutron diffraction, including single-crystal diffraction and powder diffraction. Techniques useful for analyzing powder diffraction data include profile refinement, such as Rietveld refinement, which may be used, e.g., to analyze diffraction peaks associated with a single phase in a sample comprising more than one solid phase. Other methods useful for analyzing powder diffraction data include unit cell indexing, which allows one of skill in the art to determine unit cell parameters from a sample comprising crystalline powder.

As used herein and unless otherwise specified, the terms “about” and “approximately,” when used in connection with a numeric value or a range of values which is provided to characterize a particular solid form, e.g., a specific temperature or temperature range, such as, e.g., that describing a DSC or TGA thermal event, including, e.g., melting, dehydration, desolvation or glass transition events; a mass change, such as, e.g., a mass change as a function of temperature or humidity; a solvent or water content, in terms of, e.g., mass or a percentage; or a peak position, such as, e.g., in analysis by IR or Raman spectroscopy or XRPD; indicate that the value or range of values may deviate to an extent deemed reasonable to one of ordinary skill in the art while still describing the particular solid form. For example, in particular embodiments, the terms “about” and “approximately,” when used in this context and unless otherwise specified, indicate that the numeric value or range of values may vary within 25%, 20%, 15%, 10%, 9%, 8%, 7%, 6%, 5%, 4%, 3%, 2%, 1.5%, 1%, 0.5%, or 0.25% of the recited value or range of values.

In one embodiment with respect to XRPD peaks, “approximately” means±0.2 degrees two theta (° 2θ).

As used herein and unless otherwise specified, a sample comprising a particular crystal form or amorphous form that is “substantially pure,” e.g., substantially free of other solid forms and/or of other chemical compounds, contains, in particular embodiments, less than about 25%, 20%, 15%, 10%, 9%, 8%, 7%, 6%, 5%, 4%, 3%, 2%, 1%, 0.9%, 0.8%, 0.75%, 0.7%, 0.6%, 0.5%, 0.4%, 0.3%, 0.25%, 0.2% or 0.1% percent by weight of one or more other solid forms and/or of other chemical compounds.

As used herein and unless otherwise specified, a sample or composition that is “substantially free” of one or more other solid forms and/or other chemical compounds means that the composition contains, in particular embodiments, less than about 25%, 20%, 15%, 10%, 9%, 8%, 7%, 6%, 5%, 4%, 3%, 2%, 1%, 0.9%, 0.8%, 0.75%, 0.7%, 0.6%, 0.5%, 0.4%, 0.3%, 0.25%, 0.2% or 0.1% percent by weight of one or more other solid forms and/or other chemical compounds.

As used herein, an amount of a compound effective to treat a disorder, or a “therapeutically effective amount” refers to an amount of the compound which is effective, upon single or multiple dose administration to a subject, in treating a cell, or in curing, alleviating, relieving or improving a subject with a disorder beyond that expected in the absence of such treatment.

The term “subject” or “patient” refers to an animal, including, but not limited to, a mammal, including a primate (e.g., human), cow, sheep, goat, horse, dog, cat, rabbit, rat, or mouse. The terms “subject” and “patient” are used interchangeably herein in reference, for example, to a mammalian subject, such as a human subject.

As used herein, and unless otherwise specified, the terms “treat,” “treating” and “treatment” refer to the eradication or amelioration of a disease or disorder, or of one or more symptoms associated with the disease or disorder. In certain embodiments, the terms refer to minimizing the spread or worsening of the disease or disorder resulting from the administration of one or more prophylactic or therapeutic agents to a patient with such a disease or disorder. In some embodiments, the terms refer to the administration of a compound provided herein, with or without other additional active agent, after the onset of symptoms of the particular disease. In one embodiment, the disease is an auto-immune disease, an inflammatory disorder, a cardiovascular disease, a nerve disorder, a neurodegenerative disorder, an allergic disorder, asthma, pancreatitis, multi-organ failure, a kidney disease, platelet aggregation, cancer, transplantation, sperm motility, erythrocyte deficiency, graft rejection, a lung injury, a respiratory disease, an ischemic condition, bacterial infection or a viral infection.

As used herein, and unless otherwise specified, the terms “prevent,” “preventing” and “prevention” refer to the prevention of the onset, recurrence or spread of a disease or disorder, or of one or more symptoms thereof. In certain embodiments, the terms refer to the treatment with or administration of a compound provided herein, with or without other additional active compound, prior to the onset of symptoms, particularly to patients at risk of diseases or disorders provided herein. The terms encompass the inhibition or reduction of a symptom of the particular disease. Patients with familial history of a disease in particular are candidates for preventive regimens in certain embodiments. In addition, patients who have a history of recurring symptoms are also potential candidates for the prevention. In this regard, the term “prevention” may be interchangeably used with the term “prophylactic treatment.”

As used herein, and unless otherwise specified, the terms “manage,” “managing” and “management” refer to preventing or slowing the progression, spread or worsening of a disease or disorder, or of one or more symptoms thereof. Often, the beneficial effects that a patient derives from a prophylactic and/or therapeutic agent do not result in a cure of the disease or disorder. In this regard, the term “managing” encompasses treating a patient who had suffered from the particular disease in an attempt to prevent or minimize the recurrence of the disease.

As used herein, and unless otherwise specified, a “therapeutically effective amount” of a compound is an amount sufficient to provide a therapeutic benefit in the treatment and/or management of a disease or disorder, or to delay or minimize one or more symptoms associated with the disease or disorder. A therapeutically effective amount of a compound means an amount of therapeutic agent, alone or in combination with other therapies, which provides a therapeutic benefit in the treatment or management of the disease or disorder. The term “therapeutically effective amount” can encompass an amount that improves overall therapy, reduces or avoids symptoms or causes of disease or disorder, or enhances the therapeutic efficacy of another therapeutic agent.

As used herein, and unless otherwise specified, a “prophylactically effective amount” of a compound is an amount sufficient to prevent a disease or disorder, or prevent its recurrence. A prophylactically effective amount of a compound means an amount of therapeutic agent, alone or in combination with other agents, which provides a prophylactic benefit in the prevention of the disease. The term “prophylactically effective amount” can encompass an amount that improves overall prophylaxis or enhances the prophylactic efficacy of another prophylactic agent.

The terms “co-administration” and “in combination with” include the administration of two therapeutic agents (for example, a compound provided herein and another anti-cancer agent) either simultaneously, concurrently or sequentially with no specific time limits. In one embodiment, both agents are present in the cell or in the patient's body at the same time or exert their biological or therapeutic effect at the same time. In one embodiment, the two therapeutic agents are in the same composition or unit dosage form. In another embodiment, the two therapeutic agents are in separate compositions or unit dosage forms.

The term “the supportive care agent” refers to any substance that treats, prevents and/or manages an adverse effect from treatment with the solid form of Compound 1.

The term “biological therapy” refers to administration of biological therapeutics such as cord blood, stem cells, growth factors and the like.

The term “composition” as used herein is intended to encompass a product comprising the specified ingredients (and in the specified amounts, if indicated), as well as any product which results, directly or indirectly, from combination of the specified ingredients in the specified amounts. By “pharmaceutically acceptable” it is meant that the diluent, excipient or carrier must be compatible with the other ingredients of the formulation and not deleterious to the recipient thereof.

A “pharmaceutically acceptable excipient,” refers to a substance that aids the administration of an active agent to a subject by for example modifying the stability of an active agent or modifying the absorption by a subject upon administration. A pharmaceutically acceptable excipient typically has no significant adverse toxicological effect on the patient. Examples of pharmaceutically acceptable excipients include, for example bulking agents, buffers, binders, fillers, disintegrants, lubricants, coatings, sweeteners, flavors, fatty acid esters, hydroxymethycellulose, polyvinyl pyrrolidine, colors, solvents, antioxidants, preservatives, wetting agents, surfactants, and coatings and the like. One of skill in the art will recognize that other pharmaceutical excipients known in the art are useful in the present invention and include those listed in for example the Handbook of Pharmaceutical Excipients, Rowe R. C., Shesky P. J., and Quinn M. E., 6^{th} Ed., The Pharmaceutical Press, RPS Publishing (2009). The terms “bulking agent”, and “buffer” are used in accordance with the plain and ordinary meaning within the art.

It should be noted that if there is a discrepancy between a depicted structure and a name given that structure, the depicted structure is to be accorded more weight. In addition, if the stereochemistry of a structure or a portion of a structure is not indicated with, for example, bold or dashed lines, the structure or portion of the structure is to be interpreted as encompassing all stereoisomers of it.

In certain embodiments, the disclosure relates to solid forms of Compound 1, which is 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium, as well as methods of using, and compositions comprising, a solid form of Compound 1. For example, the present disclosure encompasses the in vitro and in vivo use of a solid form of Compound 1, and the incorporation of a solid form of Compound 1 into pharmaceutical compositions and single unit dosage forms useful in the treatment and prevention of a variety of diseases and disorders.

In certain embodiments, the disclosure relates to solid forms of Compound 1A, which is a potassium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate, as well as methods of using, and compositions comprising, a solid form of Compound 1A. For example, the present disclosure encompasses the in vitro and in vivo use of a solid form of Compound 1A, and the incorporation of a solid form of Compound 1A into pharmaceutical compositions and single unit dosage forms useful in the treatment and prevention of a variety of diseases and disorders.

In certain embodiments, the disclosure relates to solid forms of Compound 1B, which is a magnesium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate, as well as methods of using, and compositions comprising, a solid form of Compound 1B. For example, the present disclosure encompasses the in vitro and in vivo use of a solid form of Compound 1B, and the incorporation of a solid form of Compound 1B into pharmaceutical compositions and single unit dosage forms useful in the treatment and prevention of a variety of diseases and disorders.

In certain embodiments, the disclosure relates to solid forms of Compound 1C, which is a calcium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate, as well as methods of using, and compositions comprising, a solid form of Compound 1C. For example, the present disclosure encompasses the in vitro and in vivo use of a solid form of Compound 1C, and the incorporation of a solid form of Compound 1C into pharmaceutical compositions and single unit dosage forms useful in the treatment and prevention of a variety of diseases and disorders.

In certain embodiments, the disclosure relates to solid forms of Compound 1D, which is a ammonium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate, as well as methods of using, and compositions comprising, a solid form of Compound 1D. For example, the present disclosure encompasses the in vitro and in vivo use of a solid form of Compound 1D, and the incorporation of a solid form of Compound 1D into pharmaceutical compositions and single unit dosage forms useful in the treatment and prevention of a variety of diseases and disorders.

In certain embodiments, the disclosure relates to solid forms of Compound 1E, which is a arginine salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate, as well as methods of using, and compositions comprising, a solid form of Compound 1E. For example, the present disclosure encompasses the in vitro and in vivo use of a solid form of Compound 1E, and the incorporation of a solid form of Compound 1E into pharmaceutical compositions and single unit dosage forms useful in the treatment and prevention of a variety of diseases and disorders.

In certain embodiments, the disclosure relates to solid forms of Compound 1F, which is a lysine salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate, as well as methods of using, and compositions comprising, a solid form of Compound 1F. For example, the present disclosure encompasses the in vitro and in vivo use of a solid form of Compound 1F, and the incorporation of a solid form of Compound 1F into pharmaceutical compositions and single unit dosage forms useful in the treatment and prevention of a variety of diseases and disorders.

In certain embodiments, the disclosure relates to solid forms of Compound 1G, which is a choline salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate, as well as methods of using, and compositions comprising, a solid form of Compound 1G. For example, the present disclosure encompasses the in vitro and in vivo use of a solid form of Compound 1G, and the incorporation of a solid form of Compound 1G into pharmaceutical compositions and single unit dosage forms useful in the treatment and prevention of a variety of diseases and disorders.

In certain embodiments, the disclosure relates to solid forms of Compound 1H, which is a tris salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate, as well as methods of using, and compositions comprising, a solid form of Compound 1H. For example, the present disclosure encompasses the in vitro and in vivo use of a solid form of Compound 1H, and the incorporation of a solid form of Compound 1H into pharmaceutical compositions and single unit dosage forms useful in the treatment and prevention of a variety of diseases and disorders.

In certain embodiments, the disclosure relates to solid forms of Compound 1I, which is 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate, as well as methods of using, and compositions comprising, a solid form of Compound 1I. For example, the present disclosure encompasses the in vitro and in vivo use of a solid form of Compound 1I, and the incorporation of a solid form of Compound 1I into pharmaceutical compositions and single unit dosage forms useful in the treatment and prevention of a variety of diseases and disorders.

### 6.2. Exemplary Solid Forms

In one embodiment, provided herein are solid forms of Compound 1, Compound 1A, Compound 1B, Compound 1C, Compound 1D, Compound 1E, Compound 1F, Compound 1G, Compound 1H and Compound 1I.

In one embodiment, provided herein are solid forms of Compound 1. Compound 1 can be prepared using the methods as described in U.S. Pat. No. 11,370,787 B2, the disclosure of which is incorporated herein by reference in its entirety.

The solid forms comprising Compound 1, Compound 1A, Compound 1B, Compound 1C, Compound 1D, Compound 1E, Compound 1F, Compound 1G, Compound 1H or Compound 1I provided herein include single-component and multiple-component forms, including crystal forms and amorphous forms.

Particular embodiments herein provide single-component amorphous solid forms of Compound 1. Particular embodiments herein provide single-component crystalline solid forms of Compound 1. Particular embodiments herein provide multiple-component amorphous forms comprising Compound 1. Particular embodiments herein provide multiple-component crystalline solid forms comprising Compound 1.

Particular embodiments herein provide single-component amorphous solid forms of Compound 1A. Particular embodiments herein provide single-component crystalline solid forms of Compound 1A. Particular embodiments herein provide multiple-component amorphous forms comprising Compound 1A. Particular embodiments herein provide multiple-component crystalline solid forms comprising Compound 1A.

Particular embodiments herein provide single-component amorphous solid forms of Compound 1B. Particular embodiments herein provide single-component crystalline solid forms of Compound 1B. Particular embodiments herein provide multiple-component amorphous forms comprising Compound 1B. Particular embodiments herein provide multiple-component crystalline solid forms comprising Compound 1B.

Particular embodiments herein provide single-component amorphous solid forms of Compound 1C. Particular embodiments herein provide single-component crystalline solid forms of Compound 1C. Particular embodiments herein provide multiple-component amorphous forms comprising Compound 1C. Particular embodiments herein provide multiple-component crystalline solid forms comprising Compound 1C.

Particular embodiments herein provide single-component amorphous solid forms of Compound 1D. Particular embodiments herein provide single-component crystalline solid forms of Compound 1D. Particular embodiments herein provide multiple-component amorphous forms comprising Compound 1D. Particular embodiments herein provide multiple-component crystalline solid forms comprising Compound 1D.

Particular embodiments herein provide single-component amorphous solid forms of Compound 1E. Particular embodiments herein provide single-component crystalline solid forms of Compound 1E. Particular embodiments herein provide multiple-component amorphous forms comprising Compound 1E. Particular embodiments herein provide multiple-component crystalline solid forms comprising Compound 1E.

Particular embodiments herein provide single-component amorphous solid forms of Compound 1F. Particular embodiments herein provide single-component crystalline solid forms of Compound 1F. Particular embodiments herein provide multiple-component amorphous forms comprising Compound 1F. Particular embodiments herein provide multiple-component crystalline solid forms comprising Compound 1F.

Particular embodiments herein provide single-component amorphous solid forms of Compound 1G. Particular embodiments herein provide single-component crystalline solid forms of Compound 1G. Particular embodiments herein provide multiple-component amorphous forms comprising Compound 1G. Particular embodiments herein provide multiple-component crystalline solid forms comprising Compound 1G.

Particular embodiments herein provide single-component amorphous solid forms of Compound 1H. Particular embodiments herein provide single-component crystalline solid forms of Compound 1H. Particular embodiments herein provide multiple-component amorphous forms comprising Compound 1H. Particular embodiments herein provide multiple-component crystalline solid forms comprising Compound 1H.

Particular embodiments herein provide single-component amorphous solid forms of Compound 1I. Particular embodiments herein provide single-component crystalline solid forms of Compound 1I. Particular embodiments herein provide multiple-component amorphous forms comprising Compound 1I. Particular embodiments herein provide multiple-component crystalline solid forms comprising Compound 1I.

The solid forms provided herein can be prepared by the methods described herein, including the methods described in the Examples below, or by techniques known in the art, including heating, cooling, freeze drying, lyophilization, quench cooling the melt, rapid solvent evaporation, slow solvent evaporation, solvent recrystallization, antisolvent addition, slurry recrystallization, crystallization from the melt, desolvation, recrystallization in confined spaces such as, e.g., in nanopores or capillaries, recrystallization on surfaces or templates such as, e.g., on polymers, recrystallization in the presence of additives, such as, e.g., co-crystal counter-molecules, desolvation, dehydration, rapid cooling, slow cooling, exposure to solvent and/or water, drying, including, e.g., vacuum drying, vapor diffusion, sublimation, grinding (including, e.g., cryo-grinding, solvent-drop grinding or liquid assisted grinding), microwave-induced precipitation, sonication-induced precipitation, laser-induced precipitation and precipitation from a supercritical fluid. The particle size of the resulting solid forms, which can vary, (e.g., from nanometer dimensions to millimeter dimensions), can be controlled, e.g., by varying crystallization conditions, such as, e.g., the rate of crystallization and/or the crystallization solvent system, or by particle-size reduction techniques, e.g., grinding, milling, micronizing or sonication.

While not intending to be bound by any particular theory, certain solid forms are characterized by physical properties, e.g., stability, solubility and dissolution rate, appropriate for pharmaceutical and therapeutic dosage forms. Moreover, while not wishing to be bound by any particular theory, certain solid forms are characterized by physical properties (e.g., density, compressibility, hardness, morphology, cleavage, stickiness, solubility, water uptake, electrical properties, thermal behavior, solid-state reactivity, physical stability, and chemical stability) affecting particular processes (e.g., yield, filtration, washing, drying, milling, mixing, tableting, flowability, dissolution, formulation, and lyophilization) which make certain solid forms suitable for the manufacture of a solid dosage form. Such properties can be determined using particular analytical chemical techniques, including solid-state analytical techniques (e.g., X-ray diffraction, microscopy, spectroscopy and thermal analysis), as described herein and known in the art.

The solid forms provided herein may be characterized using a number of methods known to a person having ordinary skill in the art, including, but not limited to, single crystal X-ray diffraction, X-ray powder diffraction (XRPD), microscopy (e.g., scanning electron microscopy (SEM)), thermal analysis (e.g., differential scanning calorimetry (DSC), thermal gravimetric analysis (TGA), and hot-stage microscopy), spectroscopy (e.g., infrared, Raman, and solid-state nuclear magnetic resonance), single differential thermal analysis (SDTA), high performance liquid chromatography coupled with mass spectroscopy (HPLC-MS), thermogravimetrical analysis coupled with single differential thermal analysis (TGA-SDTA), and thermogravimetric analysis coupled with mass spectroscopy (TGA-MS). The particle size and size distribution of the solid form provided herein may be determined by conventional methods, such as laser light scattering technique.

The purity of the solid forms provided herein may be determined by standard analytical methods, such as thin layer chromatography (TLC), gel electrophoresis, gas chromatography, high performance liquid chromatography (HPLC), and mass spectrometry (MS).

It should be understood that the numerical values of the peaks of an X-ray powder diffraction pattern may vary slightly from one machine to another or from one sample to another, and so the values quoted are not to be construed as absolute, but with an allowable variability, such as ±0.2 degrees two theta (° 2θ) (see United States Pharmacopoeia, page 2228 (2003)).

Certain embodiments herein provide compositions comprising one or more of the solid forms. Certain embodiments provide compositions of one or more solid forms in combination with other active ingredients. Certain embodiments provide methods of using these compositions in the treatment, prevention and/or management of diseases and disorders including, but not limited to, the diseases and disorders provided herein.

### 6.2.1. Form D of Compound 1

In certain embodiments, provided herein is Form D of Compound 1.

In one embodiment, Form D is a hydrated form of Compound 1. In another embodiment, Form D of Compound 1 is crystalline.

In certain embodiments, Form D is obtained by crystallization from certain solvent systems, for example, solvent systems comprising one or more of the following solvents: acetone and the solvent mixture of methanol and water at room temperature. In certain embodiments, Form D is obtained as an intermediate solid form from slurries of other forms, by exposing other forms to ambient conditions and storing other forms under ambient conditions for 17 or 18 days.

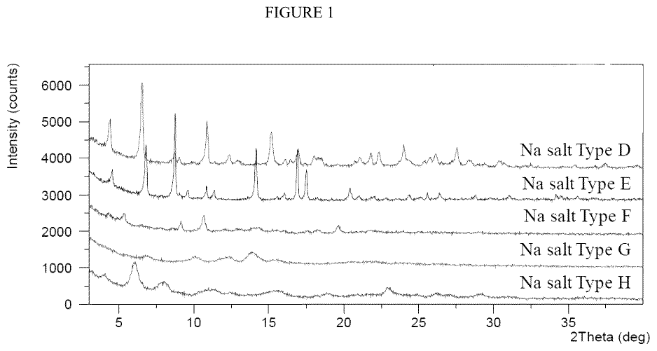

In certain embodiments, Form D is substantially crystalline, as indicated by, e.g., X-ray powder diffraction measurements. In one embodiment, Form D of Compound 1 has an X-ray powder diffraction pattern substantially as shown in FIG. 1.

In one embodiment, Form D of Compound 1 has one or more characteristic X-ray powder diffraction peaks at a two-theta angle of approximately 4.41, 6.55, 10.88, 15.17, 24.01 or 27.54 degrees 2θ as depicted in FIG. 1. In another embodiment, Form D of Compound 1 has one, two, three, four or five characteristic X-ray powder diffraction peaks at a two-theta angle of approximately 4.41, 6.55, 10.88, 15.17, or 27.54 degrees 2θ. In another embodiment, Form D of Compound 1 has one, two, three or four characteristic X-ray powder diffraction peaks at a two-theta angle of approximately 4.41, 6.55, 10.88 or 15.17 degrees 2θ. In another embodiment, Form D of Compound 1 has one, two, or three characteristic X-ray powder diffraction peaks at a two-theta angle of approximately 6.55, 10.88 or 15.17 degrees 2θ. In another embodiment, Form D of Compound 1 has one or more characteristic X-ray powder diffraction peaks as set forth in Table 18. In another embodiment, Form D of Compound 1 has one, two, three, four, five, six or seven characteristic X-ray powder diffraction peaks as set forth in Table 18. In another embodiment, Form D of Compound 1 has one, two, or three characteristic X-ray powder diffraction peaks as set forth in Table 18.

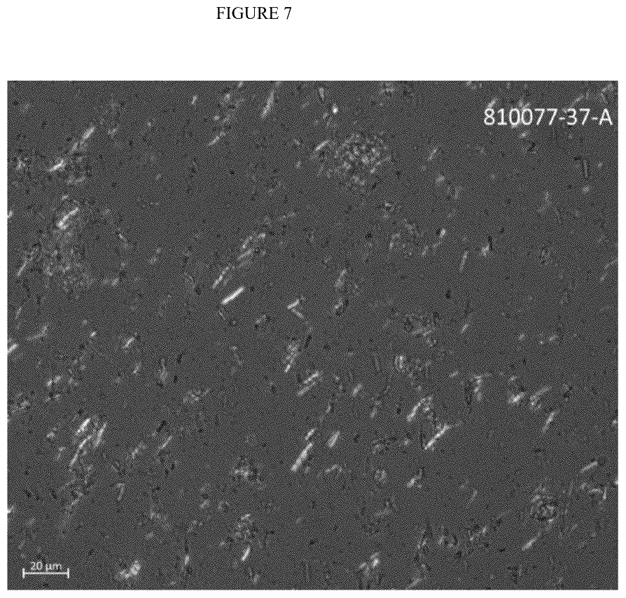

In one embodiment, Form D of Compound 1 has polarized light microscopic (PLM) picture as shown in FIG. 7.

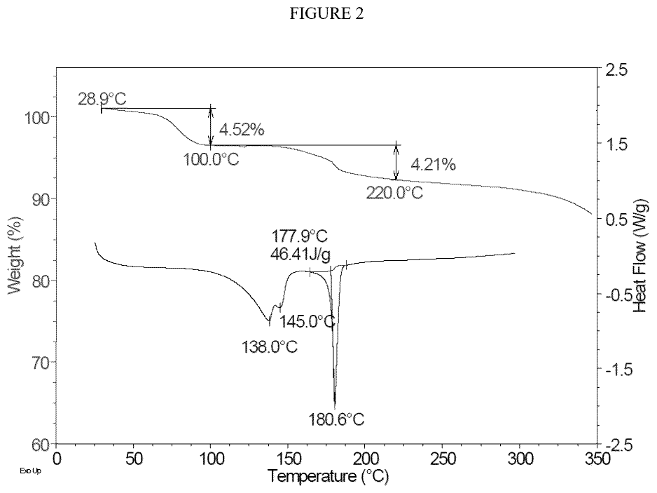

In one embodiment, provided herein is a solid form of Compound 1 having a thermogravimetric (TGA) thermograph corresponding substantially to the representative TGA thermogram as depicted in FIG. 2. In certain embodiments, Form D shows a TGA weight loss of about 6.5% up to about 100° C. In certain embodiments, Form D shows a TGA weight loss of about 4.5% between about 100° C. and 220° C. In certain embodiments, Form D shows a two step TGA weight loss of about 6.5% up to about 100° C., and about 4.5% between about 100° C. and 220° C.

In one embodiment, provided herein is solid Form D of Compound 1 having a DSC thermogram corresponding substantially as depicted in FIG. 2. In certain embodiments, Form D is characterized by a DSC plot comprising three endotherms at about 125.2° C., about 131.1° C. (peak) and about 177.5° C. (onset).

In certain embodiments, Form D remains unchanged after heating to 150° C. and cooling to room temperature.

In certain embodiments, Form D provides Form P after N₂ sweeping for 20 min at 30° C. In one embodiment, Form D provides Form Q upon heating to 150° C. and cooling to 30° C. with N₂ protection. In one embodiment, upon exposure to ambient conditions, Form Q provides Form D.

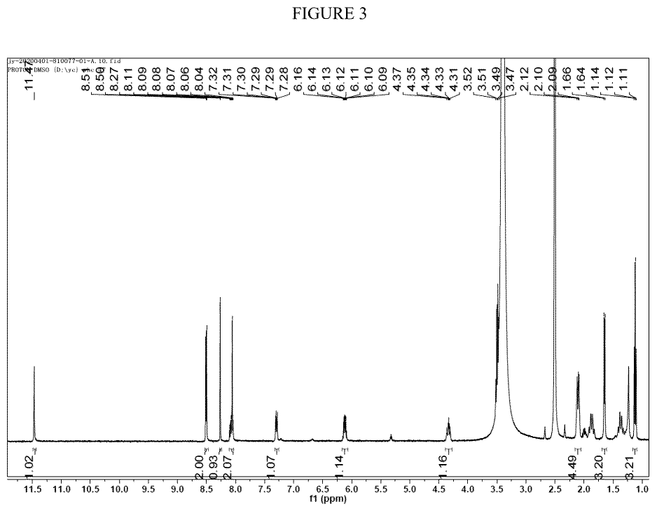

In one embodiment, Form D has ¹H NMR shown in FIG. 3.

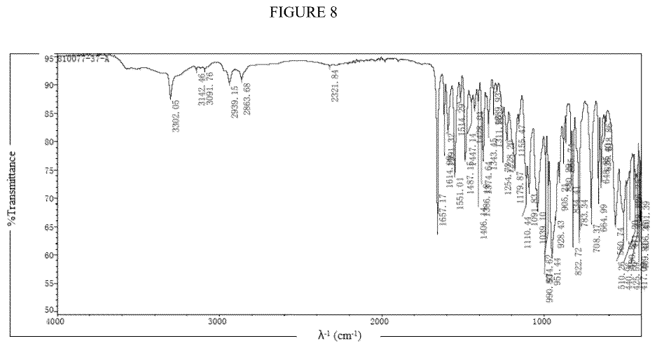

In one embodiment, Form D has FTIR spectrum provided in FIG. 8.

In one embodiment, Form D of Compound 1 is substantially pure. In certain embodiments, the substantially pure Form D of Compound 1 is substantially free of other solid forms, e.g., amorphous form. In certain embodiments, the purity of the substantially pure Form D of Compound 1 is no less than about 95% pure, no less than about 96% pure, no less than about 97% pure, no less than about 98% pure, no less than about 98.5% pure, no less than about 99% pure, no less than about 99.1% pure, no less than about 99.2% pure, no less than about 99.3% pure, no less than about 99.4% pure, no less than about 99.5% pure, no less than about 99.6% pure, no less than about 99.7% pure, no less than about 99.8% pure, or no less than about 99.9% pure.

Certain embodiments herein provide Form D of Compound 1 which is substantially pure. Certain embodiments herein provide Form D of Compound 1 which is substantially free of other solid forms comprising Compound 1 including, e.g., Forms E, J, L, U, O, Q, R, T, W, H, N, X, F, G, I, K, M, P, S, V, Y of Compound 1 as provided herein. Certain embodiments herein provide Form D as a mixture of solid forms comprising Compound 1, including, e.g., a mixture comprising one or more of the following: Forms E, J, L, U, O, Q, R, T, W, H, N, X, F, G, I, K, M, P, S, V of Compound 1 as provided herein.

Certain embodiments herein provide Form D of Compound 1 which is substantially free of other solid forms comprising Compound 1 including, e.g., Forms A, B, C, E, J, L, U, O, Q, R, T, W, H, N, X, F, G, I, K, M, P, S, V, Y, NP1, NP3, and NP4 of Compound 1 as provided herein. Certain embodiments herein provide Form D as a mixture of solid forms comprising Compound 1, including, e.g., a mixture comprising one or more of the following: Forms A, B, C, E, J, L, U, O, Q, R, T, W, H, N, X, F, G, I, K, M, P, S, V, Y, NP1, NP3, and NP4 of Compound 1 as provided herein.

### 6.2.2. Form E of Compound 1

In certain embodiments, provided herein is Form E of Compound 1.

In one embodiment, Form E is a hydrated form of Compound 1. In another embodiment, Form E of Compound 1 is crystalline.

In certain embodiments, Form E is obtained via slurry of Form D in 4-methyl-2-pentanone (MIBK) at about 50° C.

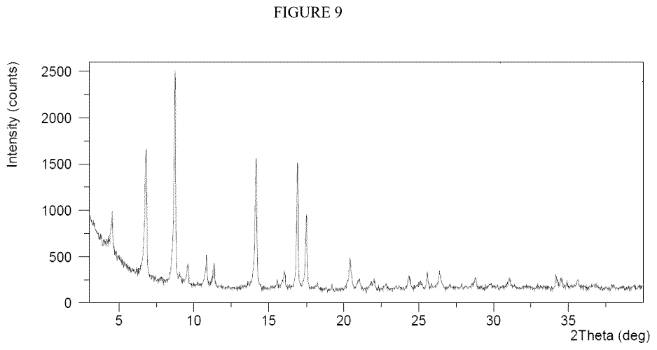

In certain embodiments, Form E is crystalline, as indicated by, e.g., X-ray powder diffraction measurements. In one embodiment, Form E of Compound 1 has an X-ray powder diffraction pattern substantially as shown in FIG. 9.

In one embodiment, Form E of Compound 1 has one or more characteristic X-ray powder diffraction peaks at a two-theta angle of approximately 8.64, 14.06, 16.81, 17.41, 25.47, 26.28, 34.07 or 34.39, degrees 2θ as depicted in FIG. 9. In another embodiment, Form E of Compound 1 has one, two, three, four or five characteristic X-ray powder diffraction peaks at a two-theta angle of approximately 8.64, 14.06, 16.81, 17.41 or 34.07 degrees 2θ. In another embodiment, Form E of Compound 1 has one, two, three or four characteristic X-ray powder diffraction peaks at a two-theta angle of approximately 8.64, 14.06, 16.81 or 17.41 degrees 2θ. In another embodiment, Form E of Compound 1 has one, two or three characteristic X-ray powder diffraction peaks at a two-theta angle of approximately 8.64, 16.81 or 17.41 degrees 2θ. In another embodiment, Form E of Compound 1 has one or more characteristic X-ray powder diffraction peaks as set forth in Table 20. In another embodiment, Form E of Compound 1 has one, two, three, four, five, six or seven characteristic X-ray powder diffraction peaks as set forth in Table 20. In another embodiment, Form E of Compound 1 has one, two, or three characteristic X-ray powder diffraction peaks as set forth in Table 20.

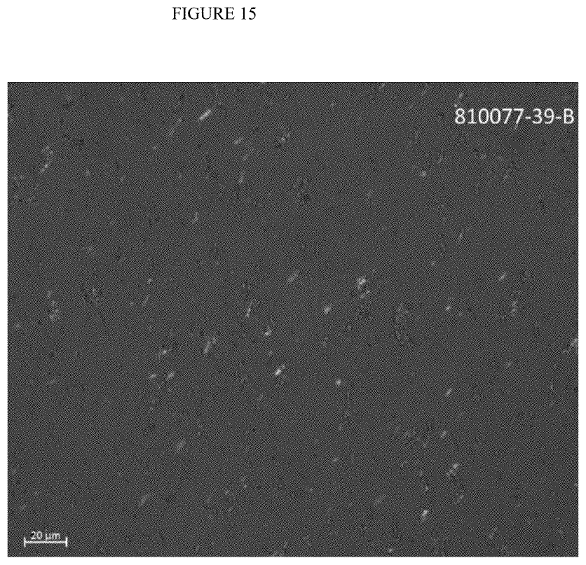

In one embodiment, Form E of Compound 1 has the PLM picture as shown in FIG. 15.

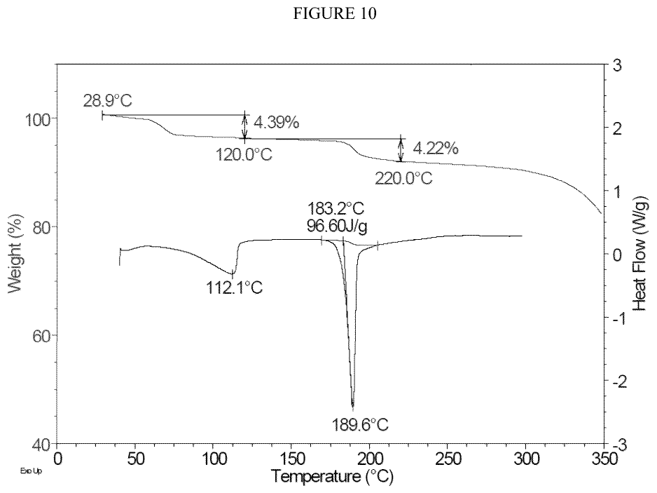

In one embodiment, provided herein is a solid form of Compound 1 having a thermogravimetric thermograph corresponding substantially to the representative TGA thermogram as depicted in FIG. 10. In certain embodiments, Form E shows a TGA weight loss of about 4.4% up to about 120° C. In certain embodiments, Form E shows a TGA weight loss of about 4.2% between about 120° C. and 220° C. In certain embodiments, Form E shows a two step TGA weight loss of about 4.4% up to about 120° C., and about 4.2% between about 120° C. and 220° C.

In one embodiment, provided herein is solid Form E of Compound 1 having a DSC thermogram corresponding substantially as depicted in FIG. 10. In certain embodiments, Form E is characterized by a DSC plot comprising two endotherms at about 112.1° C. (peak) and about 183.2° C. (onset).

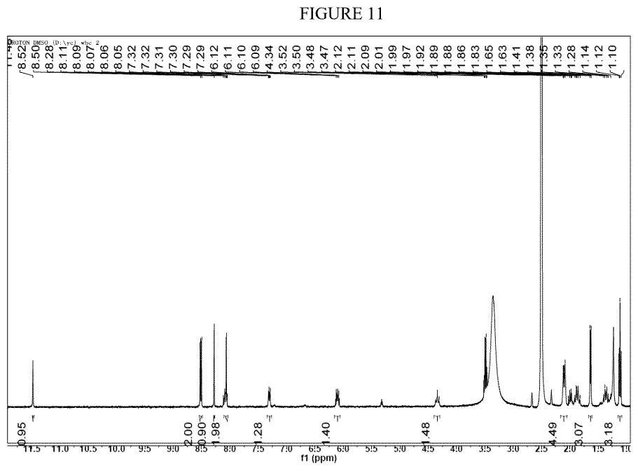

In certain embodiments, Form E shows no residual solvent (MIBK) by ¹H NMR (FIG. 11).

In certain embodiments, Form E has superior processing characteristics, as compared to the other forms of Compound 1. In certain embodiments, Form E has better bulk density (BD) as compared to the other forms of Compound 1. In certain embodiments, the bulk density (BD) of Form E helps flow and handling of the drug substance.

In one embodiment, Forms D and E exhibit higher bulk density and reduced impurity levels relative to other forms of Compound 1. In one embodiment, Form E has slightly higher bulk density and reduced “fluffiness” and better processing capability than the other solid forms of Compound 1. In one embodiment, Form E has slightly higher bulk density and reduced “fluffiness” and better processing capability than Form D of Compound 1.

In certain embodiments, Form E provides Form R after N₂ sweeping for 20 min at 30° C. In one embodiment, Form R remains unchanged upon heating to 150° C. and cooling to 30° C. with N₂ protection. In one embodiment, upon exposure to ambient conditions, Form R changes to Form E.

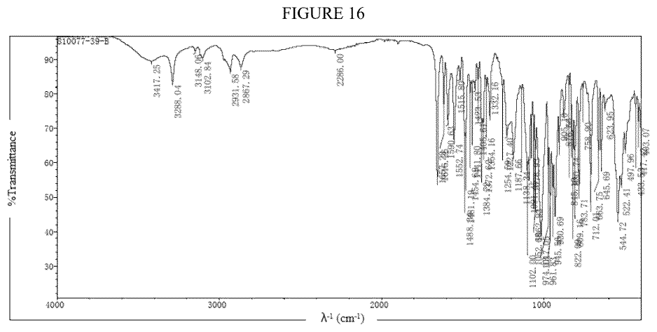

In one embodiment, Form E has FTIR spectrum provided in FIG. 16.

In still another embodiment, Form E of Compound 1 is substantially pure. In certain embodiments, the substantially pure Form E of Compound 1 is substantially free of other solid forms, e.g., amorphous form. In certain embodiments, the purity of the substantially pure Form E of Compound 1 is no less than about 95% pure, no less than about 96% pure, no less than about 97% pure, no less than about 98% pure, no less than about 98.5% pure, no less than about 99% pure, no less than about 99.1% pure, no less than about 99.2% pure, no less than about 99.3% pure, no less than about 99.4% pure, no less than about 99.5% pure, no less than about 99.6% pure, no less than about 99.7% pure, no less than about 99.8% pure, or no less than about 99.9% pure.

Certain embodiments herein provide Form E of Compound 1 which is substantially pure. Certain embodiments herein provide Form E of Compound 1 which is substantially free of other solid forms comprising Compound 1 including, e.g., Forms D, J, L, U, O, Q, R, T, W, H, N, X, F, G, I, K, M, P, S, V and Y of Compound 1 as provided herein. Certain embodiments herein provide Form E as a mixture of solid forms comprising Compound 1, including, e.g., a mixture comprising one or more of the following: Forms D, J, L, U, O, Q, R, T, W, H, N, X, F, G, I, K, M, P, S, V and Y of Compound 1 as provided herein.

Certain embodiments herein provide Form E of Compound 1 which is substantially free of other solid forms comprising Compound 1 including, e.g., Forms A, B, C, D, J, L, U, O, Q, R, T, W, H, N, X, F, G, I, K, M, P, S, V, Y, NP1, NP3, and NP4 of Compound 1 as provided herein. Certain embodiments herein provide Form E as a mixture of solid forms comprising Compound 1, including, e.g., a mixture comprising one or more of the following: Forms A, B, C, D, J, L, U, O, Q, R, T, W, H, N, X, F, G, I, K, M, P, S, V, Y, NP1, NP3, and NP4 of Compound 1 as provided herein.

### 6.2.3. Form J of Compound 1

In certain embodiments, provided herein is Form J of Compound 1.

In one embodiment, Form J is a hydrated form of Compound 1. In another embodiment, Form J of Compound 1 is crystalline.

In certain embodiments, Form J is obtained via slurry of Form D in methanol at room temperature.

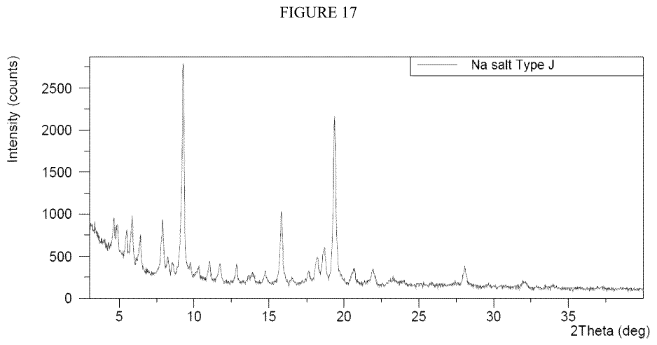

In certain embodiments, Form J is crystalline, as indicated by, e.g., X-ray powder diffraction measurements. In one embodiment, Form J of Compound 1 has an X-ray powder diffraction pattern substantially as shown in FIG. 17.

In one embodiment, Form J of Compound 1 has one or more characteristic X-ray powder diffraction peaks at a two-theta angle of approximately 5.87, 6.42, 7.89, 9.26, 15.82 or 19.37 degrees 2θ as depicted in FIG. 17. In another embodiment, Form J of Compound 1 has one, two, three, four or five characteristic X-ray powder diffraction peaks at a two-theta angle of approximately 5.87, 7.89, 9.26, 15.82 or 19.37 degrees 2θ. In another embodiment, Form J of Compound 1 has one, two, three or four characteristic X-ray powder diffraction peaks at a two-theta angle of approximately 7.89, 9.26, 15.82 or 19.37 degrees 2θ. In another embodiment, Form D of Compound 1 has one, two, or three characteristic X-ray powder diffraction peaks at a two-theta angle of approximately 9.26, 15.82 or 19.37 degrees 2θ. In another embodiment, Form J of Compound 1 has one or more characteristic X-ray powder diffraction peaks as set forth in Table 22. In another embodiment, Form J of Compound 1 has one, two, three, four, five, six or seven characteristic X-ray powder diffraction peaks as set forth in Table 22. In another embodiment, Form J of Compound 1 has one, two, or three characteristic X-ray powder diffraction peaks as set forth in Table 22.

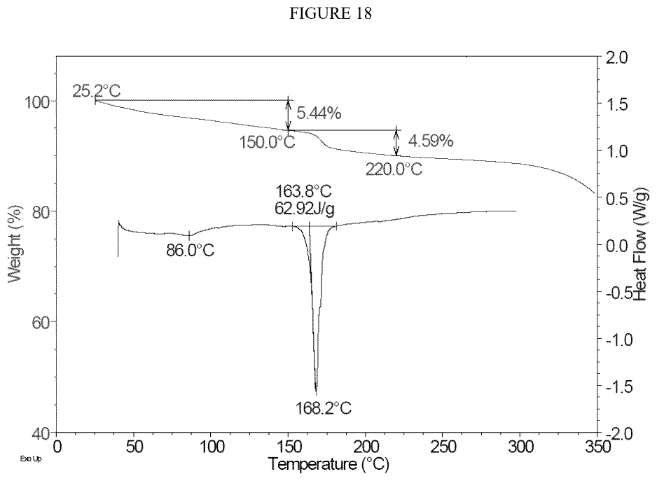

In one embodiment, provided herein is a solid form of Compound 1 having a thermogravimetric thermograph corresponding substantially to the representative TGA thermogram as depicted in FIG. 18. In certain embodiments, Form J shows a TGA weight loss of about 5.4% up to about 150° C. In certain embodiments, Form J shows a TGA weight loss of about 4.6% between about 150° C. and 220° C. In certain embodiments, Form J shows a two step TGA weight loss of about 5.4% up to about 150° C., and about 4.6% between about 150° C. and 220° C.

In one embodiment, provided herein is solid Form J of Compound 1 having a DSC thermogram corresponding substantially as depicted in FIG. 18. In certain embodiments, Form J is characterized by a DSC plot comprising two endotherms at about 86° C. (peak) and about 163.8° C. (onset).

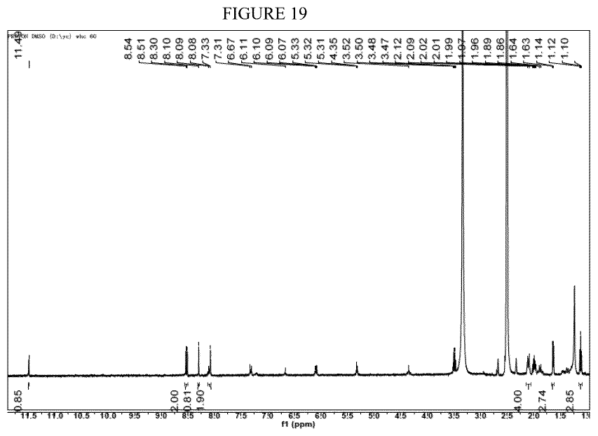

In certain embodiments, Form J shows no residual solvent (MeOH) by ¹H NMR (FIG. 19).

In certain embodiments, Form J provides Form O upon heating to 130° C. and cooling to 30° C. with N₂ protection. In one embodiment, upon exposure to ambient conditions, Form O changes to Form J.

In still another embodiment, Form J of Compound 1 is substantially pure. In certain embodiments, the substantially pure Form J of Compound 1 is substantially free of other solid forms, e.g., amorphous form. In certain embodiments, the purity of the substantially pure Form J of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form J of Compound 1 which is substantially pure. Certain embodiments herein provide Form J of Compound 1 which is substantially free of other solid forms comprising Compound 1 including, e.g., Forms D, E, L, U, O, Q, R, T, W, H, N, X, F, G, I, K, M, P, S, V and Y of Compound 1 as provided herein. Certain embodiments herein provide Form J as a mixture of solid forms comprising Compound 1, including, e.g., a mixture comprising one or more of the following: Forms D, E, L, U, O, Q, R, T, W, H, N, X, F, G, I, K, M, P, S, V and Y of Compound 1 as provided herein.

Certain embodiments herein provide Form J of Compound 1 which is substantially free of other solid forms comprising Compound 1 including, e.g., Forms A, B, C, D, E, L, U, O, Q, R, T, W, H, N, X, F, G, I, K, M, P, S, V, Y, NP1, NP3, and NP4 of Compound 1 as provided herein. Certain embodiments herein provide Form J as a mixture of solid forms comprising Compound 1, including, e.g., a mixture comprising one or more of the following: Forms A, B, C, D, E, L, U, O, Q, R, T, W, H, N, X, F, G, I, K, M, P, S, V, Y, NP1, NP3, and NP4 of Compound 1 as provided herein.

### 6.2.4. Form L of Compound 1

In certain embodiments, provided herein is Form L of Compound 1.

In one embodiment, Form L is a hydrated form of Compound 1. In another embodiment, Form L of Compound 1 is crystalline.

In certain embodiments, Form L is obtained by adding anti-solvent ACN into THF/H₂O (1:1, v/v) solution of Form D.

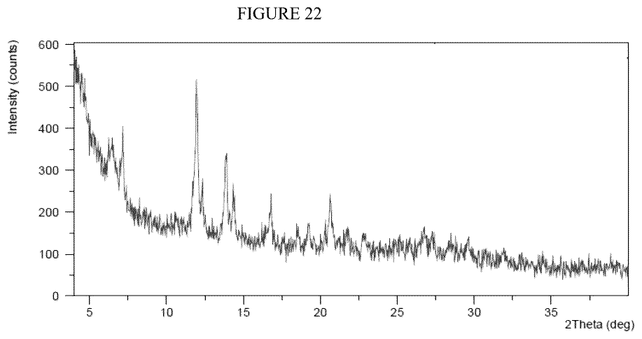

In certain embodiments, Form L is crystalline, as indicated by, e.g., X-ray powder diffraction measurements. In one embodiment, Form L of Compound 1 has an X-ray powder diffraction pattern substantially as shown in FIG. 22.

In one embodiment, Form L of Compound 1 has one or more characteristic X-ray powder diffraction peaks at a two-theta angle of approximately 6.45, 7.16, 11.97, 13.87, 14.35, 16.79, 20.62 or 26.75 as depicted in FIG. 22. In another embodiment, Form L of Compound 1 has one, two, three, four or five characteristic X-ray powder diffraction peaks at a two-theta angle of approximately 7.16, 11.97, 13.87, 14.35 or 20.62 degrees 2θ. In another embodiment, Form L of Compound 1 has one, two, three or four characteristic X-ray powder diffraction peaks at a two-theta angle of approximately 7.16, 11.97, 13.87 or 20.62 degrees 2θ. In another embodiment, Form L of Compound 1 has one, two or three characteristic X-ray powder diffraction peaks at a two-theta angle of approximately 7.16, 11.97 or 13.87 degrees 2θ. In another embodiment, Form L of Compound 1 has one or more characteristic X-ray powder diffraction peaks as set forth in Table 23. In another embodiment, Form L of Compound 1 has one, two, three, four, five, six or seven characteristic X-ray powder diffraction peaks as set forth in Table 23. In another embodiment, Form L of Compound 1 has one, two, or three characteristic X-ray powder diffraction peaks as set forth in Table 23.

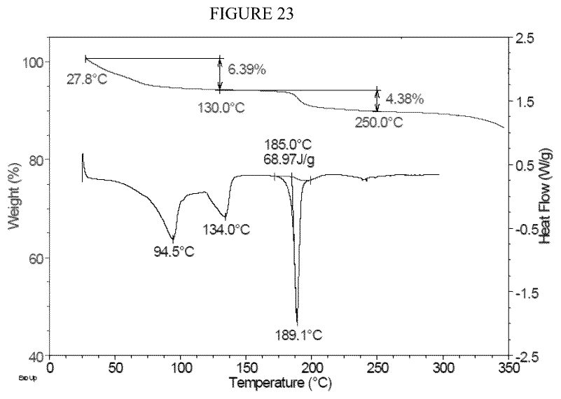

In one embodiment, provided herein is a solid form of Compound 1 having a thermogravimetric thermograph corresponding substantially to the representative TGA thermogram as depicted in FIG. 23. In certain embodiments, Form L shows a TGA weight loss of about 6.4% up to about 130° C. In certain embodiments, Form L shows a TGA weight loss of about 4.4% between about 130° C. and 250° C. In certain embodiments, Form L shows a two step TGA weight loss of about 5.4% up to about 150° C., and about 4.4% between about 130° C. and 250° C.

In one embodiment, provided herein is solid Form L of Compound 1 having a DSC thermogram corresponding substantially as depicted in FIG. 23. In certain embodiments, Form L is characterized by a DSC plot comprising three endotherms at about 94.5° C., about 134.0° C. (peak) and about 185.0° C. (onset).

In certain embodiments, Form L shows no residual solvent (ACN or THF) by ¹H NMR.

In certain embodiments, Form L provides Form V upon N₂ sweeping for about 20 min at about 30° C. In certain embodiments, Form L provides Form W upon heating to about 150° C. and cooling to about 30° C. with N₂ protection, followed by exposed to ambient condition for about 30 min.

In still another embodiment, Form L of Compound 1 is substantially pure. In certain embodiments, the substantially pure Form L of Compound 1 is substantially free of other solid forms, e.g., amorphous form. In certain embodiments, the purity of the substantially pure Form L of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form L of Compound 1 which is substantially pure. Certain embodiments herein provide Form L of Compound 1 which is substantially free of other solid forms comprising Compound 1 including, e.g., Forms D, E, J, U, O, Q, R, T, W, H, N, X, F, G, I, K, M, P, S, V and Y of Compound 1 as provided herein. Certain embodiments herein provide Form L as a mixture of solid forms comprising Compound 1, including, e.g., a mixture comprising one or more of the following: Forms D, E, J, U, O, Q, R, T, W, H, N, X, F, G, I, K, M, P, S, V and Y of Compound 1 as provided herein.

Certain embodiments herein provide Form L of Compound 1 which is substantially free of other solid forms comprising Compound 1 including, e.g., Forms A, B, C, D, E, J, U, O, Q, R, T, W, H, N, X, F, G, I, K, M, P, S, V, Y, NP1, NP3, and NP4 of Compound 1 as provided herein. Certain embodiments herein provide Form L as a mixture of solid forms comprising Compound 1, including, e.g., a mixture comprising one or more of the following: Forms A, B, C, D, E, J, U, O, Q, R, T, W, H, N, X, F, G, I, K, M, P, S, V, Y, NP1, NP3, and NP4 of Compound 1 as provided herein.

### 6.2.5. Form U of Compound 1

In certain embodiments, provided herein is Form U of Compound 1.

In one embodiment, Form U is a hydrated form of Compound 1. In another embodiment, Form U of Compound 1 is crystalline.

In certain embodiments, Form U is obtained by hearing Form N to 150° C. and cooling to 30° C. with N₂ protection, followed by exposure to ambient conditions for 30 min.

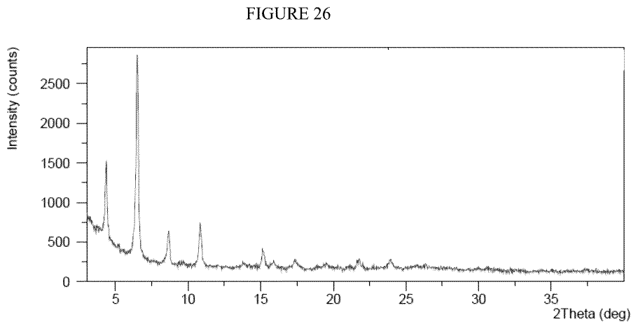

In certain embodiments, Form U is crystalline, as indicated by, e.g., X-ray powder diffraction measurements. In one embodiment, Form U of Compound 1 has an X-ray powder diffraction pattern substantially as shown in FIG. 26.

In one embodiment, Form U of Compound 1 has one or more characteristic X-ray powder diffraction peaks at a two-theta angle of approximately 4.36, 6.50, 8.66 or 10.83 as depicted in FIG. 26. In another embodiment, Form U of Compound 1 has one, two or three characteristic X-ray powder diffraction peaks at a two-theta angle of approximately 4.36, 6.50 or 10.83 degrees 2θ. In another embodiment, Form U of Compound 1 has one or more characteristic X-ray powder diffraction peaks as set forth in Table 24. In another embodiment, Form U of Compound 1 has one, two, three, four or five characteristic X-ray powder diffraction peaks as set forth in Table 24. In another embodiment, Form U of Compound 1 has one, two, or three characteristic X-ray powder diffraction peaks as set forth in Table 24.

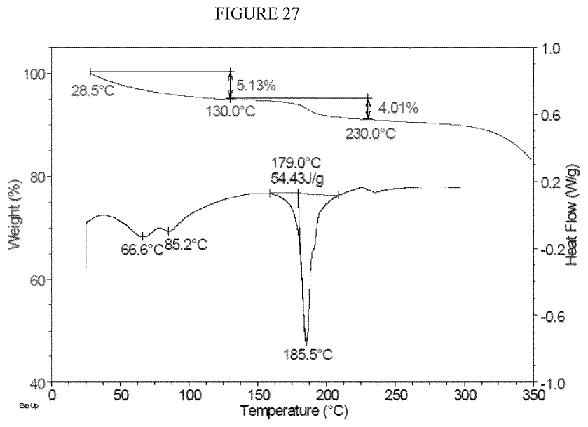

In one embodiment, provided herein is a solid form of Compound 1 having a thermogravimetric thermograph corresponding substantially to the representative TGA thermogram as depicted in FIG. 27. In certain embodiments, Form U shows a TGA weight loss of about 5.1% up to about 130° C. In certain embodiments, Form U shows a TGA weight loss of about 4.0% between about 130° C. and 230° C. In certain embodiments, Form U shows a two step TGA weight loss of about 5.1% up to about 130° C. and about 4.0% between about 130° C. and about 230° C.

In one embodiment, provided herein is solid Form U of Compound 1 having a DSC thermogram corresponding substantially as depicted in FIG. 27. In certain embodiments, Form U is characterized by a DSC plot comprising three endotherms at about 66.6° C., about 85.2° C. (peak) and about 179.0° C. (onset).

In still another embodiment, Form U of Compound 1 is substantially pure. In certain embodiments, the substantially pure Form U of Compound 1 is substantially free of other solid forms, e.g., amorphous form. In certain embodiments, the purity of the substantially pure Form U of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form U of Compound 1 which is substantially pure. Certain embodiments herein provide Form U of Compound 1 which is substantially free of other solid forms comprising Compound 1 including, e.g., Forms D, E, J, L, O, Q, R, T, W, H, N, X, F, G, I, K, M, P, S, V and Y of Compound 1 as provided herein. Certain embodiments herein provide Form U as a mixture of solid forms comprising Compound 1, including, e.g., a mixture comprising one or more of the following: Forms D, E, J, L, O, Q, R, T, W, H, N, X, F, G, I, K, M, P, S, V and Y of Compound 1 as provided herein.

Certain embodiments herein provide Form U of Compound 1 which is substantially free of other solid forms comprising Compound 1 including, e.g., Forms A, B, C, D, E, J, L, O, Q, R, T, W, H, N, X, F, G, I, K, M, P, S, V, Y, NP1, NP3, and NP4 of Compound 1 as provided herein. Certain embodiments herein provide Form U as a mixture of solid forms comprising Compound 1, including, e.g., a mixture comprising one or more of the following: Forms A, B, C, D, E, J, L, O, Q, R, T, W, H, N, X, F, G, I, K, M, P, S, V, Y, NP1, NP3, and NP4 of Compound 1 as provided herein.

### 6.2.6. Form O of Compound 1

In certain embodiments, provided herein is Form O of Compound 1.

In one embodiment, Form O is an anhydrate of Compound 1. In another embodiment, Form O of Compound 1 is crystalline.

In certain embodiments, Form O is obtained by hearing Form J to 130° C. and cooling to 30° C. with N₂ protection. In certain embodiments, Form O converts to Form J upon exposure to ambient conditions.

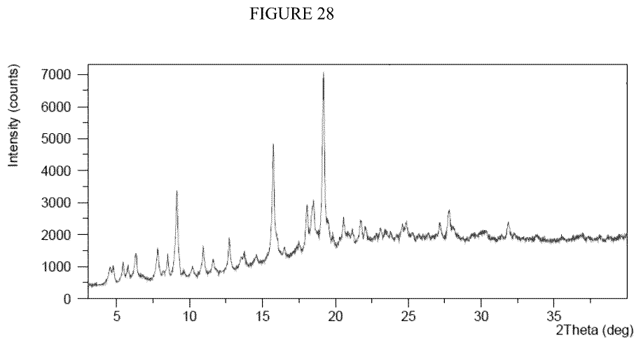

In certain embodiments, Form O is crystalline, as indicated by, e.g., X-ray powder diffraction measurements. In one embodiment, Form O of Compound 1 has an X-ray powder diffraction pattern substantially as shown in FIG. 28.

In one embodiment, Form O of Compound 1 has one or more characteristic X-ray powder diffraction peaks at a two-theta angle of approximately 9.12, 10.94, 12.71, 15.72, 18.04, 18.40, 19.17 or 27.79 as depicted in FIG. 28. In another embodiment, Form O of Compound 1 has one, two, three or four characteristic X-ray powder diffraction peaks at a two-theta angle of approximately 9.12, 15.72, 18.04 or 19.17 degrees 2θ. In another embodiment, Form O of Compound 1 has one, two or three characteristic X-ray powder diffraction peaks at a two-theta angle of approximately 9.12, 15.72 or 19.17 degrees 2θ. In another embodiment, Form O of Compound 1 has one or more characteristic X-ray powder diffraction peaks as set forth in Table 25. In another embodiment, Form O of Compound 1 has one, two, three, four, five, six or seven characteristic X-ray powder diffraction peaks as set forth in Table 25. In another embodiment, Form O of Compound 1 has one, two, or three characteristic X-ray powder diffraction peaks as set forth in Table 25.

In still another embodiment, Form O of Compound 1 is substantially pure. In certain embodiments, the substantially pure Form O of Compound 1 is substantially free of other solid forms, e.g., amorphous form. In certain embodiments, the purity of the substantially pure Form O of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form O of Compound 1 which is substantially pure. Certain embodiments herein provide Form O of Compound 1 which is substantially free of other solid forms comprising Compound 1 including, e.g., Forms D, E, J, L, U, Q, R, T, W, H, N, X, F, G, I, K, M, P, S, V and Y of Compound 1 as provided herein. Certain embodiments herein provide Form O as a mixture of solid forms comprising Compound 1, including, e.g., a mixture comprising one or more of the following: Forms D, E, J, L, U, Q, R, T, W, H, N, X, F, G, I, K, M, P, S, V and Y of Compound 1 as provided herein.

Certain embodiments herein provide Form O of Compound 1 which is substantially free of other solid forms comprising Compound 1 including, e.g., Forms A, B, C, D, E, J, L, U, Q, R, T, W, H, N, X, F, G, I, K, M, P, S, V, Y, NP1, NP3, and NP4 of Compound 1 as provided herein. Certain embodiments herein provide Form O as a mixture of solid forms comprising Compound 1, including, e.g., a mixture comprising one or more of the following: Forms A, B, C, D, E, J, L, U, Q, R, T, W, H, N, X, F, G, I, K, M, P, S, V, Y, NP1, NP3, and NP4 of Compound 1 as provided herein.

### 6.2.7. Form Q of Compound 1

In certain embodiments, provided herein is Form Q of Compound 1.

In one embodiment, Form Q is an anhydrate of Compound 1. In another embodiment, Form Q of Compound 1 is crystalline.

In certain embodiments, Form Q is obtained by hearing Form D to 150° C. and cooling to 30° C. with N₂ protection. In certain embodiments, Form Q converts to Form D upon exposure to ambient conditions.

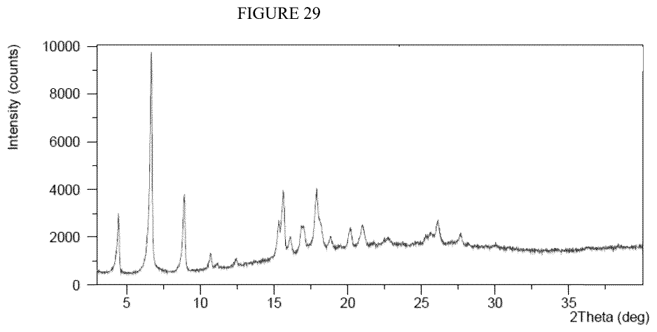

In certain embodiments, Form Q is crystalline, as indicated by, e.g., X-ray powder diffraction measurements. In one embodiment, Form Q of Compound 1 has an X-ray powder diffraction pattern substantially as shown in FIG. 29.

In one embodiment, Form Q of Compound 1 has one or more characteristic X-ray powder diffraction peaks at a two-theta angle of approximately 6.68, 6.69, 8.91, 8.93, 15.62 or 17.88 as depicted in FIG. 29. In another embodiment, Form Q of Compound 1 has one, two, three or four characteristic X-ray powder diffraction peaks at a two-theta angle of approximately 6.68, 6.69, 8.91 or 17.88 degrees 2θ. In another embodiment, Form Q of Compound 1 has one, two or three characteristic X-ray powder diffraction peaks at a two-theta angle of approximately 6.68, 6.69 or 8.91 degrees 2θ. In another embodiment, Form Q of Compound 1 has one or more characteristic X-ray powder diffraction peaks as set forth in Table 26. In another embodiment, Form Q of Compound 1 has one, two, three, four, five, six or seven characteristic X-ray powder diffraction peaks as set forth in Table 26. In another embodiment, Form Q of Compound 1 has one, two, or three characteristic X-ray powder diffraction peaks as set forth in Table 26.

In still another embodiment, Form Q of Compound 1 is substantially pure. In certain embodiments, the substantially pure Form Q of Compound 1 is substantially free of other solid forms, e.g., amorphous form. In certain embodiments, the purity of the substantially pure Form Q of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form Q of Compound 1 which is substantially pure. Certain embodiments herein provide Form Q of Compound 1 which is substantially free of other solid forms comprising Compound 1 including, e.g., Forms D, E, J, L, U, O, R, T, W, H, N, X, F, G, I, K, M, P, S, V and Y of Compound 1 as provided herein. Certain embodiments herein provide Form Q as a mixture of solid forms comprising Compound 1, including, e.g., a mixture comprising one or more of the following: Forms D, E, J, L, U, O, R, T, W, H, N, X, F, G, I, K, M, P, S, V and Y of Compound 1 as provided herein.

Certain embodiments herein provide Form Q of Compound 1 which is substantially free of other solid forms comprising Compound 1 including, e.g., Forms A, B, C, D, E, J, L, U, O, R, T, W, H, N, X, F, G, I, K, M, P, S, V, Y, NP1, NP3, and NP4 of Compound 1 as provided herein. Certain embodiments herein provide Form Q as a mixture of solid forms comprising Compound 1, including, e.g., a mixture comprising one or more of the following: Forms A, B, C, D, E, J, L, U, O, R, T, W, H, N, X, F, G, I, K, M, P, S, V, Y, NP1, NP3, and NP4 of Compound 1 as provided herein.

### 6.2.8. Form R of Compound 1

In certain embodiments, provided herein is Form R of Compound 1.

In one embodiment, Form R is an anhydrate of Compound 1. In another embodiment, Form R of Compound 1 is crystalline.

In certain embodiments, Form R is obtained by N₂ sweeping of Form E at 30° C. for 20 min.

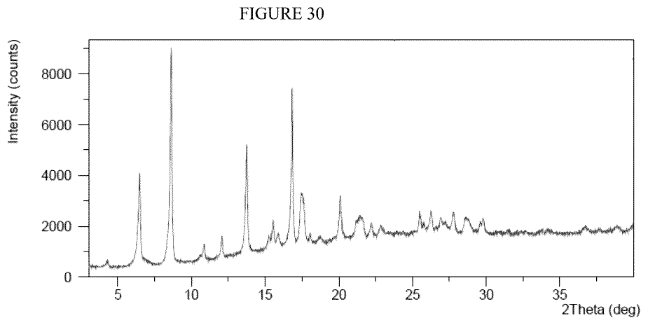

In certain embodiments, Form R is crystalline, as indicated by, e.g., X-ray powder diffraction measurements. In one embodiment, Form R of Compound 1 has an X-ray powder diffraction pattern substantially as shown in FIG. 30.

In one embodiment, Form R of Compound 1 has one or more characteristic X-ray powder diffraction peaks at a two-theta angle of approximately 6.47, 8.62, 13.73, 16.82, 17.45 or 20.08 as depicted in FIG. 30. In another embodiment, Form R of Compound 1 has one, two, three or four characteristic X-ray powder diffraction peaks at a two-theta angle of approximately 6.47, 8.62, 13.73 or 16.82 degrees 2θ. In another embodiment, Form R of Compound 1 has one, two or three characteristic X-ray powder diffraction peaks at a two-theta angle of approximately 8.62, 13.73 or 16.82 degrees 2θ. In another embodiment, Form R of Compound 1 has one or more characteristic X-ray powder diffraction peaks as set forth in Table 27. In another embodiment, Form R of Compound 1 has one, two, three, four, five, six or seven characteristic X-ray powder diffraction peaks as set forth in Table 27. In another embodiment, Form R of Compound 1 has one, two, or three characteristic X-ray powder diffraction peaks as set forth in Table 27.

In still another embodiment, Form R of Compound 1 is substantially pure. In certain embodiments, the substantially pure Form R of Compound 1 is substantially free of other solid forms, e.g., amorphous form. In certain embodiments, the purity of the substantially pure Form R of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form R of Compound 1 which is substantially pure. Certain embodiments herein provide Form R of Compound 1 which is substantially free of other solid forms comprising Compound 1 including, e.g., Forms D, E, J, L, U, O, Q, T, W, H, N, X, F, G, I, K, M, P, S, V and Y of Compound 1 as provided herein. Certain embodiments herein provide Form R as a mixture of solid forms comprising Compound 1, including, e.g., a mixture comprising one or more of the following: Forms D, E, J, L, U, O, Q, T, W, H, N, X, F, G, I, K, M, P, S, V and Y of Compound 1 as provided herein.

Certain embodiments herein provide Form R of Compound 1 which is substantially free of other solid forms comprising Compound 1 including, e.g., Forms A, B, C, D, E, J, L, U, O, Q, T, W, H, N, X, F, G, I, K, M, P, S, V, Y, NP1, NP3, and NP4 of Compound 1 as provided herein. Certain embodiments herein provide Form R as a mixture of solid forms comprising Compound 1, including, e.g., a mixture comprising one or more of the following: Forms A, B, C, D, E, J, L, U, O, Q, T, W, H, N, X, F, G, I, K, M, P, S, V, Y, NP1, NP3, and NP4 of Compound 1 as provided herein.

### 6.2.9. Form T of Compound 1

In certain embodiments, provided herein is Form T of Compound 1.

In one embodiment, Form T is an anhydrate of Compound 1. In another embodiment, Form T of Compound 1 is crystalline.

In certain embodiments, Form T is obtained by hearing Form N to 150° C. and cooling to 30° C. with N₂ protection. In certain embodiments, Form T converts to Form U upon exposure to ambient conditions.

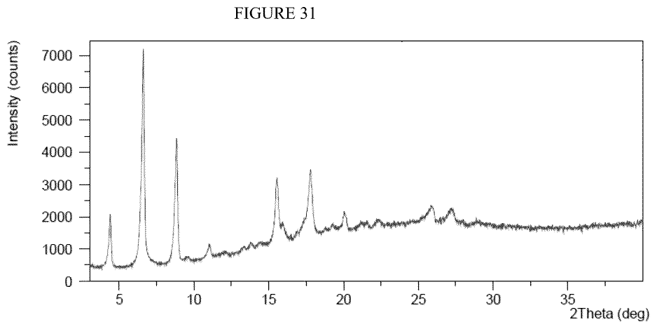

In certain embodiments, Form T is crystalline, as indicated by, e.g., X-ray powder diffraction measurements. In one embodiment, Form T of Compound 1 has an X-ray powder diffraction pattern substantially as shown in FIG. 31.

In one embodiment, Form T of Compound 1 has one or more characteristic X-ray powder diffraction peaks at a two-theta angle of approximately 4.40, 6.60, 8.83, 15.54 or 17.79 as depicted in FIG. 31. In another embodiment, Form T of Compound 1 has one, two, three or four characteristic X-ray powder diffraction peaks at a two-theta angle of approximately 6.60, 8.83, 15.54 or 17.79 degrees 2θ. In another embodiment, Form T of Compound 1 has one, two or three characteristic X-ray powder diffraction peaks at a two-theta angle of approximately 6.60, 8.83 or 15.54 degrees 2θ. In another embodiment, Form T of Compound 1 has one or more characteristic X-ray powder diffraction peaks as set forth in Table 28. In another embodiment, Form T of Compound 1 has one, two, three, four, five, six or seven characteristic X-ray powder diffraction peaks as set forth in Table 28. In another embodiment, Form T of Compound 1 has one, two, or three characteristic X-ray powder diffraction peaks as set forth in Table 28.

In still another embodiment, Form T of Compound 1 is substantially pure. In certain embodiments, the substantially pure Form T of Compound 1 is substantially free of other solid forms, e.g., amorphous form. In certain embodiments, the purity of the substantially pure Form T of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form T of Compound 1 which is substantially pure. Certain embodiments herein provide Form T of Compound 1 which is substantially free of other solid forms comprising Compound 1 including, e.g., Forms D, E, J, L, U, O, Q, R, W, H, N, X, F, G, I, K, M, P, S, V and Y of Compound 1 as provided herein. Certain embodiments herein provide Form T as a mixture of solid forms comprising Compound 1, including, e.g., a mixture comprising one or more of the following: Forms D, E, J, L, U, O, Q, R, W, H, N, X, F, G, I, K, M, P, S, V and Y of Compound 1 as provided herein.

Certain embodiments herein provide Form T of Compound 1 which is substantially free of other solid forms comprising Compound 1 including, e.g., Forms A, B, C, D, E, J, L, U, O, Q, R, W, H, N, X, F, G, I, K, M, P, S, V, Y, NP1, NP3, and NP4 of Compound 1 as provided herein. Certain embodiments herein provide Form T as a mixture of solid forms comprising Compound 1, including, e.g., a mixture comprising one or more of the following: Forms A, B, C, D, E, J, L, U, O, Q, R, W, H, N, X, F, G, I, K, M, P, S, V, Y, NP1, NP3, and NP4 of Compound 1 as provided herein.

### 6.2.10. Form W of Compound 1

In certain embodiments, provided herein is Form W of Compound 1.

In one embodiment, Form W is an anhydrate of Compound 1. In another embodiment, Form W of Compound 1 is crystalline.

In certain embodiments, Form W is obtained by hearing Form L to 150° C. and cooling to 30° C. with N₂ protection, followed by exposure to ambient conditions.

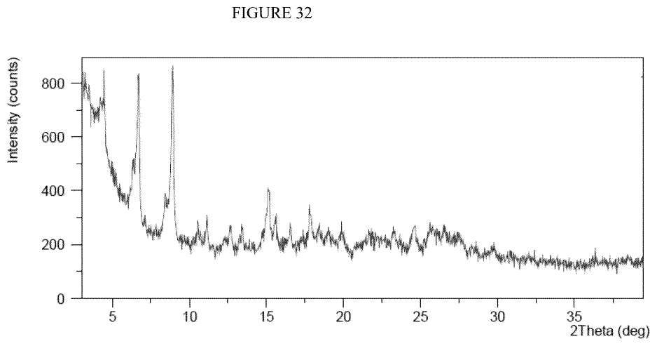

In certain embodiments, Form W is crystalline, as indicated by, e.g., X-ray powder diffraction measurements. In one embodiment, Form W of Compound 1 has an X-ray powder diffraction pattern substantially as shown in FIG. 32.

In one embodiment, Form W of Compound 1 has one or more characteristic X-ray powder diffraction peaks at a two-theta angle of approximately 4.47, 6.33, 6.70, 8.42, 8.92, 15.14 or 17.86 as depicted in FIG. 32. In another embodiment, Form W of Compound 1 has one, two, three or four characteristic X-ray powder diffraction peaks at a two-theta angle of approximately 4.47, 6.70, 8.92 or 15.14 degrees 2θ. In another embodiment, Form W of Compound 1 has one, two or three characteristic X-ray powder diffraction peaks at a two-theta angle of approximately 4.47, 6.70 or 8.92 degrees 2θ. In another embodiment, Form W of Compound 1 has one or more characteristic X-ray powder diffraction peaks as set forth in Table 29. In another embodiment, Form W of Compound 1 has one, two, three, four, five, six or seven characteristic X-ray powder diffraction peaks as set forth in Table 29. In another embodiment, Form W of Compound 1 has one, two, or three characteristic X-ray powder diffraction peaks as set forth in Table 29.

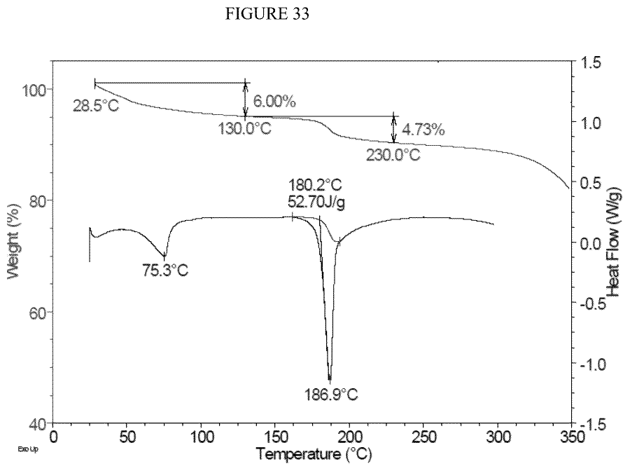

In one embodiment, provided herein is a solid form of Compound 1 having a thermogravimetric thermograph corresponding substantially to the representative TGA thermogram as depicted in FIG. 33. In certain embodiments, Form W shows a TGA weight loss of about 6.0% up to about 130° C. In certain embodiments, Form W shows a TGA weight loss of about 4.7% between about 130° C. and 230° C. In certain embodiments, Form W shows a two step TGA weight loss of about 6.0% up to about 130° C. and about 4.7% between about 130° C. and about 230° C.

In one embodiment, provided herein is solid Form W of Compound 1 having a DSC thermogram corresponding substantially as depicted in FIG. 33. In certain embodiments, Form W is characterized by a DSC plot comprising two endotherms at about 75.3° C. (peak) and about 180.2° C. (onset).

In still another embodiment, Form W of Compound 1 is substantially pure. In certain embodiments, the substantially pure Form W of Compound 1 is substantially free of other solid forms, e.g., amorphous form. In certain embodiments, the purity of the substantially pure Form W of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form W of Compound 1 which is substantially pure. Certain embodiments herein provide Form W of Compound 1 which is substantially free of other solid forms comprising Compound 1 including, e.g., Forms D, E, J, L, U, O, Q, R, T, H, N, X, F, G, I, K, M, P, S, V and Y of Compound 1 as provided herein. Certain embodiments herein provide Form T as a mixture of solid forms comprising Compound 1, including, e.g., a mixture comprising one or more of the following: Forms D, E, J, L, U, O, Q, R, T, H, N, X, F, G, I, K, M, P, S, V and Y of Compound 1 as provided herein.

Certain embodiments herein provide Form W of Compound 1 which is substantially free of other solid forms comprising Compound 1 including, e.g., Forms A, B, C, D, E, J, L, U, O, Q, R, T, H, N, X, F, G, I, K, M, P, S, V, Y, NP1, NP3, and NP4 of Compound 1 as provided herein. Certain embodiments herein provide Form W as a mixture of solid forms comprising Compound 1, including, e.g., a mixture comprising one or more of the following: Forms A, B, C, D, E, J, L, U, O, Q, R, T, H, N, X, F, G, I, K, M, P, S, V, Y, NP1, NP3, and NP4 of Compound 1 as provided herein.

### 6.2.11. Form H of Compound 1

In certain embodiments, provided herein is Form H of Compound 1.

In one embodiment, Form H is a solvate of Compound 1. In another embodiment, Form H of Compound 1 is crystalline.

In certain embodiments, Form H is obtained via adding anti-solvent 1,4-dioxane into MeOH/DCM (1:1, v/v) solution of Form D.

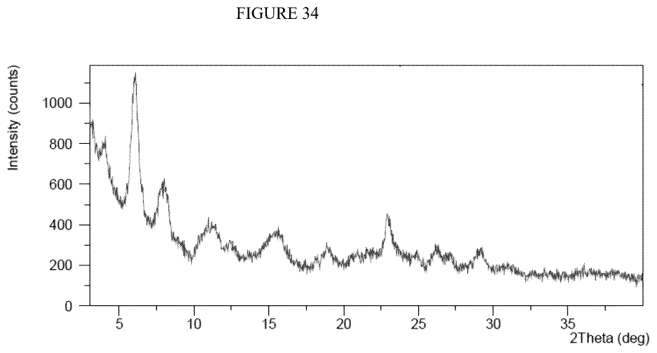

In certain embodiments, Form H is crystalline, as indicated by, e.g., X-ray powder diffraction measurements. In one embodiment, Form H of Compound 1 has an X-ray powder diffraction pattern substantially as shown in FIG. 34.

In one embodiment, Form H of Compound 1 has one or more characteristic X-ray powder diffraction peaks at a two-theta angle of approximately 4.05, 6.06, 7.96, 10.97, 15.51, 22.94 or 29.31 as depicted in FIG. 34. In another embodiment, Form H of Compound 1 has one, two, three or four characteristic X-ray powder diffraction peaks at a two-theta angle of approximately 6.06, 7.96, 15.51 or 22.94 degrees 2θ. In another embodiment, Form H of Compound 1 has one, two or three characteristic X-ray powder diffraction peaks at a two-theta angle of approximately 6.06, 7.96 or 22.94 degrees 2θ. In another embodiment, Form H of Compound 1 has one or more characteristic X-ray powder diffraction peaks as set forth in Table 30. In another embodiment, Form H of Compound 1 has one, two, three, four, five, six or seven characteristic X-ray powder diffraction peaks as set forth in Table 30. In another embodiment, Form H of Compound 1 has one, two, or three characteristic X-ray powder diffraction peaks as set forth in Table 30.

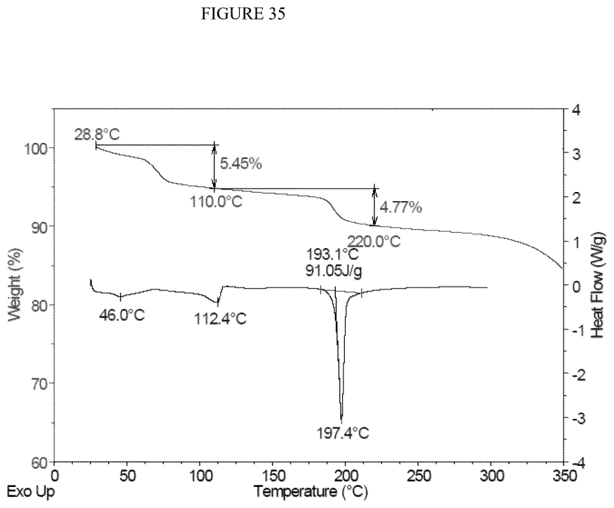

In one embodiment, provided herein is a solid form of Compound 1 having a thermogravimetric thermograph corresponding substantially to the representative TGA thermogram as depicted in FIG. 35. In certain embodiments, Form H shows a TGA weight loss of about 5.5% up to about 110° C. In certain embodiments, Form H shows a TGA weight loss of about 4.8% between about 130° C. and 230° C. In certain embodiments, Form H shows a two step TGA weight loss of about 5.5% up to about 110° C. and about 4.8% between about 110° C. and about 220° C.

In one embodiment, provided herein is solid Form H of Compound 1 having a DSC thermogram corresponding substantially as depicted in FIG. 35. In certain embodiments, Form H is characterized by a DSC plot comprising three endotherms at about 46.0° C., about 112.4° C. (peak) and about 193.1° C. (onset).

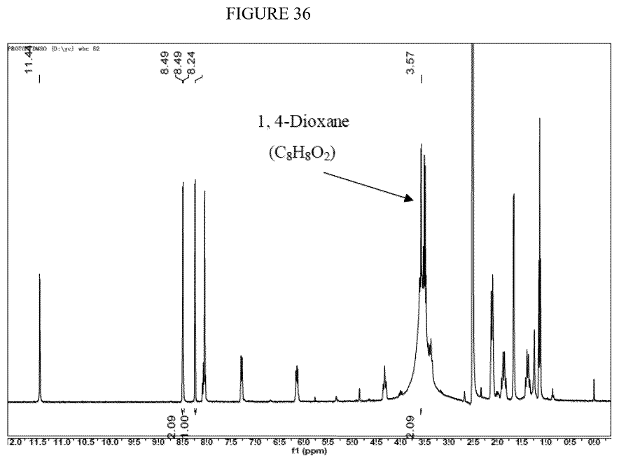

In one embodiment, Form H has ¹H NMR shown in FIG. 36. In one embodiment, the molar ratio of residual 1,4-dioxane/Compound 1 is about 0.3:1.

In still another embodiment, Form H of Compound 1 is substantially pure. In certain embodiments, the substantially pure Form H of Compound 1 is substantially free of other solid forms, e.g., amorphous form. In certain embodiments, the purity of the substantially pure Form H of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form H of Compound 1 which is substantially pure. Certain embodiments herein provide Form H of Compound 1 which is substantially free of other solid forms comprising Compound 1 including, e.g., Forms D, E, J, L, U, O, Q, R, T, W, N, X, F, G, I, K, M, P, S, V and Y of Compound 1 as provided herein. Certain embodiments herein provide Form H as a mixture of solid forms comprising Compound 1, including, e.g., a mixture comprising one or more of the following: Forms D, E, J, L, U, O, Q, R, T, W, N, X, F, G, I, K, M, P, S, V and Y of Compound 1 as provided herein.

Certain embodiments herein provide Form H of Compound 1 which is substantially free of other solid forms comprising Compound 1 including, e.g., Forms A, B, C, D, E, J, L, U, O, Q, R, W, T, N, X, F, G, I, K, M, P, S, V, Y, NP1, NP3, and NP4 of Compound 1 as provided herein. Certain embodiments herein provide Form H as a mixture of solid forms comprising Compound 1, including, e.g., a mixture comprising one or more of the following: Forms A, B, C, D, E, J, L, U, O, Q, R, W, T, N, X, F, G, I, K, M, P, S, V, Y, NP1, NP3, and NP4 of Compound 1 as provided herein.

### 6.2.12. Form N of Compound 1

In certain embodiments, provided herein is Form N of Compound 1.

In one embodiment, Form N is a solvate of Compound 1. In another embodiment, Form N of Compound 1 is crystalline.

In certain embodiments, Form N is obtained via adding anti-solvent 1,4-dioxane into MeOH/DCM (1:1, v/v) solution of Form D.

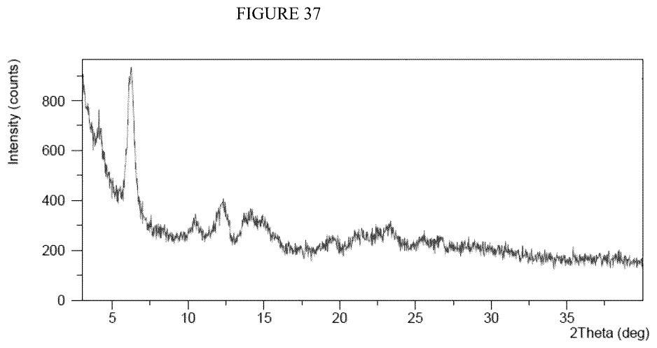

In certain embodiments, Form N is crystalline, as indicated by, e.g., X-ray powder diffraction measurements. In one embodiment, Form N of Compound 1 has an X-ray powder diffraction pattern substantially as shown in FIG. 37.

In one embodiment, Form N of Compound 1 has one or more characteristic X-ray powder diffraction peaks at a two-theta angle of approximately 4.15, 6.23, 12.32, 14.36 or 23.30 as depicted in FIG. 37. In another embodiment, Form N of Compound 1 has one, two, three or four characteristic X-ray powder diffraction peaks at a two-theta angle of approximately 4.15, 6.23, 12.32 or 14.36 degrees 2θ. In another embodiment, Form N of Compound 1 has one, two or three characteristic X-ray powder diffraction peaks at a two-theta angle of approximately 6.23, 12.32 or 14.36 degrees 2θ. In another embodiment, Form N of Compound 1 has one or more characteristic X-ray powder diffraction peaks as set forth in Table 31. In another embodiment, Form N of Compound 1 has one, two, three, four, five, six or seven characteristic X-ray powder diffraction peaks as set forth in Table 31. In another embodiment, Form N of Compound 1 has one, two, or three characteristic X-ray powder diffraction peaks as set forth in Table 31.

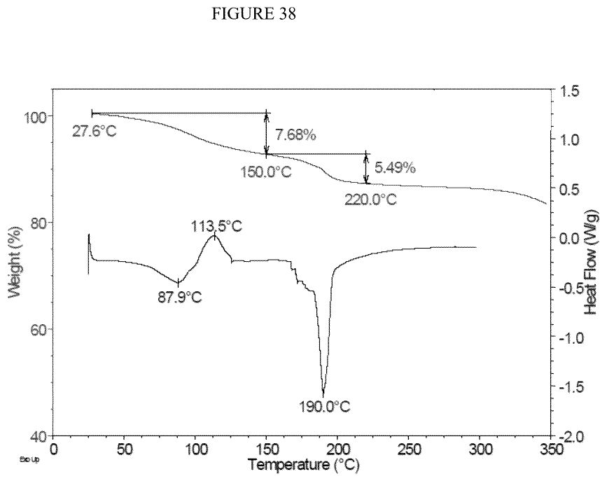

In one embodiment, provided herein is a solid form of Compound 1 having a thermogravimetric thermograph corresponding substantially to the representative TGA thermogram as depicted in FIG. 38. In certain embodiments, Form H shows a TGA weight loss of about 7.7% up to about 150° C. In certain embodiments, Form H shows a TGA weight loss of about 5.5% between about 150° C. and about 220° C. In certain embodiments, Form N shows a two step TGA weight loss of about 7.7% up to about 150° C. and about 5.5% between about 150° C. and about 220° C.

In one embodiment, provided herein is solid Form N of Compound 1 having a DSC thermogram corresponding substantially as depicted in FIG. 38. In certain embodiments, Form N is characterized by a DSC plot comprising two endotherms at about 87.9° C. and about 190.0° C. (peak), and an exotherm at about 113.5° C. (peak).

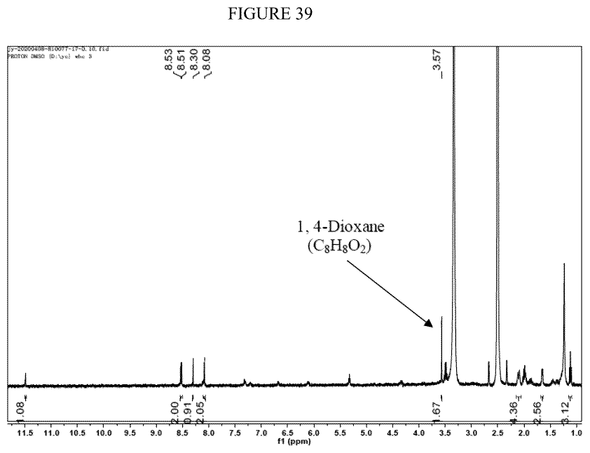

In one embodiment, Form N has ¹H NMR shown in FIG. 39. In one embodiment, the molar ratio of residual 1,4-dioxane/Compound 1 is about 0.3:1.

In certain embodiments, Form S is obtained by N₂ sweeping Form N for about 20 min at about 30° C. In one embodiment, Form T is obtained by heating to 150° C. and cooling to 30° C. with N₂ protection. In certain embodiments, Form T converts to Form U upon exposure to ambient conditions.

In still another embodiment, Form N of Compound 1 is substantially pure. In certain embodiments, the substantially pure Form N of Compound 1 is substantially free of other solid forms, e.g., amorphous form. In certain embodiments, the purity of the substantially pure Form N of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form N of Compound 1 which is substantially pure. Certain embodiments herein provide Form N of Compound 1 which is substantially free of other solid forms comprising Compound 1 including, e.g., Forms D, E, J, L, U, O, Q, R, T, W, H, X, F, G, I, K, M, P, S, V and Y of Compound 1 as provided herein. Certain embodiments herein provide Form N as a mixture of solid forms comprising Compound 1, including, e.g., a mixture comprising one or more of the following: Forms D, E, J, L, U, O, Q, R, T, W, H, X, F, G, I, K, M, P, S, V and Y of Compound 1 as provided herein.

Certain embodiments herein provide Form N of Compound 1 which is substantially free of other solid forms comprising Compound 1 including, e.g., Forms A, B, C, D, E, J, L, U, O, Q, R, W, T, H, X, F, G, I, K, M, P, S, V, Y, NP1, NP3, and NP4 of Compound 1 as provided herein. Certain embodiments herein provide Form N as a mixture of solid forms comprising Compound 1, including, e.g., a mixture comprising one or more of the following: Forms A, B, C, D, E, J, L, U, O, Q, R, W, T, H, X, F, G, I, K, M, P, S, V, Y, NP1, NP3, and NP4 of Compound 1 as provided herein.

### 6.2.13. Form X of Compound 1

In certain embodiments, provided herein is Form X of Compound 1.

In one embodiment, Form X is a MeOH solvate of Compound 1. In another embodiment, Form X of Compound 1 is crystalline.

In certain embodiments, Form X is obtained by slurrying the mixture of forms D/E/J in MeOH (aw˜0) for 3 days (wet sample).

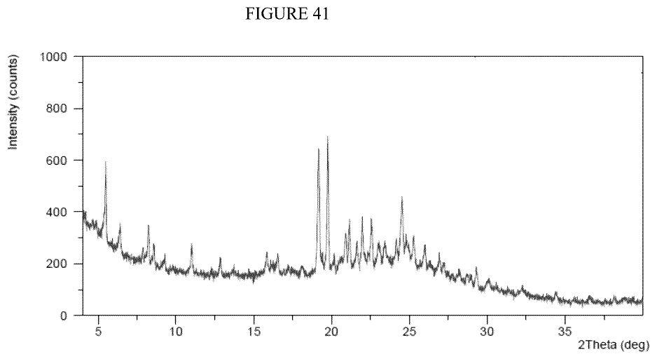

In certain embodiments, Form X is crystalline, as indicated by, e.g., X-ray powder diffraction measurements. In one embodiment, Form X of Compound 1 has an X-ray powder diffraction pattern substantially as shown in FIG. 41.

In one embodiment, Form X of Compound 1 has one or more characteristic X-ray powder diffraction peaks at a two-theta angle of approximately 5.50, 19.16, 19.75, 21.97, 22.56, 24.51 or 25.28 as depicted in FIG. 41. In another embodiment, Form X of Compound 1 has one, two, three or four characteristic X-ray powder diffraction peaks at a two-theta angle of approximately 5.50, 19.16, 19.75 or 24.51 or degrees 2θ. In another embodiment, Form X of Compound 1 has one, two or three characteristic X-ray powder diffraction peaks at a two-theta angle of approximately 19.16, 19.75 or 24.51 degrees 2θ. In another embodiment, Form X of Compound 1 has one or more characteristic X-ray powder diffraction peaks as set forth in Table 32. In another embodiment, Form X of Compound 1 has one, two, three, four, five, six or seven characteristic X-ray powder diffraction peaks as set forth in Table 32. In another embodiment, Form X of Compound 1 has one, two, or three characteristic X-ray powder diffraction peaks as set forth in Table 32.

In still another embodiment, Form X of Compound 1 is substantially pure. In certain embodiments, the substantially pure Form X of Compound 1 is substantially free of other solid forms, e.g., amorphous form. In certain embodiments, the purity of the substantially pure Form X of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form X of Compound 1 which is substantially pure. Certain embodiments herein provide Form X of Compound 1 which is substantially free of other solid forms comprising Compound 1 including, e.g., Forms D, E, J, L, U, O, Q, R, T, W, H, N, F, G, I, K, M, P, S, V and Y of Compound 1 as provided herein. Certain embodiments herein provide Form X as a mixture of solid forms comprising Compound 1, including, e.g., a mixture comprising one or more of the following: Forms D, E, J, L, U, O, Q, R, T, W, H, N, F, G, I, K, M, P, S, V and Y of Compound 1 as provided herein.

Certain embodiments herein provide Form X of Compound 1 which is substantially free of other solid forms comprising Compound 1 including, e.g., Forms A, B, C, D, E, J, L, U, O, Q, R, T, W, H, N, F, G, I, K, M, P, S, V, Y, NP1, NP3, and NP4 of Compound 1 as provided herein. Certain embodiments herein provide Form X as a mixture of solid forms comprising Compound 1, including, e.g., a mixture comprising one or more of the following: Forms A, B, C, D, E, J, L, U, O, Q, R, T, W, H, N, F, G, I, K, M, P, S, V, Y, NP1, NP3, and NP4 of Compound 1 as provided herein.

In one embodiment, Form X converted to Form Y after drying at room temperature.

### 6.2.14. Form F of Compound 1

In certain embodiments, provided herein is Form F of Compound 1.

In another embodiment, Form F of Compound 1 is crystalline.

In certain embodiments, Form F is obtained by slurrying Form D in MeOH at room temperature.

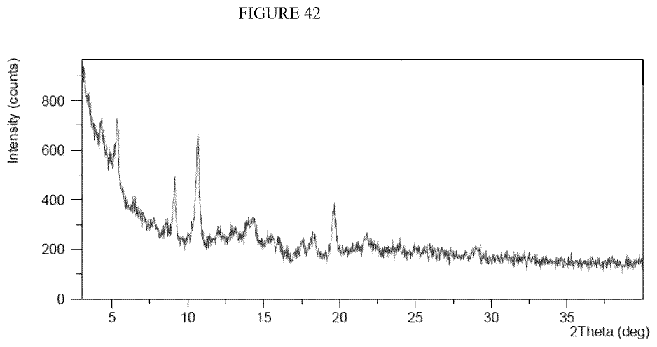

In certain embodiments, Form F is crystalline, as indicated by, e.g., X-ray powder diffraction measurements. In one embodiment, Form F of Compound 1 has an X-ray powder diffraction pattern substantially as shown in FIG. 42.

In one embodiment, Form F of Compound 1 has one or more characteristic X-ray powder diffraction peaks at a two-theta angle of approximately 4.27, 5.35, 9.13, 10.66, 14.26, 18.28, 19.61 or 21.78 as depicted in FIG. 42. In another embodiment, Form F of Compound 1 has one, two, three or four characteristic X-ray powder diffraction peaks at a two-theta angle of approximately 5.35, 9.13, 10.66 or 19.61 degrees 2θ. In another embodiment, Form F of Compound 1 has one, two or three characteristic X-ray powder diffraction peaks at a two-theta angle of approximately 5.35, 9.13 or 10.66 degrees 2θ. In another embodiment, Form F of Compound 1 has one or more characteristic X-ray powder diffraction peaks as set forth in Table 33. In another embodiment, Form F of Compound 1 has one, two, three, four, five, six or seven characteristic X-ray powder diffraction peaks as set forth in Table 33. In another embodiment, Form F of Compound 1 has one, two, or three characteristic X-ray powder diffraction peaks as set forth in Table 33.

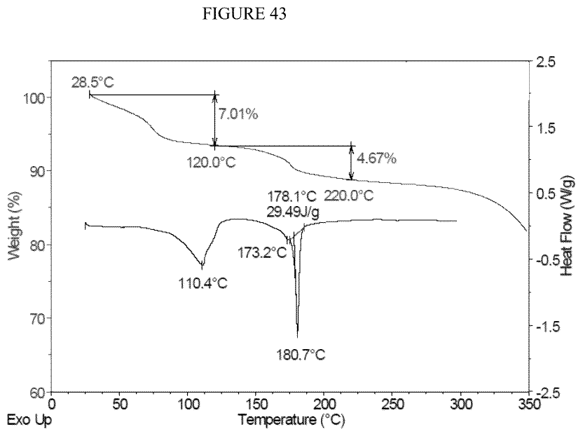

In one embodiment, provided herein is a solid form of Compound 1 having a thermogravimetric thermograph corresponding substantially to the representative TGA thermogram as depicted in FIG. 43. In certain embodiments, Form F shows a TGA weight loss of about 7.0% up to about 120° C. In certain embodiments, Form F shows a TGA weight loss of about 4.7% between about 120° C. and about 220° C. In certain embodiments, Form F shows a two step TGA weight loss of about 7.0% up to about 120° C. and about 4.7% between about 120° C. and about 220° C.

In one embodiment, provided herein is solid Form F of Compound 1 having a DSC thermogram corresponding substantially as depicted in FIG. 43. In certain embodiments, Form F is characterized by a DSC plot comprising three endotherms at about 110.4° C., about 173.2° C. and about 180.7° C. (peak).

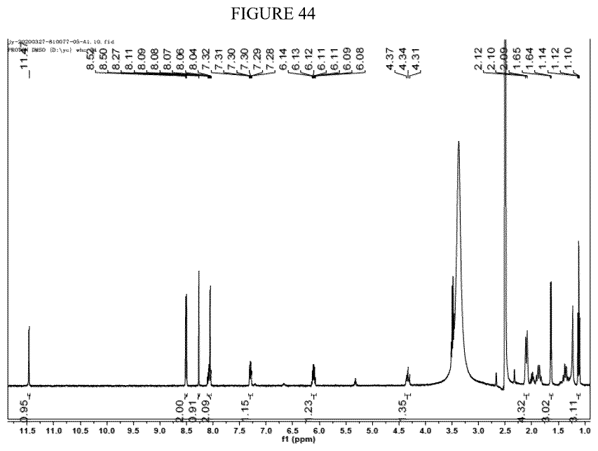

In one embodiment, Form F has ¹H NMR shown in FIG. 44.

In still another embodiment, Form F of Compound 1 is substantially pure. In certain embodiments, the substantially pure Form F of Compound 1 is substantially free of other solid forms, e.g., amorphous form. In certain embodiments, the purity of the substantially pure Form F of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form F of Compound 1 which is substantially pure. Certain embodiments herein provide Form F of Compound 1 which is substantially free of other solid forms comprising Compound 1 including, e.g., Forms D, E, J, L, U, O, Q, R, T, W, N, X, H, G, I, K, M, P, S, V and Y of Compound 1 as provided herein. Certain embodiments herein provide Form F as a mixture of solid forms comprising Compound 1, including, e.g., a mixture comprising one or more of the following: Forms D, E, J, L, U, O, Q, R, T, W, N, X, H, G, I, K, M, P, S, V and Y of Compound 1 as provided herein.

Certain embodiments herein provide Form F of Compound 1 which is substantially free of other solid forms comprising Compound 1 including, e.g., Forms A, B, C, D, E, J, L, U, O, Q, R, T, W, H, N, X, G, I, K, M, P, S, V, Y, NP1, NP3, and NP4 of Compound 1 as provided herein. Certain embodiments herein provide Form F as a mixture of solid forms comprising Compound 1, including, e.g., a mixture comprising one or more of the following: Forms A, B, C, D, E, J, L, U, O, Q, R, T, W, H, N, X, G, I, K, M, P, S, V, Y, NP1, NP3, and NP4 of Compound 1 as provided herein.

### 6.2.15. Form G of Compound 1

In certain embodiments, provided herein is Form G of Compound 1.

In another embodiment, Form G of Compound 1 is crystalline. Form G is a metastable form at ambient temperature.

In certain embodiments, Form G is obtained by slurrying Form D in ethanol at 50° C. In one embodiment, Form G is obtained by slurrying Form D in ethanol at room temperature, followed by addition of polymer mixture A (polyvinyl pyrrolidone (PVP), polyvinyl alcohol (PVA), polyvinylchloride (PVC), polyvinyl acetate (PVAC), hypromellose (HPMC), methyl cellulose (MC) (mass ratio of 1:1:1:1:1:1)).

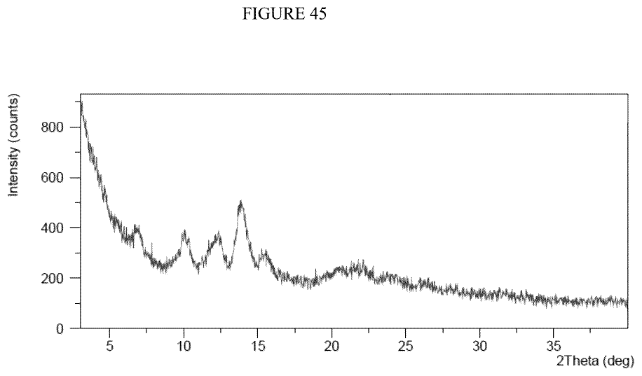

In certain embodiments, Form G is crystalline, as indicated by, e.g., X-ray powder diffraction measurements. In one embodiment, Form G of Compound 1 has an X-ray powder diffraction pattern substantially as shown in FIG. 45.

In one embodiment, Form G of Compound 1 has one or more characteristic X-ray powder diffraction peaks at a two-theta angle of approximately 6.95, 10.08, 12.39, 13.89, 15.40 or 22.10 as depicted in FIG. 45. In another embodiment, Form G of Compound 1 has one, two, three or four characteristic X-ray powder diffraction peaks at a two-theta angle of approximately 6.95, 10.08, 12.39 or 13.89 degrees 2θ. In another embodiment, Form G of Compound 1 has one, two or three characteristic X-ray powder diffraction peaks at a two-theta angle of approximately 10.08, 12.39 or 13.89 degrees 2θ. In another embodiment, Form G of Compound 1 has one or more characteristic X-ray powder diffraction peaks as set forth in Table 34. In another embodiment, Form G of Compound 1 has one, two, three, four, five, six or seven characteristic X-ray powder diffraction peaks as set forth in Table 34. In another embodiment, Form G of Compound 1 has one, two, or three characteristic X-ray powder diffraction peaks as set forth in Table 34.

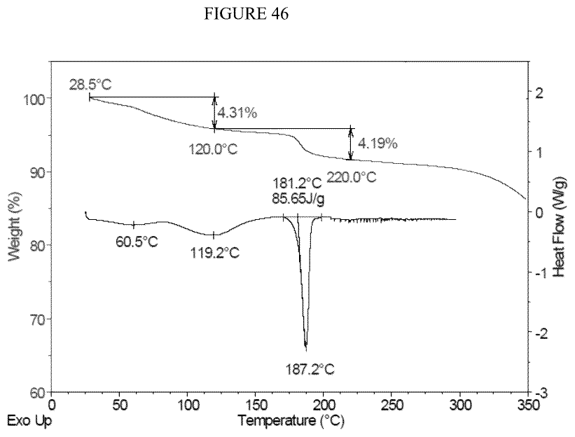

In one embodiment, provided herein is a solid form of Compound 1 having a thermogravimetric thermograph corresponding substantially to the representative TGA thermogram as depicted in FIG. 46. In certain embodiments, Form G shows a TGA weight loss of about 4.3% up to about 120° C. In certain embodiments, Form G shows a TGA weight loss of about 4.2% between about 120° C. and about 220° C. In certain embodiments, Form G shows a two-step weight loss of about 4.3% up to about 120° C. and about 4.2% between about 120° C. and about 220° C.

In one embodiment, provided herein is solid Form G of Compound 1 having a DSC thermogram corresponding substantially as depicted in FIG. 46. In certain embodiments, Form G is characterized by a DSC plot comprising three endotherms at about 60.5° C., about 119.2° C. (peak) and about 181.2° C. (onset).

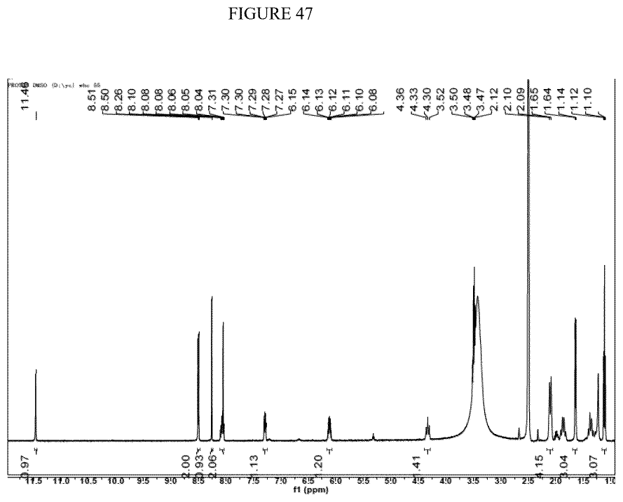

In one embodiment, Form G has ¹H NMR shown in FIG. 47.

In still another embodiment, Form G of Compound 1 is substantially pure. In certain embodiments, the substantially pure Form G of Compound 1 is substantially free of other solid forms, e.g., amorphous form. In certain embodiments, the purity of the substantially pure Form G of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form G of Compound 1 which is substantially pure. Certain embodiments herein provide Form G of Compound 1 which is substantially free of other solid forms comprising Compound 1 including, e.g., Forms D, E, J, L, U, O, Q, R, T, W, N, X, H, F, I, K, M, P, S, V and Y of Compound 1 as provided herein. Certain embodiments herein provide Form G as a mixture of solid forms comprising Compound 1, including, e.g., a mixture comprising one or more of the following: Forms D, E, J, L, U, O, Q, R, T, W, N, X, H, F, I, K, M, P, S, V and Y of Compound 1 as provided herein.

Certain embodiments herein provide Form G of Compound 1 which is substantially free of other solid forms comprising Compound 1 including, e.g., Forms A, B, C, D, E, J, L, U, O, Q, R, W, T, H, N, X, F, I, K, M, P, S, V, Y, NP1, NP3, and NP4 of Compound 1 as provided herein. Certain embodiments herein provide Form G as a mixture of solid forms comprising Compound 1, including, e.g., a mixture comprising one or more of the following: Forms A, B, C, D, E, J, L, U, O, Q, R, W, T, H, N, X, F, I, K, M, P, S, V, Y, NP1, NP3, and NP4 of Compound 1 as provided herein.

### 6.2.16. Form I of Compound 1

In certain embodiments, provided herein is Form I of Compound 1.

In another embodiment, Form I of Compound 1 is crystalline. In one embodiment, Form I of Compound 1 is a hydrate. In one embodiment, Form I of Compound 1 is a hygroscopic anhydrate.

In certain embodiments, Form I is obtained by adding anti-solvent ACN into THF/H₂O (1:1, v/v) solution of Form D.

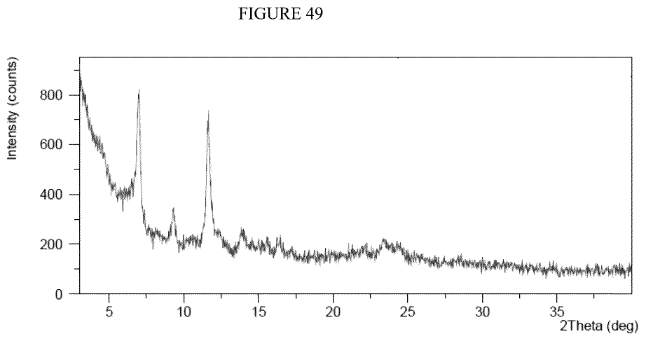

In certain embodiments, Form I is crystalline, as indicated by, e.g., X-ray powder diffraction measurements. In one embodiment, Form I of Compound 1 has an X-ray powder diffraction pattern substantially as shown in FIG. 49.

In one embodiment, Form I of Compound 1 has one or more characteristic X-ray powder diffraction peaks at a two-theta angle of approximately 6.98, 9.20, 11.62 or 23.40 as depicted in FIG. 49. In another embodiment, Form I of Compound 1 has one, two or three characteristic X-ray powder diffraction peaks at a two-theta angle of approximately 6.98, 9.20 or 11.62 degrees 2θ. In another embodiment, Form I of Compound 1 has one or more characteristic X-ray powder diffraction peaks as set forth in Table 35. In another embodiment, Form I of Compound 1 has one, two, three, four, five, six or seven characteristic X-ray powder diffraction peaks as set forth in Table 35. In another embodiment, Form I of Compound 1 has one, two, or three characteristic X-ray powder diffraction peaks as set forth in Table 35.

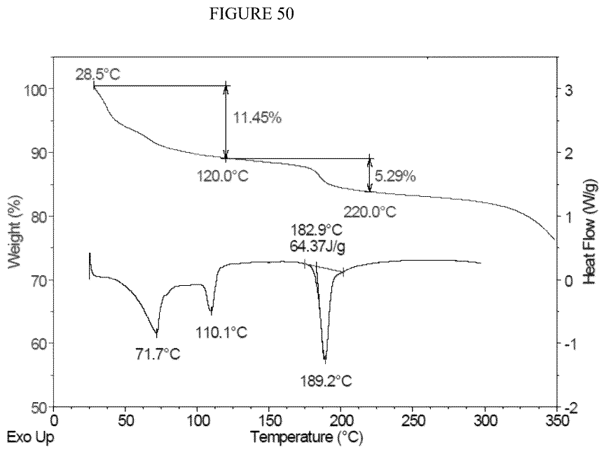

In one embodiment, provided herein is a solid form of Compound 1 having a thermogravimetric thermograph corresponding substantially to the representative TGA thermogram as depicted in FIG. 50. In certain embodiments, Form I shows a TGA weight loss of about 11.5% up to about 120° C. In certain embodiments, Form I shows a TGA weight loss of about 5.3% between about 120° C. and about 220° C. In certain embodiments, Form I shows a two-step weight loss of about 11.5% up to about 120° C. and about 5.3% between about 120° C. and about 220° C.

In one embodiment, provided herein is solid Form I of Compound 1 having a DSC thermogram corresponding substantially as depicted in FIG. 50. In certain embodiments, Form I is characterized by a DSC plot comprising three endotherms at about 71.7° C., about 110.1° C. (peak) and about 182.9° C. (onset).

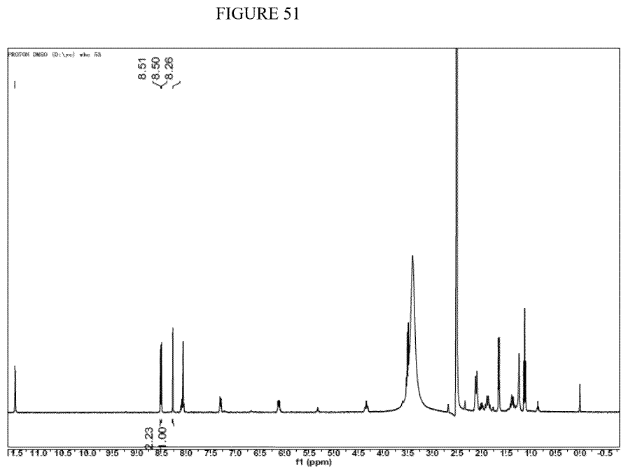

In one embodiment, Form I has ¹H NMR shown in FIG. 51.

In still another embodiment, Form I of Compound 1 is substantially pure. In certain embodiments, the substantially pure Form I of Compound 1 is substantially free of other solid forms, e.g., amorphous form. In certain embodiments, the purity of the substantially pure Form I of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form I of Compound 1 which is substantially pure. Certain embodiments herein provide Form I of Compound 1 which is substantially free of other solid forms comprising Compound 1 including, e.g., Forms D, E, J, L, U, O, Q, R, T, W, N, X, H, F, G, K, M, P, S, V and Y of Compound 1 as provided herein. Certain embodiments herein provide Form I as a mixture of solid forms comprising Compound 1, including, e.g., a mixture comprising one or more of the following: Forms D, E, J, L, U, O, Q, R, T, W, N, X, H, F, G, K, M, P, S, V and Y of Compound 1 as provided herein.

Certain embodiments herein provide Form I of Compound 1 which is substantially free of other solid forms comprising Compound 1 including, e.g., Forms A, B, C, D, E, J, L, U, O, Q, R, W, T, H, N, X, F, G, K, M, P, S, V, Y, NP1, NP3, and NP4 of Compound 1 as provided herein. Certain embodiments herein provide Form I as a mixture of solid forms comprising Compound 1, including, e.g., a mixture comprising one or more of the following: Forms A, B, C, D, E, J, L, U, O, Q, R, W, T, H, N, X, F, G, I, K, M, P, S, V, Y, NP1, NP3, and NP4 of Compound 1 as provided herein.

### 6.2.17. Form K of Compound 1

In certain embodiments, provided herein is Form K of Compound 1.

In another embodiment, Form K of Compound 1 is crystalline.

In certain embodiments, Form K is obtained via solid vapor diffusion of Form D in IPA atmosphere.

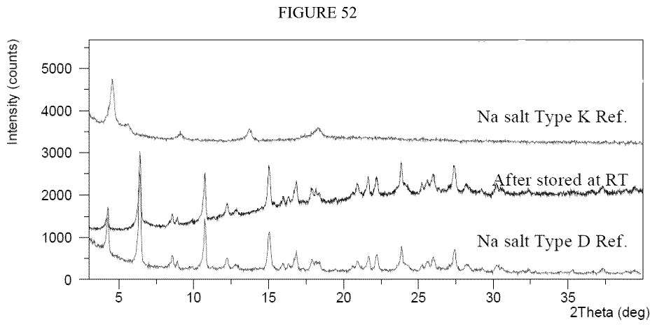

In certain embodiments, Form K converts to Form D after storing under ambient conditions for 17 days. In one embodiment, Form K of Compound 1 has an X-ray powder diffraction pattern substantially as shown in the XRPD patterns overlay displayed in FIG. 52.

In one embodiment, Form K of Compound 1 has one or more characteristic X-ray powder diffraction peaks at a two-theta angle of approximately 4.56, 13.38, 13.73 or 18.23 or as depicted in FIG. 52. In another embodiment, Form K of Compound 1 has one, two or three characteristic X-ray powder diffraction peaks at a two-theta angle of approximately 4.56, 13.73 or 18.23 degrees 2θ. In another embodiment, Form K of Compound 1 has one or more characteristic X-ray powder diffraction peaks as set forth in Table 36. In another embodiment, Form K of Compound 1 has one, two, or three characteristic X-ray powder diffraction peaks as set forth in Table 36.

In still another embodiment, Form K of Compound 1 is substantially pure. In certain embodiments, the substantially pure Form K of Compound 1 is substantially free of other solid forms, e.g., amorphous form. In certain embodiments, the purity of the substantially pure Form K of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form K of Compound 1 which is substantially pure. Certain embodiments herein provide Form K of Compound 1 which is substantially free of other solid forms comprising Compound 1 including, e.g., Forms D, E, J, L, U, O, Q, R, T, W, N, X, H, F, G, I, M, P, S, V and Y of Compound 1 as provided herein. Certain embodiments herein provide Form K as a mixture of solid forms comprising Compound 1, including, e.g., a mixture comprising one or more of the following: Forms D, E, J, L, U, O, Q, R, T, W, N, X, H, F, G, I, M, P, S, V and Y of Compound 1 as provided herein.

Certain embodiments herein provide Form K of Compound 1 which is substantially free of other solid forms comprising Compound 1 including, e.g., Forms A, B, C, D, E, J, L, U, O, Q, R, W, T, H, N, X, F, G, I, M, P, S, V, Y, NP1, NP3, and NP4 of Compound 1 as provided herein. Certain embodiments herein provide Form K as a mixture of solid forms comprising Compound 1, including, e.g., a mixture comprising one or more of the following: Forms A, B, C, D, E, J, L, U, O, Q, R, W, T, H, N, X, F, G, I, M, P, S, V, Y, NP1, NP3, and NP4 of Compound 1 as provided herein.

### 6.2.18. Form M of Compound 1

In certain embodiments, provided herein is Form M of Compound 1.

In another embodiment, Form M of Compound 1 is crystalline. In one embodiment, Form M of Compound 1 is a hydrate. In one embodiment, Form M of Compound 1 is a hygroscopic anhydrate.

In certain embodiments, Form M is obtained via slow cooling of ACN/H₂O (1:1, v/v) solution of Form D from 50° C. to 5° C., followed by evaporation at RT.

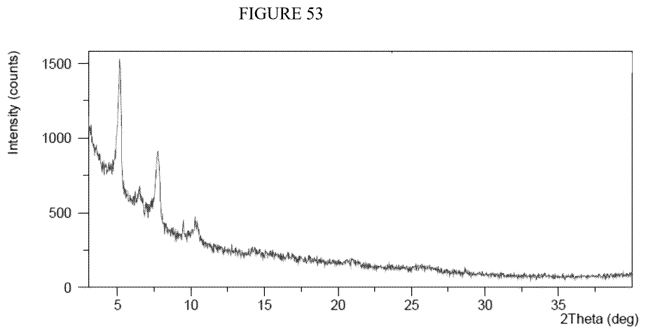

In certain embodiments, Form M is crystalline, as indicated by, e.g., X-ray powder diffraction measurements. In one embodiment, Form M of Compound 1 has an X-ray powder diffraction pattern substantially as shown in FIG. 53.

In one embodiment, Form M of Compound 1 has one or more characteristic X-ray powder diffraction peaks at a two-theta angle of approximately 5.16, 6.49, 7.76 or 10.34 as depicted in FIG. 53. In another embodiment, Form M of Compound 1 has one, two or three characteristic X-ray powder diffraction peaks at a two-theta angle of approximately 5.16, 7.76 or 10.34 degrees 2θ. In another embodiment, Form M of Compound 1 has one or more characteristic X-ray powder diffraction peaks as set forth in Table 37. In another embodiment, Form M of Compound 1 has one, two, three or four characteristic X-ray powder diffraction peaks as set forth in Table 37. In another embodiment, Form M of Compound 1 has one, two, or three characteristic X-ray powder diffraction peaks as set forth in Table 37.

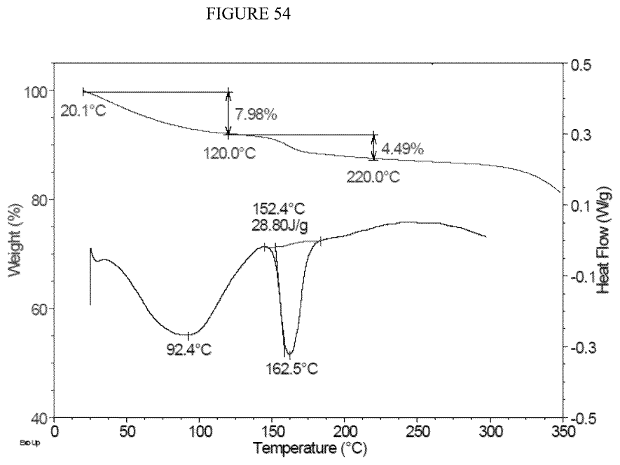

In one embodiment, provided herein is a solid form of Compound 1 having a thermogravimetric thermograph corresponding substantially to the representative TGA thermogram as depicted in FIG. 54. In certain embodiments, Form M shows a TGA weight loss of about 8.0% up to about 120° C. In certain embodiments, Form M shows a TGA weight loss of about 4.5% between about 120° C. and about 220° C. In certain embodiments, Form M shows a two-step weight loss of about 8.0% up to about 120° C. and about 4.5% between about 120° C. and about 220° C.

In one embodiment, provided herein is solid Form M of Compound 1 having a DSC thermogram corresponding substantially as depicted in FIG. 54. In certain embodiments, Form M is characterized by a DSC plot comprising two endotherms at about 92.4° C. (peak) and about 152.4° C. (onset).

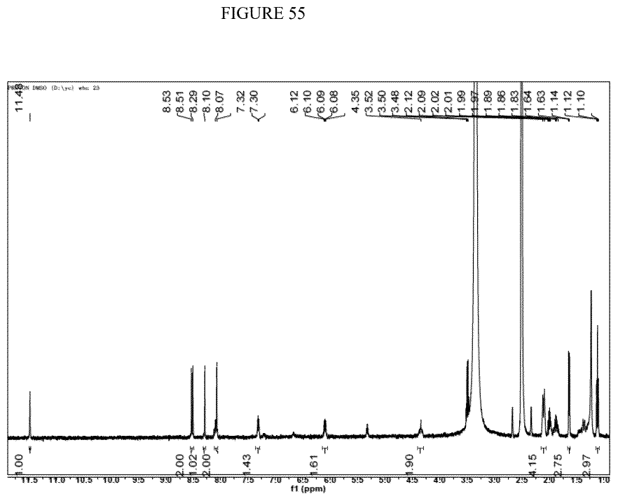

In one embodiment, Form M has ¹H NMR shown in FIG. 55.

In still another embodiment, Form M of Compound 1 is substantially pure. In certain embodiments, the substantially pure Form M of Compound 1 is substantially free of other solid forms, e.g., amorphous form. In certain embodiments, the purity of the substantially pure Form M of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form M of Compound 1 which is substantially pure. Certain embodiments herein provide Form M of Compound 1 which is substantially free of other solid forms comprising Compound 1 including, e.g., Forms D, E, J, L, U, O, Q, R, T, W, N, X, H, F, G, K, I, P, S, V and Y of Compound 1 as provided herein. Certain embodiments herein provide Form M as a mixture of solid forms comprising Compound 1, including, e.g., a mixture comprising one or more of the following: Forms D, E, J, L, U, O, Q, R, T, W, N, X, H, F, G, K, I, P, S, V and Y of Compound 1 as provided herein.

### 6.2.19. Form P of Compound 1

In certain embodiments, provided herein is Form P of Compound 1.

In another embodiment, Form P of Compound 1 is crystalline.

In certain embodiments, Form P is obtained via N₂ sweeping Form D at about 30° C. for about 20 min.

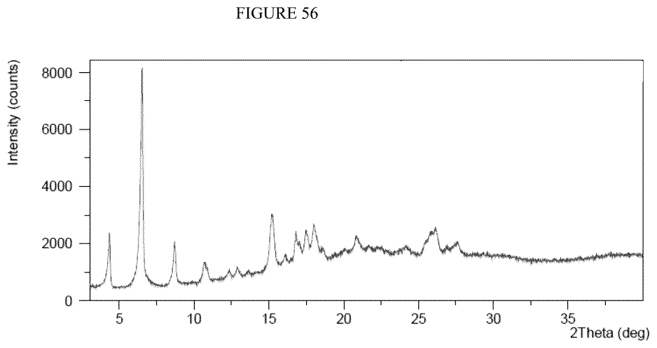

In one embodiment, Form P of Compound 1 has an X-ray powder diffraction pattern substantially as shown in FIG. 56.

In one embodiment, Form P of Compound 1 has one or more characteristic X-ray powder diffraction peaks at a two-theta angle of approximately 4.36, 6.51, 8.70, 15.20 or 18.01 or as depicted in FIG. 56. In another embodiment, Form P of Compound 1 has one, two or three characteristic X-ray powder diffraction peaks at a two-theta angle of approximately 4.36, 6.51 or 15.20 or degrees 2θ. In another embodiment, Form P of Compound 1 has one or more characteristic X-ray powder diffraction peaks as set forth in Table 38. In another embodiment, Form P of Compound 1 has one, two, or three characteristic X-ray powder diffraction peaks as set forth in Table 38.

In still another embodiment, Form P of Compound 1 is substantially pure. In certain embodiments, the substantially pure Form P of Compound 1 is substantially free of other solid forms, e.g., amorphous form. In certain embodiments, the purity of the substantially pure Form P of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form P of Compound 1 which is substantially pure. Certain embodiments herein provide Form P of Compound 1 which is substantially free of other solid forms comprising Compound 1 including, e.g., Forms D, E, J, L, U, O, Q, R, T, W, N, X, H, F, G, I, M, K, S, V and Y of Compound 1 as provided herein. Certain embodiments herein provide Form P as a mixture of solid forms comprising Compound 1, including, e.g., a mixture comprising one or more of the following: Forms D, E, J, L, U, O, Q, R, T, W, N, X, H, F, G, I, M, K, S, V and Y of Compound 1 as provided herein.

Certain embodiments herein provide Form P of Compound 1 which is substantially free of other solid forms comprising Compound 1 including, e.g., Forms A, B, C, D, E, J, L, U, O, Q, R, W, T, H, N, X, F, G, I, K, M, S, V, Y, NP1, NP3, and NP4 of Compound 1 as provided herein. Certain embodiments herein provide Form P as a mixture of solid forms comprising Compound 1, including, e.g., a mixture comprising one or more of the following: Forms A, B, C, D, E, J, L, U, O, Q, R, W, T, H, N, X, F, G, I, K, M, S, V, Y, NP1, NP3, and NP4 of Compound 1 as provided herein.

### 6.2.20. Form S of Compound 1

In certain embodiments, provided herein is Form S of Compound 1.

In another embodiment, Form S of Compound 1 is crystalline.

In certain embodiments, Form S is obtained via N₂ sweeping Form N at about 30° C. for about 20 min.

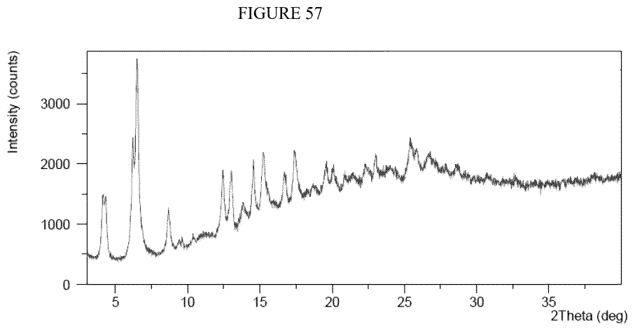

In one embodiment, Form S of Compound 1 has an X-ray powder diffraction pattern substantially as shown in FIG. 57.

In one embodiment, Form S of Compound 1 has one or more characteristic X-ray powder diffraction peaks at a two-theta angle of approximately 4.13, 4.32, 6.19, 6.48, 12.44, 13.02, 14.52 or 15.19 as depicted in FIG. 57. In another embodiment, Form S of Compound 1 has one, two, three or four characteristic X-ray powder diffraction peaks at a two-theta angle of approximately 6.19, 6.48, 12.44 or 13.02 degrees 2θ. In another embodiment, Form S of Compound 1 has one, two or three characteristic X-ray powder diffraction peaks at a two-theta angle of approximately 6.19, 6.48 or 12.44 degrees 2θ. In another embodiment, Form S of Compound 1 has one or more characteristic X-ray powder diffraction peaks as set forth in Table 39. In another embodiment, Form S of Compound 1 has one, two, three, four or five characteristic X-ray powder diffraction peaks as set forth in Table 39.

In still another embodiment, Form S of Compound 1 is substantially pure. In certain embodiments, the substantially pure Form S of Compound 1 is substantially free of other solid forms, e.g., amorphous form. In certain embodiments, the purity of the substantially pure Form S of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form S of Compound 1 which is substantially pure. Certain embodiments herein provide Form S of Compound 1 which is substantially free of other solid forms comprising Compound 1 including, e.g., Forms D, E, J, L, U, O, Q, R, T, W, N, X, H, F, G, I, M, K, P, V and Y of Compound 1 as provided herein. Certain embodiments herein provide Form S as a mixture of solid forms comprising Compound 1, including, e.g., a mixture comprising one or more of the following: Forms D, E, J, L, U, O, Q, R, T, W, N, X, H, F, G, I, M, K, P, V and Y of Compound 1 as provided herein.

Certain embodiments herein provide Form S of Compound 1 which is substantially free of other solid forms comprising Compound 1 including, e.g., Forms A, B, C, D, E, J, L, U, O, Q, R, W, T, H, N, X, F, G, I, K, M, P, V, Y, NP1, NP3, and NP4 of Compound 1 as provided herein. Certain embodiments herein provide Form S as a mixture of solid forms comprising Compound 1, including, e.g., a mixture comprising one or more of the following: Forms A, B, C, D, E, J, L, U, O, Q, R, W, T, H, N, X, F, G, I, K, M, P, V, Y, NP1, NP3, and NP4 of Compound 1 as provided herein.

### 6.2.21. Form V of Compound 1

In certain embodiments, provided herein is Form V of Compound 1.

In another embodiment, Form V of Compound 1 is crystalline.

In certain embodiments, Form V is obtained via N₂ sweeping Form L at about 30° C. for about 20 min.

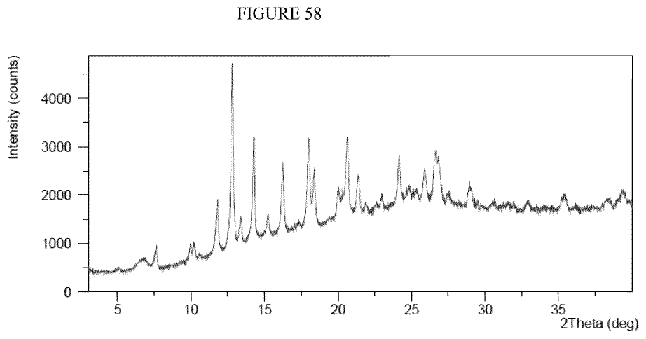

In one embodiment, Form V of Compound 1 has an X-ray powder diffraction pattern substantially as shown in FIG. 58.

In one embodiment, Form V of Compound 1 has one or more characteristic X-ray powder diffraction peaks at a two-theta angle of approximately 11.79, 12.81, 14.27, 16.24, 18.00, 18.37 or 20.61 as depicted in FIG. 58. In another embodiment, Form V of Compound 1 has one, two, three or four characteristic X-ray powder diffraction peaks at a two-theta angle of approximately 12.81, 14.27, 18.00 or 20.61 degrees 2θ. In another embodiment, Form V of Compound 1 has one or more characteristic X-ray powder diffraction peaks as set forth in Table 40. In another embodiment, Form V of Compound 1 has one, two or three characteristic X-ray powder diffraction peaks at a two-theta angle of approximately 12.81, 14.27 or 18.00 degrees 2θ. In another embodiment, Form V of Compound 1 has one, two, or three characteristic X-ray powder diffraction peaks as set forth in Table 40.

In still another embodiment, Form V of Compound 1 is substantially pure. In certain embodiments, the substantially pure Form V of Compound 1 is substantially free of other solid forms, e.g., amorphous form. In certain embodiments, the purity of the substantially pure Form V of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form V of Compound 1 which is substantially pure. Certain embodiments herein provide Form V of Compound 1 which is substantially free of other solid forms comprising Compound 1 including, e.g., Forms D, E, J, L, U, O, Q, R, T, W, N, X, H, F, G, I, M, K, P, S and Y of Compound 1 as provided herein. Certain embodiments herein provide Form V as a mixture of solid forms comprising Compound 1, including, e.g., a mixture comprising one or more of the following: Forms D, E, J, L, U, O, Q, R, T, W, N, X, H, F, G, I, M, K, P, S and Y of Compound 1 as provided herein.

Certain embodiments herein provide Form V of Compound 1 which is substantially free of other solid forms comprising Compound 1 including, e.g., Forms A, B, C, D, E, J, L, U, O, Q, R, W, T, H, N, X, F, G, I, K, M, P, S, Y, NP1, NP3, and NP4 of Compound 1 as provided herein. Certain embodiments herein provide Form V as a mixture of solid forms comprising Compound 1, including, e.g., a mixture comprising one or more of the following: Forms A, B, C, D, E, J, L, U, O, Q, R, W, T, H, N, X, F, G, I, K, M, P, S, Y, NP1, NP3, and NP4 of Compound 1 as provided herein.

### 6.2.22. Form Y of Compound 1

In certain embodiments, provided herein is Form Y of Compound 1.

In another embodiment, Form Y of Compound 1 is crystalline.

In certain embodiments, Form Y is obtained after slurrying the mixture of Forms D/E/J in MeOH (aw˜0) for 3 days and drying at RT.

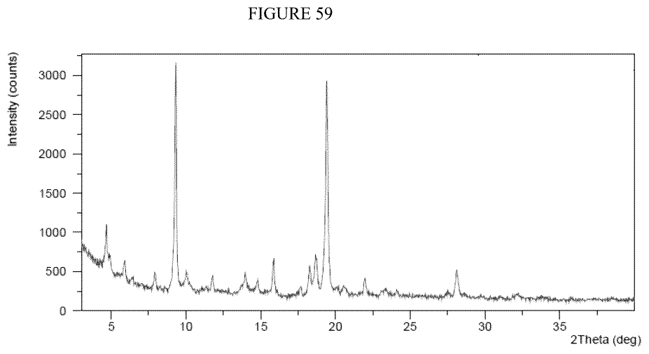

In one embodiment, Form Y of Compound 1 has an X-ray powder diffraction pattern substantially as shown in FIG. 59.

In one embodiment, Form Y of Compound 1 has one or more characteristic X-ray powder diffraction peaks at a two-theta angle of approximately 4.68, 9.31, 15.86 or 19.41 as depicted in FIG. 59. In another embodiment, Form Y of Compound 1 has one, two or three characteristic X-ray powder diffraction peaks at a two-theta angle of approximately 4.68, 9.31 or 19.41 degrees 2θ. In another embodiment, Form Y of Compound 1 has one or more characteristic X-ray powder diffraction peaks as set forth in Table 41. In another embodiment, Form Y of Compound 1 has one, two, or three characteristic X-ray powder diffraction peaks as set forth in Table 41.

In still another embodiment, Form Y of Compound 1 is substantially pure. In certain embodiments, the substantially pure Form Y of Compound 1 is substantially free of other solid forms, e.g., amorphous form. In certain embodiments, the purity of the substantially pure Form Y of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form Y of Compound 1 which is substantially pure. Certain embodiments herein provide Form Y of Compound 1 which is substantially free of other solid forms comprising Compound 1 including, e.g., Forms D, E, J, L, U, O, Q, R, T, W, N, X, H, F, G, I, M, K, P, S and V of Compound 1 as provided herein. Certain embodiments herein provide Form Y as a mixture of solid forms comprising Compound 1, including, e.g., a mixture comprising one or more of the following: Forms D, E, J, L, U, O, Q, R, T, W, N, X, H, F, G, I, M, K, P, S and V of Compound 1 as provided herein.

Certain embodiments herein provide Form Y of Compound 1 which is substantially free of other solid forms comprising Compound 1 including, e.g., Forms A, B, C, D, E, J, L, U, O, Q, R, W, T, H, N, X, F, G, I, K, M, P, S, V, NP1, NP3, and NP4 of Compound 1 as provided herein. Certain embodiments herein provide Form Y as a mixture of solid forms comprising Compound 1, including, e.g., a mixture comprising one or more of the following: Forms A, B, C, D, E, J, L, U, O, Q, R, W, T, H, N, X, F, G, I, K, M, P, S, V, NP1, NP3, and NP4 of Compound 1 as provided herein.

### 6.2.23. Form NP1 of Compound 1

In certain embodiments, provided herein is Form NP1 of Compound 1.

In another embodiment, Form NP1 of Compound 1 is crystalline.

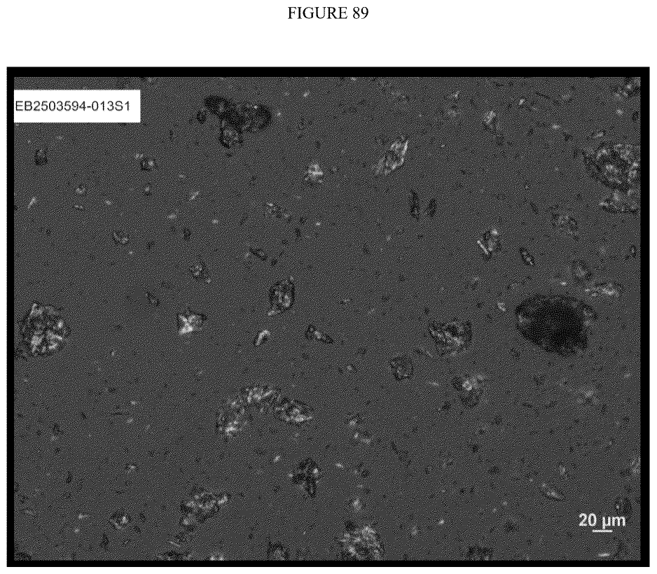

In one embodiment, Form NP1 has the PLM image provided in FIG. 89.

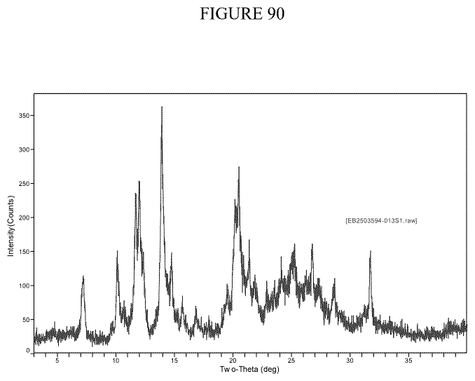

In one embodiment, Form NP1 of Compound 1 has an X-ray powder diffraction pattern substantially as shown in FIG. 90.

In one embodiment, Form NP1 of Compound 1 has one or more characteristic X-ray powder diffraction peaks at a two-theta angle of approximately 13.94 as depicted in FIG. 90. In another embodiment, Form NP1 of Compound 1 has one, two or three characteristic X-ray powder diffraction peaks at a two-theta angle of approximately 11.97, 13.94 or 20.52 degrees 2θ. In one embodiment, Form NP1 of Compound 1 has one, two, three, four or five characteristic X-ray powder diffraction peaks at a two-theta angle of approximately 11.67, 11.97, 13.94, 20.17 or 20.52 as depicted in FIG. 90. In another embodiment, Form NP1 of Compound 1 has one or more characteristic X-ray powder diffraction peaks as set forth in Table N1. In another embodiment, Form NP1 of Compound 1 has one, two, or three characteristic X-ray powder diffraction peaks as set forth in Table N1.

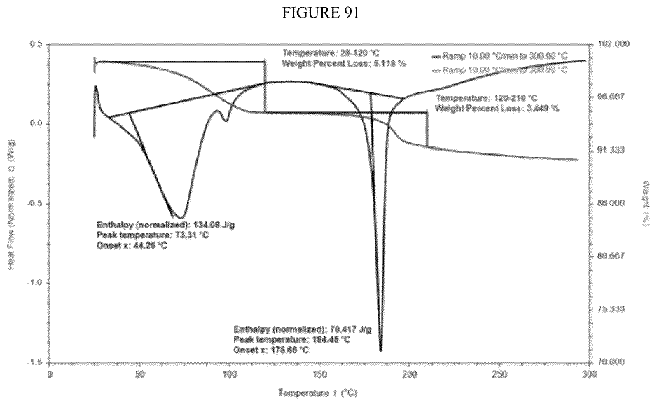

In one embodiment, provided herein is a solid form of Compound 1 having a thermogravimetric thermograph corresponding substantially to the representative TGA thermogram as depicted in FIG. 91. In certain embodiments, Form NP1 shows a TGA weight loss of about 3.1% between about 35° C. and about 130° C. In certain embodiments, Form NP1 shows a TGA weight loss of about 2.6% between about 130° C. and 190° C. In certain embodiments, Form NP1 shows a two step TGA weight loss of about 3.1% between about 35° C. and about 130° C. and about 2.6% between about 130° C. and about 190° C.

In one embodiment, provided herein is solid Form NP1 of Compound 1 having a DSC thermogram corresponding substantially as depicted in FIG. 91. In certain embodiments, Form NP1 is characterized by a DSC plot comprising multiple adjacent endotherms between 30° C. to 140° C. In certain embodiments, Form NP1 is characterized by a DSC plot comprising multiple adjacent endotherms between 30° C. to 140° C., and ΔH of 165.9/174.1 and 56.0 J/g.

In still another embodiment, Form NP1 of Compound 1 is substantially pure. In certain embodiments, the substantially pure Form NP1 of Compound 1 is substantially free of other solid forms, e.g., amorphous form. In certain embodiments, the purity of the substantially pure Form NP1 of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form NP1 of Compound 1 which is substantially pure. Certain embodiments herein provide Form NP1 of Compound 1 which is substantially free of other solid forms comprising Compound 1 including, e.g., Forms A, B, C, D, E, J, L, U, O, Q, R, T, W, N, X, H, F, G, I, M, K, P, S, V, Y, NP3 and NP4 of Compound 1 as provided herein. Certain embodiments herein provide Form NP1 as a mixture of solid forms comprising Compound 1, including, e.g., a mixture comprising one or more of the following: Forms A, B, C, D, E, J, L, U, O, Q, R, T, W, N, X, H, F, G, I, M, K, P, S, V, Y, NP3 and NP4 of Compound 1 as provided herein.

### 6.2.24. Form NP3 of Compound 1

In certain embodiments, provided herein is Form NP3 of Compound 1.

In another embodiment, Form NP3 of Compound 1 is crystalline.

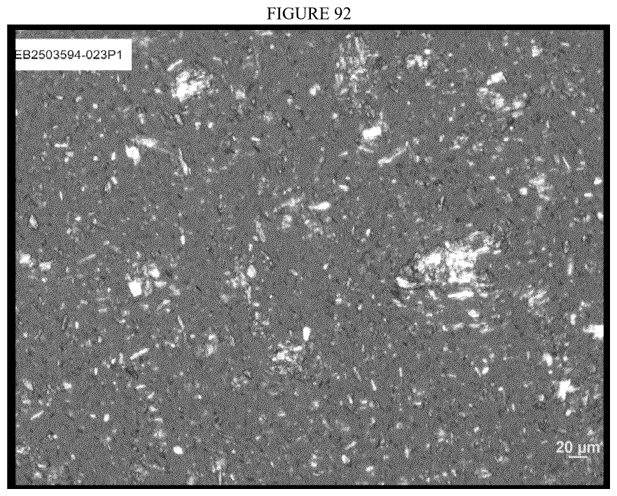

In one embodiment, Form NP3 has the PLM image provided in FIG. 92.

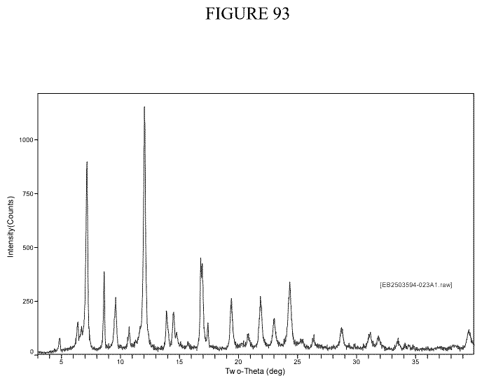

In one embodiment, Form NP3 of Compound 1 has an X-ray powder diffraction pattern substantially as shown in FIG. 93.

In one embodiment, Form NP3 of Compound 1 has one or more characteristic X-ray powder diffraction peaks at a two-theta angle of approximately 12.04 as depicted in FIG. 93. In another embodiment, Form NP3 of Compound 1 has one, two or three characteristic X-ray powder diffraction peaks at a two-theta angle of approximately 7.18, 8.62 or 16.82 degrees 2θ. In one embodiment, Form NP3 of Compound 1 has one or more characteristic X-ray powder diffraction peaks at a two-theta angle of approximately 7.18, 8.62, 12.04, 16.82, or 24.34 as depicted in FIG. 93. In another embodiment, Form NP3 of Compound 1 has one or more characteristic X-ray powder diffraction peaks as set forth in Table N3. In another embodiment, Form NP3 of Compound 1 has one, two, or three characteristic X-ray powder diffraction peaks as set forth in Table N3.

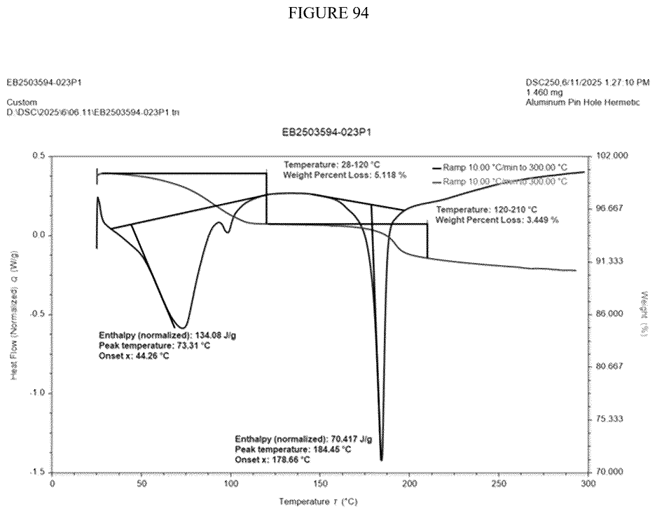

In one embodiment, provided herein is a solid form of Compound 1 having a thermogravimetric thermograph corresponding substantially to the representative TGA thermogram as depicted in FIG. 94. In certain embodiments, Form NP3 shows a TGA weight loss of about 5.1% between about 28° C. and about 120° C. In certain embodiments, Form NP3 shows a TGA weight loss of about 2.6% between about 60° C. and 120° C. In certain embodiments, Form NP3 shows a TGA weight loss of about 3.4% between about 120° C. and 210° C. In certain embodiments, Form NP3 shows a three step TGA weight loss of about 5.1% between about 28° C.-120° C., about 2.6% between about 60° C.-120° C., and about 3.4% between about 120° C.-210° C.

In one embodiment, provided herein is solid Form NP3 of Compound 1 having a DSC thermogram corresponding substantially as depicted in FIG. 94. In certain embodiments, Form NP3 is characterized by a DSC plot comprising endotherms between about 44.3° C. to about 184.5° C. In certain embodiments, Form NP1 is characterized by a DSC plot comprising multiple adjacent endotherms between about 44.3° C. to 184.5°, and ΔH of 165.9/174.1 and 56.0 J/g.

In still another embodiment, Form NP3 of Compound 1 is substantially pure. In certain embodiments, the substantially pure Form NP3 of Compound 1 is substantially free of other solid forms, e.g., amorphous form. In certain embodiments, the purity of the substantially pure Form NP3 of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form NP3 of Compound 1 which is substantially pure. Certain embodiments herein provide Form NP3 of Compound 1 which is substantially free of other solid forms comprising Compound 1 including, e.g., Forms A, B, C, D, E, J, L, U, O, Q, R, T, W, N, X, H, F, G, I, M, K, P, S, V, Y, NP1 and NP4 of Compound 1 as provided herein. Certain embodiments herein provide Form NP3 as a mixture of solid forms comprising Compound 1, including, e.g., a mixture comprising one or more of the following: Forms A, B, C, D, E, J, L, U, O, Q, R, T, W, N, X, H, F, G, I, M, K, P, S, V, Y, NP1 and NP4 of Compound 1 as provided herein.

### 6.2.25. Form NP4 of Compound 1

In certain embodiments, provided herein is Form NP4 of Compound 1.

In another embodiment, Form NP4 of Compound 1 is crystalline.

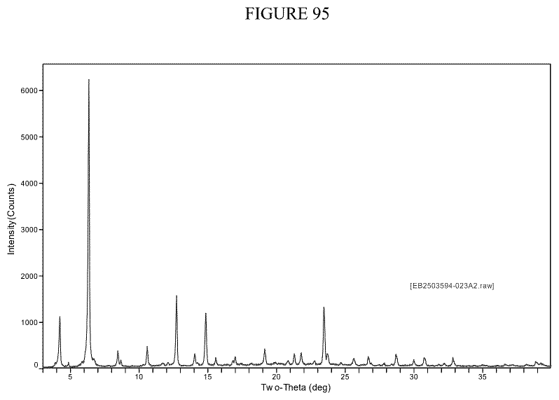

In one embodiment, Form NP4 of Compound 1 has an X-ray powder diffraction pattern substantially as shown in FIG. 95.

In one embodiment, Form NP4 of Compound 1 has one or more characteristic X-ray powder diffraction peaks at a two-theta angle of approximately 6.35 as depicted in FIG. 95. In one embodiment, Form NP4 of Compound 1 has one, two or three characteristic X-ray powder diffraction peaks at a two-theta angle of approximately 6.35, 12.73 or 23.45, as depicted in FIG. 95. In another embodiment, Form NP4 of Compound 1 has one or more characteristic X-ray powder diffraction peaks at a two-theta angle of approximately 6.35, 10.59, 12.73, 14.87 or 23.45 degrees 2θ. In another embodiment, Form NP4 of Compound 1 has one or more characteristic X-ray powder diffraction peaks as set forth in Table N4. In another embodiment, Form NP4 of Compound 1 has one, two, or three characteristic X-ray powder diffraction peaks as set forth in Table N4.

In still another embodiment, Form NP4 of Compound 1 is substantially pure. In certain embodiments, the substantially pure Form NP4 of Compound 1 is substantially free of other solid forms, e.g., amorphous form. In certain embodiments, the purity of the substantially pure Form NP4 of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form NP4 of Compound 1 which is substantially pure. Certain embodiments herein provide Form NP4 of Compound 1 which is substantially free of other solid forms comprising Compound 1 including, e.g., Forms A, B, C, D, E, J, L, U, O, Q, R, T, W, N, X, H, F, G, I, M, K, P, S, V, Y, NP1 and NP3 of Compound 1 as provided herein. Certain embodiments herein provide Form NP4 as a mixture of solid forms comprising Compound 1, including, e.g., a mixture comprising one or more of the following: Forms A, B, C, D, E, J, L, U, O, Q, R, T, W, N, X, H, F, G, I, M, K, P, S, V, Y, NP1 and NP3 of Compound 1 as provided herein.

### 6.2.26. Form A of Compound 1

In certain embodiments, provided herein is Form A of Compound 1.

In one embodiment, Form A is crystalline.

In certain embodiments, Form A is obtained via a slurry of freeform 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and NaOH in methanol at room temperature. In one embodiment, Form A is obtained via a slurry of NaOH and freeform Compound 1 in a ratio of 2:1 in methanol at room temperature.

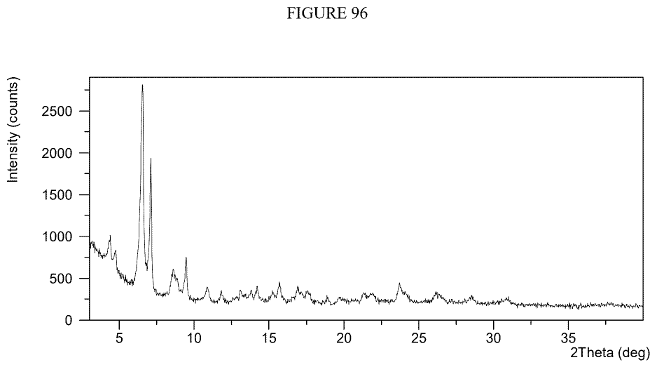

In certain embodiments, Form A is crystalline, as indicated by, e.g., X-ray powder diffraction measurements. In one embodiment, Form A of Compound 1 has an X-ray powder diffraction pattern substantially as shown in FIG. 96.

In one embodiment, Form A of Compound 1 has one or more characteristic X-ray powder diffraction peaks at a two-theta angle of approximately 6.56 as depicted in FIG. 96. In another embodiment, Form A of Compound 1 has one, two or three characteristic X-ray powder diffraction peaks at approximately 6.56, 7.10 and 9.46 degrees 2θ. In another embodiment, Form A of Compound 1 has one, two, three, four or five characteristic X-ray powder diffraction peaks at approximately 4.41, 6.56, 7.10, 8.56 and 9.46 degrees 2θ. In another embodiment, Form A of Compound 1 has one or more characteristic X-ray powder diffraction peaks as set forth in Table 64. In another embodiment, Form A of Compound 1 has one, two, three, four, five, six or seven characteristic X-ray powder diffraction peaks as set forth in Table 64. In another embodiment, Form A of Compound 1 has one, two, or three characteristic X-ray powder diffraction peaks as set forth in Table 64.

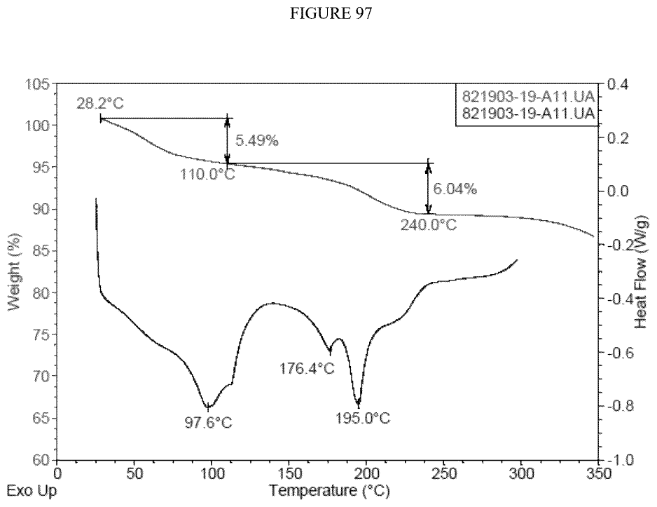

In one embodiment, provided herein is a solid form of Compound 1 having a thermogravimetric thermograph corresponding substantially to the representative TGA thermogram as depicted in FIG. 97. In certain embodiments, Form A shows a TGA weight loss of about 5.5% up to about 110° C. In certain embodiments, Form A shows a TGA weight loss of about 6.0% between about 110° C. and 240° C. In certain embodiments, Form A shows a two step TGA weight loss of about 5.5% up to about 110° C. and about 6.0% between about 110° C. and about 240° C.

In one embodiment, provided herein is solid Form A of Compound 1 having a DSC thermogram corresponding substantially as depicted in FIG. 97. In certain embodiments, Form A is characterized by a DSC plot comprising three endotherms at about 97.6° C., 176.4° C. and 195.0° C. (peak).

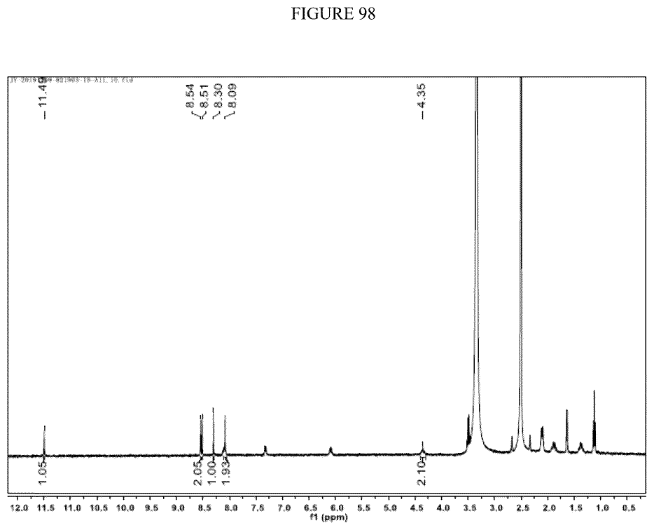

In one embodiment, Form A has ¹H NMR shown in FIG. 98. In one embodiment, the stoichiometric ratio of Na⁺/freeform was 1.5:1 by HPLC combined with IC.

In still another embodiment, Form A of Compound 1 is substantially pure. In certain embodiments, the substantially pure Form A of Compound 1 is substantially free of other solid forms, e.g., amorphous form. In certain embodiments, the purity of the substantially pure Form A of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form A of Compound 1 which is substantially free of other solid forms comprising Compound 1 including, e.g., Forms B, C, D, E, J, L, U, O, Q, R, W, T, H, N, X, F, G, I, K, M, P, S, V, Y, NP1, NP3, and NP4 of Compound 1 as provided herein. Certain embodiments herein provide Form A as a mixture of solid forms comprising Compound 1, including, e.g., a mixture comprising one or more of the following: Forms B, C, D, E, J, L, U, O, Q, R, W, T, H, N, X, F, G, I, K, M, P, S, V, Y, NP1, NP3, and NP4 of Compound 1 as provided herein.

### 6.2.27. Form B of Compound 1

In certain embodiments, provided herein is Form B of Compound 1.

In one embodiment, Form B is crystalline.

In certain embodiments, Form B is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and NaOH in DMSO/Acetone (1:4 v/v) at room temperature. In one embodiment, Form B is obtained via a slurry of NaOH and freeform Compound 1 in a ratio of 2:1 in DMSO/Acetone (1:4 v/v) at room temperature.

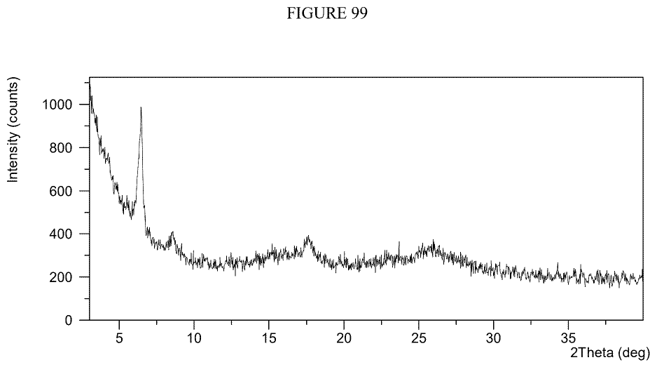

In certain embodiments, Form B is crystalline, as indicated by, e.g., X-ray powder diffraction measurements. In one embodiment, Form B of Compound 1 has an X-ray powder diffraction pattern substantially as shown in FIG. 99.

In one embodiment, Form B of Compound 1 has one or more characteristic X-ray powder diffraction peaks at a two-theta angle of approximately 6.48 as depicted in FIG. 99. In another embodiment, Form B of Compound 1 has one, two or three characteristic X-ray powder diffraction peaks at a two-theta angle of approximately 6.48, 8.59 and 17.60 degrees 2θ. In another embodiment, Form B of Compound 1 has one or more characteristic X-ray powder diffraction peaks as set forth in Table 65. In another embodiment, Form B of Compound 1 has one, two or three characteristic X-ray powder diffraction peaks as set forth in Table 65.

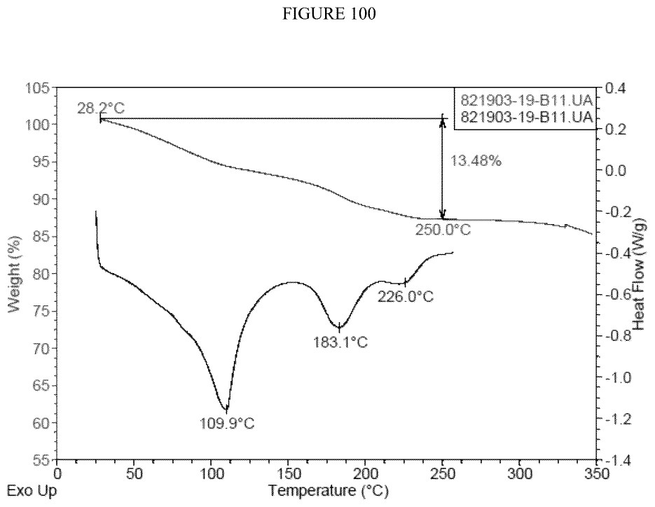

In one embodiment, provided herein is a solid form of Compound 1 having a thermogravimetric thermograph corresponding substantially to the representative TGA thermogram as depicted in FIG. 100. In certain embodiments, Form B shows a TGA weight loss of about 13.5% up to about 250° C.

In one embodiment, provided herein is solid Form B of Compound 1 having a DSC thermogram corresponding substantially as depicted in FIG. 100. In certain embodiments, Form B is characterized by a DSC plot comprising three endotherms at about 109.9° C., 183.1° C. and 226.0° C. (peak).

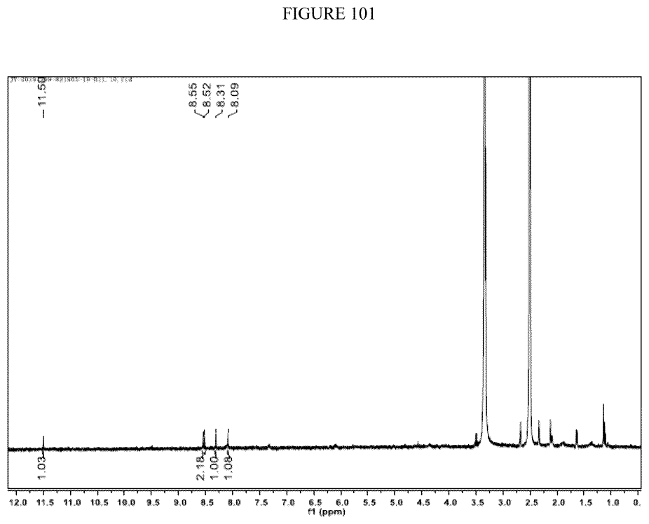

In one embodiment, the ¹H NMR of Form B shows no residual solvent DMSO or Acetone. In one embodiment, Form B has ¹H NMR shown in FIG. 101. In one embodiment, the stoichiometric ratio of Na⁺/freeform was 1.5:1 by HPLC/IC.

In still another embodiment, Form B of Compound 1 is substantially pure. In certain embodiments, the substantially pure Form B of Compound 1 is substantially free of other solid forms, e.g., amorphous form. In certain embodiments, the purity of the substantially pure Form B of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form B of Compound 1 which is substantially free of other solid forms comprising Compound 1 including, e.g., Forms A, C, D, E, J, L, U, O, Q, R, W, T, H, N, X, F, G, I, K, M, P, S, V, Y, NP1, NP3, and NP4 of Compound 1 as provided herein. Certain embodiments herein provide Form B as a mixture of solid forms comprising Compound 1, including, e.g., a mixture comprising one or more of the following: Forms A, C, D, E, J, L, U, O, Q, R, W, T, H, N, X, F, G, I, K, M, P, S, V, Y, NP1, NP3, and NP4 of Compound 1 as provided herein.

### 6.2.28. Form C of Compound 1

In certain embodiments, provided herein is Form C of Compound 1.

In one embodiment, Form C is crystalline.

In certain embodiments, Form C is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and NaOH in EtOAc at room temperature. In one embodiment, Form C is obtained via a slurry of NaOH and freeform Compound 1 in a ratio of 2:1 in EtOAc at room temperature.

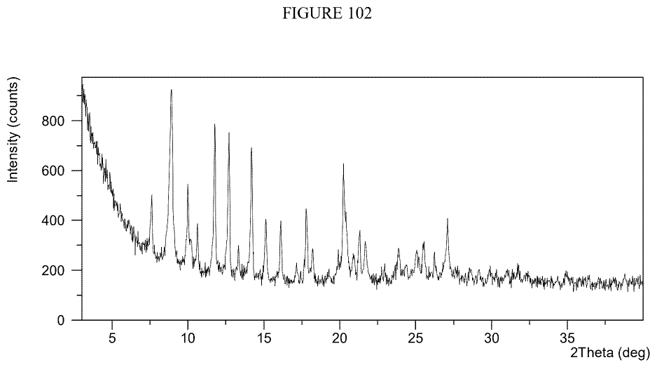

In certain embodiments, Form C is crystalline, as indicated by, e.g., X-ray powder diffraction measurements. In one embodiment, Form C of Compound 1 has an X-ray powder diffraction pattern substantially as shown in FIG. 102.

In one embodiment, Form C of Compound 1 has one or more characteristic X-ray powder diffraction peaks at a two-theta angle of approximately 8.93 as depicted in FIG. 102. In another embodiment, Form C of Compound 1 has one, two or three characteristic X-ray powder diffraction peaks at a two-theta angle of approximately 8.93, 11.77 or 12.70 degrees 2θ. In another embodiment, Form C of Compound 1 has one, two, three or four characteristic X-ray powder diffraction peaks at a two-theta angle of approximately 8.93, 11.77, 12.70 or 14.20 degrees 2θ. In another embodiment, Form C of Compound 1 has one, two, three, four or five characteristic X-ray powder diffraction peaks at a two-theta angle of approximately 8.93, 11.77, 12.70, 14.20 or 20.24 degrees 2θ. In another embodiment, Form C of Compound 1 has one or more characteristic X-ray powder diffraction peaks as set forth in Table 66. In another embodiment, Form C of Compound 1 has one, two, three, four, five, six or seven characteristic X-ray powder diffraction peaks as set forth in Table 66. In another embodiment, Form C of Compound 1 has one, two, or three characteristic X-ray powder diffraction peaks as set forth in Table 66.

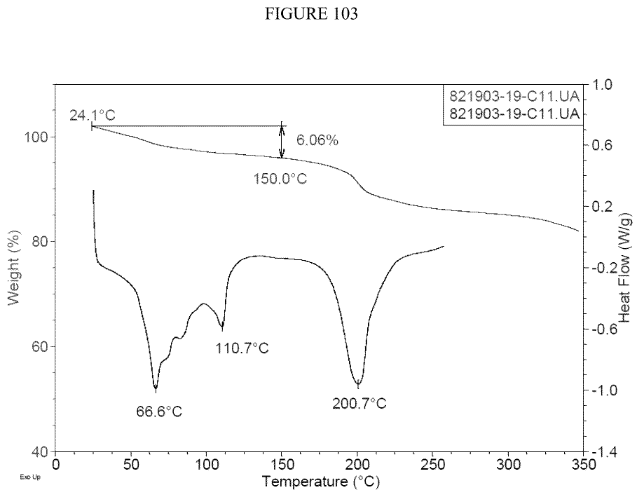

In one embodiment, provided herein is a solid form of Compound 1 having a thermogravimetric thermograph corresponding substantially to the representative TGA thermogram as depicted in FIG. 103. In certain embodiments, Form C shows a TGA weight loss of about 6.1% up to about 150° C.

In one embodiment, provided herein is solid Form C of Compound 1 having a DSC thermogram corresponding substantially as depicted in FIG. 103. In certain embodiments, Form C is characterized by a DSC plot comprising three endotherms at about 66.6° C., 110.7° C. and 200.7° C. (peak).

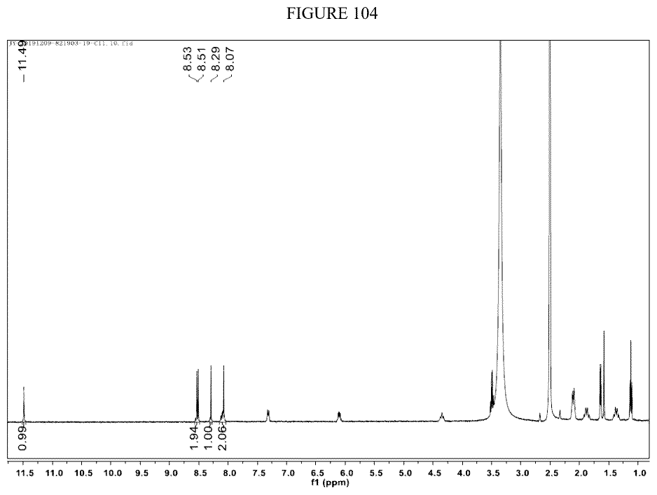

In one embodiment, the ¹H NMR of Form C shows no residual solvent EiOAc. In one embodiment, Form C has ¹H NMR shown in FIG. 104. In one embodiment, the stoichiometric ratio of Na⁺/freeform was 1.5:1 by HPLC/IC.

In still another embodiment, Form C of Compound 1 is substantially pure. In certain embodiments, the substantially pure Form C of Compound 1 is substantially free of other solid forms, e.g., amorphous form. In certain embodiments, the purity of the substantially pure Form C of Compound 1 is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form C of Compound 1 which is substantially free of other solid forms comprising Compound 1 including, e.g., Forms A, B, D, E, J, L, U, O, Q, R, W, T, H, N, X, F, G, I, K, M, P, S, V, Y, NP1, NP3, and NP4 of Compound 1 as provided herein. Certain embodiments herein provide Form C as a mixture of solid forms comprising Compound 1, including, e.g., a mixture comprising one or more of the following: Forms A, B, D, E, J, L, U, O, Q, R, W, T, H, N, X, F, G, I, K, M, P, S, V, Y, NP1, NP3, and NP4 of Compound 1 as provided herein.

### 6.2.29. Form A of Compound 1A

In certain embodiments, provided herein is Form A of Compound 1A.

In one embodiment, Form A of Compound 1A is crystalline.

In certain embodiments, Form A is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and equimolar KOH in methanol at room temperature.

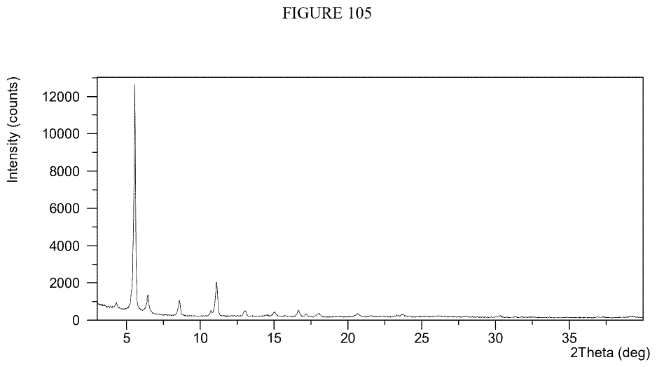

In certain embodiments, Form A is crystalline, as indicated by, e.g., X-ray powder diffraction measurements. In one embodiment, Form A of Compound 1 has an X-ray powder diffraction pattern substantially as shown in FIG. 105.

In one embodiment, Form A of Compound 1A has one or more characteristic X-ray powder diffraction peaks at a two-theta angle of approximately 5.56 as depicted in FIG. 105. In another embodiment, Form A of Compound 1A has one, two or three characteristic X-ray powder diffraction peaks at a two-theta angle of approximately 5.56, 6.45 or 11.10 degrees 2θ. In another embodiment, Form A of Compound 1A has one, two, three or four characteristic X-ray powder diffraction peaks at a two-theta angle of approximately 5.56, 6.45, 8.59 or 11.10 degrees 2θ. In another embodiment, Form A of Compound 1A has one or more characteristic X-ray powder diffraction peaks as set forth in Table 67. In another embodiment, Form A of Compound 1A has one, two, three, or four characteristic X-ray powder diffraction peaks as set forth in Table 67. In another embodiment, Form A of Compound 1A has one, two, or three characteristic X-ray powder diffraction peaks as set forth in Table 67.

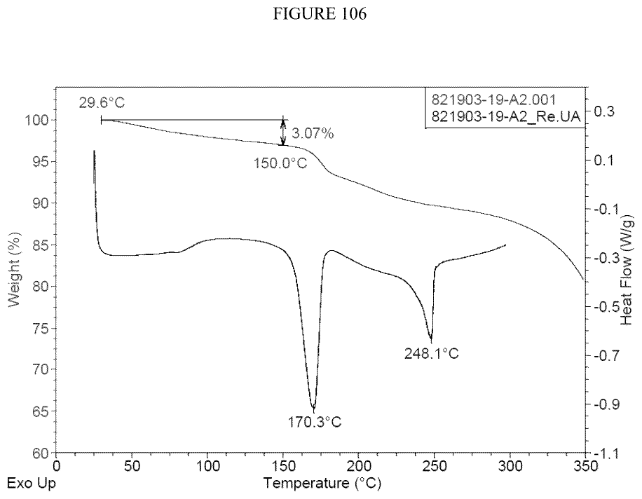

In one embodiment, provided herein is a solid form of Compound 1A having a thermogravimetric thermograph corresponding substantially to the representative TGA thermogram as depicted in FIG. 106. In certain embodiments, Form C shows a TGA weight loss of about 3.1% up to about 150° C.

In one embodiment, provided herein is solid Form A of Compound 1A having a DSC thermogram corresponding substantially as depicted in FIG. 106. In certain embodiments, Form A is characterized by a DSC plot comprising two endotherms at about 170.3° C. and 248.1° C. (peak).

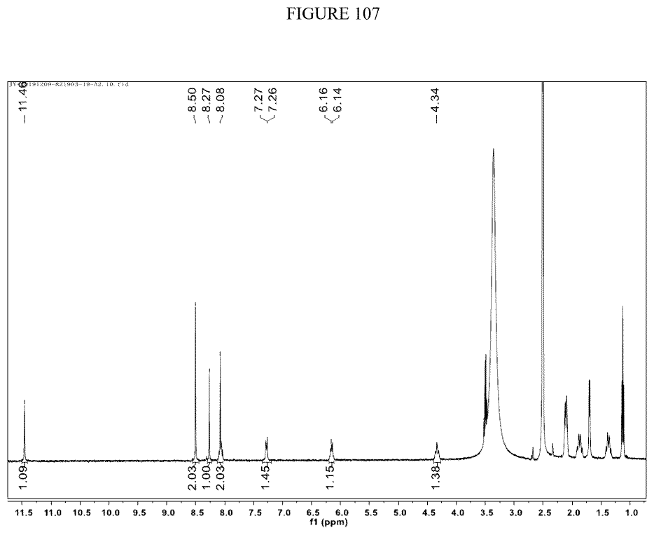

In one embodiment, the ¹H NMR of Form A shows no residual solvent methanol. In one embodiment, Form A has ¹H NMR shown in FIG. 107. In one embodiment, the stoichiometric ratio of K⁺/freeform was 0.7:1 by HPLC/IC.

In still another embodiment, Form A of Compound 1A is substantially pure. In certain embodiments, the substantially pure Form A of Compound 1A is substantially free of other solid forms, e.g., amorphous form. In certain embodiments, the purity of the substantially pure Form A of Compound 1A is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form A of Compound 1A which is substantially free of other solid forms comprising Compound 1A including, e.g., Forms B, C and D of Compound 1A as provided herein. Certain embodiments herein provide Form A as a mixture of solid forms comprising Compound 1A, including, e.g., a mixture comprising one or more of the following: Forms B, C and D of Compound 1A as provided herein.

### 6.2.30. Form B of Compound 1A

In certain embodiments, provided herein is Form B of Compound 1A.

In one embodiment, Form B of Compound 1A is a hydrate.

In one embodiment, Form B of Compound 1A is crystalline.

In certain embodiments, Form B is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and equimolar KOH in EtOAc at room temperature.

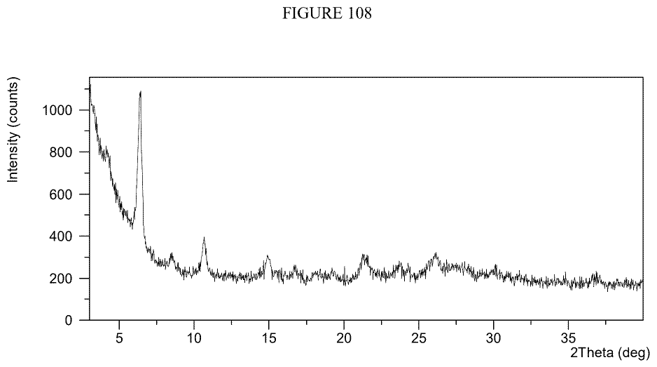

In certain embodiments, Form B is crystalline, as indicated by, e.g., X-ray powder diffraction measurements. In one embodiment, Form B of Compound 1 has an X-ray powder diffraction pattern substantially as shown in FIG. 108.

In one embodiment, Form B of Compound 1A has one or more characteristic X-ray powder diffraction peaks at a two-theta angle of approximately 6.41 as depicted in FIG. 108. In another embodiment, Form B of Compound 1A has one, two or three characteristic X-ray powder diffraction peaks at a two-theta angle of approximately 6.41, 10.67 or 14.94 degrees 2θ. In another embodiment, Form B of Compound 1A has one, two, three, four or five characteristic X-ray powder diffraction peaks at a two-theta angle of approximately 6.41, 10.67, 14.94, 21.37 or 26.02 degrees 2θ. In another embodiment, Form B of Compound 1A has one or more characteristic X-ray powder diffraction peaks as set forth in Table 68. In another embodiment, Form B of Compound 1A has one, two, three, four, five, six or seven characteristic X-ray powder diffraction peaks as set forth in Table 68. In another embodiment, Form B of Compound 1A has one, two, or three characteristic X-ray powder diffraction peaks as set forth in Table 68.

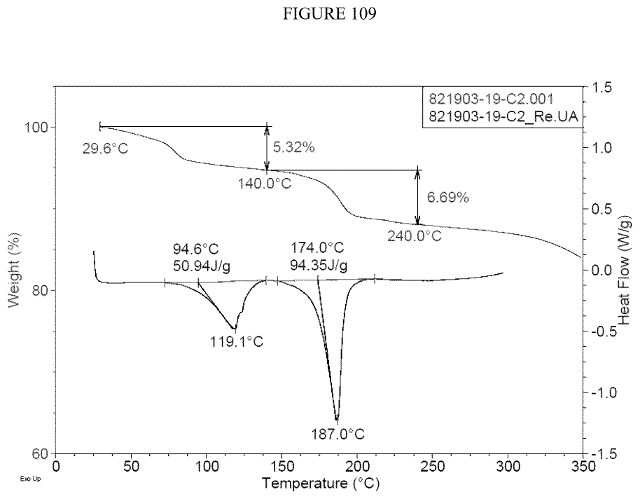

In one embodiment, provided herein is a solid form of Compound 1A having a thermogravimetric thermograph corresponding substantially to the representative TGA thermogram as depicted in FIG. 109. In certain embodiments, Form B shows a TGA weight loss of about 5.3% up to about 140° C. In certain embodiments, Form B shows a TGA weight loss of about 6.7% between about 140° C. and about 240° C. In certain embodiments, Form B shows a two step TGA weight loss of about 5.3% up to about 140° C., and about 6.7% between about 140° C. and about 240° C.

In one embodiment, provided herein is solid Form B of Compound 1A having a DSC thermogram corresponding substantially as depicted in FIG. 109. In certain embodiments, Form B is characterized by a DSC plot comprising two endotherms at about 119.1° C. and 187.0° C. (peak).

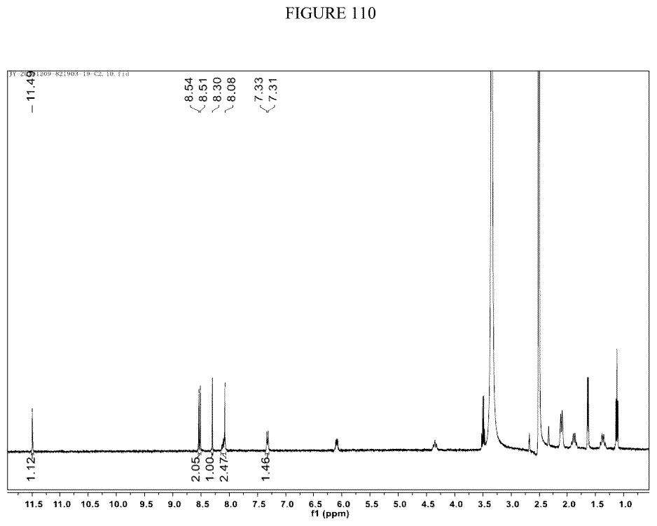

In one embodiment, the ¹H NMR of Form B shows no residual solvent EtOAc. In one embodiment, Form B has ¹H NMR shown in FIG. 110. In one embodiment, the stoichiometric ratio of K⁺/freeform was 1.1:1 by HPLC/IC.

In still another embodiment, Form B of Compound 1A is substantially pure. In certain embodiments, the substantially pure Form B of Compound 1A is substantially free of other solid forms, e.g., amorphous form. In certain embodiments, the purity of the substantially pure Form B of Compound 1A is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form B of Compound 1A which is substantially free of other solid forms comprising Compound 1A including, e.g., Forms A, C and D of Compound 1A as provided herein. Certain embodiments herein provide Form B as a mixture of solid forms comprising Compound 1A, including, e.g., a mixture comprising one or more of the following: Forms A, C and D of Compound 1A as provided herein.

### 6.2.31. Form C of Compound 1A

In certain embodiments, provided herein is Form C of Compound 1A.

In one embodiment, Form C of Compound 1A is a hydrate.

In one embodiment, Form C of Compound 1A is crystalline.

In certain embodiments, Form C is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and equimolar KOH in THF/H₂O (9:1, v/v) at room temperature.

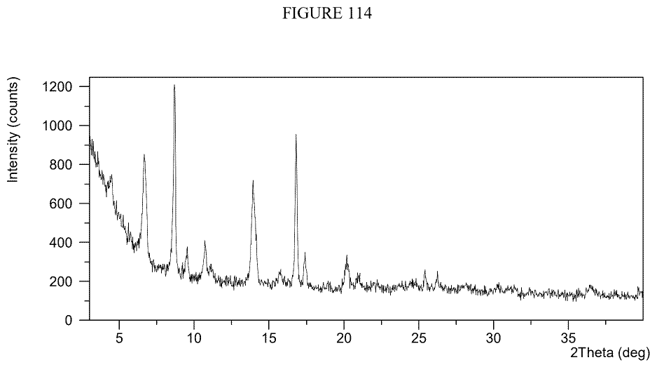

In certain embodiments, Form C is crystalline, as indicated by, e.g., X-ray powder diffraction measurements. In one embodiment, Form C of Compound 1 has an X-ray powder diffraction pattern substantially as shown in FIG. 114.

In one embodiment, Form C of Compound 1A has one or more characteristic X-ray powder diffraction peaks at a two-theta angle of approximately 8.69 as depicted in FIG. 114. In another embodiment, Form C of Compound 1A has one, two or three characteristic X-ray powder diffraction peaks at a two-theta angle of approximately 6.67, 8.69 or 16.82 degrees 2θ. In another embodiment, Form C of Compound 1A has one, two, three, four or five characteristic X-ray powder diffraction peaks at a two-theta angle of approximately 6.67, 8.69, 10.72, 13.91 or 16.82 degrees 2θ. In another embodiment, Form C of Compound 1A has one or more characteristic X-ray powder diffraction peaks as set forth in Table 69. In another embodiment, Form C of Compound 1A has one, two, three, four, five, six or seven characteristic X-ray powder diffraction peaks as set forth in Table 69. In another embodiment, Form C of Compound 1A has one, two, or three characteristic X-ray powder diffraction peaks as set forth in Table 69.

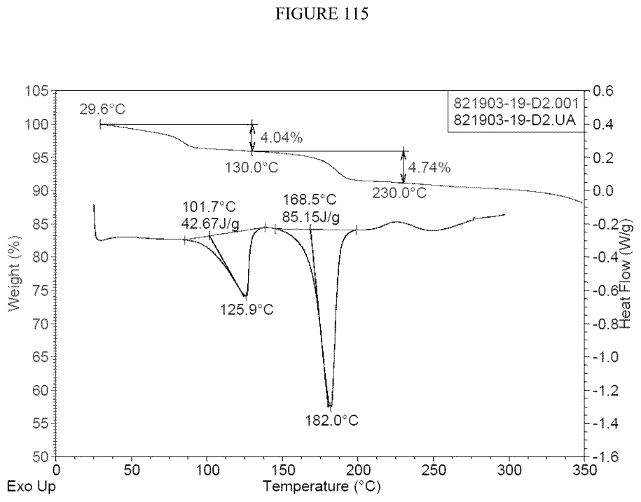

In one embodiment, provided herein is a solid form of Compound 1A having a thermogravimetric thermograph corresponding substantially to the representative TGA thermogram as depicted in FIG. 115. In certain embodiments, Form C shows a TGA weight loss of about 4.0% up to about 130° C. In certain embodiments, Form C shows a TGA weight loss of about 4.7% between about 130° C. and about 230° C. In certain embodiments, Form C shows a two step TGA weight loss of about 4.0% up to about 130° C., and about 4.7% between about 130° C. and about 230° C.

In one embodiment, provided herein is solid Form C of Compound 1A having a DSC thermogram corresponding substantially as depicted in FIG. 115. In certain embodiments, Form C is characterized by a DSC plot comprising two endotherms at about 125.9° C. and 182.0° C. (peak).

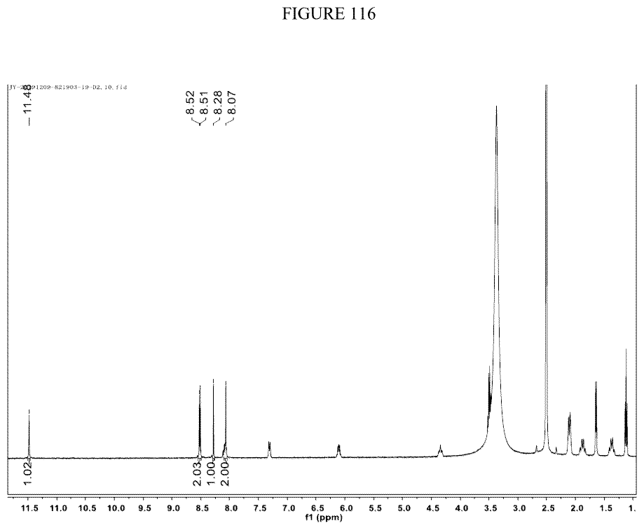

In one embodiment, the ¹H NMR of Form C shows no residual solvent THF. In one embodiment, Form C has ¹H NMR shown in FIG. 116. In one embodiment, the stoichiometric ratio of K⁺/freeform was 1.0:1 by HPLC/IC.

In still another embodiment, Form C of Compound 1A is substantially pure. In certain embodiments, the substantially pure Form C of Compound 1A is substantially free of other solid forms, e.g., amorphous form. In certain embodiments, the purity of the substantially pure Form C of Compound 1A is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form C of Compound 1A which is substantially free of other solid forms comprising Compound 1A including, e.g., Forms A, B and D of Compound 1A as provided herein. Certain embodiments herein provide Form C as a mixture of solid forms comprising Compound 1A, including, e.g., a mixture comprising one or more of the following: Forms A, B and D of Compound 1A as provided herein.

### 6.2.32. Form D of Compound 1A

In certain embodiments, provided herein is Form D of Compound 1A.

In one embodiment, Form D of Compound 1A is a hydrate.

In one embodiment, Form D of Compound 1A is crystalline.

In certain embodiments, Form D is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and KOH (in DMSO/Acetone (1:4, v/v) at room temperature. In one embodiment, the charge ratio of base to 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate is 2:1.

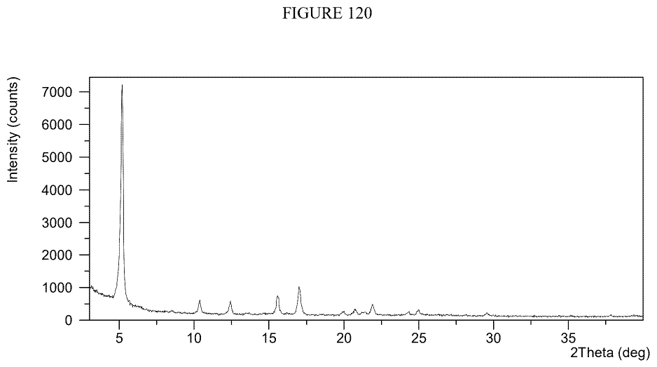

In certain embodiments, Form D is crystalline, as indicated by, e.g., X-ray powder diffraction measurements. In one embodiment, Form D of Compound 1A has an X-ray powder diffraction pattern substantially as shown in FIG. 120.

In one embodiment, Form D of Compound 1A has one or more characteristic X-ray powder diffraction peaks at a two-theta angle of approximately 5.20 as depicted in FIG. 120. In another embodiment, Form D of Compound 1A has one, two or three characteristic X-ray powder diffraction peaks at a two-theta angle of approximately 5.20, 15.57 or 17.01 degrees 2θ. In another embodiment, Form D of Compound 1A has one, two, three, four or five characteristic X-ray powder diffraction peaks at a two-theta angle of approximately 5.20, 10.37, 15.57, 17.1 or 21.92 degrees 2θ. In another embodiment, Form D of Compound 1A has one or more characteristic X-ray powder diffraction peaks as set forth in Table 70. In another embodiment, Form D of Compound 1A has one, two, three, four, five, six or seven characteristic X-ray powder diffraction peaks as set forth in Table 70. In another embodiment, Form D of Compound 1A has one, two, or three characteristic X-ray powder diffraction peaks as set forth in Table 70.

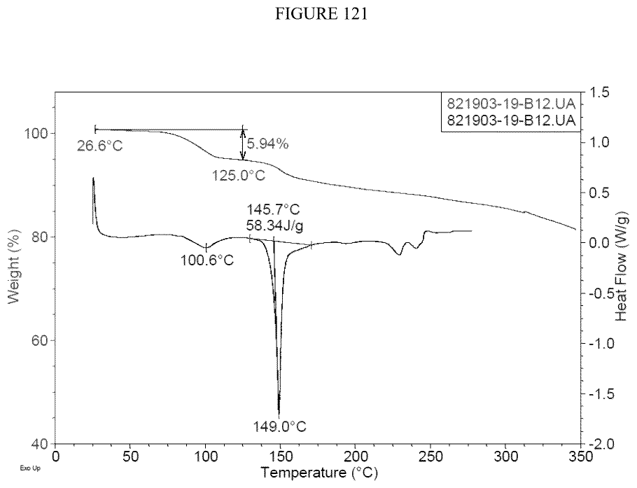

In one embodiment, provided herein is a solid form of Compound 1A having a thermogravimetric thermograph corresponding substantially to the representative TGA thermogram as depicted in FIG. 121. In certain embodiments, Form D shows a TGA weight loss of about 5.9% up to about 125° C.

In one embodiment, provided herein is solid Form D of Compound 1A having a DSC thermogram corresponding substantially as depicted in FIG. 121. In certain embodiments, Form D is characterized by a DSC plot comprising a weak endotherm at 100.6° C. (peak) and a sharp endotherm at 149.0° C. (peak).

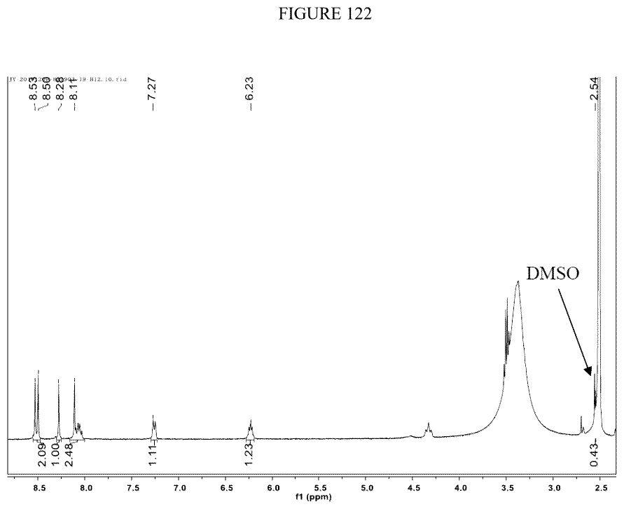

In one embodiment, the ¹H NMR of Form D shows the molar ratio of residual solvent DMSO/freeform was 0.07:1. In one embodiment, Form D has ¹H NMR shown in FIG. 122. In one embodiment, the stoichiometric ratio of K⁺/freeform was 1.4:1 by HPLC/IC.

In still another embodiment, Form D of Compound 1A is substantially pure. In certain embodiments, the substantially pure Form D of Compound 1A is substantially free of other solid forms, e.g., amorphous form. In certain embodiments, the purity of the substantially pure Form D of Compound 1A is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form D of Compound 1A which is substantially free of other solid forms comprising Compound 1A including, e.g., Forms A, B, C and E of Compound 1A as provided herein. Certain embodiments herein provide Form D as a mixture of solid forms comprising Compound 1A, including, e.g., a mixture comprising one or more of the following: Forms A, B, C and E of Compound 1A as provided herein.

### 6.2.33. Form E of Compound 1A

In certain embodiments, provided herein is Form E of Compound 1A.

In one embodiment, Form E of Compound 1A is crystalline.

In certain embodiments, Form D is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and KOH (in DMSO/Acetone (1:4, v/v) at room temperature. In one embodiment, the charge ratio of base to 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate is 2:1.

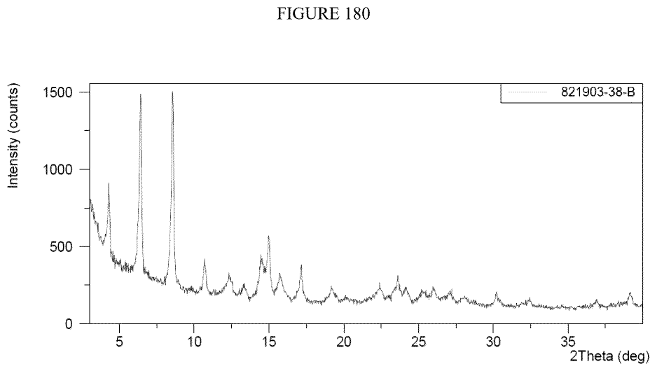

In certain embodiments, Form E is crystalline, as indicated by, e.g., X-ray powder diffraction measurements. In one embodiment, Form E of Compound 1A has an X-ray powder diffraction pattern substantially as shown in FIG. 180.

In one embodiment, Form E of Compound 1A has one or more characteristic X-ray powder diffraction peaks at a two-theta angle of approximately 8.55 as depicted in FIG. 180. In another embodiment, Form E of Compound 1A has one, two or three characteristic X-ray powder diffraction peaks at a two-theta angle of approximately 4.28, 6.41 or 8.55 degrees 2θ. In another embodiment, Form E of Compound 1A has one, two, three, four or five characteristic X-ray powder diffraction peaks at a two-theta angle of approximately 4.28, 6.41, 8.55, 14.98 or 17.14 degrees 2θ. In another embodiment, Form E of Compound 1A has one or more characteristic X-ray powder diffraction peaks as set forth in Table 89. In another embodiment, Form E of Compound 1A has one, two, three, four, five, six or seven characteristic X-ray powder diffraction peaks as set forth in Table 89. In another embodiment, Form E of Compound 1A has one, two, or three characteristic X-ray powder diffraction peaks as set forth in Table 89.

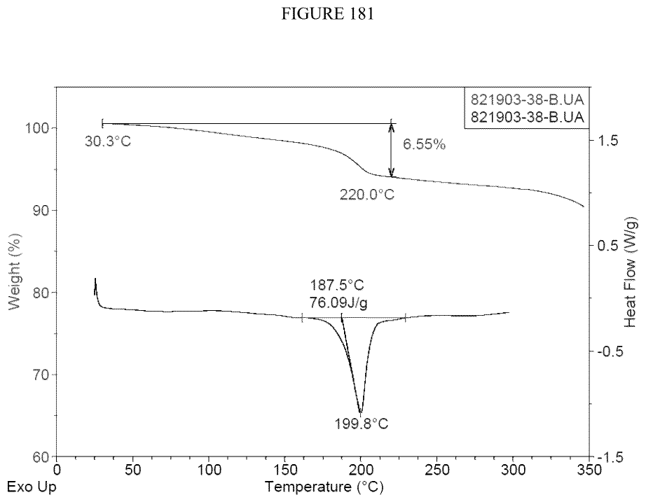

In one embodiment, provided herein is a solid form of Compound 1A having a thermogravimetric thermograph corresponding substantially to the representative TGA thermogram as depicted in FIG. 181. In certain embodiments, Form E shows a TGA weight loss of about 6.6% up to about 220° C.

In one embodiment, provided herein is solid Form E of Compound 1A having a DSC thermogram corresponding substantially as depicted in FIG. 181. In certain embodiments, Form E is characterized by a DSC plot comprising a endotherm at 199.8° C. (onset).

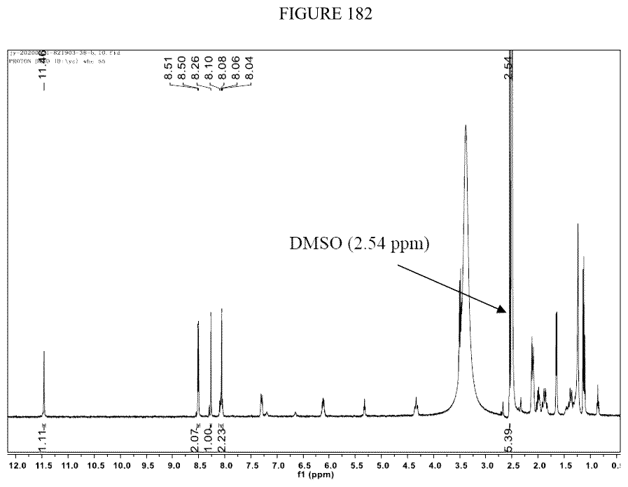

In one embodiment, the ¹H NMR of Form E shows the molar ratio of residual solvent DMSO/freeform was 0.9:1. In one embodiment, Form E has ¹H NMR shown in FIG. 182. In one embodiment, the stoichiometric ratio of K⁺/freeform was 1:1 by HPLC/IC.

In still another embodiment, Form E of Compound 1A is substantially pure. In certain embodiments, the substantially pure Form E of Compound 1A is substantially free of other solid forms, e.g., amorphous form. In certain embodiments, the purity of the substantially pure Form E of Compound 1A is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form E of Compound 1A which is substantially free of other solid forms comprising Compound 1A including, e.g., Forms A, B, C and D of Compound 1A as provided herein. Certain embodiments herein provide Form E as a mixture of solid forms comprising Compound 1A, including, e.g., a mixture comprising one or more of the following: Forms A, B, C and D of Compound 1A as provided herein.

### 6.2.34. Form A of Compound 1B

In certain embodiments, provided herein is Form A of Compound 1B.

In one embodiment, Form A of Compound 1B is crystalline.

In certain embodiments, Form A is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and equimolar Mg(OH)₂ in methanol at room temperature.

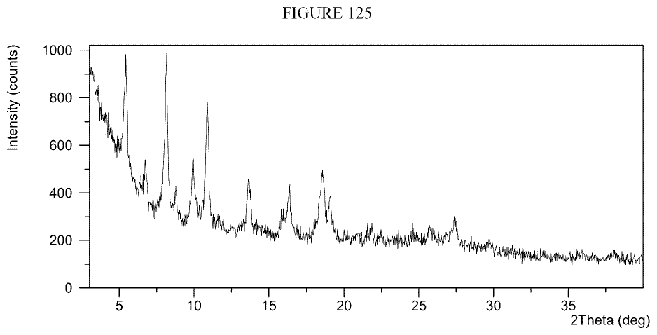

In certain embodiments, Form A is crystalline, as indicated by, e.g., X-ray powder diffraction measurements. In one embodiment, Form A of Compound 1B has an X-ray powder diffraction pattern substantially as shown in FIG. 125.

In one embodiment, Form A of Compound 1B has one or more characteristic X-ray powder diffraction peaks at a two-theta angle of approximately 8.16 as depicted in FIG. 125. In another embodiment, Form A of Compound 1B has one, two or three characteristic X-ray powder diffraction peaks at a two-theta angle of approximately 5.44, 8.16 or 10.90 degrees 2θ. In another embodiment, Form A of Compound 1B has one, two, three, four or five characteristic X-ray powder diffraction peaks at a two-theta angle of approximately 5.44, 8.16, 9.92, 10.90 or 18.60 degrees 2θ. In another embodiment, Form A of Compound 1B has one or more characteristic X-ray powder diffraction peaks as set forth in Table 71. In another embodiment, Form A of Compound 1B has one, two, three, four, five, six or seven characteristic X-ray powder diffraction peaks as set forth in Table 71. In another embodiment, Form A of Compound 1B has one, two, or three characteristic X-ray powder diffraction peaks as set forth in Table 71.

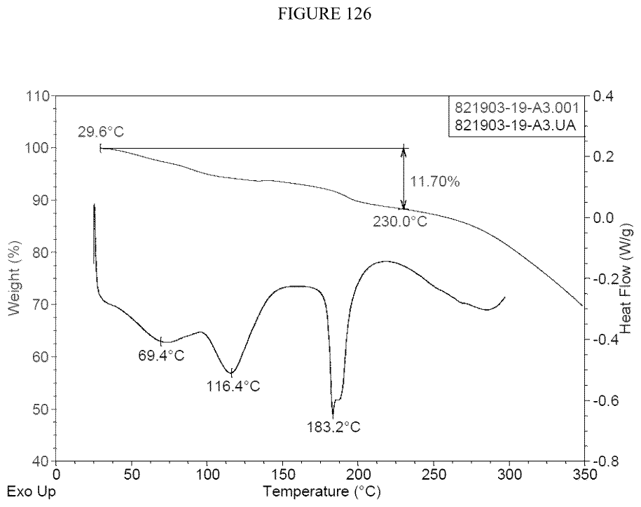

In one embodiment, provided herein is a solid form of Compound 1B having a thermogravimetric thermograph corresponding substantially to the representative TGA thermogram as depicted in FIG. 126. In certain embodiments, Form A shows a TGA weight loss of about 11.7% up to about 230° C.

In one embodiment, provided herein is solid Form A of Compound 1B having a DSC thermogram corresponding substantially as depicted in FIG. 126. In certain embodiments, Form A is characterized by a DSC plot comprising three endotherms at 69.4° C., 116.4° C. and 183.2° C. (peak).

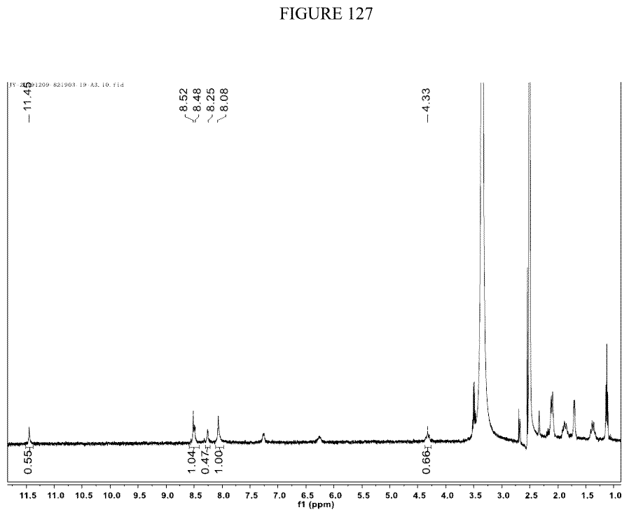

In one embodiment, the ¹H NMR of Form A shows no residual solvent EtOAc. In one embodiment, Form A has ¹H NMR shown in FIG. 127. In one embodiment, the stoichiometric ratio of Mg⁺⁺/freeform was 1.0:1 by HPLC/IC.

In still another embodiment, Form A of Compound 1B is substantially pure. In certain embodiments, the substantially pure Form A of Compound 1B is substantially free of other solid forms, e.g., amorphous form. In certain embodiments, the purity of the substantially pure Form A of Compound 1B is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form A of Compound 1B which is substantially free of other solid forms comprising Compound 1B. Certain embodiments herein provide Form A as a mixture of solid forms comprising Compound 1B.

### 6.2.35. Form a of Compound 1C

In certain embodiments, provided herein is Form A of Compound 1C.

In one embodiment, Form A of Compound 1C is crystalline.

In certain embodiments, Form A is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and equimolar Ca(OH)₂ in THF/H₂O (9:1, v/v) at room temperature.

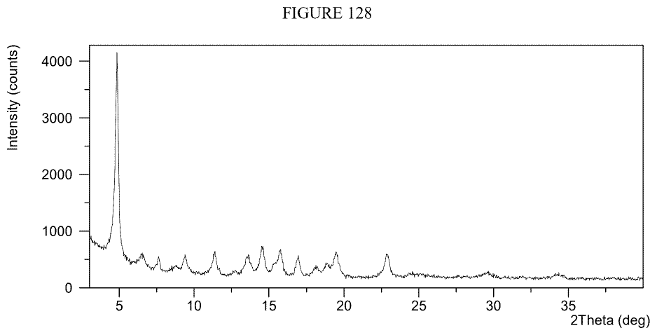

In certain embodiments, Form A is crystalline, as indicated by, e.g., X-ray powder diffraction measurements. In one embodiment, Form A of Compound 1C has an X-ray powder diffraction pattern substantially as shown in FIG. 128.

In one embodiment, Form A of Compound 1C has one or more characteristic X-ray powder diffraction peaks at a two-theta angle of approximately 4.86 as depicted in FIG. 128. In another embodiment, Form A of Compound 1C has one, two or three characteristic X-ray powder diffraction peaks at a two-theta angle of approximately 4.86, 14.56 or 15.73 degrees 2θ. In another embodiment, Form A of Compound 1C has one, two, three, four or five characteristic X-ray powder diffraction peaks at a two-theta angle of approximately 4.86, 14.56, 15.73, 19.47 or 22.90 degrees 2θ. In another embodiment, Form A of Compound 1C has one or more characteristic X-ray powder diffraction peaks as set forth in Table 72. In another embodiment, Form A of Compound 1C has one, two, three, four, five, six or seven characteristic X-ray powder diffraction peaks as set forth in Table 72. In another embodiment, Form A of Compound 1C has one, two, or three characteristic X-ray powder diffraction peaks as set forth in Table 72.

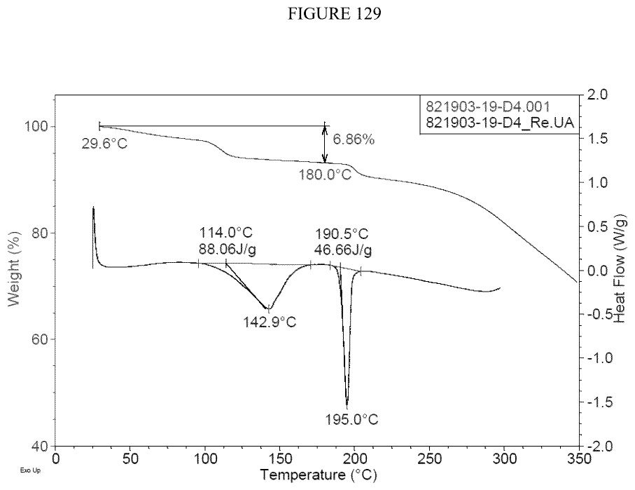

In one embodiment, provided herein is a solid form of Compound 1C having a thermogravimetric thermograph corresponding substantially to the representative TGA thermogram as depicted in FIG. 129. In certain embodiments, Form A shows a TGA weight loss of about 6.9% up to about 180° C.

In one embodiment, provided herein is solid Form A of Compound 1C having a DSC thermogram corresponding substantially as depicted in FIG. 129. In certain embodiments, Form A is characterized by a DSC plot comprising two endotherms at 142.9° C. and 195.0° C. (peak).

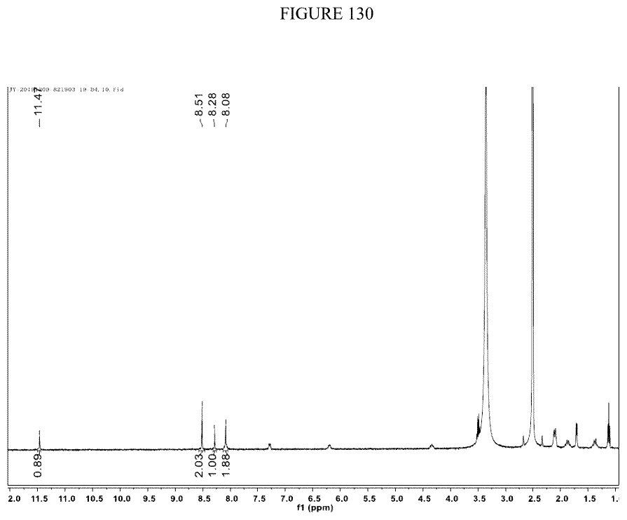

In one embodiment, the ¹H NMR of Form A shows no residual solvent THF. In one embodiment, Form A has ¹H NMR shown in FIG. 130. In one embodiment, the stoichiometric ratio of Ca⁺⁺/freeform was 0.8:1 by HPLC/IC.

In still another embodiment, Form A of Compound 1C is substantially pure. In certain embodiments, the substantially pure Form A of Compound 1C is substantially free of other solid forms, e.g., amorphous form. In certain embodiments, the purity of the substantially pure Form A of Compound 1C is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form A of Compound 1C which is substantially free of other solid forms comprising Compound 1C. Certain embodiments herein provide Form A as a mixture of solid forms comprising Compound 1C.

### 6.2.36. Form A of Compound 1D

In certain embodiments, provided herein is Form A of Compound 1D.

In one embodiment, Form A of Compound 1D is crystalline.

In certain embodiments, Form A is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and equimolar NH₃·H₂O in THF/H₂O (9:1, v/v) at room temperature.

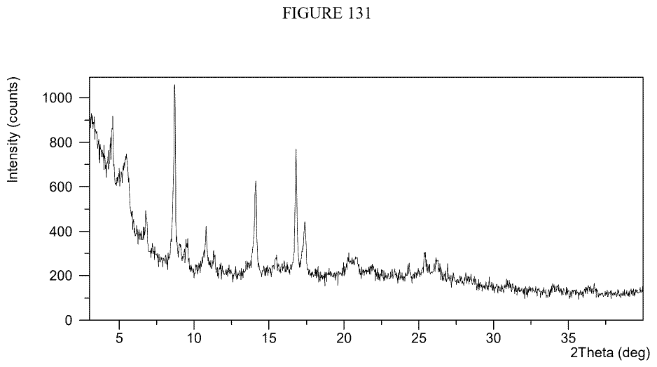

In certain embodiments, Form A is crystalline, as indicated by, e.g., X-ray powder diffraction measurements. In one embodiment, Form A of Compound 1D has an X-ray powder diffraction pattern substantially as shown in FIG. 131.

In one embodiment, Form A of Compound 1D has one or more characteristic X-ray powder diffraction peaks at a two-theta angle of approximately 8.70 as depicted in FIG. 131. In another embodiment, Form A of Compound 1D has one, two or three characteristic X-ray powder diffraction peaks at a two-theta angle of approximately 8.70, 14.12 or 16.80 degrees 2θ. In another embodiment, Form A of Compound 1D has one, two, three, four or five characteristic X-ray powder diffraction peaks at a two-theta angle of approximately 4.52, 8.70, 14.12, 16.80 or 17.41 degrees 2θ. In another embodiment, Form A of Compound 1D has one or more characteristic X-ray powder diffraction peaks as set forth in Table 73. In another embodiment, Form A of Compound 1D has one, two, three, four, five, six or seven characteristic X-ray powder diffraction peaks as set forth in Table 73. In another embodiment, Form A of Compound 1D has one, two, or three characteristic X-ray powder diffraction peaks as set forth in Table 73.

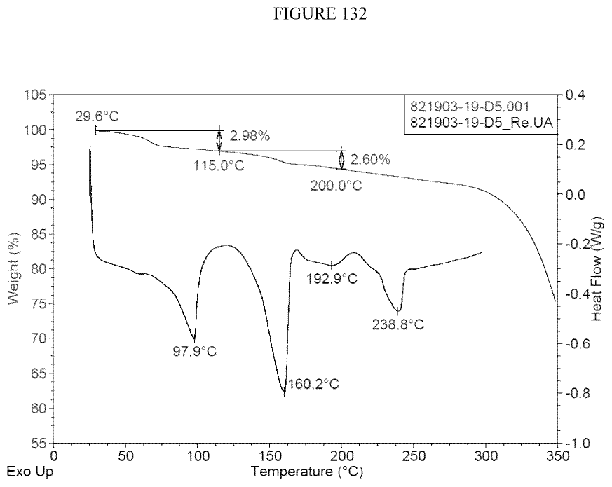

In one embodiment, provided herein is a solid form of Compound 1D having a thermogravimetric thermograph corresponding substantially to the representative TGA thermogram as depicted in FIG. 132. In certain embodiments, Form A shows a TGA weight loss of about 3.0% up to about 115° C. In certain embodiments, Form A shows a TGA weight loss of about 2.6% from about 115° C. to about 200° C. In certain embodiments, Form A shows a two-step TGA weight loss of about 3.0% up to about 115° C. and about 2.6% from about 115° C. to about 200° C.

In one embodiment, provided herein is solid Form A of Compound 1D having a DSC thermogram corresponding substantially as depicted in FIG. 132. In certain embodiments, Form A is characterized by a DSC plot comprising four endotherms at 97.9° C., 160.2° C., 192.9° C. and 238.8° C. (peak).

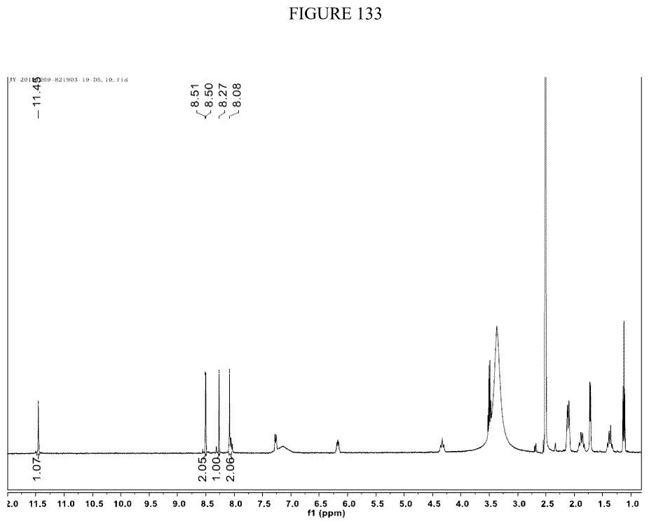

In one embodiment, the ¹H NMR of Form A shows no residual solvent THF. In one embodiment, Form A has ¹H NMR shown in FIG. 133. In one embodiment, the stoichiometric ratio of NH₄⁺/freeform was 0.6:1 by HPLC/IC.

In still another embodiment, Form A of Compound 1D is substantially pure. In certain embodiments, the substantially pure Form A of Compound 1D is substantially free of other solid forms, e.g., amorphous form. In certain embodiments, the purity of the substantially pure Form A of Compound 1D is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form A of Compound 1D which is substantially free of other solid forms comprising Compound 1D. Certain embodiments herein provide Form A as a mixture of solid forms comprising Compound 1D.

### 6.2.37. Form A of Compound 1E

In certain embodiments, provided herein is Form A of Compound 1E.

In one embodiment, Form A of Compound 1E is crystalline.

In certain embodiments, Form A is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and equimolar Arginine in methanol at room temperature.

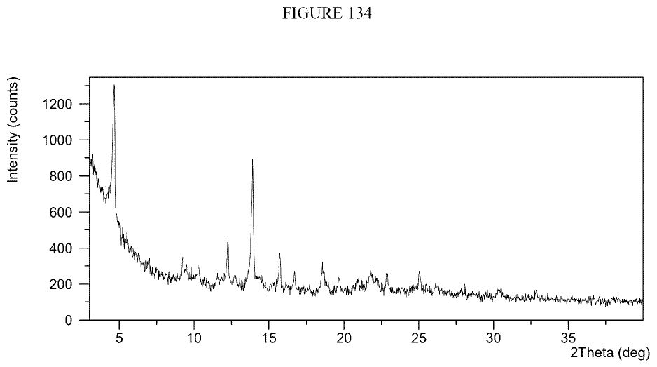

In certain embodiments, Form A is crystalline, as indicated by, e.g., X-ray powder diffraction measurements. In one embodiment, Form A of Compound 1E has an X-ray powder diffraction pattern substantially as shown in FIG. 134.

In one embodiment, Form A of Compound 1E has one or more characteristic X-ray powder diffraction peaks at a two-theta angle of approximately 4.65 as depicted in FIG. 134. In another embodiment, Form A of Compound 1E has one, two or three characteristic X-ray powder diffraction peaks at a two-theta angle of approximately 4.65, 12.25 or 13.91 degrees 2θ. In another embodiment, Form A of Compound 1E has one, two, three, four or five characteristic X-ray powder diffraction peaks at a two-theta angle of approximately 4.65, 12.25, 13.91, 15.73 or 18.59 degrees 2θ. In another embodiment, Form A of Compound 1E has one or more characteristic X-ray powder diffraction peaks as set forth in Table 74. In another embodiment, Form A of Compound 1E has one, two, three, four, five, six or seven characteristic X-ray powder diffraction peaks as set forth in Table 74. In another embodiment, Form A of Compound 1E has one, two, or three characteristic X-ray powder diffraction peaks as set forth in Table 74.

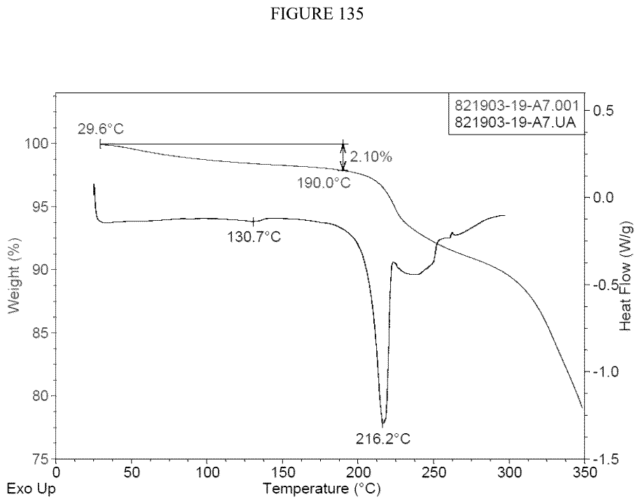

In one embodiment, provided herein is a solid form of Compound 1E having a thermogravimetric thermograph corresponding substantially to the representative TGA thermogram as depicted in FIG. 135. In certain embodiments, Form A shows a TGA weight loss of about 2.1% up to about 190° C.

In one embodiment, provided herein is solid Form A of Compound 1E having a DSC thermogram corresponding substantially as depicted in FIG. 135. In certain embodiments, Form A is characterized by a DSC plot comprising a weak endotherm at 130.7° C. (peak) and a sharp endotherm at 216.2° C. (peak).

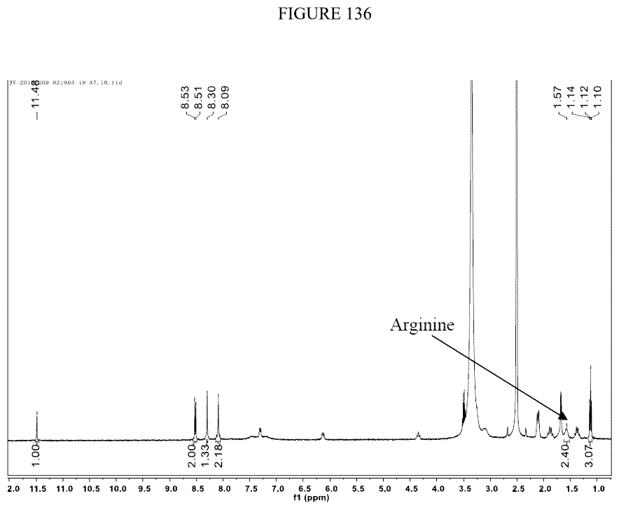

In one embodiment, the ¹H NMR of Form A shows no residual solvent methanol. In one embodiment, Form A has ¹H NMR shown in FIG. 136. In one embodiment, the stoichiometric ratio of arginine/freeform was 1.2:1 by HPLC/IC.

In still another embodiment, Form A of Compound 1E is substantially pure. In certain embodiments, the substantially pure Form A of Compound 1E is substantially free of other solid forms, e.g., amorphous form. In certain embodiments, the purity of the substantially pure Form A of Compound 1E is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form A of Compound 1E which is substantially free of other solid forms comprising Compound 1E including, e.g., Forms B and C of Compound 1E as provided herein. Certain embodiments herein provide Form A as a mixture of solid forms comprising Compound 1E, including, e.g., a mixture comprising one or more of the following: Forms B and C of Compound 1E as provided herein.

### 6.2.38. Form B of Compound 1E

In certain embodiments, provided herein is Form B of Compound 1E.

In one embodiment, Form B of Compound 1E is crystalline.

In certain embodiments, Form B is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and arginine in THF/H₂O (9:1, v/v) at room temperature.

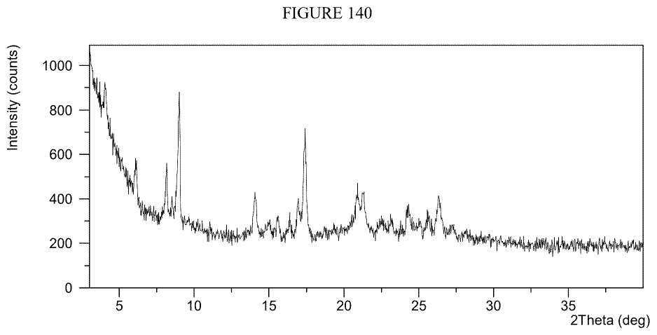

In certain embodiments, Form B is crystalline, as indicated by, e.g., X-ray powder diffraction measurements. In one embodiment, Form B of Compound 1E has an X-ray powder diffraction pattern substantially as shown in FIG. 140.

In one embodiment, Form B of Compound 1E has one or more characteristic X-ray powder diffraction peaks at a two-theta angle of approximately 9.01 as depicted in FIG. 140. In another embodiment, Form B of Compound 1E has one, two or three characteristic X-ray powder diffraction peaks at a two-theta angle of approximately 8.16, 9.01 or 17.43 degrees 2θ. In another embodiment, Form B of Compound 1E has one, two, three, four or five characteristic X-ray powder diffraction peaks at a two-theta angle of approximately 8.16, 9.01, 14.06, 17.43 or 21.29 degrees 2θ. In another embodiment, Form B of Compound 1E has one or more characteristic X-ray powder diffraction peaks as set forth in Table 75. In another embodiment, Form B of Compound 1E has one, two, three, four, five, six or seven characteristic X-ray powder diffraction peaks as set forth in Table 75. In another embodiment, Form B of Compound 1E has one, two, or three characteristic X-ray powder diffraction peaks as set forth in Table 75.

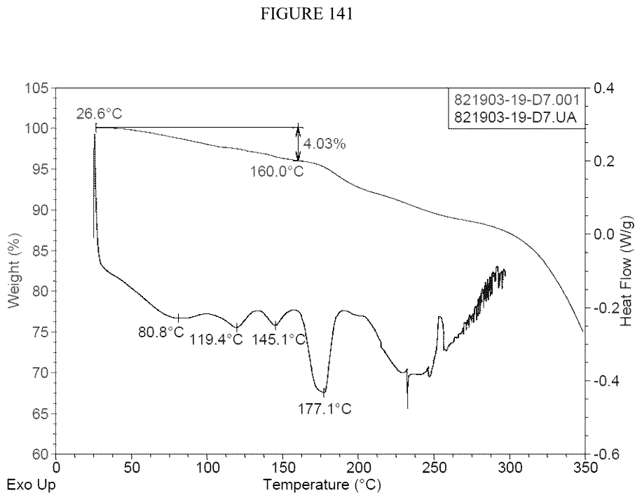

In one embodiment, provided herein is a solid form of Compound 1E having a thermogravimetric thermograph corresponding substantially to the representative TGA thermogram as depicted in FIG. 141. In certain embodiments, Form B shows a TGA weight loss of about 4.0% up to about 160° C.

In one embodiment, provided herein is solid Form B of Compound 1E having a DSC thermogram corresponding substantially as depicted in FIG. 141. In certain embodiments, Form B is characterized by a DSC plot comprising four endotherms at 80.8° C., 119.4° C., 145.1° C. and 177.1° C. (peak).

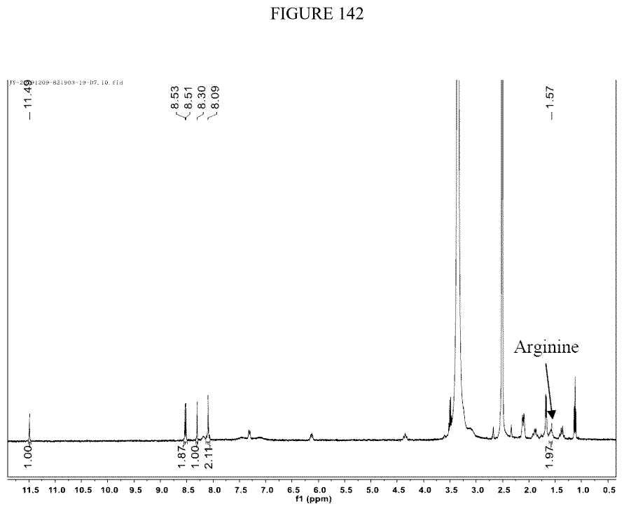

In one embodiment, the ¹H NMR of Form B shows no residual solvent THF. In one embodiment, Form B has ¹H NMR shown in FIG. 142. In one embodiment, the stoichiometric ratio of arginine/freeform was 1:1 by HPLC/IC.

In still another embodiment, Form B of Compound 1E is substantially pure. In certain embodiments, the substantially pure Form B of Compound 1E is substantially free of other solid forms, e.g., amorphous form. In certain embodiments, the purity of the substantially pure Form B of Compound 1E is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form B of Compound 1E which is substantially free of other solid forms comprising Compound 1E including, e.g., Forms A and C of Compound 1E as provided herein. Certain embodiments herein provide Form B as a mixture of solid forms comprising Compound 1E, including, e.g., a mixture comprising one or more of the following: Forms A and C of Compound 1E as provided herein.

### 6.2.39. Form C of Compound 1E

In certain embodiments, provided herein is Form C of Compound 1E.

In one embodiment, Form C of Compound 1E is crystalline.

In certain embodiments, Form C is obtained by heating arginine salt Form A of Compound 1E to 140° C. with N₂ protection. In certain embodiments, after cooling to 30° C. with N₂ protection, arginine salt Form C converted to arginine salt Form A.

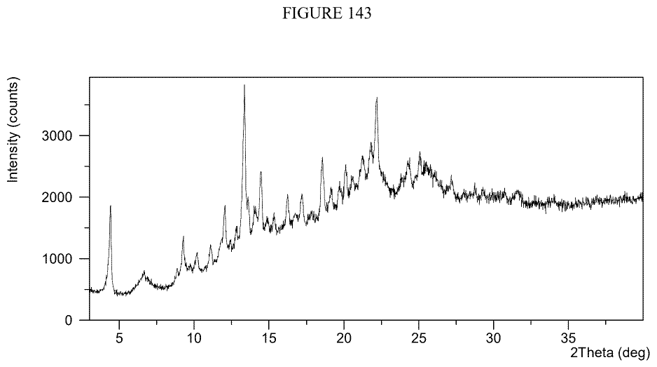

In certain embodiments, Form C is crystalline, as indicated by, e.g., X-ray powder diffraction measurements. In one embodiment, Form C of Compound 1E has an X-ray powder diffraction pattern substantially as shown in FIG. 143.

In one embodiment, Form C of Compound 1E has one or more characteristic X-ray powder diffraction peaks at a two-theta angle of approximately 13.36 as depicted in FIG. 143. In another embodiment, Form C of Compound 1E has one, two or three characteristic X-ray powder diffraction peaks at a two-theta angle of approximately 4.42, 13.36 or 22.21 degrees 2θ. In another embodiment, Form C of Compound 1E has one, two, three, four or five characteristic X-ray powder diffraction peaks at a two-theta angle of approximately 4.42, 13.36, 14.46, 21.80 or 22.21 degrees 2θ. In another embodiment, Form C of Compound 1E has one or more characteristic X-ray powder diffraction peaks as set forth in Table 76. In another embodiment, Form C of Compound 1E has one, two, three, four, five, six or seven characteristic X-ray powder diffraction peaks as set forth in Table 76. In another embodiment, Form C of Compound 1E has one, two, or three characteristic X-ray powder diffraction peaks as set forth in Table 76.

In still another embodiment, Form C of Compound 1E is substantially pure. In certain embodiments, the substantially pure Form C of Compound 1E is substantially free of other solid forms, e.g., amorphous form. In certain embodiments, the purity of the substantially pure Form C of Compound 1E is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form C of Compound 1E which is substantially free of other solid forms comprising Compound 1E including, e.g., Forms A and B of Compound 1E as provided herein. Certain embodiments herein provide Form C as a mixture of solid forms comprising Compound 1E, including, e.g., a mixture comprising one or more of the following: Forms A and B of Compound 1E as provided herein.

### 6.2.40. Form A of Compound 1F

In certain embodiments, provided herein is Form A of Compound 1F.

In one embodiment, Form A of Compound 1F is crystalline.

In certain embodiments, Form A is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and lysine in methanol at room temperature.

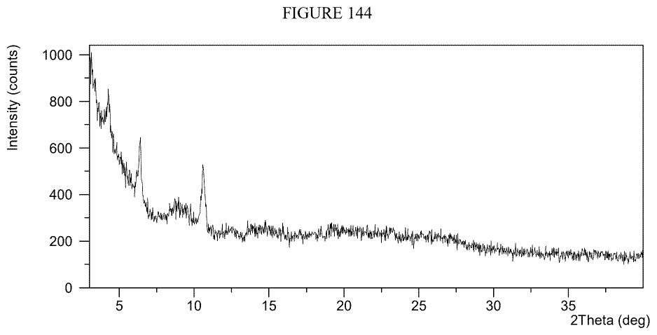

In certain embodiments, Form A is crystalline, as indicated by, e.g., X-ray powder diffraction measurements. In one embodiment, Form A of Compound 1F has an X-ray powder diffraction pattern substantially as shown in FIG. 144.

In one embodiment, Form A of Compound 1F has one or more characteristic X-ray powder diffraction peaks at a two-theta angle of approximately 10.60 as depicted in FIG. 144. In another embodiment, Form A of Compound 1F has one, two or three characteristic X-ray powder diffraction peaks at a two-theta angle of approximately 4.27, 6.39 or 10.60 degrees 2θ. In another embodiment, Form A of Compound 1F has one or more characteristic X-ray powder diffraction peaks as set forth in Table 77. In another embodiment, Form A of Compound 1F has one, two or three characteristic X-ray powder diffraction peaks as set forth in Table 77. In another embodiment, Form A of Compound 1F has one, two, or three characteristic X-ray powder diffraction peaks as set forth in Table 77.

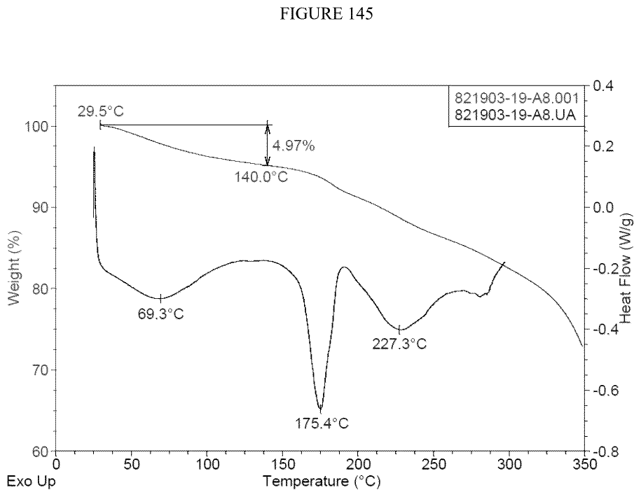

In one embodiment, provided herein is a solid form of Compound 1F having a thermogravimetric thermograph corresponding substantially to the representative TGA thermogram as depicted in FIG. 145. In certain embodiments, Form A shows a TGA weight loss of about 5.0% up to about 140° C.

In one embodiment, provided herein is solid Form A of Compound 1F having a DSC thermogram corresponding substantially as depicted in FIG. 145. In certain embodiments, Form A is characterized by a DSC plot comprising three endotherms at 69.3° C., 175.4° C. and 227.3° C. (peak).

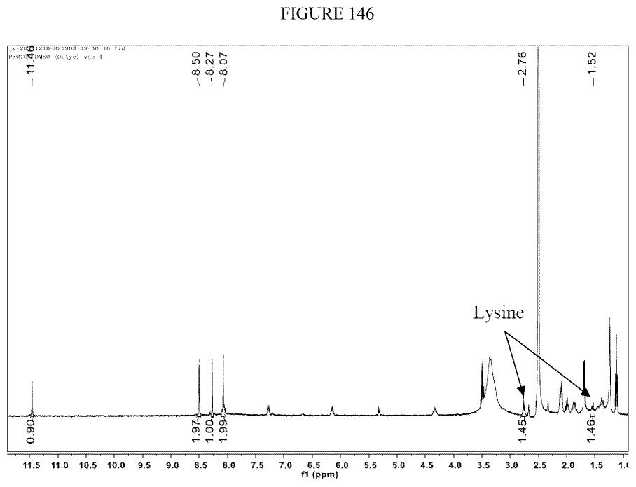

In one embodiment, the ¹H NMR of Form A shows no residual solvent methanol. In one embodiment, Form A has ¹H NMR shown in FIG. 146. In one embodiment, the stoichiometric ratio of lysine/freeform was 0.7:1 by HPLC/IC.

In still another embodiment, Form A of Compound 1F is substantially pure. In certain embodiments, the substantially pure Form A of Compound 1F is substantially free of other solid forms, e.g., amorphous form. In certain embodiments, the purity of the substantially pure Form A of Compound 1F is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form A of Compound 1F which is substantially free of other solid forms comprising Compound 1F. Certain embodiments herein provide Form A as a mixture of solid forms comprising Compound 1F.

### 6.2.41. Form A of Compound 1G

In certain embodiments, provided herein is Form A of Compound 1G.

In one embodiment, Form A of Compound 1G is crystalline.

In one embodiment, Form A of Compound 1G is anhydrate.

In certain embodiments, Form A is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and equimolar choline in EtOAc at room temperature.

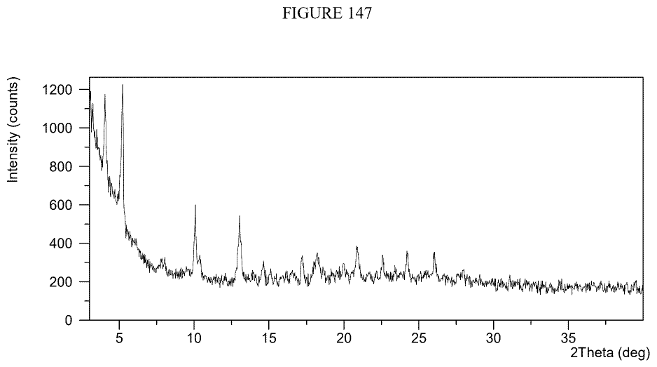

In certain embodiments, Form A is crystalline, as indicated by, e.g., X-ray powder diffraction measurements. In one embodiment, Form A of Compound 1G has an X-ray powder diffraction pattern substantially as shown in FIG. 147.

In one embodiment, Form A of Compound 1G has one or more characteristic X-ray powder diffraction peaks at a two-theta angle of approximately 5.22 as depicted in FIG. 147. In another embodiment, Form A of Compound 1G has one, two or three characteristic X-ray powder diffraction peaks at a two-theta angle of approximately 4.05, 5.22 or 10.07 degrees 2θ. In another embodiment, Form A of Compound 1G has one, two, three, four or five characteristic X-ray powder diffraction peaks at a two-theta angle of approximately 4.05, 5.22, 10.07, 13.03, or 20.89 degrees 2θ. In another embodiment, Form A of Compound 1G has one or more characteristic X-ray powder diffraction peaks as set forth in Table 78. In another embodiment, Form A of Compound 1G has one, two, three, four, five, six or seven characteristic X-ray powder diffraction peaks as set forth in Table 78. In another embodiment, Form A of Compound 1G has one, two, or three characteristic X-ray powder diffraction peaks as set forth in Table 78.

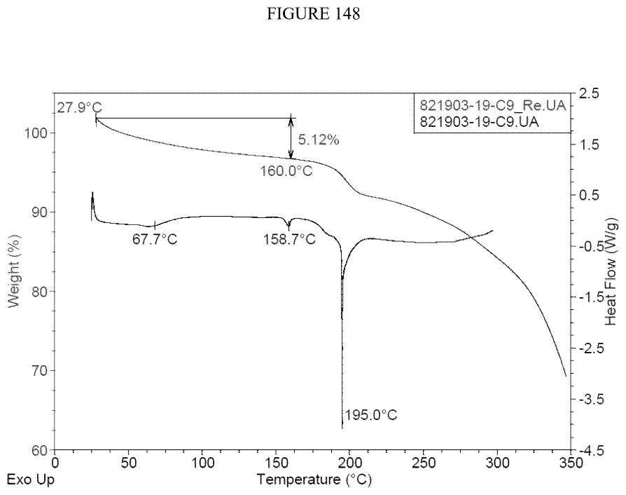

In one embodiment, provided herein is a solid form of Compound 1G having a thermogravimetric thermograph corresponding substantially to the representative TGA thermogram as depicted in FIG. 148. In certain embodiments, Form A shows a TGA weight loss of about 5.1% up to about 160° C.

In one embodiment, provided herein is solid Form A of Compound 1G having a DSC thermogram corresponding substantially as depicted in FIG. 148. In certain embodiments, Form A is characterized by a DSC plot comprising two weak endotherms at 67.7° C. and 158.7° C. (peak), and a sharp endotherm at 195.0° C. (peak).

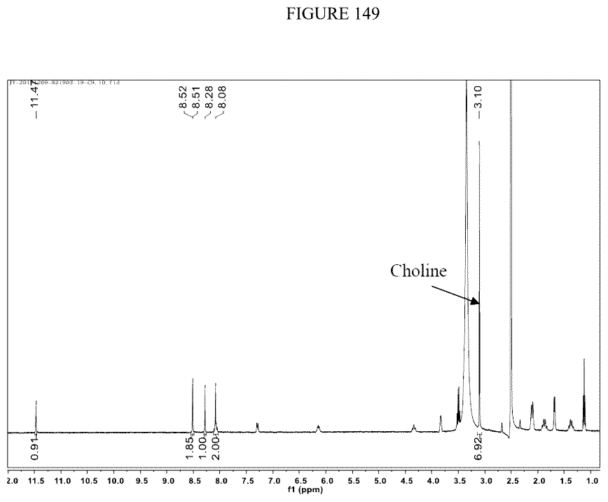

In one embodiment, the ¹H NMR of Form A shows no residual solvent EtOAc. In one embodiment, Form A has ¹H NMR shown in FIG. 149. In one embodiment, the stoichiometric ratio of choline/freeform was 0.8:1 by HPLC/IC.

In still another embodiment, Form A of Compound 1G is substantially pure. In certain embodiments, the substantially pure Form A of Compound 1G is substantially free of other solid forms, e.g., amorphous form. In certain embodiments, the purity of the substantially pure Form A of Compound 1G is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form A of Compound 1G which is substantially free of other solid forms comprising Compound 1G including, e.g., Form B of Compound 1G as provided herein. Certain embodiments herein provide Form A as a mixture of solid forms comprising Compound 1G, including, e.g., a mixture comprising Form B of Compound 1G as provided herein.

### 6.2.42. Form B of Compound 1G

In certain embodiments, provided herein is Form B of Compound 1G.

In one embodiment, Form B of Compound 1G is crystalline.

In one embodiment, Form B of Compound 1G is anhydrate.

In certain embodiments, Form B is obtained after storing choline salt Form A for 23 days at room temperature.

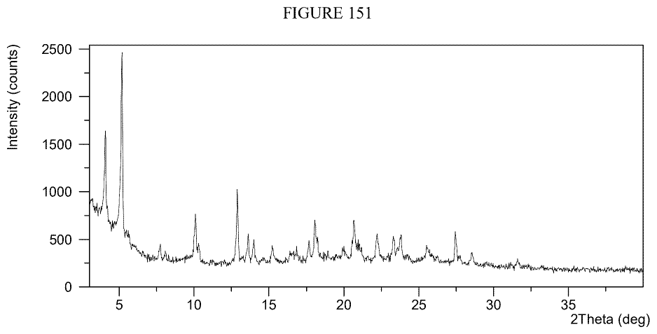

In certain embodiments, Form B is crystalline, as indicated by, e.g., X-ray powder diffraction measurements. In one embodiment, Form B of Compound 1G has an X-ray powder diffraction pattern substantially as shown in FIG. 151.

In one embodiment, Form B of Compound 1G has one or more characteristic X-ray powder diffraction peaks at a two-theta angle of approximately 5.18 as depicted in FIG. 151. In another embodiment, Form B of Compound 1G has one, two or three characteristic X-ray powder diffraction peaks at a two-theta angle of approximately 4.07, 5.18 or 12.89 degrees 2θ. In another embodiment, Form B of Compound 1G has one, two, three, four or five characteristic X-ray powder diffraction peaks at a two-theta angle of approximately 4.07, 5.18, 12.89, 18.07 or 20.67 degrees 2θ. In another embodiment, Form B of Compound 1G has one or more characteristic X-ray powder diffraction peaks as set forth in Table 79. In another embodiment, Form B of Compound 1G has one, two, three, four, five, six or seven characteristic X-ray powder diffraction peaks as set forth in Table 79. In another embodiment, Form B of Compound 1G has one, two, or three characteristic X-ray powder diffraction peaks as set forth in Table 79.

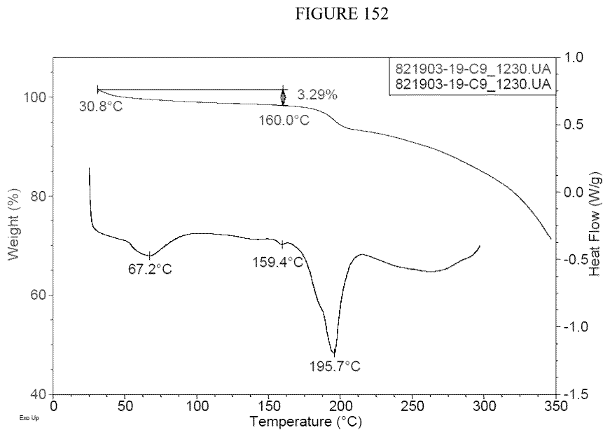

In one embodiment, provided herein is a solid form of Compound 1G having a thermogravimetric thermograph corresponding substantially to the representative TGA thermogram as depicted in FIG. 152. In certain embodiments, Form B shows a TGA weight loss of about 3.3% up to about 160° C.

In one embodiment, provided herein is solid Form B of Compound 1G having a DSC thermogram corresponding substantially as depicted in FIG. 152. In certain embodiments, Form B is characterized by a DSC plot comprising three endotherms at 67.2° C., 159.4° C. and 195.7° (peak).

In one embodiment, Form B converted to form A of Compound 1G after nitrogen purging Form B for 20 min at 30° C. In one embodiment, after further heating to 100° C. and cooling to 30° C. with N₂ protection, Form A is obtained.

In still another embodiment, Form B of Compound 1G is substantially pure. In certain embodiments, the substantially pure Form B of Compound 1G is substantially free of other solid forms, e.g., amorphous form. In certain embodiments, the purity of the substantially pure Form B of Compound 1G is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form B of Compound 1G which is substantially free of other solid forms comprising Compound 1G including, e.g., Form A of Compound 1G as provided herein. Certain embodiments herein provide Form B as a mixture of solid forms comprising Compound 1G, including, e.g., a mixture comprising Form A of Compound 1G as provided herein.

### 6.2.43. Form A of Compound 1H

In certain embodiments, provided herein is Form A of Compound 1H.

In one embodiment, Form A of Compound 1H is crystalline.

In one embodiment, Form A of Compound 1H is channel hydrate.

In certain embodiments, Form A is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and equimolar tromethamine in methanol at room temperature.

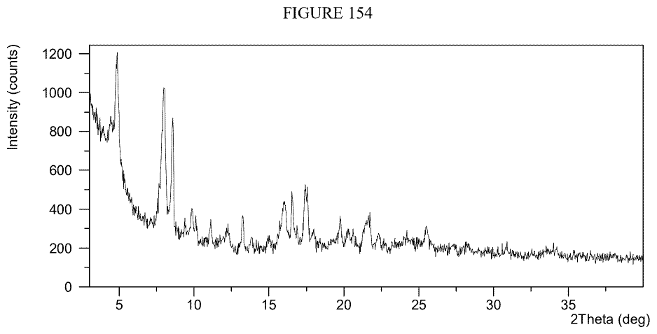

In certain embodiments, Form A is crystalline, as indicated by, e.g., X-ray powder diffraction measurements. In one embodiment, Form A of Compound 1H has an X-ray powder diffraction pattern substantially as shown in FIG. 154.

In one embodiment, Form A of Compound 1H has one or more characteristic X-ray powder diffraction peaks at a two-theta angle of approximately 8.00 as depicted in FIG. 154. In another embodiment, Form A of Compound 1H has one, two or three characteristic X-ray powder diffraction peaks at a two-theta angle of approximately 4.86, 8.00 or 8.57 degrees 2θ. In another embodiment, Form A of Compound 1H has one, two, three, four or five characteristic X-ray powder diffraction peaks at a two-theta angle of approximately 4.86, 8.00, 8.57, 16.55 or 17.48 degrees 2θ. In another embodiment, Form A of Compound 1H has one or more characteristic X-ray powder diffraction peaks as set forth in Table 80. In another embodiment, Form A of Compound 1H has one, two, three, four, five, six or seven characteristic X-ray powder diffraction peaks as set forth in Table 80. In another embodiment, Form A of Compound 1H has one, two, or three characteristic X-ray powder diffraction peaks as set forth in Table 80.

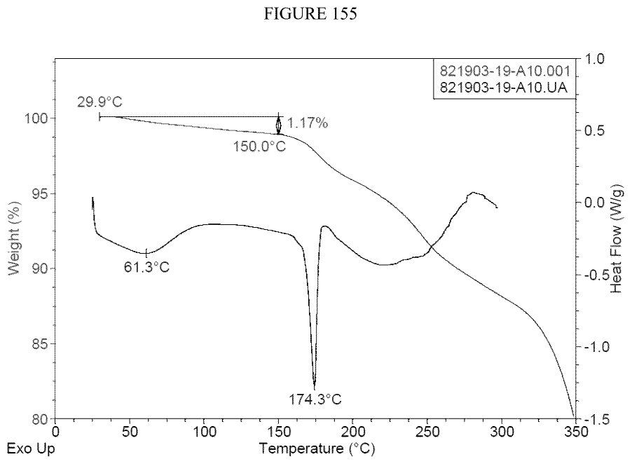

In one embodiment, provided herein is a solid form of Compound 1H having a thermogravimetric thermograph corresponding substantially to the representative TGA thermogram as depicted in FIG. 155. In certain embodiments, Form A shows a TGA weight loss of about 1.2% up to about 150° C.

In one embodiment, provided herein is solid Form A of Compound 1H having a DSC thermogram corresponding substantially as depicted in FIG. 155. In certain embodiments, Form A is characterized by a DSC plot comprising a broad endotherm at 61.3° C. and a sharp endotherm at 174.3° (peak).

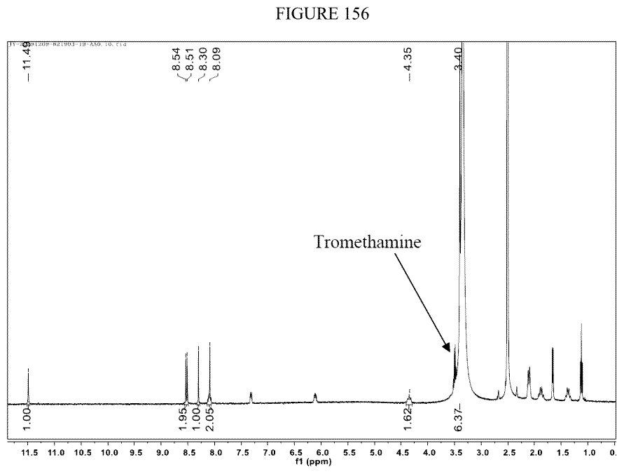

In one embodiment, the ¹H NMR of Form A shows no residual solvent methanol. In one embodiment, Form A has ¹H NMR shown in FIG. 156. In one embodiment, the stoichiometric ratio of tromethamine/freeform was 1:1 by HPLC/IC.

In still another embodiment, Form A of Compound 1H is substantially pure. In certain embodiments, the substantially pure Form A of Compound 1H is substantially free of other solid forms, e.g., amorphous form. In certain embodiments, the purity of the substantially pure Form A of Compound 1H is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form A of Compound 1H which is substantially free of other solid forms comprising Compound 1H including, e.g., Forms B and C of Compound 1H as provided herein. Certain embodiments herein provide Form A as a mixture of solid forms comprising Compound 1H, including, e.g., a mixture comprising one or more of the following: Forms B and C of Compound 1H as provided herein.

### 6.2.44. Form B of Compound 1H

In certain embodiments, provided herein is Form B of Compound 1H.

In one embodiment, Form B of Compound 1H is crystalline.

In certain embodiments, Form B is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and equimolar tromethamine in DMSO/acetone (4:1, v/v) at room temperature.

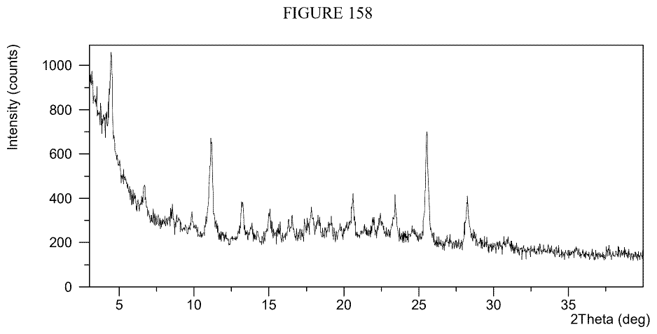

In certain embodiments, Form B is crystalline, as indicated by, e.g., X-ray powder diffraction measurements. In one embodiment, Form B of Compound 1H has an X-ray powder diffraction pattern substantially as shown in FIG. 158.

In one embodiment, Form B of Compound 1H has one or more characteristic X-ray powder diffraction peaks at a two-theta angle of approximately 25.55 as depicted in FIG. 158. In another embodiment, Form B of Compound 1H has one, two or three characteristic X-ray powder diffraction peaks at a two-theta angle of approximately 4.49, 11.16 or 25.55 degrees 2θ. In another embodiment, Form B of Compound 1H has one, two, three, four or five characteristic X-ray powder diffraction peaks at a two-theta angle of approximately 4.49, 11.16, 20.60, 25.55 or 28.24 degrees 2θ. In another embodiment, Form B of Compound 1H has one or more characteristic X-ray powder diffraction peaks as set forth in Table 81. In another embodiment, Form B of Compound 1H has one, two, three, four, five, six or seven characteristic X-ray powder diffraction peaks as set forth in Table 81. In another embodiment, Form B of Compound 1H has one, two, or three characteristic X-ray powder diffraction peaks as set forth in Table 81.

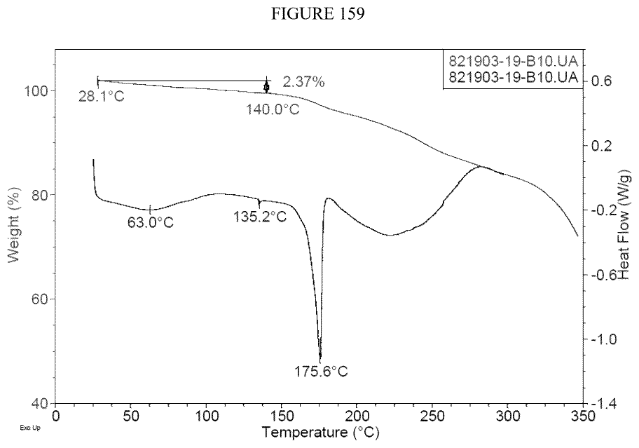

In one embodiment, provided herein is a solid form of Compound 1H having a thermogravimetric thermograph corresponding substantially to the representative TGA thermogram as depicted in FIG. 159. In certain embodiments, Form B shows a TGA weight loss of about 2.4% up to about 140° C.

In one embodiment, provided herein is solid Form B of Compound 1H having a DSC thermogram corresponding substantially as depicted in FIG. 159. In certain embodiments, Form B is characterized by a DSC plot comprising three endotherms at 63.0° C., 135.2° C. and 175.6° C. (peak).

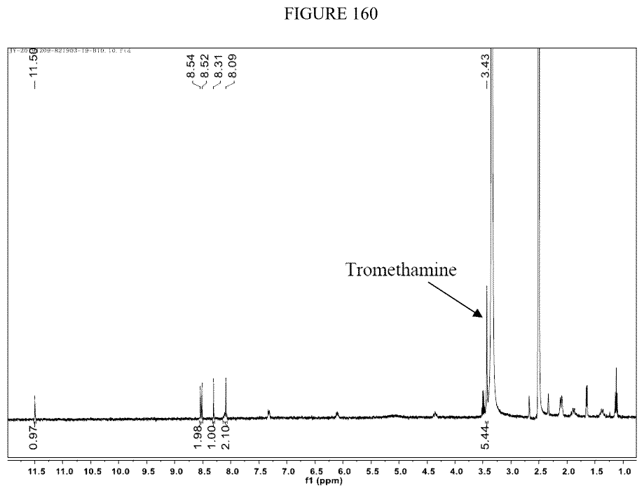

In one embodiment, the ¹H NMR of Form B shows no residual solvent DMSO or acetone. In one embodiment, Form B has ¹H NMR shown in FIG. 160. In one embodiment, the stoichiometric ratio of tromethamine/freeform was 0.9:1 by HPLC/IC.

In still another embodiment, Form B of Compound 1H is substantially pure. In certain embodiments, the substantially pure Form B of Compound 1H is substantially free of other solid forms, e.g., amorphous form. In certain embodiments, the purity of the substantially pure Form B of Compound 1H is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form B of Compound 1H which is substantially free of other solid forms comprising Compound 1H including, e.g., Forms A and C of Compound 1H as provided herein. Certain embodiments herein provide Form B as a mixture of solid forms comprising Compound 1H, including, e.g., a mixture comprising one or more of the following: Forms A and C of Compound 1H as provided herein.

### 6.2.45. Form C of Compound 1H

In certain embodiments, provided herein is Form C of Compound 1H.

In one embodiment, Form C of Compound 1H is crystalline.

In certain embodiments, Form C is obtained by stirring a suspension of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and tromethamine in methanol at room temperature for 2 days.

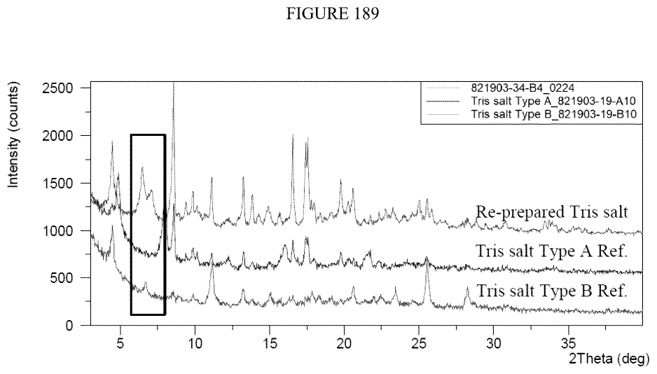

In certain embodiments, Form C is crystalline, as indicated by, e.g., X-ray powder diffraction measurements. In one embodiment, Form C of Compound 1H has an X-ray powder diffraction pattern substantially as shown in FIG. 189.

In one embodiment, Form C of Compound 1H has one or more characteristic X-ray powder diffraction peaks at a two-theta angle of approximately 8.56 as depicted in FIG. 189. In another embodiment, Form C of Compound 1H has one, two or three characteristic X-ray powder diffraction peaks at a two-theta angle of approximately 8.56, 16.54 or 17.56 degrees 2θ. In another embodiment, Form C of Compound 1H has one, two, three, four or five characteristic X-ray powder diffraction peaks at a two-theta angle of approximately 4.46, 8.56, 16.54 17.39 or 17.56 degrees 2θ. In another embodiment, Form C of Compound 1H has one or more characteristic X-ray powder diffraction peaks as set forth in Table 90. In another embodiment, Form C of Compound 1H has one, two, three, four, five, six or seven characteristic X-ray powder diffraction peaks as set forth in Table 90. In another embodiment, Form C of Compound 1H has one, two, or three characteristic X-ray powder diffraction peaks as set forth in Table 90.

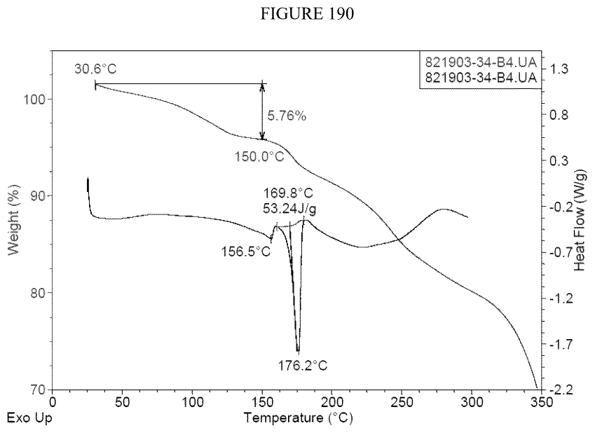

In one embodiment, provided herein is a solid form of Compound 1H having a thermogravimetric thermograph corresponding substantially to the representative TGA thermogram as depicted in FIG. 190. In certain embodiments, Form C shows a TGA weight loss of about 5.8% up to about 150° C.

In one embodiment, provided herein is solid Form C of Compound 1H having a DSC thermogram corresponding substantially as depicted in FIG. 190. In certain embodiments, Form C is characterized by a DSC plot comprising two endotherms at 156.5° C. and 176.2° C. (peak).

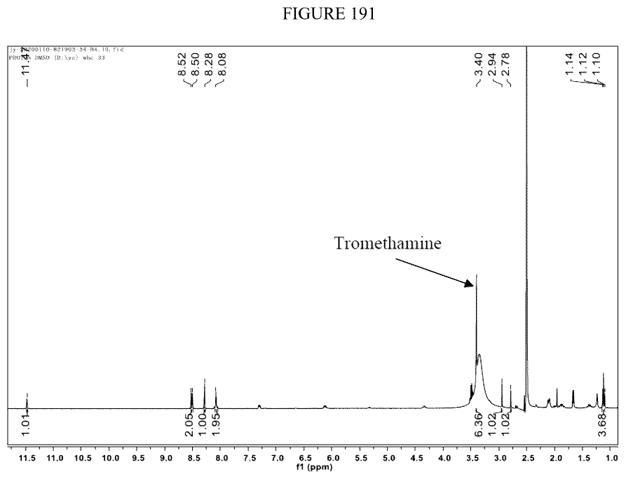

In one embodiment, the ¹H NMR of Form C shows negligible residual solvent MeOH. In one embodiment, Form C has ¹H NMR shown in FIG. 191. In one embodiment, the molar ratio of base/freeform was around 1.1:1 (the peak of Tromethamine is overlapped with H₂O).

In still another embodiment, Form C of Compound 1H is substantially pure. In certain embodiments, the substantially pure Form C of Compound 1H is substantially free of other solid forms, e.g., amorphous form. In certain embodiments, the purity of the substantially pure Form C of Compound 1H is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form C of Compound 1H which is substantially free of other solid forms comprising Compound 1H including, e.g., Forms A and B of Compound 1H as provided herein. Certain embodiments herein provide Form C as a mixture of solid forms comprising Compound 1H, including, e.g., a mixture comprising one or more of the following: Forms A and B of Compound 1H as provided herein.

### 6.2.46. Form A of Compound 1I

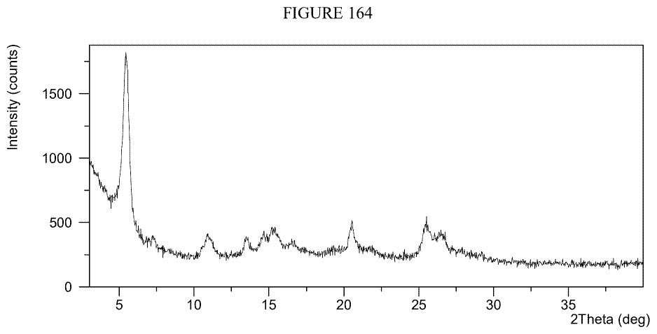

The starting material was crystalline and assigned as Freeform Form A. In certain embodiments, Form A is crystalline, as indicated by, e.g., X-ray powder diffraction measurements. In one embodiment, Form A of Compound 1I has an X-ray powder diffraction pattern substantially as shown in FIG. 164.

In one embodiment, Form A of Compound 1I has one or more characteristic X-ray powder diffraction peaks at a two-theta angle of approximately 5.51 as depicted in FIG. 164. In another embodiment, Form A of Compound 1I has one, two or three characteristic X-ray powder diffraction peaks at a two-theta angle of approximately 5.51, 20.54 or 25.48 degrees 2θ. In another embodiment, Form A of Compound 1I has one, two, three, four or five characteristic X-ray powder diffraction peaks at a two-theta angle of approximately 5.51, 15.29, 20.54, 25.48 or 26.56 degrees 2θ. In another embodiment, Form A of Compound 1I has one or more characteristic X-ray powder diffraction peaks as set forth in Table 84. In another embodiment, Form A of Compound 1I has one, two, three, four, five, six or seven characteristic X-ray powder diffraction peaks as set forth in Table 84. In another embodiment, Form A of Compound 1I has one, two, or three characteristic X-ray powder diffraction peaks as set forth in Table 84.

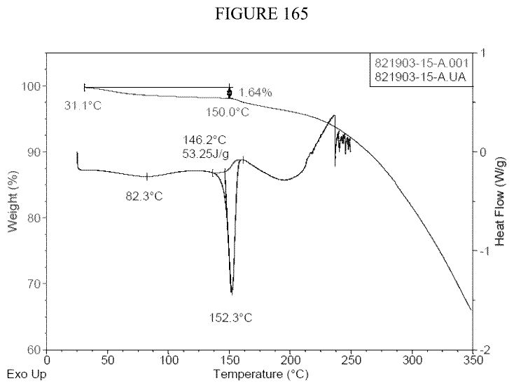

In one embodiment, provided herein is a solid form A of Compound 1I having a thermogravimetric thermograph corresponding substantially to the representative TGA thermogram as depicted in FIG. 165. In certain embodiments, Form A shows a TGA weight loss of about 2.4% up to about 140° C.

In one embodiment, provided herein is solid Form A of Compound 1I having a DSC thermogram corresponding substantially as depicted in FIG. 165. In certain embodiments, Form A is characterized by a DSC plot comprising three endotherms at 63.0° C., 135.2° C. and 175.6° C. (peak).

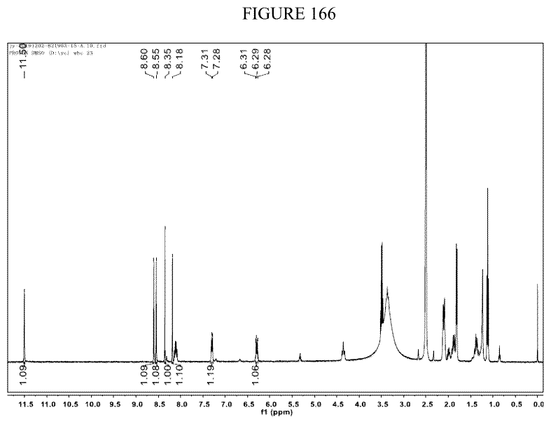

In one embodiment, the ¹H NMR of Form A shows no residual solvent DMSO or acetone. In one embodiment, Form A has ¹H NMR shown in FIG. 166. In one embodiment, the stoichiometric ratio of tromethamine/freeform was 0.9:1 by HPLC/IC.

In still another embodiment, Form A of Compound 1I is substantially pure. In certain embodiments, the substantially pure Form A of Compound 1I is substantially free of other solid forms, e.g., amorphous form. In certain embodiments, the purity of the substantially pure Form A of Compound 1I is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form A of Compound 1I which is substantially free of other solid forms comprising Compound 1I including, e.g., Forms B, C and D of Compound 1I as provided herein. Certain embodiments herein provide Form A as a mixture of solid forms comprising Compound 1I, including, e.g., a mixture comprising one or more of the following: Forms B, C and D of Compound 1I as provided herein.

### 6.2.47. Form B of Compound 1I

In certain embodiments, provided herein is Form B of Compound 1I.

In one embodiment, Form B of Compound 1I is crystalline.

In certain embodiments, Form B is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate in methanol at room temperature.

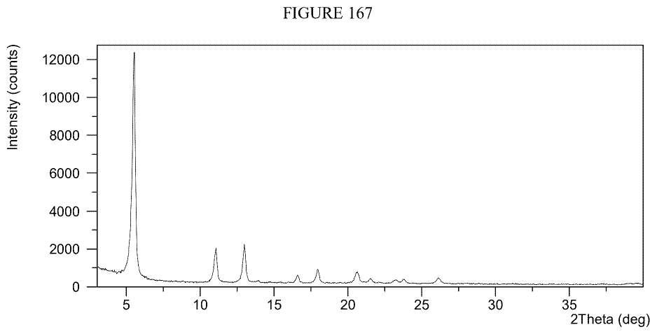

In certain embodiments, Form B is crystalline, as indicated by, e.g., X-ray powder diffraction measurements. In one embodiment, Form B of Compound 1I has an X-ray powder diffraction pattern substantially as shown in FIG. 167.

In one embodiment, Form B of Compound 1I has one or more characteristic X-ray powder diffraction peaks at a two-theta angle of approximately 5.53 as depicted in FIG. 167. In another embodiment, Form B of Compound 1I has one, two or three characteristic X-ray powder diffraction peaks at a two-theta angle of approximately 5.53, 11.06 or 12.99 degrees 2θ. In another embodiment, Form B of Compound 1I has one, two, three, four or five characteristic X-ray powder diffraction peaks at a two-theta angle of approximately 5.53, 11.06, 12.99, 17.95 or 20.69 degrees 2θ. In another embodiment, Form B of Compound 1I has one or more characteristic X-ray powder diffraction peaks as set forth in Table 85. In another embodiment, Form B of Compound 1I has one, two, three, four, five, six or seven characteristic X-ray powder diffraction peaks as set forth in Table 85. In another embodiment, Form B of Compound 1I has one, two, or three characteristic X-ray powder diffraction peaks as set forth in Table 85.

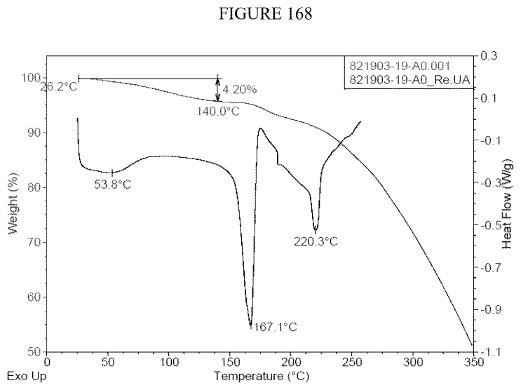

In one embodiment, provided herein is a solid form of Compound 1I having a thermogravimetric thermograph corresponding substantially to the representative TGA thermogram as depicted in FIG. 168. In certain embodiments, Form B shows a TGA weight loss of about 4.2% up to about 140° C.

In one embodiment, provided herein is solid Form B of Compound 1I having a DSC thermogram corresponding substantially as depicted in FIG. 168. In certain embodiments, Form B is characterized by a DSC plot comprising three endotherms at 53.8° C., 167.1° C. and 220.3° (peak).

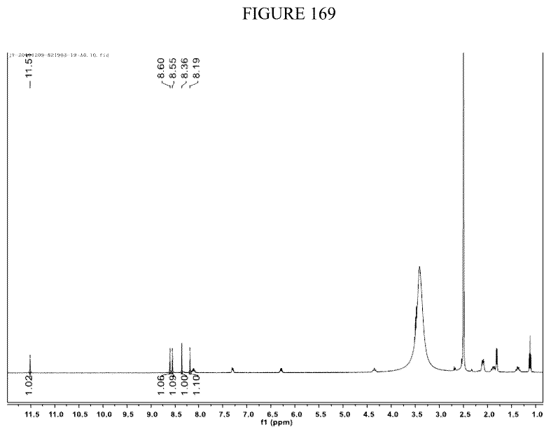

In one embodiment, the ¹H NMR of Form B shows no residual solvent methanol. In one embodiment, Form B has ¹H NMR shown in FIG. 169.

In still another embodiment, Form B of Compound 1I is substantially pure. In certain embodiments, the substantially pure Form B of Compound 1I is substantially free of other solid forms, e.g., amorphous form. In certain embodiments, the purity of the substantially pure Form A of Compound 1I is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form B of Compound 1I which is substantially free of other solid forms comprising Compound 1I including, e.g., Forms A, C and D of Compound 1I as provided herein. Certain embodiments herein provide Form C as a mixture of solid forms comprising Compound 1I, including, e.g., a mixture comprising one or more of the following: Forms A, C and D of Compound 1I as provided herein.

### 6.2.48. Form C of Compound 1I

In certain embodiments, provided herein is Form C of Compound 1I.

In one embodiment, Form C of Compound 1I is crystalline.

In certain embodiments, Form C is obtained via a slurry of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate in DMSO/Acetone (1:4, v/v) at room temperature.

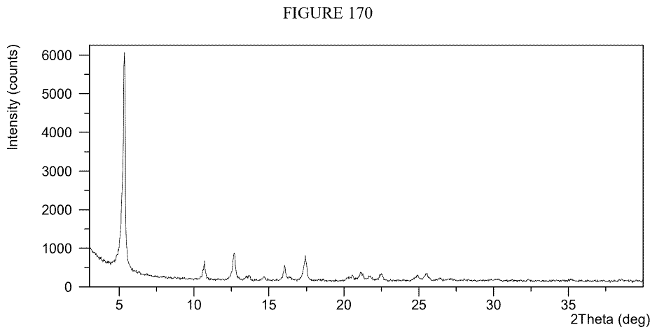

In certain embodiments, Form C is crystalline, as indicated by, e.g., X-ray powder diffraction measurements. In one embodiment, Form C of Compound 1I has an X-ray powder diffraction pattern substantially as shown in FIG. 170.

In one embodiment, Form C of Compound 1I has one or more characteristic X-ray powder diffraction peaks at a two-theta angle of approximately 5.35 as depicted in FIG. 170. In another embodiment, Form C of Compound 1I has one, two or three characteristic X-ray powder diffraction peaks at a two-theta angle of approximately 5.35, 12.68 or 17.43 degrees 2θ. In another embodiment, Form C of Compound 1I has one, two, three, four or five characteristic X-ray powder diffraction peaks at a two-theta angle of approximately 5.35, 10.70, 12.68, 16.05 or 17.43 degrees 2θ. In another embodiment, Form C of Compound 1I has one or more characteristic X-ray powder diffraction peaks as set forth in Table 86. In another embodiment, Form C of Compound 1I has one, two, three, four, five, six or seven characteristic X-ray powder diffraction peaks as set forth in Table 86. In another embodiment, Form C of Compound 1I has one, two, or three characteristic X-ray powder diffraction peaks as set forth in Table 86.

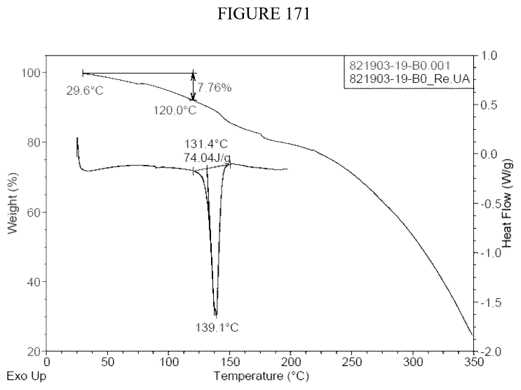

In one embodiment, provided herein is a solid form of Compound 1I having a thermogravimetric thermograph corresponding substantially to the representative TGA thermogram as depicted in FIG. 171. In certain embodiments, Form C shows a TGA weight loss of about 7.8% up to about 120° C.

In one embodiment, provided herein is solid Form C of Compound 1I having a DSC thermogram corresponding substantially as depicted in FIG. 171. In certain embodiments, Form C is characterized by a DSC plot comprising three endotherms at 131.4° C. (peak).

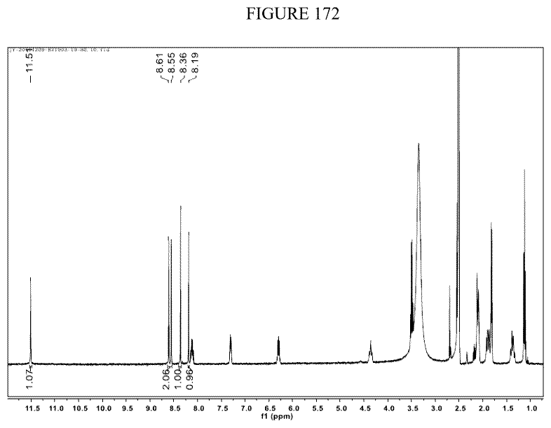

In one embodiment, the ¹H NMR of Form C shows no residual solvent DMSO or acetone. In one embodiment, Form C has ¹H NMR shown in FIG. 172.

In still another embodiment, Form C of Compound 1I is substantially pure. In certain embodiments, the substantially pure Form C of Compound 1I is substantially free of other solid forms, e.g., amorphous form. In certain embodiments, the purity of the substantially pure Form C of Compound 1I is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form C of Compound 1I which is substantially free of other solid forms comprising Compound 1I including, e.g., Forms A, B and D of Compound 1I as provided herein. Certain embodiments herein provide Form C as a mixture of solid forms comprising Compound 1I, including, e.g., a mixture comprising one or more of the following: Forms A, B and D of Compound 1I as provided herein.

### 6.2.49. Form D of Compound 1I

In certain embodiments, provided herein is Form D of Compound 1I.

In one embodiment, Form D of Compound 1I is crystalline.

In certain embodiments, Form D is obtained via a slurry of equimolar 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate NaOH in DMSO/acetone (4:1, v/v).

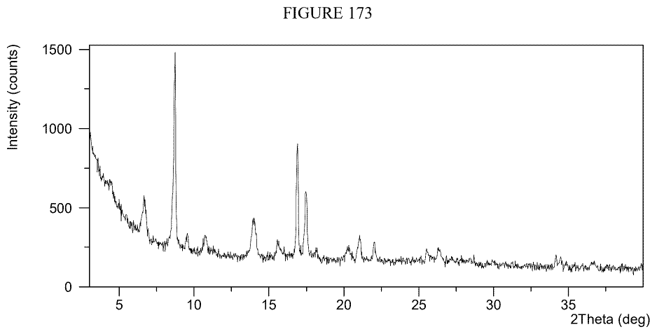

In certain embodiments, Form D is crystalline, as indicated by, e.g., X-ray powder diffraction measurements. In one embodiment, Form D of Compound 1I has an X-ray powder diffraction pattern substantially as shown in FIG. 173.

In one embodiment, Form D of Compound 1I has one or more characteristic X-ray powder diffraction peaks at a two-theta angle of approximately 8.73 as depicted in FIG. 173. In another embodiment, Form D of Compound 1I has one, two or three characteristic X-ray powder diffraction peaks at a two-theta angle of approximately 8.73, 16.90 or 17.47 degrees 2θ. In another embodiment, Form D of Compound 1I has one, two, three, four or five characteristic X-ray powder diffraction peaks at a two-theta angle of approximately 6.70, 8.73, 13.99, 16.90 or 17.47 degrees 2θ. In another embodiment, Form D of Compound 1I has one or more characteristic X-ray powder diffraction peaks as set forth in Table 87. In another embodiment, Form D of Compound 1I has one, two, three, four, five, six or seven characteristic X-ray powder diffraction peaks as set forth in Table 87. In another embodiment, Form D of Compound 1I has one, two, or three characteristic X-ray powder diffraction peaks as set forth in Table 87.

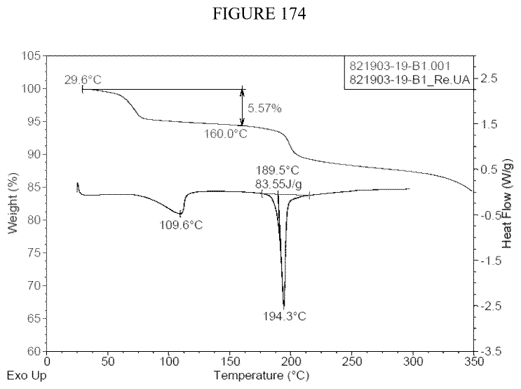

In one embodiment, provided herein is a solid form of Compound 1I having a thermogravimetric thermograph corresponding substantially to the representative TGA thermogram as depicted in FIG. 174. In certain embodiments, Form D shows a stepwise TGA weight loss of 5.6% up to 160° C.

In one embodiment, provided herein is solid Form D of Compound 1I having a DSC thermogram corresponding substantially as depicted in FIG. 174. In certain embodiments, Form D is characterized by a DSC plot comprising two endotherms at 109.6° C. and 194.3° C. (peak).

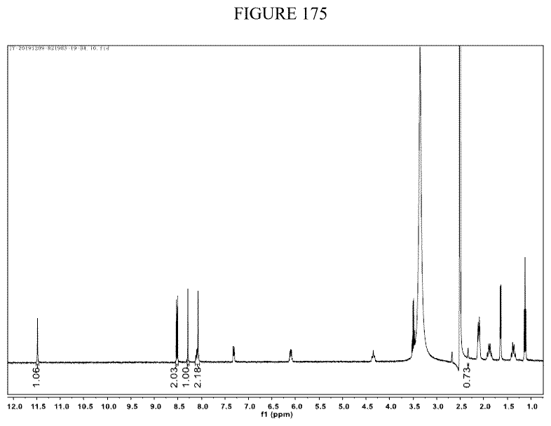

In one embodiment, the ¹H NMR of Form D shows no residual solvent DMSO or acetone. In one embodiment, Form D has ¹H NMR shown in FIG. 175.

In still another embodiment, Form D of Compound 1I is substantially pure. In certain embodiments, the substantially pure Form D of Compound 1I is substantially free of other solid forms, e.g., amorphous form. In certain embodiments, the purity of the substantially pure Form D of Compound 1I is no less than about 95% pure, no less than about 96% pure, no less than about 97% pure, no less than about 98% pure, no less than about 98.5% pure, no less than about 99% pure, no less than about 99.5% pure, or no less than about 99.8% pure.

Certain embodiments herein provide Form D of Compound 1I which is substantially free of other solid forms comprising Compound 1I including, e.g., Forms A, B and C of Compound 1I as provided herein. Certain embodiments herein provide Form D as a mixture of solid forms comprising Compound 1I, including, e.g., a mixture comprising one or more of the following: Forms A, B and C of Compound 1I as provided herein.

### 6.3. Methods of Treatment

### A. Diseases/Disorders

The solid forms provided herein, including solid forms of Compound 1 provided herein, as well as combinations and/or compositions thereof, may be used to ameliorate, treat, and/or prevent a variety of diseases, conditions, and/or disorders. In particular embodiments, the disclosed solid forms, including solid forms of Compound 1 or compositions thereof, may be useful for treating conditions in which inhibition of an interleukin-1 receptor-associated kinase (IRAK) pathway is therapeutically useful. In some embodiments, the solid forms of Compound 1 directly inhibit an IRAK protein, such as IRAK1, IRAK2, IRAK3 and/or IRAK4. In certain embodiments, the solid forms, including the solid forms of Compound 1 are useful for treating, preventing, and/or ameliorating auto-immune diseases, inflammatory disorders, cardiovascular diseases, nerve disorders, neurodegenerative disorders, allergic disorders, asthma, pancreatitis, multi-organ failure, kidney diseases, platelet aggregation, cancer, transplantation, sperm motility, erythrocyte deficiency, graft rejection, lung injuries, respiratory diseases, ischemic conditions, and bacterial and viral infections.

In some embodiments, the solid forms provided herein, including the solid forms of Compound 1, or compositions thereof, may be used to treat or prevent allergic diseases, amyotrophic lateral sclerosis (ALS), systemic lupus erythematosus, rheumatoid arthritis, type I diabetes mellitus, inflammatory bowel disease, biliary cirrhosis, uveitis, multiple sclerosis, Crohn's disease, ulcerative colitis, bullous pemphigoid, sarcoidosis, psoriasis, autoimmune myositis, Wegener's granulomatosis, ichthyosis, Graves ophthalmopathy, or asthma.

The solid forms provided herein, including the solid forms of Compound 1, or compositions thereof, may also be useful for ameliorating, treating, and/or preventing immune regulatory disorders related to bone marrow or organ transplant rejection or graft-versus-host disease. Examples of inflammatory and immune regulatory disorders that can be treated with the solid forms, including the solid forms of Compound 1 include, but are not limited to, transplantation of organs or tissue, graft-versus-host diseases brought about by transplantation, autoimmune syndromes including arthralgia, arthritis, rheumatoid arthritis, lupus, including systemic lupus erythematosus, Hashimoto's thyroiditis, multiple sclerosis, systemic sclerosis, myasthenia gravis, type I diabetes, uveitis, posterior uveitis, allergic encephalomyelitis, glomerulonephritis, postinfectious autoimmune diseases including rheumatic fever and post-infectious glomerulonephritis, inflammatory and hyperproliferative skin diseases, psoriasis, atopic dermatitis, contact dermatitis, eczematous dermatitis, seborrhoeic dermatitis, lichen planus, pemphigus, bullous pemphigoid, epidermolysis bullosa, urticaria, angioedemas, vasculitis, erythema, cutaneous eosinophilia, lupus erythematosus, acne, alopecia areata, keratoconjunctivitis, vernal conjunctivitis, uveitis associated with Behcet's disease, keratitis, herpetic keratitis, conical cornea, dystrophia epithelialis corneae, corneal leukoma, ocular pemphigus, Mooren's ulcer, scleritis, Graves' opthalmopathy, Vogt-Koyanagi-Harada syndrome, sarcoidosis, pollen allergies, reversible obstructive airway disease, bronchial asthma, allergic asthma, intrinsic asthma, extrinsic asthma, dust asthma, chronic or inveterate asthma, late asthma and airway hyper-responsiveness, bronchitis, gastric ulcers, vascular damage caused by ischemic diseases and thrombosis, ischemic bowel diseases, inflammatory bowel diseases, necrotizing enterocolitis, intestinal lesions associated with thermal burns, celiac diseases, proctitis, eosinophilic gastroenteritis, mastocytosis, Crohn's disease, ulcerative colitis, migraine, rhinitis, eczema, interstitial nephritis, Goodpasture's syndrome, hemolytic-uremic syndrome, diabetic nephropathy, multiple myositis, Guillain-Barre syndrome, Meniere's disease, polyneuritis, multiple neuritis, mononeuritis, radiculopathy, hyperthyroidism, Basedow's disease, pure red cell aplasia, aplastic anemia, hypoplastic anemia, idiopathic thrombocytopenic purpura, autoimmune hemolytic anemia, agranulocytosis, pernicious anemia, megaloblastic anemia, erythroplasia, osteoporosis, sarcoidosis, fibroid lung, idiopathic interstitial pneumonia, dermatomyositis, leukoderma vulgaris, ichthyosis vulgaris, photoallergic sensitivity, cutaneous T cell lymphoma, chronic lymphocytic leukemia, arteriosclerosis, atherosclerosis, aortitis syndrome, polyarteritis nodosa, myocardosis, scleroderma, Wegener's granuloma, Sjögren's syndrome, adiposis, eosinophilic fascitis, lesions of gingiva, periodontium, alveolar bone, substantia ossea dentis, glomerulonephritis, male pattern alopecia or alopecia senilis by preventing epilation or providing hair germination and/or promoting hair generation and hair growth, muscular dystrophy, pyoderma and Sezary's syndrome, Addison's disease, ischemia-reperfusion injury of organs which occurs upon preservation, transplantation or ischemic disease, endotoxin-shock, pseudomembranous colitis, colitis caused by drug or radiation, ischemic acute renal insufficiency, chronic renal insufficiency, toxinosis caused by lung-oxygen or drugs, lung cancer, pulmonary emphysema, cataracta, siderosis, retinitis pigmentosa, senile macular degeneration, vitreal scarring, corneal alkali burn, dermatitis erythema multiforme, linear IgA bullous dermatitis and cement dermatitis, gingivitis, periodontitis, sepsis, pancreatitis, diseases caused by environmental pollution, aging, carcinogenesis, metastasis of carcinoma and hypobaropathy, disease caused by histamine or leukotriene-C4 release, Behcet's disease, autoimmune hepatitis, primary biliary cirrhosis, sclerosing cholangitis, partial liver resection, acute liver necrosis, necrosis caused by toxin, viral hepatitis, shock, or anoxia, B-virus hepatitis, non-A/non-B hepatitis, cirrhosis, alcoholic liver disease, including alcoholic cirrhosis, non-alcoholic steatohepatitis (NASH), hepatic failure, fulminant hepatic failure, late-onset hepatic failure, “acute-on-chronic” liver failure, augmentation of chemotherapeutic effect, cytomegalovirus infection, HCMV infection, AIDS, cancer, senile dementia, Parkinson's disease, trauma, chronic bacterial infection, palmoplantar pustulosis, hidradenitis suppurativa, cytokine release syndrome (CRS), acute respiratory distress syndrome (ARDS), acute kidney injury (AKI), kidney malfunction, or thrombosis.

In some embodiments, the disease or condition is a lymphoid neoplasm, a myeloid neoplasm or a myeloid/lymphoid neoplasm. In some embodiments, the disease or condition is hidradenitis suppurativa, or a lymphoid, myeloid or myeloid/lymphoid neoplasm selected from myeloproliferative neoplasms (MPN), myeloid/lymphoid neoplasms with PDGFRA rearrangement, myeloid/lymphoid neoplasms with PDGFRB rearrangement, myeloid/lymphoid neoplasms with FGFR1 rearrangement, myeloid/lymphoid neoplasms with PCM1-JAK2, myelodysplastic/myeloproliferative neoplasms (MDS/MPN), myeloid sarcoma, myeloid proliferations related to Down syndrome, blastic plasmacytoid dendritic cell neoplasm, B-lymphoblastic leukemia/lymphoma; and/or T-lymphoblastic leukemia/lymphoma. In some embodiments, the myeloid neoplasm is a myeloproliferative neoplasm selected from chronic myeloid leukemia (CML), chronic neutrophilic leukemia (CNL), primary myelofibrosis (PMF), essential thrombocythemia, chronic eosinophilic leukemia, or a combination thereof. In other embodiments, the myeloid neoplasm is a myelodysplastic/myeloproliferative neoplasm. In other embodiments, the myelodysplastic/myeloproliferative neoplasm is selected from chronic myelomonocytic leukemia, atypical chronic myeloid leukemia (aCML), juvenile myelomonocytic leukemia (JMML), MDS/MPN with ring sideroblasts and thrombocytosis (MDS/MPN-RS-T), or a combination thereof.

In certain embodiments, the solid forms provided herein, including the solid forms of Compound 1 are useful for treating nerve pain, including neuropathic pain and inflammation induced pain.

In certain embodiments, the solid forms provided herein, including the solid forms of Compound 1 or compositions thereof, are useful for treating and/or preventing arthralgia, arthritis, rheumatoid arthritis, psoriatic arthritis, osteoarthritis, systemic lupus erythematosus, lupus nephritis, ankylosing spondylitis, osteoporosis, systemic sclerosis, multiple sclerosis, psoriasis, in particular pustular psoriasis, type I diabetes, type II diabetes, inflammatory bowel disease (Crohn's disease and ulcerative colitis), hyperimmunoglobulinemia d and periodic fever syndrome, cryopyrin-associated periodic syndromes, Schnitzler's syndrome, systemic juvenile idiopathic arthritis, adult's onset Still's disease, gout, gout flares, pseudogout, SAPHO (Synovitis, Acne, Pustulosis, Hyperostosis, and Osteitis) syndrome, Castleman's disease, sepsis, stroke, atherosclerosis, celiac disease, DIRA (deficiency of Il-1 receptor antagonist), Alzheimer's disease, or Parkinson's disease.

Proliferative diseases that may be treated by the solid forms provided herein, including the solid forms of Compound 1, or compositions thereof, include benign or malignant tumors, solid tumor, carcinoma of the brain, kidney, liver, adrenal gland, bladder, breast, stomach, gastric tumors, ovaries, colon, rectum, prostate, pancreas, lung, vagina, cervix, testis, genitourinary tract, esophagus, larynx, skin, bone or thyroid, sarcoma, glioblastomas, neuroblastomas, multiple myeloma, gastrointestinal cancer, especially colon carcinoma or colorectal adenoma, a tumor of the neck and head, an epidermal hyperproliferation, psoriasis, prostate hyperplasia, a neoplasia, a neoplasia of epithelial character, adenoma, adenocarcinoma, keratoacanthoma, epidermoid carcinoma, large cell carcinoma, non-small-cell lung carcinoma, lymphomas, Hodgkins and Non-Hodgkins, a mammary carcinoma, follicular carcinoma, undifferentiated carcinoma, papillary carcinoma, seminoma, melanoma, IL-1 driven disorders, a MyD88 driven disorder (such as ABC diffuse large B-cell lymphoma (DLBCL), Waldenstrom's macroglobulinemia, Hodgkin's lymphoma, primary cutaneous T-cell lymphoma or chronic lymphocytic leukemia), smoldering or indolent multiple myeloma, or hematological malignancies (including leukemia, acute myeloid leukemia (AML), DLBCL, ABC DLBCL, chronic lymphocytic leukemia (CLL), chronic lymphocytic lymphoma, primary effusion lymphoma, Burkitt lymphoma/leukemia, acute lymphocytic leukemia, B-cell prolymphocytic leukemia, lymphoplasmacytic lymphoma, myelodysplastic syndrome (MDS), clonal cytopenia of undetermined significance (CCUS), myelofibrosis, polycythemia vera, Kaposi's sarcoma, Waldenstrom's macroglobulinemia (WM), splenic marginal zone lymphoma, multiple myeloma, plasmacytoma, intravascular large B-cell lymphoma). In particular, the solid forms, including the solid forms of Compound 1 are useful in treating drug resistant malignancies, such as those resistant to JAK inhibitors ibrutinib resistant malignancies, including ibrutinib resistant hematological malignancies, such as ibrutinib resistant CLL and ibrutinib resistant Waldenström's macroglobulinemia.

In one embodiment, myelodysplastic syndrome (MDS) is relapsed, resistant or refractory MDS. In one embodiment, MDS is refractory anemia (RA); RA with ringed sideroblasts (RARS); RA with excess of blasts (RAEB); refractory cytopenia with multilineage dysplasia (RCMD), refractory cytopenia with unilineage dysplasia (RCUD); unclassifiable myelodysplastic syndrome (MDS-U), myelodysplastic syndrome associated with an isolated del(5q) chromosome abnormality, therapy-related myeloid neoplasms or chronic myelomonocytic leukemia (CMML). In some embodiments, the MDS is very low risk, low risk, intermediate risk, high risk or very high risk MD based on the Revised International Prognostic Scoring System (IPSS-R). In some embodiments, the MDS is very low, low, or intermediate-1 risk (IPSS-R≤3.5), collectively, lower-risk MDS (LR-MDS). In some embodiments, the MDS patient has bone marrow blast ≤5%. In one embodiment, the MDS is very low risk. In another embodiment, the MDS is low risk. In another embodiment, the MDS is intermediate risk. In another embodiment, the MDS is high risk. In another embodiment, the MDS is very high risk MDS. In some embodiments, the MDS is IPSS-R intermediate, high or very high risk MDS (IPSS-R>3.5), collectively, higher-risk MDS (HR-MDS). In some embodiments, the MDS is primary or de novo MDS. In other embodiments, the MDS is secondary MDS.

In yet certain embodiments, the MDS is transfusion dependent (TD) lower risk MDS (LR-MDS). In yet certain embodiments, the MDS is high transfusion burden MDS, wherein the patient requires about or greater than 8 red blood cell units for over 8 weeks or for over 16 weeks. In yet certain embodiments, the MDS is a low transfusion burden MDS, wherein the patient requires from about 3 to about 7 red blood cell units for over 8 weeks or for over 16 weeks. In yet certain embodiments, the MDS is transfusion dependent MDS wherein the patient requires about 4 or more red blood cell units over 8 weeks who have not responded to or have lost response to or are ineligible for erythropoiesis-stimulating agents (ESAs). In yet certain embodiments, the MDS is transfusion dependent MDS wherein the patient requires about 2 or more red blood cell units over 8 weeks. In yet certain embodiments, the MDS is MDS with symptomatic anemia with hemoglobin 5 9.0 g/dL and no red blood cell (RBC) transfusion for at least 16 weeks prior to administration of Compound 1. In yet certain embodiments, the MDS is transfusion dependent MDS, wherein the patient requires about or greater than 2 red blood cell units within 8 weeks in the preceding 16 weeks for a hemoglobin <9.0 g/dL prior to administration of Compound 1. In yet certain embodiments, the MDS is relapsed, refractory or ineligible for ESAs and have previously received one or more prior approved therapies for LR-MDS. In yet certain embodiments, the MDS is MDS with del (5q) mutation and which has failed prior lenalidomide therapy. In yet certain embodiments, the MDS is LR-MDS wherein the patient has transfusion-dependent anemia. In certain embodiments, the MDS is transfusion-dependent MDS which is relapsed, refractory to or have had inadequate response to prior therapies for MDS or to HMAs. In yet certain embodiments, the MDS is ring sideroblast-negative (RS-negative MDS). In yet certain embodiments, the MDS is ring sideroblast-negative MDS wherein the patient is relapsed, refractor or ineligible for ESAs. In yet certain embodiments, the MDS is very low risk, low risk, moderate low risk, moderate high risk, high risk or very high risk MDS based on the Molecular International Prognostic scoring system IPSS-M. In one embodiment, MDS has a prognostic score of <=3 IPSS. In one embodiment, the MDS is relapsed, refractory to prior therapy such as luspatercept or imetelstat. In yet certain embodiments, the MDS is relapsed, refractory and/or eligible for prior therapy with ESAs. In yet certain embodiments, the MDS is HMA naïve. In one embodiment, the MDS is previously-treated transfusion dependent LR-MDS.

Examples of allergic disorders that may be treated using solid forms of Compound 1, or compositions thereof, include, but are not limited to, asthma (e.g. atopic asthma, allergic asthma, atopic bronchial IgE-mediated asthma, non-atopic asthma, bronchial asthma, non-allergic asthma, essential asthma, true asthma, intrinsic asthma caused by pathophysiologic disturbances, essential asthma of unknown or unapparent cause, emphysematous asthma, exercise-induced asthma, emotion-induced asthma, extrinsic asthma caused by environmental factors, cold air induced asthma, occupational asthma, infective asthma caused by or associated with bacterial, fungal, protozoal, or viral infection, incipient asthma, wheezy infant syndrome, bronchiolitis, cough variant asthma or drug-induced asthma), allergic bronchopulmonary aspergillosis (ABPA), allergic rhinitis, perennial allergic rhinitis, perennial rhinitis, vasomotor rhinitis, post-nasal drip, purulent or non-purulent sinusitis, acute or chronic sinusitis, and ethmoid, frontal, maxillary, or sphenoid sinusitis.

As another example, rheumatoid arthritis (RA) typically results in swelling, pain, loss of motion and tenderness of target joints throughout the body. RA is characterized by chronically inflamed synovium that is densely crowded with lymphocytes. The synovial membrane, which is typically one cell layer thick, becomes intensely cellular and assumes a form similar to lymphoid tissue, including dendritic cells, T-, B- and NK cells, macrophages and clusters of plasma cells. This process, as well as a plethora of immunopathological mechanisms including the formation of antigen-immunoglobulin complexes, eventually result in destruction of the integrity of the joint, resulting in deformity, permanent loss of function and/or bone erosion at or near the joint. The disclosed solid forms of Compound 1, or compositions thereof, may be used to treat, ameliorate, or prevent any single, several or all of these symptoms of RA. Thus, in the context of RA, the solid forms of Compound 1 are considered to provide therapeutic benefit when a reduction or amelioration of any of the symptoms commonly associated with RA is achieved, regardless of whether the treatment results in a concomitant treatment of the underlying RA and/or a reduction in the amount of circulating rheumatoid factor (“RF”).

The American College of Rheumatology (ACR) has developed criteria for defining improvement and clinical remission in RA. Once such parameter, the ACR20 (ACR criteria for 20% clinical improvement), requires a 20% improvement in the tender and swollen joint count, as well as a 20% improvement in 3 of the following 5 parameters: patient's global assessment, physician's global assessment, patient's assessment of pain, degree of disability, and level of acute phase reactant. These criteria have been expanded for 50% and 70% improvement in ACR50 and ACR70, respectively. Other criteria include Paulu's criteria and radiographic progression (e.g. Sharp score).

In some embodiments, therapeutic benefit in patients suffering from RA is achieved when the patient exhibits an ACR20. In specific embodiments, ACR improvements of ACRC50 or even ACR70 may be achieved.

Cytokine release syndrome (CRS) is a potentially life-threatening condition that may result from a variety of factors, including severe viral infections such as influenza, administration of antibodies that are used for immunotherapy, such as cancer immunotherapy, and non-protein-based cancer drugs such as oxaliplatin and lenalidomide. Immunotherapy can involve high levels of immune activation that exceed naturally occurring immune activation levels, and CRS is a non-antigen specific toxicity that can occur as a result. As immune-based therapies become more potent, CRS is becoming increasing diagnosed. CRS has also been observed in the setting of haploidentical donor stem cell transplantation, and graft-versus-host disease. Shimabukuro-Vornhagen et al., Journal for ImmunoTherapy of Cancer 6:56 (2018). CRS is associated with elevated circulating levels of several cytokines including interleukin (IL)-6 and interferon γ. Lee et al., Blood 124(2):188-195 (10 Jul. 2014; Epub 29 May 2014).

CRS typically is clinically observed when significant numbers of lymphocytes and/or myeloid cells are activated and release inflammatory cytokines. The cytokine release may be induced by chemo- or biotherapy, and/or may be associated with therapeutic antibody treatments, such as immunotherapy, for example, for cancer treatment. Exemplary immunotherapies that may result in CRS include, but are not limited to, therapies where the cells express recombinant receptors, such as chimeric antigen receptors (CARs) and/or other transgenic receptors such as T cell receptors (TCRs). CRS induced by CAR T therapy generally occurs within days of T cell infusion at the peak of CAR T cell expansion. Giavridis et al., Nat Med. 24(6):731-738 (June 2018; Epub 28 May 2018). Examples of CAR T therapy that can induce CRS include axicabtagene ciloleucel (marketed as YESCARTA®) and tisagenlecleucel (marketed as KYMRIAH®).

Highly elevated interleukin 6 (IL-6) levels have been observed in patients with CRS and also in murine models of the disease, indicating that IL-6 may have a role in CRS pathophysiology. Shimabukuro-Vornhagen, J Immunother Cancer 6(1), 56 (2018). IL-6 can signal via two different modes. Classical IL-6 signaling involves binding of IL-6 to a membrane-bound IL-6 receptor. However, the IL-6 receptor does not possess intracellular signaling domains. Instead, after soluble IL-6 binds to membrane-bound IL-6 receptors, the IL-6/IL-6 receptor complex binds to membrane-bound gp130, which initiates signaling through its intracellular domain. In trans-signaling, IL-6 binds to a soluble form of the IL-6 receptor, which is typically cleaved from the cell surface by metalloproteinases. The resulting soluble IL-6/IL-6 receptor complex binds to gp130 and therefore can also induce signaling in cell types that do not express membrane bound IL-6 receptors.

IL-6 contributes to many of the key symptoms of CRS. Via trans-signaling, IL-6 leads to characteristic symptoms of severe CRS, i.e. vascular leakage, and activation of the complement and coagulation cascade inducing disseminated intravascular coagulation (DIC). In addition, IL-6 likely contributes to cardiomyopathy that is often observed in patients with CRS by promoting myocardial dysfunction. In a murine model, CRS developed within 2-3 days of CAR T cell infusion and could be lethal. Giavridis et al., Nat Med. 24(6): 731-738 (2018). CRS symptoms may start within minutes or hours of the start of antibody treatment, and can include a fever, which may reach or exceed 40° C., nausea, fatigue, headache, tachycardia, hypotension, rash, shortness of breath, and/or myalgias. However, in certain cases, additional and potentially more serious complications may develop, including cardiac dysfunction, adult respiratory distress syndrome, neurological toxicity, renal and/or hepatic failure, and/or disseminated intravascular coagulation.

The National Cancer Institute Common Terminology Criteria for Adverse Events (CTCAE v. 5.0, pub. Nov. 27, 2017) includes a grading system for CRS.

Grade 1: Fever with or without constitutional symptoms.

Grade 2: Hypotension responding to fluids; hypoxia responding to <40% O2.

Grade 3: Hypotension managed with one pressor; hypoxia requiring ≥40% O2.

Grade 4: Life-threatening consequences; urgent intervention indicated.

Grade 5: Death.

The subject may not exhibit a sign or symptom of CRS and/or may be at risk of developing CRS. In such embodiments, administering the solid forms of Compound 1 substantially prevents the onset of CRS, or prevents the onset of grade 2 or higher CRS.

Alternatively, the subject exhibits at least one sign or symptom of CRS and may exhibit at least one sign or symptom of grade 1 CRS. Or the subject may exhibit at least one sign or symptom of grade 2 or higher CRS, such as grade 3 or higher CRS. The disclosed solid forms, including the solid forms of Compound 1 may be administered within 24 hours of the onset of the sign or symptom, and/or administering the solid forms, including the solid forms of Compound 1 may ameliorate the sign or symptom of CRS, compared to the severity of the sign or symptom prior to administration of the solid forms, including the solid forms of Compound 1, such as reducing the grade of CRS from 4 to 3, 2 or 1, or from 3, to 2 or 1, or from 2 to 1. Alternatively, CRS symptoms are substantially reduced to below grade 1 level, such that the subject no longer experiences symptoms associated with CRS. In some embodiments the sign or symptom is a fever and may be a fever of 40° C. or higher.

The solid forms, including the solid forms of Compound 1 may be administered to a subject that has previously been administered a first therapy for which CRS is a known, suspected, or potential side effect. Administration of the first therapy may be initiated from greater than zero to 10 days, or longer, prior to administration of the solid forms provided herein, including the solid forms of Compound 1. Alternatively, the solid forms provided herein, including the solid forms of Compound 1 may be administered to a subject who will be, or is concurrently being, administered a first therapy for which CRS is a known, suspected, and/or potential side effect. The first therapy may comprise a cell therapy, including, but not limited to, chimeric antigen receptor (CAR)-expressing therapy and/or a transgenic receptor therapy. Cell-free antibodies are also known to elicit this syndrome, particularly those that activate T-cells.

A second therapeutic agent, for example, a steroid, an anti-inflammatory agent, an immunosuppressant, or a combination thereof, also may be administered to treat or prevent CRS. The disclosed solid forms, including the solid forms of Compound 1 may be administered substantially simultaneously with the second therapeutic agent, or the solid forms, including the solid forms of Compound 1 and second therapeutic agent may be administered sequentially in any order.

Acute respiratory distress syndrome (ARDS) is a syndrome characterized by a severe shortness of breath, labored and unusually rapid breathing, low blood pressure, confusion and extreme tiredness. This syndrome can be diagnosed based on a PaO₂/FiO₂ ratio of less than 300 mmHg despite a PEEP of more than 5 cm H₂O (Fan et al JAMA. 319: 698-71).

ARDS occurs when fluid builds up in lung alveoli. The fluid prevents the lungs from filling with enough air, limiting the amount of oxygen that reaches the bloodstream which, in turn, deprives the organs of the oxygen they need to function. The symptoms of ARDS can vary in intensity, depending on its cause and severity. Severe shortness of breath—the hallmark of ARDS—usually develops within a few hours to a few days after the infection by some respiratory viruses, e.g., COVID-19 and influenza. Many people who develop ARDS do not survive, and the risk of death increases with age and severity of illness. Of the patients that survive ARDS, some completely recover while others have lasting damage to their lungs. ARDS may be referred to as Acute Lung Injury (ALI) in some publications.

Acute kidney injury (AKI), also known as acute renal injury (ARI) or acute renal failure (ARF), is a syndrome characterized by an abrupt reduction of renal function including, e.g., the ability to excrete waste from a patient's blood. AKI is characterized by a decline of glomerular filtration rate, urine output, or both. This loss of filtration capacity results in retention of nitrogenous (urea and creatinine) and non-nitrogenous waste products that are normally excreted by the kidney, a reduction in urine output, or both. AKI may be categorized as prerenal, intrinsic renal, or postrenal in causation. Intrinsic renal disease can be further divided into glomerular, tubular, interstitial, and vascular abnormalities. AKI is accompanied by an inflammatory response that if unchecked can lead to renal fibrosis and chronic renal failure. AKI usually occurs over a period of hours or days and is potentially reversible. AKI may be characterized as an abrupt (i.e., for example, within 14 days, within 7 days, within 72 hours, or within 48 hours) reduction in kidney function identified by an absolute increase in serum creatinine of greater than or equal to 0.3 mg/dl (≥26.4 μmol/l), a percentage increase in serum creatinine of greater than or equal to 50% (1.5-fold from baseline), or a reduction in urine output (documented oliguria of less than 0.5 ml/kg per hour for at least 6 hours). Risk factors include, for example, a subject undergoing or having undergone major vascular surgery, coronary artery bypass, or other cardiac surgery; a subject having pre-existing congestive heart failure, preeclampsia, eclampsia, diabetes mellitus, hypertension, coronary artery disease, proteinuria, renal insufficiency, glomerular filtration below the normal range, cirrhosis, serum creatinine above the normal range, or sepsis; or a subject exposed to NSAIDs, cyclosporines, tacrolimus, aminoglycosides, foscarnet, ethylene glycol, hemoglobin, myoglobin, ifosfamide, heavy metals, methotrexate, radiopaque contrast agents, or streptozotocin. This list is not meant to be limiting.

Kidney malfunction includes, but is not limited to, kidney disorders, kidney disease, kidney dysfunction, kidney cancer, absence of at least one kidney due to accidents, surgical removal or genetic disorders, or other conditions where one or both of the kidneys are not properly functioning. Kidney malfunction may include acute kidney injury.

Thrombosis is a clotting disorder to which an excess of platelets contributes. Thrombosis may refer to the formation of a thrombus (blood clot) inside a blood vessel. The term encompasses, without limitation, arterial and venous thrombosis, including deep vein thrombosis, portal vein thrombosis, jugular vein thrombosis, renal vein thrombosis, stroke, myocardial infarction, Budd-Chiari syndrome, Paget-Schroetter disease, and cerebral venous sinus thrombosis. In some embodiments, the patient is at heightened risk relative to the general population (e.g., as measured by recognized risk factors) of a thrombotic event. In some embodiments, a patient has one or more risk factors that make the patient have a high risk of developing thrombosis relative to the general population. Risk factors for thrombosis include, e.g., classical cardiovascular disease risk factors: hyperlipidemia, smoking, diabetes, hypertension, and abdominal obesity; strong classical venous thromboembolism risk factors: trauma or fractures, major orthopedic surgery, and oncological surgery; moderate classical venous thromboembolism risk factors: non-oncological surgery, oral contraceptives and hormone replacement therapy, pregnancy and puerperium, hypercoagulability, and previous venous thromboembolism; and weak classical venous thromboembolism risk factors: age, bed rest (>3 days), prolonged travel, and metabolic syndrome. Additional risk factors include inherited, acquired and mixed coagulation or metabolic risk factors for thrombosis such as, e.g., inherited: antithrombin deficiency, protein C deficiency, Protein S deficiency, Factor V Leiden, Prothrombin G20210A; acquired: antiphospholipid syndrome; mixed: hyperhomocysteinemia, increased fibrinogen levels, increased factor VIII levels, increased factor IX levels. In some cases, the use of heparin may increase the risk of thrombosis including, e.g., heparin-induced thrombocytopenia (HIT). Diseases and conditions associated with thrombosis include, without limitation, acute venous thrombosis, pulmonary embolism, thrombosis during pregnancy, hemorrhagic skin necrosis, acute or chronic disseminated intravascular coagulation (DIC), sepsis induced coagulopathy (SIC), clot formation from surgery, long bed rest, long periods of immobilization, venous thrombosis, fulminant meningococcemia, acute thrombotic stroke, acute coronary occlusion, acute peripheral arterial occlusion, massive pulmonary embolism, axillary vein thrombosis, massive iliofemoral vein thrombosis, occluded arterial cannulae, occluded venous cannulae, cardiomyopathy, venoocclusive disease of the liver, hypotension, decreased cardiac output, decreased vascular resistance, pulmonary hypertension, diminished lung compliance, leukopenia, thrombocytopenia (e.g., immune thrombocytopenia), and immune thrombocytic purpura. In a subject at risk for thrombosis, the subject may be monitored using methods known to those of skill in the art of maintaining hemostasis in patients at risk for thrombosis. Examples of methods for monitoring patients at risk of thrombosis included, without limitation, digital subtraction angiography, in vitro assays or non-invasive methods. Examples of in vitro assays useful for identifying and monitoring subjects at risk for thrombosis and for treatment using the present methods include, without limitation, functional assays and antibody detection assays.

Thrombotic event refers to any disorder which involves a blockage or partial blockage of an artery or vein with a thrombosis. A thrombotic event includes, but is not limited to, thrombotic disorders such as myocardial infarction, unstable angina, stroke, pulmonary embolism, transient ischemic attack, deep vein thrombosis, thrombotic re-occlusion and peripheral vascular thrombosis. A thrombotic event also includes thrombotic re-occlusion which occurs subsequent to a coronary intervention procedure or thrombolytic therapy.

COVID-19 is a disease caused by infection by SARS-CoV-2 (previously known as 2019-nCoV) which first appeared in Wuhan, China.

COVID-19-associated ARDS refers to ARDS that is caused by infection by SARS-CoV-2. Patients having COVID-19-associated ARDS may have been diagnosed as having a COVID-19, may have been exposed to another person having a COVID19, or may be suspected of having a COVID-19 based on their symptoms.

COVID-19-associated AKI refers to AKI that is caused by infection by SARS-CoV-2. Patients having COVID-19-associated AKI may have been diagnosed as having a COVID-19, may have been exposed to another person having a COVID-19, or may be suspected of having a COVID-19 based on their symptoms. In some cases, COVID-19-associated AKI includes AKI with the symptoms described, e.g., in Batlle et al. J. AM. SOC. NEPHROL. 2020, 31(7): 1380-1383 and Gabarre et al. Intensive Care Med. 2020, 46(7): 1339-1348, the disclosures of which are incorporated herein by reference in their entireties.

COVID-19-associated thrombosis refers to thrombosis that is caused by infection by SARS-CoV-2. Patients having COVID-19-associated thrombosis may have been diagnosed as having a COVID-19, may have been exposed to another person having a COVID-19, or may be suspected of having a COVID-19 based on their symptoms. In some cases, COVID-19-associated thrombosis includes any of the symptoms described in, e.g., Connors et al. Blood 2020, 135(23): 2033-2040 and Bikdeli et al. J. Am. Coll. Cardiol. 2020, 75(23): 2950-73, the disclosures of which are incorporated herein by reference in their entireties.

The term “associated with COVID-19” refers to a symptom or indication that typically develops within 28 days of hospitalization due to/signs of COVID-19.

For COVID-19-associated ARDS, successful treatment may include a decrease in shortness of breath, less labored or less rapid breathing, higher blood pressure, decreased confusion and/or a decrease tiredness. A treatment may be administered prophylactically, i.e., before the onset of ARDS. A prophylactic treatment prevents ARDS and can be administered to patients that have or are suspected of having a COVID-19 infection, but without the severe symptoms of ARDS. For example, prophylactic treatment can be administered to patients that have a cough without the other symptoms of ARDS.

For COVID-19-associated AKI, successful treatment may include increased kidney function. Kidney function may be assessed by measuring serum creatinine levels, serum creatinine clearance, or blood urea nitrogen levels. In some cases, the successful treatment includes a reduction in metabolic acidosis, hyperkalaemia, oliguria or anuria, azotemia, restoration in body fluid balance, and improved effects on other organ systems. A treatment may be administered prophylactically, i.e., before the onset of AKI. A prophylactic treatment prevents AKI and can be administered to patients that have or are suspected of having a COVID-19 infection, but without the severe symptoms of AKI. For example, prophylactic treatment can be administered to patients that have one or more of increased serum or urine creatinine, hematuria, hypoproteinemia, decreased antithrombin III levels, hypalbuminemia, leukocyturia, or proteinuria without the other symptoms of AKI.

For COVID-19-associated thrombosis, successful treatment may include improvement in the subject's coagulation profile, or preventing, slowing, delaying, or arresting, a worsening of the coagulation profile for which the subject is at risk. A coagulation profile may be assessed by measurement of one or more coagulation parameters including, e.g., a subject's serum level of one or more of D-dimer, Factor II, Factor V (e.g., Factor V Leiden), Factor VII, Factor VIII, Factor IX, Factor XI, Factor XII, Factor XIII, F/fibrin degradation products, thrombin-antithrombin 111 complex, fibrinogen, plasminogen, prothrombin, and von Willebrand factor. Additional coagulation parameters that may be measured for the coagulation profile include, e.g., prothrombin time, thromboplastin time, activated partial thromboplast time (aPTT), antithrombin activity, platelet count, protein C levels, and protein S levels. In addition, the levels of C reactive protein may also be assessed in the patient prior to treatment and if elevated this may be used as a further indicator as to an increased risk of thrombosis in the patient.

Sepsis is a clinical syndrome of life-threatening organ dysfunction caused by a dysregulated immune response to infection. The more severe form of sepsis “septic shock” is characterized by a critical reduction in tissue perfusion; acute failure of multiple organs, including the lungs, kidneys, and liver. Common causes in immunocompetent patients include many different species of gram-positive and gram-negative bacteria. Immunocompromised patients may have uncommon bacterial or fungal species as a cause. Signs include fever, hypotension, oliguria, and confusion. Diagnosis is primarily clinical combined with culture results showing infection; early recognition and treatment is critical. Treatment is aggressive fluid resuscitation, antibiotics, surgical excision of infected or necrotic tissue and drainage of pus, and supportive care.

Influenza is a disease generally known as the “flu.” Influenza is caused by a group of viruses that can be broken down into 4 separate groups: Influenza A, Influenza B, Influenza C and Influenza D which are separated based on their nuceloproteins and matrix proteins. Influenza causes viral respiratory infection resulting in fever, coryza, cough, headache, and malaise. Influenza A, B, and C all infect humans while there have been no documented cases of human Influenza D infection. Influenza C on the other hand does not cause typical influenza illness seen in individuals infected with Influenza A, B or C.

Influenza A strains are further classified based on two surface proteins, hemagglutinin (H) and neuraminidase (N). There are 18 different hemagglutinin subtypes and 11 different neuraminidase subtypes (H1 through H18 and N1 through N11, respectively). While there are potentially 198 different influenza A subtype combinations, only 131 subtypes have been detected in nature. Current subtypes of influenza A viruses that routinely circulate in people include: A(H1N1) and A(H3N2).

Cytokine release-related condition associated with influenza refers to any condition associated with influenza that leads to high levels of cytokine releases in the lungs and/or kidneys. Cytokine releases-related conditions, include without limitation, influenza-associated ARDS, influenza-associated AKI, influenza-associated thrombosis, influenza-associated sepsis, influenza-associated septic shock, etc.

Influenza-associated ARDS is ARDS that is caused by influenza infection. Patients having influenza-associated ARDS may have been diagnosed as having an influenza infection, may have been exposed to another person having an influenza infection, or may be suspected of having an influenza infection based on their symptoms.

Influenza-associated AKI is AKI that is caused by influenza infection. Patients having influenza-associated AKI may have been diagnosed as having an influenza infection, may have been exposed to another person having an influenza infection, or may be suspected of having an influenza infection based on their symptoms. In some cases, influenza-associated AKI includes AKI with the symptoms described, e.g., in Batlle et al. J. AM. SOC. NEPHROL. 2020, 31(7): 1380-1383 and Gabarre et al. Intensive Care Med. 2020, 46(7): 1339-1348, the disclosures of which are incorporated herein by reference in their entireties.

Influenza-associated thrombosis is thrombosis that is caused by influenza infection. Patients having influenza-associated thrombosis may have been diagnosed as having an influenza infection, may have been exposed to another person having an influenza infection, or may be suspected of having an influenza infection based on their symptoms. In some cases, influenza-associated thrombosis includes any of the symptoms described in, e.g., Connors et al. Blood 2020, 135(23): 2033-2040 and Bikdeli et al. J. Am. Coll. Cardiol. 2020, 75(23): 2950-73, the disclosures of which are incorporated herein by reference in their entireties.

Influenza-associated sepsis is sepsis that is caused by influenza infection. Patients having influenza-associated sepsis may have been diagnosed as having an influenza infection, may have been exposed to another person having an influenza infection, or may be suspected of having an influenza infection based on their symptoms. In some cases, influenza-associated thrombosis includes any of the symptoms described in, e.g., Florescu et al. Virulence. 2014 Jan. 1; 5(1): 137-142. and Gu et al. Eur Respir Rev. 2020 Jul. 21; 29(157):200038, the disclosures of which are incorporated herein by reference in their entireties.

The term “associated with influenza” refers to a symptom or indication that develops within 28 days of hospitalization/signs of influenza infection.

For influenza-associated ARDS, successful treatment may include a decrease in shortness of breath, less labored or less rapid breathing, higher blood pressure, decreased confusion and/or a decrease tiredness. A treatment may be administered prophylactically, i.e., before the onset of ARDS. A prophylactic treatment prevents ARDS and can be administered to patients that have or are suspected of having an influenza infection, but without the severe symptoms of ARDS. For example, prophylactic treatment can be administered to patients that have a cough without the other symptoms of ARDS.

For influenza-associated AKI, successful treatment may include increased kidney function. Kidney function may be assessed by measuring serum creatinine levels, serum creatinine clearance, or blood urea nitrogen levels. In some cases, the successful treatment includes a reduction in metabolic acidosis, hyperkalaemia, oliguria or anuria, azotemia, restoration in body fluid balance, and improved effects on other organ systems. A treatment may be administered prophylactically, i.e., before the onset of AKI. A prophylactic treatment prevents AKI and can be administered to patients that have or are suspected of having an influenza infection, but without the severe symptoms of AKI. For example, prophylactic treatment can be administered to patients that have one or more of increased serum or urine creatinine, hematuria, hypoproteinemia, decreased antithrombin III levels, hypalbuminemia, leukocyturia, or proteinuria without the other symptoms of AKI.

For influenza-associated thrombosis, successful treatment may include improvement in the subject's coagulation profile, or preventing, slowing, delaying, or arresting, a worsening of the coagulation profile for which the subject is at risk. A coagulation profile may be assessed by measurement of one or more coagulation parameters including, e.g., a subject's serum level of one or more of D-dimer, Factor II, Factor V (e.g., Factor V Leiden), Factor VII, Factor VIII, Factor IX, Factor XI, Factor XII, Factor XIII, F/fibrin degradation products, thrombin-antithrombin 111 complex, fibrinogen, plasminogen, prothrombin, and von Willebrand factor. Additional coagulation parameters that may be measured for the coagulation profile include, e.g., prothrombin time, thromboplastin time, activated partial thromboplast time (aPTT), antithrombin activity, platelet count, protein C levels, and protein S levels. In addition, the levels of C reactive protein may also be assessed in the patient prior to treatment and if elevated this may be used as a further indicator as to an increased risk of thrombosis in the patient.

For influenza-associated sepsis or septic shock, successful treatment may include a reduction in fever, a reduction in high or moderately-high heartbeat (e.g. tachycardia), a reduction in sweating (i.e. diaphoresis), decreased confusion and/or a decrease tiredness, and/or a decrease in shortness of breath, less labored or less rapid breathing. A treatment may be administered prophylactically, i.e., before the onset of sepsis or septic shock. A prophylactic treatment prevents sepsis or septic shock and can be administered to patients that have or are suspected of having an influenza infection, but without the severe symptoms of sepsis or septic shock. For example, prophylactic treatment can be administered to patients that have a cough without the other symptoms of sepsis or septic shock.

Additionally, the solid forms, including the solid forms of Compound 1, or compositions thereof, may be used to treat sickle cell disease, particularly to reduce immunological responses that manifest in the disease. In some embodiments, the subject may exhibiting one or more of the following symptoms: anemia, sickle cell crisis, vaso-occlusive crisis, splenic sequestration crisis, splenic sequestration crises, acute chest syndrome, acute chest syndrome, aplastic crisis, hemolytic crisis, dactylitis, pneumonia, respiratory infection, bone-marrow embolization, or atelectasis.

Sickle cell disease (SCD) is a group of blood disorders typically inherited. The most common type is known as sickle cell anemia, which results in an abnormality in the oxygen carrying protein hemoglobin found in red blood cells. This leads to a rigid, sickle-like shape under certain circumstances. Problems in sickle cell disease typically begin around 5 to 6 months of age and a number of health problems may develop, such as attacks of pain (known as a sickle cell crisis), anemia, swelling in the hands and feet, bacterial infections and stroke. Long-term pain may develop as people get older.

Sickle cell disease occurs when a person inherits two abnormal copies of the P-globin gene (HBB) that makes hemoglobin, one from each parent. That gene occurs in chromosome 11. Several subtypes exist, depending on the exact mutation in each hemoglobin gene. An attack can be set off by temperature changes, stress, dehydration, and high altitude.

The care of people with sickle cell disease may include infection prevention with vaccination and antibiotics, high fluid intake, folic acid supplementation, and pain medication. Other measures may include blood transfusion and the medication hydroxycarbamide (hydroxyurea). A small percentage of people can be cured by a transplant of bone marrow cells. Patients with sickle cell disease may exhibit the following symptoms:

Sickle cell crisis: The terms “sickle cell crisis” or “sickling crisis” may be used to describe several independent acute conditions occurring in subjects with SCD, which results in anemia and crises that could be of many types, including the vaso-occlusive crisis, aplastic crisis, splenic sequestration crisis, hemolytic crisis, and others. Most episodes of sickle cell crises last between five and seven days. Although infection, dehydration, and acidosis (all of which favor sickling) can act as triggers, in most instances, no predisposing cause is identified.

Vaso-occlusive crisis: The vaso-occlusive crisis is caused by sickle-shaped red blood cells that obstruct capillaries and restrict blood flow to an organ, resulting in ischaemia, pain, necrosis, and often organ damage. The frequency, severity, and duration of these crises vary considerably. Painful crises are treated with hydration, analgesics, and blood transfusion; pain management requires opioid drug administration at regular intervals until the crisis has settled. For milder crises, a subgroup of subjects manages on nonsteroidal anti-inflammatory drugs such as diclofenac or naproxen. For more severe crises, most subjects require in-subject management for intravenous opioids; subject-controlled analgesia devices are commonly used in this setting. Vaso-occlusive crisis involving organs such as the penis or lungs are considered an emergency and treated with red blood cell transfusions. Incentive spirometry, a technique to encourage deep breathing to minimize the development of atelectasis, is recommended.

Splenic sequestration crisis: The spleen is frequently affected in sickle cell disease, as the sickle-shaped red blood cells cause narrowing of blood vessels and reduced function in clearing the defective cells. It is usually infarcted before the end of childhood in individuals with sickle cell anemia. This spleen damage increases the risk of infection from encapsulated organisms; preventive antibiotics and vaccinations are recommended for those lacking proper spleen function.

Splenic sequestration crises are acute, painful enlargements of the spleen, caused by intrasplenic trapping of red cells and resulting in a precipitous fall in hemoglobin levels with the potential for hypovolemic shock. Sequestration crises are considered an emergency. If not treated, subjects may die within 1-2 hours due to circulatory failure. Management is supportive, sometimes with blood transfusion. These crises are transient; they continue for 3-4 hours and may last for one day.

Acute chest syndrome: Acute chest syndrome is defined by at least two of these signs or symptoms: chest pain, fever, pulmonary infiltrate or focal abnormality, respiratory symptoms, or hypoxemia. It is the second-most common complication and it accounts for about 25% of deaths in subjects with SCD. Most cases present with vaso-occlusive crises, and then develop acute chest syndrome. Nevertheless, about 80% of people have vaso-occlusive crises during acute chest syndrome.

Aplastic crisis: Aplastic crises are instances of an acute worsening of the subject's baseline anemia, producing pale appearance, fast heart rate, and fatigue. This crisis is normally triggered by parvovirus B19, which directly affects production of red blood cells by invading the red cell precursors and multiplying in and destroying them. Parvovirus infection almost completely prevents red blood cell production for two to three days. In normal individuals, this is of little consequence, but the shortened red cell life of SCD subjects results in an abrupt, life-threatening situation. Reticulocyte counts drop dramatically during the disease (causing reticulocytopenia), and the rapid turnover of red cells leads to the drop in hemoglobin. This crisis takes 4 to 7 days to disappear. Most subjects can be managed supportively; some need a blood transfusion.

Hemolytic crisis: Hemolytic crises are acute accelerated drops in hemoglobin level. The red blood cells break down at a faster rate. This is particularly common in people with coexistent G6PD deficiency. Another influence of hemolytic crises in Sickle Cell Disease is oxidative stress on the erythrocytes, leukocytes, and platelets. When there is not enough red blood cell production in the bone marrow, the oxygen that the body receives, processes, and transports is unbalanced with the body's antioxidants. There is an imbalance in the oxygen reactive species in the cells, which leads to more production of red blood cells that are not properly oxygenated or formed. Oxidative stress may lead to anemia because of the imbalance of oxygen in the tissue. Management is supportive, sometimes with blood transfusions.

In addition, one of the earliest clinical manifestations is dactylitis, presenting as early as six months of age, and may occur in children with sickle cell trait. The crisis can last up to a month. Given that pneumonia and sickling in the lung can both produce symptoms of acute chest syndrome, the subject is treated for both conditions. It can be triggered by painful crisis, respiratory infection, bone-marrow embolization, or possibly by atelectasis, opiate administration, or surgery. Hematopoietic ulcers may also occur.

Additionally, the solid forms, including the solid forms of Compound 1, or compositions thereof, may be used to treat a lung injury. The lung injury may be a chemical- or radiation-induced lung injury.

In some embodiments, the subject may have inhaled or may be expected to be exposed to a pulmonary irritant. In some embodiments, the subject may have inhaled or may be expected to inhale a choking agent. A pulmonary agent, or choking agent, is a chemical agent designed to impede a subject's ability to breathe. These compounds generally operate by causing a build-up of fluids in the lungs, which then leads to suffocation. Inhalation of these agents cause burning of the throat, coughing, vomiting, headache, pain in chest, tightness in chest, and respiratory and circulatory failure. Examples of such agents include: chlorine gas, chloropicrin (PS), diphosgene (DP), phosgene (CG), disulfur decafluoride, perfluoroisobutene, acrolein, and piphenylcyanoarsine. Phosgene-induced acute lung injury (P-ALI) is commonly associated with short-term phosgene inhalation. Prolonged exposure can cause chronic hypoventilation, refractory pulmonary edema, and other associated lung injuries, ultimately resulting in ARDS. Chemical pneumonitis is inflammation of the lungs or breathing difficulty due to inhaling chemical fumes or breathing in and choking on certain chemicals.

Additionally, the solid forms, including the solid forms of Compound 1, or compositions thereof, may be used to treat or prevent acute inhalation injury (AII) and e-cigarette, or vaping, product use-associated lung injury (EVALI).

In other embodiments, the subject has been exposed to or is expected to be exposed to ionizing radiation. In these embodiments, the subject may have or may be expected to develop radiation induced lung injury (RILI). In some embodiments, the subject may have radiation pneumonitis or radiation pulmonary fibrosis. In these embodiments, the subject may have received or is undergoing thoracic radiotherapy, may have inhaled a radioactive agent or may have had direct exposure to ionizing radiation. For example, the subject may have inhaled a radioactive agent or have had direct exposure to ionizing radiation as a result of a nuclear weapon or leak at a nuclear power plant, for example.

The solid forms, including the solid forms of Compound 1, or compositions thereof, also may be used to treat or prevent hemorrhagic fever, or symptoms thereof, including Ebola virus disease, Alkhurma hemorrhagic fever, Chapare hemorrhagic fever, Crimean-Congo hemorrhagic fever, Hantavirus Pulmonary Syndrome (HPS), Hemorrhagic fever with renal syndrome (HFRS), Kyasanur Forest Disease (KFD), Lassa fever, Lujo hemorrhagic fever, Marburg hemorrhagic fever, Omsk hemorrhagic fever, Rift Valley fever, Yellow Fever, or Dengue fever, such as severe dengue fever (dengue hemorrhagic fever).

### B. Formulations and Administration

Pharmaceutical compositions comprising one or more solid forms, including the solid forms of Compound 1 provided herein may be manufactured by any suitable method, such as mixing, dissolving, granulating, dragee-making, levigating, emulsifying, encapsulating, entrapping or lyophilization processes. The compositions may be formulated using one or more physiologically acceptable excipients, diluents, carriers, adjuvants or auxiliaries to provide preparations which can be used pharmaceutically.

Pharmaceutical compositions comprising the disclosed solid forms, including the solid forms of Compound 1 may take a form suitable for virtually any mode of administration, including, for example, topical, ocular, oral, buccal, systemic, nasal, injection, such as i.v. or i.p., transdermal, rectal, vaginal, etc., or a form suitable for administration by inhalation or insufflation.

In one embodiment, the pharmaceutical composition comprising the disclosed solid forms, including the solid forms of Compound 1 and a pharmaceutically acceptable carrier or excipient.

In one embodiment, the pharmaceutical composition comprising the disclosed solid forms, including the solid forms of Compound 1 is a tablet.

Examples of tablets comprising the solid forms provided herein include a tablet comprising:
a) about 15% to about 35% of a solid form of Compound 1 by weight based on total weight of the tablet;
b) about 50% to about 70% intra-granular excipient by weight based on total weight of the tablet; and
c) about 10% to about 20% extra-granular excipient by weight based on total weight of the tablet.

In one embodiment, the tablet provided herein comprises:
a) about 20% to about 30% of a solid form of Compound 1 by weight based on total weight of the tablet;
b) an intra-granular excipient comprising about 25% to about 35% microcrystalline cellulose by weight based on total weight of the tablet, about 25% to about 35% mannitol by weight based on total weight of the tablet, about 2% to about 4% croscarmellose sodium by weight based on total weight of the tablet, about 0.2% to about 2% fumed silica by weight based on total weight of the tablet, and about 0.5% to about 2% sodium stearyl fumarate by weight based on total weight of the tablet; and
c) an extra-granular excipient comprising about 6% to about 10% microcrystalline cellulose by weight based on total weight of the tablet, about 2% to about 4% croscarmellose sodium by weight based on total weight of the tablet, and about 1% to about 3% sodium stearyl fumarate by weight based on total weight of the tablet.

In one embodiment, the tablet provided herein comprises:
a) about 60% to about 85% Compound 1 by weight based on total weight of the tablet;
b) about 15% to about 25% intra-granular excipient by weight based on total weight of the tablet; and
c) about 10% to about 20% extra-granular excipient by weight based on total weight of the tablet.

In one embodiment, the tablet provided herein comprises:
a) about 60% to about 75% Compound 1 by weight based on total weight of the tablet;
b) an intra-granular excipient comprising about 4% to about 10% microcrystalline cellulose by weight based on total weight of the tablet, about 4% to about 10% mannitol by weight based on total weight of the tablet, about 2% to about 4% croscarmellose sodium by weight based on total weight of the tablet, about 0.2% to about 2% fumed silica by weight based on total weight of the tablet, and about 0.5% to about 2% sodium stearyl fumarate by weight based on total weight of the tablet; and
c) an extra-granular excipient comprising about 6% to about 10% microcrystalline cellulose by weight based on total weight of the tablet, about 2% to about 4% croscarmellose sodium by weight based on total weight of the tablet, and about 1% to about 3% sodium stearyl fumarate by weight based on total weight of the tablet.

In one embodiment, provided herein are pharmaceutical compositions prepared using a solid form herein and a pharmaceutically acceptable carrier or excipient.

### C. Dosages

The solid forms provided herein, including the solid forms of Compound 1 will generally be used in an amount effective to achieve the intended result, for example, in an amount effective to treat, prevent or ameliorate a particular condition. The solid forms provided herein, including the solid forms of Compound 1, or compositions thereof, can be administered therapeutically to achieve therapeutic benefit or prophylactically to achieve a prophylactic benefit. Therapeutic benefit means eradication or amelioration of the underlying disorder being treated and/or eradication or amelioration of one or more of the symptoms associated with the underlying disorder such that the patient reports an improvement in feeling or condition, notwithstanding that the patient may still be afflicted with the underlying disorder. For example, administration of the solid forms provided herein, including the solid forms of Compound 1 to a patient suffering from an allergy provides therapeutic benefit not only when the underlying allergic response is eradicated or ameliorated, but also when the patient reports a decrease in the severity or duration of the symptoms associated with the allergy following exposure to the allergen. As another example, therapeutic benefit in the context of asthma includes an improvement in respiration following the onset of an asthmatic attack or a reduction in the frequency or severity of asthmatic episodes. Therapeutic benefit also includes halting or slowing the progression of the disease, regardless of whether improvement is realized.

As known by those of ordinary skill in the art, the preferred dosage, including the dosage of Compound 1 may depend on various factors, including the age, weight, general health, and severity of the condition of the patient or subject being treated. Dosage also may need to be tailored to the sex of the individual and/or the lung capacity of the individual, when administered by inhalation. Dosage may also be tailored to individuals suffering from more than one condition or those individuals who have additional conditions that affect lung capacity and the ability to breathe normally, for example, emphysema, bronchitis, pneumonia, and respiratory infections. Dosage, and frequency of administration of the solid forms, including the solid forms of Compound 1 or compositions thereof, will also depend on whether the solid forms, including the solid forms of Compound 1 are formulated for treatment of acute episodes of a condition or for the prophylactic treatment of a disorder. A person of ordinary skill in the art will be able to determine the optimal dose for a particular individual.

For prophylactic administration, the solid forms provided herein, including the solid forms of Compound 1, or compositions thereof, can be administered to a patient or subject at risk of developing one of the previously described conditions. For example, if it is unknown whether a patient or subject is allergic to a particular drug, the solid forms provided herein, including the solid forms of Compound 1, or compositions thereof, can be administered prior to administration of the drug to avoid or ameliorate an allergic response to the drug. Alternatively, prophylactic administration can be used to avoid or ameliorate the onset of symptoms in a patient diagnosed with the underlying disorder. For example, the solid forms provided herein, including the solid forms of Compound 1 or composition thereof, can be administered to an allergy sufferer prior to expected exposure to the allergen. The solid forms provided herein, including the solid forms of Compound 1, or compositions thereof, can also be administered prophylactically to healthy individuals who are repeatedly exposed to agents known to one of the above-described maladies to prevent the onset of the disorder. For example, the solid forms provided herein, including the solid forms of Compound 1, or compositions thereof, can be administered to a healthy individual who is repeatedly exposed to an allergen known to induce allergies, such as latex, in an effort to prevent the individual from developing an allergy. Alternatively, the solid forms provided herein, including the solid forms of Compound 1 can be administered to a patient suffering from asthma prior to partaking in activities which trigger asthma attacks to lessen the severity of, or avoid altogether, an asthmatic episode.

Effective dosages can be estimated initially from in vitro assays. For example, an initial dosage for use in subjects can be formulated to achieve a circulating blood or serum concentration of active compound that is at or above an IC₅₀ or EC₅₀ of the particular compound as measured in an in vitro assay. Dosages can be calculated to achieve such circulating blood or serum concentrations taking into account the bioavailability of the particular compound. Fingl & Woodbury, “General Principles,” In: Goodman and Gilman's The Pharmaceutical Basis of Therapeutics, Chapter 1, pages 1-46, Pergamon Press, and the references cited therein, provide additional guidance concerning effective dosages.

Initial dosages can also be estimated from in vivo data, such as animal models. Animal models useful for testing the efficacy of compounds to treat or prevent the various diseases described above are well-known in the art. Suitable animal models of hypersensitivity or allergic reactions are described in Foster, (1995) Allergy 50(21Suppl):6-9, discussion 34-38 and Tumas et al., (2001), J. Allergy Clin. Immunol. 107(6):1025-1033. Suitable animal models of allergic rhinitis are described in Szelenyi et al., (2000), Arzneimittelforschung 50(11):1037-42; Kawaguchi et al., (1994), Clin. Exp. Allergy 24(3):238-244 and Sugimoto et al., (2000), Immunopharmacology 48(1):1-7. Persons of ordinary skill in the art can adapt such information to determine dosages suitable for human administration.

Dosage amount and dosage interval can be adjusted for individuals to provide plasma levels of Compound 1 that are sufficient to maintain therapeutic or prophylactic effect. For example, the solid forms, including the solid forms of Compound 1 can be administered once per day, multiple times per day, once per week, multiple times per week (e.g., every other day), one per month, multiple times per month, or once per year, depending upon, amongst other things, the mode of administration, the specific indication being treated, and the judgment of the prescribing physician. Persons of ordinary skill in the art will be able to optimize effective local dosages without undue experimentation.

In one embodiment, the solid forms provided herein, including the solid forms of Compound 1 can be administered to a subject in an amount of about 1 mg per day to about 2000 mg per day. In one embodiment, the solid forms provided herein, including the solid forms of Compound 1 can be administered in an amount of about 100 mg per day to about 1000 mg per day. In one embodiment, the solid forms provided herein, including the solid forms of Compound 1 can be administered in an amount of about 200 mg per day to about 850 mg per day. In one embodiment, the solid forms provided herein, including the solid forms of Compound 1 can be administered in an amount of about 100 mg per day, about 125 mg per day, about 150 mg per day, about 200 mg per day, about 250 mg per day, about 300 mg per day, about 350 mg per day, about 375 mg per day, about 400 mg per day, about 450 mg per day, about 500 mg per day, about 550 mg per day, about 600 mg per day, about 650 mg per day, about 700 mg per day, about 750 mg per day, about 800 mg per day, about 850 mg per day, about 900 mg per day, about 950 mg per day or about 1000 mg per day.

In one embodiment, the methods comprise administering the solid forms provided herein, including the solid forms of Compound 1 in an amount corresponding to about 150 mg, about 200 mg, about 250 mg, about 300 mg, about 350 mg, about 375 mg, about 400 mg, about 450 mg, about 500 mg, about 550 mg, about 600 mg, about 650 mg, about 700 mg, about 750 mg, about 800 mg, about 850 mg, about 900, about 950 mg or about 1000 mg daily of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate.

In one embodiment, the solid forms provided herein, including the solid forms of Compound 1 can be administered in an amount of about 150 mg per day, about 250 mg per day, about 500 mg per day, about 750 mg per day or about 1000 mg per day.

In one embodiment, the solid forms provided herein, including the solid forms of Compound 1 can be administered in an amount of about 100 mg twice per day, about 125 mg twice per day, about 150 mg per twice day, about 200 mg twice per day, about 250 mg twice per day, about 300 mg twice per day, about 350 mg twice per day, about 375 mg twice per day, about 400 mg twice per day, about 450 mg twice per day, or about 500 mg twice per day.

In one embodiment, the solid forms provided herein, including the solid forms of Compound 1 can be administered as oral tablets.

In certain embodiments, the solid forms provided herein, including the solid forms of Compound 1, or compositions thereof, provide therapeutic or prophylactic benefit without causing substantial toxicity. Toxicity of the compound can be determined using standard pharmaceutical procedures. The dose ratio between toxic and therapeutic (or prophylactic) effect is the therapeutic index.

### 6.4. Combinations of Therapeutic Agents

In some embodiments, the solid forms provided herein, including the solid forms of Compound 1 are administered with another therapeutic agent, such as an analgesic, an antibiotic, an anticoagulant, an antibody, an anti-inflammatory agent, an immunosuppressant, a guanylate cyclase-C agonist, an intestinal secretagogue, an antiviral, anticancer, antifungal, or a combination thereof. In certain embodiments, the second therapeutic is an anti-inflammatory agent, an immunosuppressant and/or may be a steroid.

These various agents can be used in accordance with their standard or common dosages, as specified in the prescribing information accompanying commercially available forms of the drugs (see also, the prescribing information in the 2006 Edition of The Physician's Desk Reference), the disclosures of which are incorporated herein by reference.

### 6.5. Compositions Comprising the Solid Forms

The solid forms provided herein, including the solid forms of Compound 1 may be used alone, in any combination, and in combination with, or adjunctive to, at least one second therapeutic agent. Furthermore, the solid forms provided herein, including the solid forms of Compound 1, and/or the at least one second therapeutic, may be used in combination with any suitable excipient useful for forming compositions for administration to a subject. Excipients can be included in pharmaceutical compositions for a variety of purposes, such as to dilute a composition for delivery to a subject, to facilitate processing of the formulation, to provide advantageous material properties to the formulation, to facilitate dispersion from a delivery device, to stabilize the formulation (e.g., antioxidants or buffers), to provide a pleasant or palatable taste or consistency to the formulation, or the like. The pharmaceutically acceptable excipient(s) may include a pharmaceutically acceptable carrier(s) and/or a pharmaceutically acceptable adjuvant(s). Exemplary excipients include, but are not limited to: mono-, di-, and polysaccharides, sugar alcohols and other polyols, such as, lactose, glucose, raffinose, melezitose, lactitol, maltitol, trehalose, sucrose, mannitol, starch, or combinations thereof, surfactants, such as sorbitols, diphosphatidyl choline, and lecithin; bulking agents; buffers, such as phosphate and citrate buffers; anti-adherents, such as magnesium stearate; binders, such as saccharides (including disaccharides, such as sucrose and lactose,), polysaccharides (such as starches, cellulose, microcrystalline cellulose, cellulose ethers (such as hydroxypropyl cellulose)), gelatin, synthetic polymers (such as polyvinylpyrrolidone, polyalkylene glycols); coatings (such as cellulose ethers, including hydroxypropylmethyl cellulose, shellac, corn protein zein, and gelatin); release aids (such as enteric coatings); disintegrants (such as crospovidone, crosslinked sodium carboxymethyl cellulose, and sodium starch glycolate); fillers (such as dibasic calcium phosphate, vegetable fats and oils, lactose, sucrose, glucose, mannitol, sorbitol, calcium carbonate, and magnesium stearate); flavors and sweeteners (such as mint, cherry, anise, peach, apricot or licorice, raspberry, and vanilla); lubricants (such as minerals, exemplified by talc or silica, fats, exemplified by vegetable stearin, magnesium stearate or stearic acid); preservatives (such as antioxidants exemplified by vitamin A, vitamin E, vitamin C, retinyl palmitate, and selenium, amino acids, exemplified by cysteine and methionine, citric acid and sodium citrate, parabens, exemplified by methyl paraben and propyl paraben); colorants; compression aids; emulsifying agents; encapsulation agents; gums; granulation agents; and combinations thereof.

In one embodiment, the pharmaceutical compositions provided herein comprise one or more of Forms A, B, C, D, E, J, L, U, O, Q, R, T, W, N, X, H, F, G, K, I, M, P, S, V, Y, NP1, NP3 or NP4 of Compound 1 and one or more pharmaceutically acceptable excipients or carriers. In one embodiment, the pharmaceutical compositions provided herein comprise one or more of Forms D, E, J, L, U, O, Q, R, T, W, N, X, H, F, G, K, I, M, P, S, V and Y of Compound 1 and one or more pharmaceutically acceptable excipients or carriers. In one embodiment, the pharmaceutical compositions provided herein comprise Form D of Compound 1 and one or more pharmaceutically acceptable excipients or carriers. In one embodiment, the pharmaceutical compositions provided herein comprise Form E of Compound 1 and one or more pharmaceutically acceptable excipients or carriers. In one embodiment, the pharmaceutical compositions provided herein comprise Form J of Compound 1 and one or more pharmaceutically acceptable excipients or carriers. In one embodiment, the pharmaceutical compositions provided herein comprise Form L of Compound 1 and one or more pharmaceutically acceptable excipients or carriers. In one embodiment, the pharmaceutical compositions provided herein comprise Form U of Compound 1 and one or more pharmaceutically acceptable excipients or carriers. In one embodiment, the pharmaceutical compositions provided herein comprise Form O of Compound 1 and one or more pharmaceutically acceptable excipients or carriers. In one embodiment, the pharmaceutical compositions provided herein comprise Form Q of Compound 1 and one or more pharmaceutically acceptable excipients or carriers. In one embodiment, the pharmaceutical compositions provided herein comprise Form R of Compound 1 and one or more pharmaceutically acceptable excipients or carriers. In one embodiment, the pharmaceutical compositions provided herein comprise Form T of Compound 1 and one or more pharmaceutically acceptable excipients or carriers. In one embodiment, the pharmaceutical compositions provided herein comprise Form W of Compound 1 and one or more pharmaceutically acceptable excipients or carriers. In one embodiment, the pharmaceutical compositions provided herein comprise Form N of Compound 1 and one or more pharmaceutically acceptable excipients or carriers. In one embodiment, the pharmaceutical compositions provided herein comprise Form X of Compound 1 and one or more pharmaceutically acceptable excipients or carriers. In one embodiment, the pharmaceutical compositions provided herein comprise Form H of Compound 1 and one or more pharmaceutically acceptable excipients or carriers. In one embodiment, the pharmaceutical compositions provided herein comprise Form F of Compound 1 and one or more pharmaceutically acceptable excipients or carriers. In one embodiment, the pharmaceutical compositions provided herein comprise Form G of Compound 1 and one or more pharmaceutically acceptable excipients or carriers. In one embodiment, the pharmaceutical compositions provided herein comprise Form I of Compound 1 and one or more pharmaceutically acceptable excipients or carriers. In one embodiment, the pharmaceutical compositions provided herein comprise Form M of Compound 1 and one or more pharmaceutically acceptable excipients or carriers. In one embodiment, the pharmaceutical compositions provided herein comprise Form P of Compound 1 and one or more pharmaceutically acceptable excipients or carriers. In one embodiment, the pharmaceutical compositions provided herein comprise Form S of Compound 1 and one or more pharmaceutically acceptable excipients or carriers. In one embodiment, the pharmaceutical compositions provided herein comprise Form V of Compound 1 and one or more pharmaceutically acceptable excipients or carriers. In one embodiment, the pharmaceutical compositions provided herein comprise Form Y of Compound 1 and one or more pharmaceutically acceptable excipients or carriers. In one embodiment, the pharmaceutical compositions provided herein comprise Form A of Compound 1 and one or more pharmaceutically acceptable excipients or carriers. In one embodiment, the pharmaceutical compositions provided herein comprise Form B of Compound 1 and one or more pharmaceutically acceptable excipients or carriers. In one embodiment, the pharmaceutical compositions provided herein comprise Form C of Compound 1 and one or more pharmaceutically acceptable excipients or carriers. In one embodiment, the pharmaceutical compositions provided herein comprise Form NP1 of Compound 1 and one or more pharmaceutically acceptable excipients or carriers. In one embodiment, the pharmaceutical compositions provided herein comprise Form NP3 of Compound 1 and one or more pharmaceutically acceptable excipients or carriers. In one embodiment, the pharmaceutical compositions provided herein comprise Form NP4 of Compound 1 and one or more pharmaceutically acceptable excipients or carriers.

In one embodiment, the pharmaceutical composition is a tablet comprising a solid form of Compound 1 and one or more pharmaceutically acceptable excipients or carriers. Exemplary pharmaceutical compositions of Compound 1 are described in a U.S. provisional application No. 63/729,260, titled “Pharmaceutical Compositions”, filed on Dec. 6, 2024 which is incorporated herein by reference in its entirety.

### 6.6. Evaluation of Activity

Standard physiological, pharmacological and biochemical procedures are available for testing the compounds to identify those that possess the desired activity.

Such assays include, for example, biochemical assays such as binding assays, as well as a variety of cell based assays, including ELISA assay.

### 7. Enumerated Embodiments

Embodiment 1: A solid form of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium:

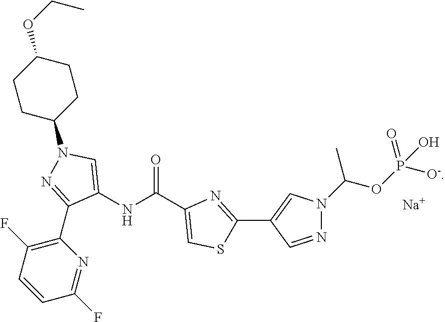

wherein the solid form is selected from:
Form E having an X-ray powder diffraction pattern comprising one or more peaks at approximately 8.64, 16.81 or 17.41 degrees 2θ;
Form D having an X-ray powder diffraction pattern comprising one or more peaks at approximately 6.55, 10.88 or 15.17 degrees 2θ;
Form J having an X-ray powder diffraction pattern comprising one or more peaks at approximately 9.26, 15.82 or 19.37 degrees 2θ;
Form L having an X-ray powder diffraction pattern comprising one or more peaks at approximately 7.16, 11.97 or 13.87 degrees 2θ;
Form U having an X-ray powder diffraction pattern comprising one or more peaks at approximately 4.36, 6.50 or 10.83 degrees 2θ;
Form O having an X-ray powder diffraction pattern comprising one or more peaks at approximately 9.12, 15.72 or 19.17 degrees 2θ;
Form Q having an X-ray powder diffraction pattern comprising one or more peaks at approximately 6.68, 6.69 or 8.91 degrees 2θ;
Form R having an X-ray powder diffraction pattern comprising one or more peaks at approximately 8.62, 13.73 or 16.82 degrees 2θ;
Form T having an X-ray powder diffraction pattern comprising one or more peaks at approximately 6.60, 8.83 or 15.54 degrees 2θ;
Form W having an X-ray powder diffraction pattern comprising one or more peaks at approximately 6.70, 4.47 or 8.92 degrees 2θ;
Form H having an X-ray powder diffraction pattern comprising one or more peaks at approximately 6.06, 7.96 or 22.94 degrees 2θ;
Form N having an X-ray powder diffraction pattern comprising one or more peaks at approximately 6.23, 12.32 or 14.36 degrees 2θ;
Form X having an X-ray powder diffraction pattern comprising one or more peaks at approximately 19.16, 19.75 or 24.51 degrees 2θ;
Form F having an X-ray powder diffraction pattern comprising one or more peaks at approximately 5.35, 9.13 or 10.66 degrees 2θ;
Form G having an X-ray powder diffraction pattern comprising one or more peaks at approximately 10.08, 12.39 or 13.89 degrees 2θ;
Form I having an X-ray powder diffraction pattern comprising one or more peaks at approximately 6.98, 9.20 or 11.62 degrees 2θ;
Form K having an X-ray powder diffraction pattern comprising one or more peaks at approximately 4.56, 13.73 or 18.23 degrees 2θ;
Form M having an X-ray powder diffraction pattern comprising one or more peaks at approximately 5.16, 7.76 or 10.34 degrees 2θ;
Form P having an X-ray powder diffraction pattern comprising one or more peaks at approximately 4.36, 6.51 or 15.20 or degrees 2θ;
Form S having an X-ray powder diffraction pattern comprising one or more peaks at approximately 6.19, 6.48 or 12.44 degrees 2θ;
Form V having an X-ray powder diffraction pattern comprising one or more peaks at approximately 12.81, 14.27 or 18.00 degrees 2θ;
Form Y having an X-ray powder diffraction pattern comprising one or more peaks at approximately 4.68, 9.31 or 19.41 degrees 2θ.

Embodiment 2: The solid form of embodiment 1, which is Form E having an X-ray powder diffraction pattern comprising one or more peaks at approximately 8.64, 16.81 or 17.41 degrees 2θ.

Embodiment 3: The solid form of embodiment 2, having an X-ray powder diffraction pattern comprising one or more peaks at approximately 8.64, 14.06, 16.81 or 17.41 degrees 2θ.

Embodiment 4: The solid form of embodiment 2, having an X-ray powder diffraction pattern substantially as shown in FIG. 9.

Embodiment 5: The solid form of embodiment 2, having a thermal gravimetric analysis plot comprising a two step weight loss of about 4.4% up to about 120° C., and about 4.2% between about 120° C. and 220° C.

Embodiment 6: The solid form of embodiment 2, having a thermal gravimetric analysis plot substantially as shown in FIG. 10.

Embodiment 7: The solid form of embodiment 2, having a differential scanning calorimetry plot comprising two endotherms at about 112.1° C. and about 183.2° C.

Embodiment 8: The solid form of embodiment 2, having a differential scanning calorimetry plot substantially as shown in FIG. 10.

Embodiment 9: The solid form of embodiment 2 which is substantially pure.

Embodiment 10: The solid form of embodiment 2, which is a hydrate.

Embodiment 11: The solid form of embodiment 1, which is Form D having an X-ray powder diffraction pattern comprising one or more peaks at approximately 6.55, 10.88 or 15.17 degrees 2θ.

Embodiment 12: The solid form of embodiment 11, having an X-ray powder diffraction pattern comprising one or more peaks at approximately 4.41, 6.55, 10.88, 15.17 or 27.54 degrees 2θ.

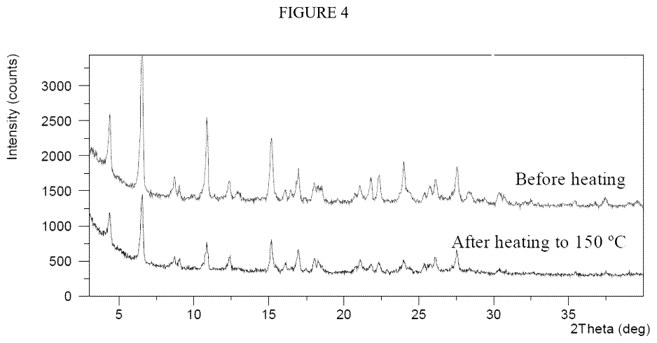

Embodiment 13: The solid form of embodiment 11, having an X-ray powder diffraction pattern substantially as shown in FIG. 4.

Embodiment 14: The solid form of embodiment 11, having a thermal gravimetric analysis plot comprising a two step weight loss of about 6.5% up to about 100° C., and about 4.5% between about 100° C. and 220° C.

Embodiment 15: The solid form of embodiment 11, having a thermal gravimetric analysis plot substantially as shown in FIG. 3.

Embodiment 16: The solid form of embodiment 11, having a differential scanning calorimetry plot comprising three endotherms at about 125.2° C., about 131.1° C. and about 177.5° C.

Embodiment 17: The solid form of embodiment 11, having a differential scanning calorimetry plot substantially as shown in FIG. 3.

Embodiment 18: The solid form of embodiment 11 which is substantially pure.

Embodiment 19: The solid form of embodiment 11, which is a hydrate.

Embodiment 20: The solid form of embodiment 1, which is Form J having an X-ray powder diffraction pattern comprising one or more peaks at approximately 9.26, 15.82 or 19.37 degrees 2θ.

Embodiment 21: The solid form of embodiment 20, having an X-ray powder diffraction pattern comprising one or more peaks at approximately 5.87, 7.89, 9.26, 15.82 or 19.37 degrees 2θ.

Embodiment 22: The solid form of embodiment 20, having an X-ray powder diffraction pattern substantially as shown in FIG. 17.

Embodiment 23: The solid form of embodiment 20, having a thermal gravimetric analysis plot comprising a two step weight loss of about 5.4% up to about 150° C., and about 4.6% between about 150° C. and 220° C.

Embodiment 24: The solid form of embodiment 20, having a thermal gravimetric analysis plot substantially as shown in FIG. 18.

Embodiment 25: The solid form of embodiment 20, having a differential scanning calorimetry plot comprising two endotherms at about 86° C. and about 163.8° C.

Embodiment 26: The solid form of embodiment 20, having a differential scanning calorimetry plot substantially as shown in FIG. 18.

Embodiment 27: The solid form of embodiment 20 which is substantially pure.

Embodiment 28: The solid form of embodiment 20, which is a hydrate.

Embodiment 29: The solid form of embodiment 1, which is Form L having an X-ray powder diffraction pattern comprising one or more peaks at approximately 7.16, 11.97 or 13.87 degrees 2θ.

Embodiment 30: The solid form of embodiment 29, having an X-ray powder diffraction pattern comprising one or more peaks at approximately 7.16, 11.97, 13.87, 14.35 or 20.62 degrees 2θ.

Embodiment 31: The solid form of embodiment 29, having an X-ray powder diffraction pattern substantially as shown in FIG. 22.

Embodiment 32: The solid form of embodiment 29, having a thermal gravimetric analysis plot comprising a two step weight loss of about 5.4% up to about 150° C., and about 4.4% between about 130° C. and 250° C.

Embodiment 33: The solid form of embodiment 29, having a thermal gravimetric analysis plot substantially as shown in FIG. 23.

Embodiment 34: The solid form of embodiment 29, having a differential scanning calorimetry plot comprising three endotherms at about 94.5° C., about 134.0° C. and about 185.0° C.

Embodiment 35: The solid form of embodiment 29, having a differential scanning calorimetry plot substantially as shown in FIG. 23.

Embodiment 36: The solid form of embodiment 29 which is substantially pure.

Embodiment 37: The solid form of embodiment 29, which is a hydrate.

Embodiment 38: The solid form of embodiment 1, which is Form U having an X-ray powder diffraction pattern comprising one or more peaks at approximately 4.36, 6.50 or 10.83 degrees 2θ.

Embodiment 39: The solid form of embodiment 38, having an X-ray powder diffraction pattern comprising one or more peaks at approximately 4.36, 6.50, 8.66 or 10.83 degrees 2θ.

Embodiment 40: The solid form of embodiment 38, having an X-ray powder diffraction pattern substantially as shown in FIG. 26.

Embodiment 41: The solid form of embodiment 38, having a thermal gravimetric analysis plot comprising a two step weight loss of about 5.1% up to about 130° C. and about 4.0% between about 130° C. and about 230° C.

Embodiment 42: The solid form of embodiment 38, having a thermal gravimetric analysis plot substantially as shown in FIG. 27.

Embodiment 43: The solid form of embodiment 38, having a differential scanning calorimetry plot comprising three endotherms at about 66.6° C., about 85.2° C. and about 179.0° C.

Embodiment 44: The solid form of embodiment 38, having a differential scanning calorimetry plot substantially as shown in FIG. 27.

Embodiment 45: The solid form of embodiment 38 which is substantially pure.

Embodiment 46: The solid form of embodiment 38, which is a hydrate.

Embodiment 47: The solid form of embodiment 1, which is Form O having an X-ray powder diffraction pattern comprising one or more peaks at approximately 9.12, 15.72 or 19.17 degrees 2θ.

Embodiment 48: The solid form of embodiment 47, having an X-ray powder diffraction pattern comprising one or more peaks at approximately 9.12, 15.72, 18.04 or 19.17 degrees 2θ.

Embodiment 49: The solid form of embodiment 47, having an X-ray powder diffraction pattern substantially as shown in FIG. 28.

Embodiment 50: The solid form of embodiment 47 which is substantially pure.

Embodiment 51: The solid form of embodiment 47, which is an anhydrate.

Embodiment 52: The solid form of embodiment 1, which is Form Q having an X-ray powder diffraction pattern comprising one or more peaks at approximately 6.68, 6.69 or 8.91 degrees 2θ.

Embodiment 53: The solid form of embodiment 52, having an X-ray powder diffraction pattern comprising one or more peaks at approximately 6.68, 6.69, 8.91, 15.62 or 17.88 degrees 2θ.

Embodiment 54: The solid form of embodiment 52, having an X-ray powder diffraction pattern substantially as shown in FIG. 29.

Embodiment 55: The solid form of embodiment 52 which is substantially pure.

Embodiment 56: The solid form of embodiment 52, which is an anhydrate.

Embodiment 57: The solid form of embodiment 1, which is Form R having an X-ray powder diffraction pattern comprising one or more peaks at approximately 8.62, 13.73 or 16.82 degrees 2θ.

Embodiment 58: The solid form of embodiment 57, having an X-ray powder diffraction pattern comprising one or more peaks at approximately 6.47, 8.62, 13.73, 16.82 or 17.45 degrees 2θ.

Embodiment 59: The solid form of embodiment 57, having an X-ray powder diffraction pattern substantially as shown in FIG. 30.

Embodiment 60: The solid form of embodiment 57 which is substantially pure.

Embodiment 61: The solid form of embodiment 57, which is an anhydrate.

Embodiment 62: The solid form of embodiment 1, which is Form T having an X-ray powder diffraction pattern comprising one or more peaks at approximately 6.60, 8.83 or 15.54 degrees 2θ.

Embodiment 63: The solid form of embodiment 62, having an X-ray powder diffraction pattern comprising one or more peaks at approximately 6.60, 8.83, 15.54 or 17.79 degrees 2θ.

Embodiment 64: The solid form of embodiment 62, having an X-ray powder diffraction pattern substantially as shown in FIG. 31.

Embodiment 65: The solid form of embodiment 62 which is substantially pure.

Embodiment 66: The solid form of embodiment 62, which is an anhydrate.

Embodiment 67: The solid form of embodiment 1, which is Form W having an X-ray powder diffraction pattern comprising one or more peaks at approximately 4.47, 6.70 or 8.92 degrees 2θ.

Embodiment 68: The solid form of embodiment 67, having an X-ray powder diffraction pattern comprising one or more peaks at approximately 4.47, 6.33, 6.70, 8.92 or 15.14 degrees 2θ.

Embodiment 69: The solid form of embodiment 67, having an X-ray powder diffraction pattern substantially as shown in FIG. 32.

Embodiment 70: solid form of embodiment 67, having a thermal gravimetric analysis plot comprising a two step weight loss of about 6.0% up to about 130° C. and about 4.7% between about 130° C. and about 230° C.

Embodiment 71: The solid form of embodiment 67, having a thermal gravimetric analysis plot substantially as shown in FIG. 33.

Embodiment 72: The solid form of embodiment 67, having a differential scanning calorimetry plot comprising two endotherms at about 75.3° C. and about 180.2° C.

Embodiment 73: The solid form of embodiment 67, having a differential scanning calorimetry plot substantially as shown in FIG. 33.

Embodiment 74: The solid form of embodiment 67 which is substantially pure.

Embodiment 75: The solid form of embodiment 67, which is an anhydrate.

Embodiment 76: The solid form of embodiment 1, which is Form H having an X-ray powder diffraction pattern comprising one or more peaks at approximately 6.06, 7.96 or 22.94 degrees 2θ.

Embodiment 77: The solid form of embodiment 76, having an X-ray powder diffraction pattern comprising one or more peaks at approximately 6.06, 7.96, 10.97, 15.51 or 22.94 degrees 2θ.

Embodiment 78: The solid form of embodiment 76, having an X-ray powder diffraction pattern substantially as shown in FIG. 34.

Embodiment 79: The solid form of embodiment 76, having a thermal gravimetric analysis plot comprising a two step weight loss of about 5.5% up to about 110° C. and about 4.8% between about 110° C. and about 220° C.

Embodiment 80: The solid form of embodiment 76, having a thermal gravimetric analysis plot substantially as shown in FIG. 35.

Embodiment 81: The solid form of embodiment 76, having a differential scanning calorimetry plot comprising three endotherms at about 46.0° C., about 112.4° C. and about 193.1° C.

Embodiment 82: The solid form of embodiment 76, having a differential scanning calorimetry plot substantially as shown in FIG. 35.

Embodiment 83: The solid form of embodiment 76 which is substantially pure.

Embodiment 84: The solid form of embodiment 76, which is a solvate.

Embodiment 85: The solid form of embodiment 1, which is Form N having an X-ray powder diffraction pattern comprising one or more peaks at approximately 6.23, 12.32 or 14.36 degrees 2θ.

Embodiment 86: The solid form of embodiment 85, having an X-ray powder diffraction pattern comprising one or more peaks at approximately 4.15, 6.23, 12.32, 14.36, or 23.30 degrees 2θ.

Embodiment 87: The solid form of embodiment 85, having an X-ray powder diffraction pattern substantially as shown in FIG. 37.

Embodiment 88: The solid form of embodiment 85, having a thermal gravimetric analysis plot comprising a two step weight loss of about 7.7% up to about 150° C. and about 5.5% between about 150° C. and about 220° C.

Embodiment 89: The solid form of embodiment 85, having a thermal gravimetric analysis plot substantially as shown in FIG. 38.

Embodiment 90: The solid form of embodiment 85, having a differential scanning calorimetry plot comprising two endotherms at about 87.9° C. and about 190.0° C., and an exotherm at about 113.5° C.

Embodiment 91: The solid form of embodiment 85, having a differential scanning calorimetry plot substantially as shown in FIG. 38.

Embodiment 92: The solid form of embodiment 85 which is substantially pure.

Embodiment 93: The solid form of embodiment 85, which is a solvate.

Embodiment 94: The solid form of embodiment 1, which is Form X having an X-ray powder diffraction pattern comprising one or more peaks at approximately 19.16, 19.75 or 24.51 degrees 2θ.

Embodiment 95: The solid form of embodiment 94, having an X-ray powder diffraction pattern comprising one or more peaks at approximately 5.50, 19.16, 19.75, 21.97 or 24.51 degrees 2θ.

Embodiment 96: The solid form of embodiment 94, having an X-ray powder diffraction pattern substantially as shown in FIG. 41.

Embodiment 97: The solid form of embodiment 94 which is substantially pure.

Embodiment 98: The solid form of embodiment 94, which is a solvate.

Embodiment 99: The solid form of embodiment 1, which is Form F having an X-ray powder diffraction pattern comprising one or more peaks at approximately 5.35, 9.13 or 10.66 degrees 2θ.

Embodiment 100: The solid form of embodiment 99, having an X-ray powder diffraction pattern comprising one or more peaks at approximately 5.35, 9.13, 10.66, 14.26 or 19.61 degrees 2θ.

Embodiment 101: The solid form of embodiment 99, having an X-ray powder diffraction pattern substantially as shown in FIG. 42.

Embodiment 102: The solid form of embodiment 99, having a thermal gravimetric analysis plot comprising a two step weight loss of about 7.0% up to about 120° C. and about 4.7% between about 120° C. and about 220° C.

Embodiment 103: The solid form of embodiment 99, having a thermal gravimetric analysis plot substantially as shown in FIG. 43.

Embodiment 104: The solid form of embodiment 99, having a differential scanning calorimetry plot comprising three endotherms at about 110.4° C., about 173.2° C. and about 180.7° C.

Embodiment 105: The solid form of embodiment 99, having a differential scanning calorimetry plot substantially as shown in FIG. 43.

Embodiment 106: The solid form of embodiment 99 which is substantially pure.

Embodiment 107: The solid form of embodiment 1, which is Form G having an X-ray powder diffraction pattern comprising one or more peaks at approximately 10.08, 12.39 or 13.89 degrees 2θ.

Embodiment 108: The solid form of embodiment 107, having an X-ray powder diffraction pattern comprising one or more peaks at approximately 6.95, 10.08, 12.39, 13.89 or 15.40 degrees 2θ.

Embodiment 109: The solid form of embodiment 107, having an X-ray powder diffraction pattern substantially as shown in FIG. 45.

Embodiment 110: The solid form of embodiment 107, having a thermal gravimetric analysis plot comprising a two step weight loss of about 4.3% up to about 120° C. and about 4.2% between about 120° C. and about 220° C.

Embodiment 111: The solid form of embodiment 107, having a thermal gravimetric analysis plot substantially as shown in FIG. 46.

Embodiment 112: The solid form of embodiment 107, having a differential scanning calorimetry plot comprising three endotherms at about 60.5° C., about 119.2° C. and about 181.2° C.

Embodiment 113: The solid form of embodiment 107, having a differential scanning calorimetry plot substantially as shown in FIG. 46.

Embodiment 114: The solid form of embodiment 107 which is substantially pure.

Embodiment 115: The solid form of embodiment 1, which is Form I having an X-ray powder diffraction pattern comprising one or more peaks at approximately 6.98, 9.20 or 11.62 degrees 2θ.

Embodiment 116: The solid form of embodiment 115, having an X-ray powder diffraction pattern comprising one or more peaks at approximately 6.98, 9.20, 11.62 or 23.40 degrees 2θ.

Embodiment 117: The solid form of embodiment 115, having an X-ray powder diffraction pattern substantially as shown in FIG. 49.

Embodiment 118: The solid form of embodiment 115, having a thermal gravimetric analysis plot comprising a two step weight loss of about 11.5% up to about 120° C. and about 5.3% between about 120° C. and about 220° C.

Embodiment 119: The solid form of embodiment 115, having a thermal gravimetric analysis plot substantially as shown in FIG. 50.

Embodiment 120: The solid form of embodiment 115, having a differential scanning calorimetry plot comprising three endotherms at about 71.7° C., about 110.1° C. and about 182.9° C.

Embodiment 121: The solid form of embodiment 115, having a differential scanning calorimetry plot substantially as shown in FIG. 50.

Embodiment 122: The solid form of embodiment 115 which is substantially pure.

Embodiment 123: The solid form of embodiment 1, which is Form K having an X-ray powder diffraction pattern comprising one or more peaks at approximately 4.56, 13.73 or 18.23 degrees 2θ.

Embodiment 124: The solid form of embodiment 123, having an X-ray powder diffraction pattern comprising one or more peaks at approximately 4.56, 13.38, 13.73 or 18.23 degrees 2θ.

Embodiment 125: The solid form of embodiment 123, having an X-ray powder diffraction pattern substantially as shown in FIG. 52.

Embodiment 126: The solid form of embodiment 123 which is substantially pure.

Embodiment 127: The solid form of embodiment 1, which is Form M having an X-ray powder diffraction pattern comprising one or more peaks at approximately 5.16, 7.76 or 10.34 degrees 2θ.

Embodiment 128: The solid form of embodiment 127, having an X-ray powder diffraction pattern comprising one or more peaks at approximately 5.16, 6.49, 7.76 or 10.34 degrees 2θ.

Embodiment 129: The solid form of embodiment 127, having an X-ray powder diffraction pattern substantially as shown in FIG. 53.

Embodiment 130: The solid form of embodiment 127, having a thermal gravimetric analysis plot comprising a two step weight loss of about 8.0% up to about 120° C. and about 4.5% between about 120° C. and about 220° C.

Embodiment 131: The solid form of embodiment 127, having a thermal gravimetric analysis plot substantially as shown in FIG. 54.

Embodiment 132: The solid form of embodiment 127, having a differential scanning calorimetry plot comprising two endotherms at about 92.4° C. and about 152.4° C.

Embodiment 133: The solid form of embodiment 127, having a differential scanning calorimetry plot substantially as shown in FIG. 54.

Embodiment 134: The solid form of embodiment 127 which is substantially pure.

Embodiment 135: The solid form of embodiment 1, which is Form P having an X-ray powder diffraction pattern comprising one or more peaks at approximately 4.36, 6.51 or 15.20 degrees 2θ.

Embodiment 136: The solid form of embodiment 135, having an X-ray powder diffraction pattern comprising one or more peaks at approximately 4.36, 6.51, 8.70, 15.20 or 18.01 degrees 2θ.

Embodiment 137: The solid form of embodiment 135, having an X-ray powder diffraction pattern substantially as shown in FIG. 56.

Embodiment 138: The solid form of embodiment 135 which is substantially pure.

Embodiment 139: The solid form of embodiment 1, which is Form S having an X-ray powder diffraction pattern comprising one or more peaks at approximately 6.19, 6.48 or 12.44 degrees 2θ.

Embodiment 140: The solid form of embodiment 139, having an X-ray powder diffraction pattern comprising one or more peaks at approximately 6.19, 6.48, 12.44, 13.02 or 15.19 degrees 2θ.

Embodiment 141: The solid form of embodiment 139, having an X-ray powder diffraction pattern substantially as shown in FIG. 57.

Embodiment 142: The solid form of embodiment 139 which is substantially pure.

Embodiment 143: The solid form of embodiment 1, which is Form V having an X-ray powder diffraction pattern comprising one or more peaks at approximately 12.81, 14.27 or 18.00 degrees 2θ.

Embodiment 144: The solid form of embodiment 143, having an X-ray powder diffraction pattern comprising one or more peaks at approximately 12.81, 14.27, 16.24, 18.00 or 20.61 degrees 2θ.

Embodiment 145: The solid form of embodiment 143, having an X-ray powder diffraction pattern substantially as shown in FIG. 58.

Embodiment 146: The solid form of embodiment 143 which is substantially pure.

Embodiment 147: The solid form of embodiment 1, which is Form Y having an X-ray powder diffraction pattern comprising one or more peaks at approximately 4.68, 9.31 or 19.41 degrees 2θ.

Embodiment 148: The solid form of embodiment 147, having an X-ray powder diffraction pattern comprising one or more peaks at approximately 4.68, 9.31, 15.86 or 19.41, degrees 2θ.

Embodiment 149: The solid form of embodiment 147, having an X-ray powder diffraction pattern substantially as shown in FIG. 59.

Embodiment 150: The solid form of embodiment 147 which is substantially pure.

Embodiment 151: A pharmaceutical composition comprising the solid form of any one of embodiments 1 to 150 and a pharmaceutically acceptable carrier, diluent or excipient.

Embodiment 152: The pharmaceutical composition of embodiment 151, wherein the composition is formulated for oral administration.

Embodiment 153: A method of treating a disease comprising administering to a subject in need thereof the solid form of any one of embodiments 1 to 150 or the pharmaceutical composition of embodiment 151 or 152, wherein the disease is an auto-immune disease, an inflammatory disorder, a cardiovascular disease, a nerve disorder, a neurodegenerative disorder, an allergic disorder, asthma, pancreatitis, multi-organ failure, a kidney disease, platelet aggregation, cancer, transplantation, sperm motility, erythrocyte deficiency, graft rejection, a lung injury, a respiratory disease, an ischemic condition, bacterial infection or a viral infection.

Embodiment 154: The method of embodiment 153, wherein disease is an allergic disease, amyotrophic lateral sclerosis (ALS), systemic lupus erythematosus, rheumatoid arthritis, type I diabetes mellitus, inflammatory bowel disease, biliary cirrhosis, uveitis, multiple sclerosis, Crohn's disease, ulcerative colitis, bullous pemphigoid, sarcoidosis, psoriasis, autoimmune myositis, Wegener's granulomatosis, ichthyosis, Graves ophthalmopathy, or asthma.

Embodiment 155: The method of embodiment 153, wherein disease is transplantation of organs or tissue, graft-versus-host diseases brought about by transplantation, autoimmune syndromes including rheumatoid arthritis, lupus, including systemic lupus erythematosus, Hashimoto's thyroiditis, multiple sclerosis, systemic sclerosis, myasthenia gravis, type I diabetes, uveitis, posterior uveitis, allergic encephalomyelitis, glomerulonephritis, postinfectious autoimmune diseases including rheumatic fever and post-infectious glomerulonephritis, inflammatory and hyperproliferative skin diseases, psoriasis, atopic dermatitis, contact dermatitis, eczematous dermatitis, seborrhoeic dermatitis, lichen planus, pemphigus, bullous pemphigoid, epidermolysis bullosa, urticaria, angioedemas, vasculitis, erythema, cutaneous eosinophilia, lupus erythematosus, acne, alopecia areata, keratoconjunctivitis, vernal conjunctivitis, uveitis associated with Behcet's disease, keratitis, herpetic keratitis, conical cornea, dystrophia epithelialis corneae, corneal leukoma, ocular pemphigus, Mooren's ulcer, scleritis, Graves' opthalmopathy, Vogt-Koyanagi-Harada syndrome, sarcoidosis, pollen allergies, reversible obstructive airway disease, bronchial asthma, allergic asthma, intrinsic asthma, extrinsic asthma, dust asthma, chronic or inveterate asthma, late asthma and airway hyper-responsiveness, bronchitis, gastric ulcers, vascular damage caused by ischemic diseases and thrombosis, ischemic bowel diseases, inflammatory bowel diseases, necrotizing enterocolitis, intestinal lesions associated with thermal burns, celiac diseases, proctitis, eosinophilic gastroenteritis, mastocytosis, Crohn's disease, ulcerative colitis, migraine, rhinitis, eczema, interstitial nephritis, Goodpasture's syndrome, hemolytic-uremic syndrome, diabetic nephropathy, multiple myositis, Guillain-Barre syndrome, Meniere's disease, polyneuritis, multiple neuritis, mononeuritis, radiculopathy, hyperthyroidism, Basedow's disease, pure red cell aplasia, aplastic anemia, hypoplastic anemia, idiopathic thrombocytopenic purpura, autoimmune hemolytic anemia, agranulocytosis, pernicious anemia, megaloblastic anemia, erythroplasia, osteoporosis, sarcoidosis, fibroid lung, idiopathic interstitial pneumonia, dermatomyositis, leukoderma vulgaris, ichthyosis vulgaris, photoallergic sensitivity, cutaneous T cell lymphoma, chronic lymphocytic leukemia, arteriosclerosis, atherosclerosis, aortitis syndrome, polyarteritis nodosa, myocardosis, scleroderma, Wegener's granuloma, Sjögren's syndrome, adiposis, eosinophilic fascitis, lesions of gingiva, periodontium, alveolar bone, substantia ossea dentis, glomerulonephritis, male pattern alopecia or alopecia senilis by preventing epilation or providing hair germination and/or promoting hair generation and hair growth, muscular dystrophy, pyoderma and Sezary's syndrome, Addison's disease, ischemia-reperfusion injury of organs which occurs upon preservation, transplantation or ischemic disease, endotoxin-shock, pseudomembranous colitis, colitis caused by drug or radiation, ischemic acute renal insufficiency, chronic renal insufficiency, toxinosis caused by lung-oxygen or drugs, lung cancer, pulmonary emphysema, cataracta, siderosis, retinitis pigmentosa, senile macular degeneration, vitreal scarring, corneal alkali burn, dermatitis erythema multiforme, linear IgA bullous dermatitis and cement dermatitis, gingivitis, periodontitis, sepsis, pancreatitis, diseases caused by environmental pollution, aging, carcinogenesis, metastasis of carcinoma and hypobaropathy, disease caused by histamine or leukotriene-C4 release, Behcet's disease, autoimmune hepatitis, primary biliary cirrhosis, sclerosing cholangitis, partial liver resection, acute liver necrosis, necrosis caused by toxin, viral hepatitis, shock, or anoxia, B-virus hepatitis, non-A/non-B hepatitis, cirrhosis, alcoholic liver disease, including alcoholic cirrhosis, non-alcoholic steatohepatitis, hepatic failure, fulminant hepatic failure, late-onset hepatic failure, “acute-on-chronic” liver failure, augmentation of chemotherapeutic effect, cytomegalovirus infection, HCMV infection, AIDS, cancer, senile dementia, Parkinson's disease, trauma, chronic bacterial infection, palmoplantar pustulosis, hidradenitis suppurativa, cytokine release syndrome, acute respiratory distress syndrome, acute kidney injury, kidney malfunction, or thrombosis.

Embodiment 156: The method of embodiment 153, wherein disease is hidradenitis suppurativa, or a lymphoid neoplasm selected from myeloproliferative neoplasms, myeloid/lymphoid neoplasms with PDGFRA rearrangement, myeloid/lymphoid neoplasms with PDGFRB rearrangement, myeloid/lymphoid neoplasms with FGFR1 rearrangement, myeloid/lymphoid neoplasms with PCM1-JAK2, myelodysplastic/myeloproliferative neoplasms, myeloid sarcoma, myeloid proliferations related to Down syndrome, blastic plasmacytoid dendritic cell neoplasm, B-lymphoblastic leukemia/lymphoma; and/or T-lymphoblastic leukemia/lymphoma.

Embodiment 157: The method of embodiment 153, wherein disease is a myeloproliferative neoplasm selected from chronic myeloid leukemia, chronic neutrophilic leukemia, primary myelofibrosis, essential thrombocythemia, chronic eosinophilic leukemia, or a combination thereof.

Embodiment 158: The method of embodiment 153, wherein disease is a myelodysplastic/myeloproliferative neoplasm selected from chronic myelomonocytic leukemia, atypical chronic myeloid leukemia, juvenile myelomonocytic leukemia, MDS/MPN with ring sideroblasts and thrombocytosis, or a combination thereof.

Embodiment 159: The method of embodiment 153, wherein disease is rheumatoid arthritis, psoriatic arthritis, osteoarthritis, systemic lupus erythematosus, lupus nephritis, ankylosing spondylitis, osteoporosis, systemic sclerosis, multiple sclerosis, psoriasis, in particular pustular psoriasis, type I diabetes, type II diabetes, inflammatory bowel disease, hyperimmunoglobulinemia d and periodic fever syndrome, cryopyrin-associated periodic syndromes, Schnitzler's syndrome, systemic juvenile idiopathic arthritis, adult's onset Still's disease, gout, gout flares, pseudogout, SAPHO syndrome, Castleman's disease, sepsis, stroke, atherosclerosis, celiac disease, deficiency of Il-1 receptor antagonist, Alzheimer's disease, or Parkinson's disease.

Embodiment 160: The method of embodiment 153, wherein disease is a solid tumor, carcinoma of the brain, kidney, liver, adrenal gland, bladder, breast, stomach, gastric tumors, ovaries, colon, rectum, prostate, pancreas, lung, vagina, cervix, testis, genitourinary tract, esophagus, larynx, skin, bone or thyroid, sarcoma, glioblastomas, neuroblastomas, multiple myeloma, gastrointestinal cancer, especially colon carcinoma or colorectal adenoma, a tumor of the neck and head, an epidermal hyperproliferation, psoriasis, prostate hyperplasia, a neoplasia, a neoplasia of epithelial character, adenoma, adenocarcinoma, keratoacanthoma, epidermoid carcinoma, large cell carcinoma, non-small-cell lung carcinoma, lymphomas, Hodgkins and Non-Hodgkins, a mammary carcinoma, follicular carcinoma, undifferentiated carcinoma, papillary carcinoma, seminoma, melanoma, IL-1 driven disorders, a MyD88 driven disorder, primary cutaneous T-cell lymphoma, chronic lymphocytic leukemia, smoldering or indolent multiple myeloma, leukemia, acute myeloid leukemia, DLBCL, ABC DLBCL, chronic lymphocytic leukemia, chronic lymphocytic lymphoma, primary effusion lymphoma, Burkitt lymphoma/leukemia, acute lymphocytic leukemia, B-cell prolymphocytic leukemia, lymphoplasmacytic lymphoma, myelodysplastic syndrome, clonal cytopenia of undetermined significance, myelofibrosis, polycythemia vera, Kaposi's sarcoma, Waldenstrom's macroglobulinemia, splenic marginal zone lymphoma, multiple myeloma, plasmacytoma or intravascular large B-cell lymphoma.

Embodiment 161: The method of embodiment 160, wherein disease is a myelodysplastic syndrome.

Embodiment 162: The method of embodiment 161, wherein the myelodysplastic syndrome is a higher-risk myelodysplastic or a lower-risk myelodysplastic syndrome.

Embodiment 163: The method of embodiment 160, wherein the myelodysplastic syndrome is refractory or relapsed myelodysplastic syndrome.

Embodiment 164: The method of any one of embodiments 153 to 163, wherein the method further comprises administering a second therapeutic agent.

### 8. EXAMPLES

The following Examples are presented by way of illustration, not limitation. The following abbreviations are used in descriptions and examples:
DVS Dynamic vapor sorption
HPLC: High performance liquid chromatography
LCMS: Liquid Chromatography with Mass Spectroscopy
NMR: Nuclear magnetic resonance
RH: Relative Humidity
RT: Room Temperature
TGA: Thermogravimetric Analysis
XRPD: X-Ray Powder Diffraction
VT-XRPD: Variable temperature XRPD
PLM: Polarized light microscopic
IC: Ion chromatograph
FTIR: Fourier Transform Infrared Spectroscopy
SM: Starting material
Temp.: Temperature
H: Hour
Wt.: Weight

### Solvent Abbreviation List

| Abbre- | | Abbre- | |
|---|---|---|---|
| viation | Solvent | viation | Solvent |
| MeOH | Methanol | THF | Tetrahydrofuran |
| EtOH | Ethanol | 2-MeTHF | 2-Methyltetrahydrofuran |
| IPA | Isopropyl alcohol | ACN | Acetonitrile |
| MIBK | 4-Methyl-2-pentanone | DCM | Dichloromethane |
| EtOAc | Ethyl acetate | DMSO | Dimethyl sulfoxide |
| IPAc | Isopropyl acetate | DMAc | Dimethylacetamide |
| MTBE | Methyl tert-butyl ether | NMP | N-Methyl pyrrolidone |
| EA | Ethyl Acetate | Hept. | Heptane |
| MEK | Butanone | n-BuOH | n-Butanol |

Compound 1 can be prepared by methods known in the art, for example, U.S. Pat. No. 11,370,787 B2, incorporated by reference in its entirety. An exemplary method of preparation is described in Example 1.

### 6.1 Example 1: Synthesis of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl Phosphate Monosodium

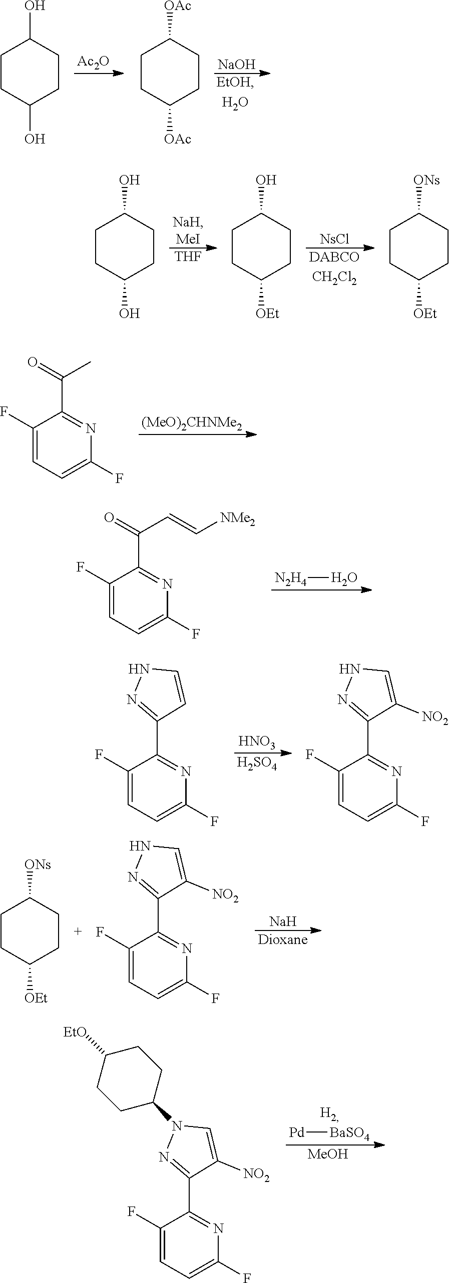

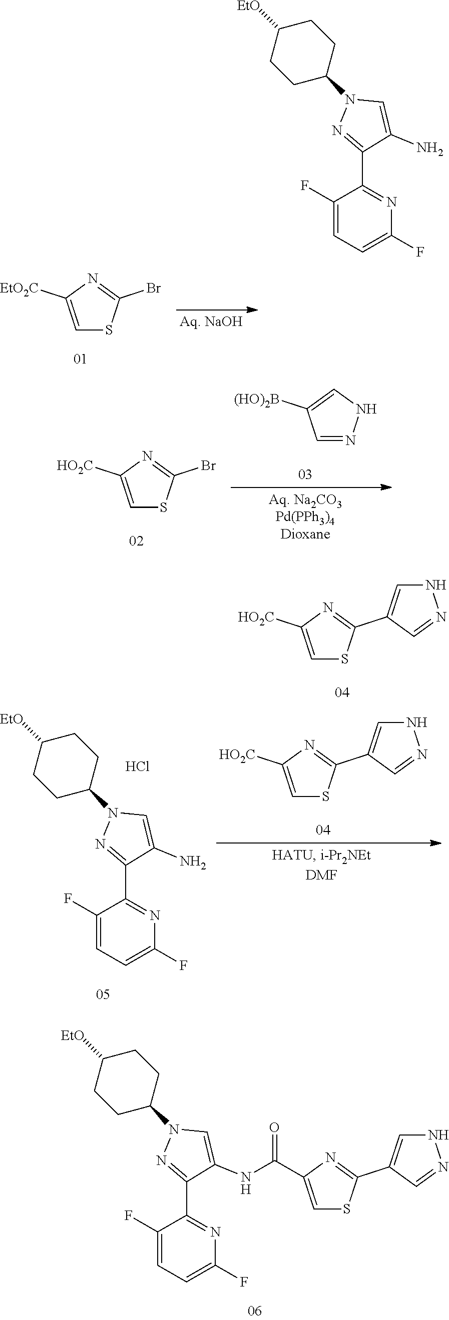

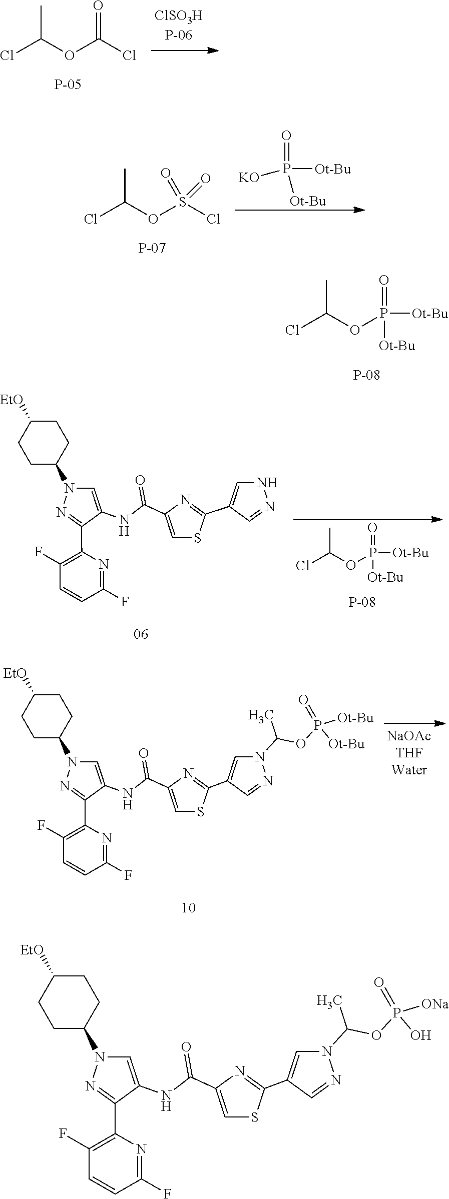

### Building Block A: N-(3-(3,6-difluoropyridin-2-yl)-1-((1r,4r)-4-ethoxycyclohexyl)-1H-pyrazol-4-yl)-2-(1H-pyrazol-4-yl)thiazole-4-carboxamide (Compound-06) Parent Compound

### Step 1: Saponification

Compound 01 is saponified in an aqueous solution of NaOH at 10° C. to 20° C. The work-up is performed with HCl, the material is then filtered and washed with water and dried to yield Compound 02.

### Step 2: Suzuki Coupling

Compound 02, Compound 03, and Na₂CO₃ are added to a mixture of dioxane and water. Tetrakis (triphenylphosphine) palladium is added as a catalyst, and the reaction mixture is heated to 40° C. to 50° C. After a polish filtration, the solution is cooled and work-up is performed with HCl to precipitate Compound 04, which is filtered and washed with water and isopropanol before drying.

### Step 3: Amide Coupling

Compound 04 is suspended in dimethylformamide. N,N-Diisopropylethylamine, HOBt, and EDCI HCl are added followed by Compound 05 and the reaction mixture is stirred at room temperature. After a polish filtration, crude N-(3-(3,6-difluoropyridin-2-yl)-1-((1r,4r)-4-ethoxycyclohexyl)-1H-pyrazol-4-yl)-2-(1H-pyrazol-4-yl)thiazole-4-carboxamide (Compound 06) is precipitated by adding the reaction mixture to an aqueous solution of sodium bicarbonate, washed with water and dried.

### Building Block B: Chloroethyl Di-Tert-Butyl Phosphate (P-08) Prodrug Moiety

### Step 1: Coupling/Substitution

Chlorosulphonic acid (P-06) is added slowly to neat chloroethyl chloroformate (P-05) and stirred at approximately −5° C. to 0° C. Extractive work-up is performed with dichloromethane and water, using sodium hydroxide to neutralize the acid. The dichloromethane layer is washed with sodium bicarbonate and sodium chloride solutions, and the aqueous layer is discarded to yield an approximately 15% to 25% w/w solution of chloroethyl chlorosulphate (P-07) in dichloromethane, used directly in the following step.

### Step 2: Coupling/Substitution

Potassium di-tert-butyl phosphate (P-02), sodium bicarbonate, tetrabutylammonium hydrogen sulfate, and water are charged to a reaction vessel and cooled to approximately 5° C. The P-07 solution in dichloromethane is chilled and added slowly to the reaction vessel. The mixture is stirred at 10° C. to 20° C. before extractive work-up by discarding the aqueous layer, washing with water and sodium chloride solution, discarding the aqueous layer again, and distilling off the dichloromethane solvent to yield a 75% to 85% w/w solution of chloroethyl di-tert-butyl phosphate (P-08) in dichloromethane.

### Addition of Prodrug Moiety to Parent Compound

### Step 1: Alkylation

N-(3-(3,6-difluoropyridin-2-yl)-1-((1r,4r)-4-ethoxycyclohexyl)-1H-pyrazol-4-yl)-2-(1H-pyrazol-4-yl)thiazole-4-carboxamide (Compound 06), tetrabutylammonium iodide and cesium carbonate are added to a mixture of tetrahydrofuran and water. P-08 solution in dichloromethane is then added to the reaction mixture and heated to 60° C. to 70° C. The mixture is then cooled and filtered to remove inorganic salts before performing a solvent swap to ethyl acetate by distilling off tetrahydrofuran. tert-Butyl methyl ether (TBME) is then added to precipitate out Compound 10, which is filtered, washed with TBME, and dried.

### Step 2: Deprotection and Salt Formation

Compound 10 is dissolved in tetrahydrofuran and water, then an aqueous solution of sodium acetate is added, and the reaction mixture is heated to 55° C. to 65° C. Acetone is added to precipitate out 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt product, which is filtered, washed with acetone, and dried.

### 6.2 Example 2: Solid Forms

### 6.2.1 Polymorph Screen

Polymorph screening experiments were performed under 100 conditions using different solid transition or solution crystallization methods. Detailed methods and results were summarized in Table 1 and described in the polymorph screening methods below. The solids isolated from polymorph screening and identification processes were characterized using XRPD. A total of 22 crystal forms of Compound 1 were obtained, which were named as Forms D, E, J, L, U, O, Q, R, T, W, H, N, X, G, K, F, I, M, P, S, V and Y. All crystal forms which could be obtained at ambient conditions were further characterized by TGA, DSC and ¹H NMR. The stoichiometric ratio was determined by HPLC/IC. Form identification confirmed that Forms D, E, J, L and U were hydrates, Forms O, Q, R, T and W were anhydrates, Forms H, N and X were solvates. Forms G and K were meta-stable forms, which could convert to Form D during storage. Forms F, I, M, P, S, V and Y were not identified due to limited amount of material and difficulties in re-preparation.

TABLE 1
Summary of polymorph screening experiments results

| | No. of | |
|---|---|---|
| Method | Experiments | Results |
| Anti-solvent addition | 12 | Forms D, G, H, I, |
| | | Amorphous |
| Solid vapor diffusion | 12 | Forms D, J, K |
| Slurry at RT | 25 | Forms D, E, F, D + E |
| Slurry at 50° C. | 16 | Forms D, E, F, G, |
| | | Amorphous |
| Slow evaporation | 4 | Form D + E |
| Slow cooling | 8 | Forms D, D + E |
| Liquid-vapor diffusion | 12 | Forms D, E, F, G, I, L |
| Polymer induced | 6 | Forms D, G |
| Grind | 5 | Form D |
| Total | 100 | Forms D~L, D + E, |
| | | Amorphous |

### 6.2.2 Polymorph Screening Methods

### A. Anti-Solvent Addition

About 12 mg of starting material was added into a 20-mL glass vial and dissolved in 1.2˜4.0 mL corresponding solvent to obtain a clear solution. The solution was magnetically stirred with addition of anti-solvent till precipitates appeared or the total volume of anti-solvent reached 10 mL. The obtained precipitates were isolated for XRPD analysis. If solids were not obtained, slurry at 5° C. or evaporation at RT will be performed. Results in Table 2 showed that Forms D, H, G, I and amorphous samples were generated.

TABLE 2
Summary of anti-solvent addition experiments

| Experiment ID | Solvent (v/v) | Anti-solvent | Result |
|---|---|---|---|
| A1 | MeOH/DCM | IPA | Amorphous |
| A2 | (1:1) | MIBK | Weak halo peaks |
| A3 | | EtOAc | Form D |
| A4* | | MTBE | Form D |
| A5 | | 1,4-Dioxane | Form H |
| A6 | THF/H₂O | IPA | Form G |
| A7 | (1:1) | Acetone | Form D |
| A8 | | ACN | Form I |
| A9^{#} | | H2O | Weak halo peaks |
| A10 | DMSO | IPAc | Amorphous |
| A11\hat{ } | | DCM | Form D |
| A12\hat{ } | | H₂O | Form D |

*Sample was clear after anti-solvent addition, which was transferred to slurry at 5° C.
^{#}Sample was clear after anti-solvent addition and slurry at 5° C., which was transferred to evaporate at RT.
\hat{ }Sample was clear after anti-solvent addition and slurry at 5° C., which was transferred to evaporate at RT followed by drying under vacuum at 50° C.

### B. Solid-Vapor Diffusion

Solid vapor diffusion experiments were conducted using 12 different solvents. Approximate 12 mg of starting material was weighed into a 3-mL vial, which was placed into a 20-mL vial with 4 mL of volatile solvent. The 20-mL vial was sealed with a cap and kept at RT for 7 days allowing solvent vapor to interact with the sample. The solids were tested by XRPD and the results summarized in Table 3 showed that Forms D, K and J were obtained.

TABLE 3
Summary of solid-vapor diffusion experiments

| Experiment ID | Solvent | Result |
|---|---|---|
| 04-A1 | H₂O | Form D |
| 04-A2 | DCM | Form D |
| 04-A3 | EtOH | Form D |
| 04-A4 | MeOH | Form J |
| 04-A5 | CAN | Form D |
| 04-A6 | THF | Form D |
| 04-A7 | CHCl₃ | Form D |
| 04-A8 | Acetone | Form D |
| 04-A9 | DMSO | Form D |
| 04-A10 | EtOAc | Form D |
| 04-A11 | 1,4-Dioxane | Form D |
| 04-A12 | IPA | Form K |

### C. Slurry at Room Temperature

About 15 mg of the starting material was suspended in 0.5 mL of corresponding solvent in an HPLC vial. After the suspension was stirred magnetically (˜1000 rpm) for 3 days at RT, the remaining solids were isolated by centrifugation for XRPD analysis. Results summarized in Table 4 indicated that Forms D, E, F, D+E and amorphous samples were generated.

TABLE 4
Summary of slurry conversion experiments at RT

| Experiment ID | Solvent (v/v) | Crystal Form |
|---|---|---|
| 05-A1 | MeOH | Form F |
| 05-A2 | IPA | Form D |
| 05-A3 | Acetone | Form D + E |
| 05-A4 | EtOAc | Form D |
| 05-A5 | THF | Form D |
| 05-A6 | 2-MeTHF | Form D |
| 05-A7 | CPME | Form D |
| 05-A8 | ACN | Form D |
| 05-A9 | DCM | Form D |
| 05-A10 | DMSO | Amorphous |
| 05-A11 | n-Heptane | Form D |
| 05-A12 | Toluene | Form D |
| 05-A13 | H₂O | Form D |
| 05-A14 | NMP/H₂O (1:1) | Form D + E |
| 05-A15 | MEK/THF (1:1) | Form E |
| 05-A16 | Acetone/IPAc (1:1) | Form D |
| 05-A17 | EtOH/2-MeTHF (1:1) | Form E |
| 05-A18 | CHCl₃/n-Heptane (1:1) | Form D |
| 05-A19 | Toluene/IPA (1:1) | Form E |
| 05-A20 | 1,4-Dioxane/MeOH (1:1) | Form D + E |
| 05-A21 | Acetone/MTBE (1:1) | Form D |
| 05-A22 | MeOH/H₂O (aw~0.2) | Form E |
| 05-A23 | MeOH/H₂O (aw~0.4) | Form D + E |
| 05-A24 | MeOH/H₂O (aw~0.6) | Form D + E |
| 05-A25 | MeOH/H₂O (aw~0.8) | Form D |

### D. Slurry at 50° C.

About 15 mg of the starting material was suspended in 0.5 ml, of corresponding solvent in an HPLC vial. After the suspension was magnetically stirred (˜1000 rpm) for 3 days at 50° C., the remaining solids were isolated by centrifugation for XRPD analysis. Results summarized in Table 5 indicated that Forms D, E, F, G and amorphous samples were generated.

TABLE 5
Summary of slurry conversion experiments at 50° C.

| Experiment ID | Solvent (v/v) | Result |
|---|---|---|
| 06-A1 | MeOH | Form F |
| 06-A2 | EtOH | Form G |
| 06-A3 | MIBK | Form E |
| 06-A4 | IPAc | Form D |
| 06-A5 | 1,4-Dioxane | Form E |
| 06-A6 | MTBE | Form D |
| 06-A7 | CHCl₃ | Form D |
| 06-A8 | DMSO | Form E |
| 06-A9 | IPA/H₂O (9:1) | Form E |
| 06-A10 | CHCl₃/n-Heptane (1:4) | Form D |
| 06-A11 | Acetone/THF (1:1) | Form E |
| 06-A12 | EtOH/THF (1:1) | Form E |
| 06-A13 | EtOAc/CHCl₃ (1:1) | Form E |
| 06-A14 | MIBK/MTBE (1:1) | Form E |
| 06-A15 | MEK/n-Heptane (1:1) | Form E |
| 06-A16 | DMSO/H₂O (9:1) | Amorphous |

### E. Slow Evaporation

Slow evaporation experiments were performed under 4 conditions. Briefly, ˜15 mg of the starting material was dissolved in 2.0 mL corresponding solvent in a 3-mL glass vial and filtered using a 0.45 μm PTFE membrane. The visually clear solutions were subjected to evaporation at RT in vials sealed by Parafilm® (poke 5 small holes). The solids were isolated for XRPD analysis, and the results summarized in Table 6 indicated that Form E and Form D+E were observed

TABLE 6
Summary of slow evaporation experiments

| Experiment ID | Solvent (v/v) | Result |
|---|---|---|
| 07-A1 | MeOH | Form E |
| 07-A2 | MeOH/DCM (1:1) | Form D + E |
| 07-A3 | THF/H₂O (9:1) | Weak halo peaks |
| 07-A4 | ACN/H₂O (1:1) | Form E |

### F. Slow Cooling

About 15 mg of the starting material was suspended in 1.0˜2.0 mL of corresponding solvent in a 3-mL glass vial at RT. The suspension was then heated to 50° C., equilibrated for about 2 hrs and filtered to a new vial using a 0.45 μm PTFE membrane. Filtrates were slowly cooled down to 5° C. at a rate of 0.1° C./min. The obtained solids were kept isothermal at 5° C. before isolation for XRPD analysis. Results summarized in Table 7 indicated that Form D, Form D+E and Form M were generated.

TABLE 7
Summary of slow cooling experiments

| Experiment ID | Solvent (v/v) | Result |
|---|---|---|
| 08-A1 | MeOH | Form D + E |
| 08-A2* | Acetone | No solid obtained |
| 08-A3* | EtOAc | No solid obtained |
| 08-A4 | THF | Form D |
| 08-A5* | CHCl₃ | Form D |
| 08-A6 | NMP | Form D + E |
| 08-A7* | ACN/H₂O (1:1) | Form M |
| 08-A8 | THF/H₂O (4:1) | 2 Peaks |

*Clear solution was obtained after slow cooling to 5° C. and placed at −20° C., which was transferred to evaporate at RT.

### G. Liquid-Vapor Diffusion

Approximate 15 mg of the starting material was dissolved in 1.2˜2.0 mL of corresponding solvent in a 3-mL glass vial to obtain a clear solution. The 3-mL vial was then placed into a 20-mL vial with 4 mL of anti-solvent. The 20-mL vial was sealed with a cap and kept at RT for 7 days allowing organic vapor to interact with the solution. The precipitates were isolated for XRPD analysis. The results summarized in Table 8 showed that Forms D, E, F, G, I, L and M were generated.

TABLE 8
Summary of liquid-vapor diffusion experiment

| Experiment ID | Solvent | Anti-solvent | Result |
|---|---|---|---|
| 09-A1 | MeOH | Toluene | Amorphous |
| 09-A2 | | H₂O | Form D |
| 09-A3 | | EtOAc | Form F |
| 09-A4* | DMSO | EtOH | Form E + peak |
| 09-A5* | | MTBE | Form E + peak |
| 09-A6* | | H₂O | Form E + peak |
| 09-A7* | THF/H₂O (1:1) | MEK | Form M |
| 09-A8 | | 1,4-Dioxane | Form L |
| 09-A9 | | IPA | Form I |
| 09-A10 | MeOH/DCM (1:1) | THF | Form G |
| 09-A11 | | ACN | Form G |
| 09-A12 | | CHCl₃ | Form E |

*No solids were obtained after vapor diffusion, which was transferred to evaporate at RT followed dry at 50° C. under vacuum.

### H. Polymer Induced Crystallization

Approximately 15 mg of Compound 1 Form D was suspended in 0.5 mL of corresponding solvent in an HPLC vial. About 2 mg of the polymer mixture was added into the HPLC vial. After the suspension was stirred magnetically (˜1000 rpm) for 3 days at RT, the remaining solids were isolated by centrifugation for XRPD analysis. Results summarized in Table 9 showed that Form D and Form G were obtain

TABLE 9
Summary of polymer-induced crystallization experiments

| Exp. ID | Solvent (v/v) | Polymer | Result |
|---|---|---|---|
| 10-A1 | EtOH | Polymer mixture A | Form G |
| 10-A2 | MIBK | | Form D |
| 10-A3 | ACN/H₂O (1:1) | | Form D |
| 10-A4 | MTBE | Polymer mixture B | Form D |
| 10-A5 | IPAc | | Form D |
| 10-A6 | MeOH/DCM (1:1) | | Form D |

Polymer mixture A: polyvinyl pyrrolidone (PVP), polyvinyl alcohol (PVA), polyvinylchloride (PVC), polyvinyl acetate (PVAC), hypromellose (HPMC), methyl cellulose (MC) (mass ratio of 1:1:1:1:1:1)
Polymer mixture B: polycaprolactone (PCL), polyethylene glycol (PEG), poly (methyl methacrylate) (PMMA) sodium alginate (SA), and hydroxyethyl cellulose (HEC) (mass ratio of 1:1:1:1:1).

### I. Grinding

Approximate 20 mg of the starting material was added into an agate mortar and manually ground using a pestle for about 3 min after adding 0.4˜0.6 mL corresponding solvent. The solids were checked by XRPD and the results summarized in Table 10 showed that only Form D was obtained.

TABLE 10
Summary of grinding experiments

| Exp. ID | Solvent | Result |
|---|---|---|
| 11-A1 | N/A | Form D |
| 11-A2 | EtOH | Form D |
| 11-A3 | Acetone | Form D |
| 11-A4 | EtOAc | Form D |
| 11-A5 | 2-MeTHF | Form D |

### 6.2.3 Instruments and Methods

### I. XRPD

For XRPD analysis, Panalytical Empyrean and X'pert3 X-ray powder diffractometers were used. Sample was spread on the middle of a zero-background Si holder. The XRPD parameters used are listed in Table 11.

TABLE 11
Parameters for XRPD test

| Parameters | Reflection Mode | VT-XRPD |
|---|---|---|
| Model | X′ Pert³ | Empyrean |

| | |
|---|---|
| X-Ray wavelength | Cu, kα, Kα1 (Å): 1.540598, |
| | Kα2 (Å): 1.544426 |
| | Kα2/Kα1 intensity ratio: 0.50 |

| | | |
|---|---|---|
| X-Ray tube setting | 45 kV, 40 mA | 45 kV, 40 mA |
| Divergence slit | ⅛° | Automatic |
| Scan mode | Continuous | Continuous |
| Scan range (°2TH) | 3°-40° | 3°-40° |
| Scan step time (s) | 46.67 | 33.02 |
| Step size (°2TH) | 0.0263 | 0.0167 |
| Test time | 5 min 4 s | 10 min 15 s |

### II. TGA and DSC

TGA data were collected using a TA Q5000 and Discovery TGA 5500 TGA from TA Instruments and DSC was performed using a TA Q2000 and Discovery DSC 2500 DSC from TA Instruments. Detailed parameters used are listed in Table 12.

TABLE 12
Parameters for TGA and DSC test

| Parameters | TGA | DSC |
|---|---|---|
| Method | Ramp | Ramp |
| Sample pan | Aluminum, open | Aluminum, crimped |
| Temperature | RT-350° C. | 25° C.-300° C. |
| Heating rate | 10° C./min | 10° C./min |
| Purge gas | N₂ | N₂ |

### III. DVS

DVS was measured via a SMS (Surface Measurement Systems) DVS Intrinsic. The relative humidity at 25° C. were calibrated against deliquescence point of LiCl, Mg(NO₃)₂ and KCl. Parameters for DVS test were listed in Table 13.

TABLE 13
Parameters for DVS test

| Parameters | DVS | |
|---|---|---|
| Temperature | 25° | C. |
| Sample size | 20~40 | mg |
| Gas and flow rate | N₂, 200 | mL/min |
| dm/dt | 0.002%/min | |
| Min. dm/dt | 10 | min |
| stability duration | | |
| Max. equilibrium time | 180 | min |

| | |
|---|---|
| RH range | Room humidity~95% RH~0% RH~95% RH |
| RH step size | 10% RH (0% RH~90% RH & 90% RH~0% RH) |
| | 5% RH (90% RH~95% RH & 95% RH~90% RH) |

### IV. ¹H Solution NMR

¹H solution NMR was collected on Bruker 400M NMR Spectrometer using DMSO-d₆ as solvent.

### V. HPLC

An Agilent 1290 UPLC with DAD detector was utilized and detailed chromatographic conditions for purity and stoichiometric ratio analysis are listed in Table 14 and Table 15.

TABLE 14
Chromatographic conditions for purity analysis

| HPLC | Agilent 1290 UPLC with DAD detector | |
|---|---|---|
| Column | Supelco Ascentis Express 2.7 um 4.6 × 100 mm | |
| Mobile phase | A: 0.05% Phosphoric acid in Water v/v | |
| | B: 0.05% Phosphoric acid in Acetonitrile v/v | |
| | Time (min) | % B |
| Gradient table | 0.0 | 5 |
| | 2.0 | 5 |
| | 20.0 | 90 |
| | 24.0 | 90 |
| | 24.1 | 5 |
| | 32.0 | 5 |

| | |
|---|---|
| Run time | 32.0 |
| Post time | 0.0 |
| Flow rate | 1.2 mL/min |
| Injection volume | 3 μL |
| Detector wavelength | 275 nm |
| Column temperature | 40° C. |
| Sampler temperature | RT |
| Diluent | THF |

TABLE 15
Chromatographic conditions for stoichiometric ratio analysis

| HPLC | Agilent 1290 UPLC with DAD detector | |
|---|---|---|
| Column | Supelco Ascentis Express 2.7 um 4.6 × 100 mm | |
| Mobile phase | A: 0.05% Phosphoric acid in Water v/v | |
| | B: 0.05% Phosphoric acid in Acetonitrile v/v | |
| | Time (min) | % B |
| Gradient table | 0.0 | 40 |
| | 8.0 | 90 |
| | 10.0 | 90 |
| | 10.1 | 40 |
| | 12.0 | 40 |

| | |
|---|---|
| Run time | 12.0 |
| Post time | 0.0 |
| Flow rate | 1.2 mL/min |
| Injection volume | 5 μL |
| Detector wavelength | 275 nm |
| Column temperature | 40° C. |
| Sampler temperature | RT |
| Diluent | THF |

### VI. Ion Chromatograph (IC)

ThermoFisher ICS-1100 was utilized and detailed conditions were listed in Table 16.

TABLE 16
Ion chromatograph conditions and parameters

| IC | ThermoFisher ICS-1100 | |
|---|---|---|
| Column | Dionex Ionpac ™ CS12A RFICTM | |
| | 4 × 250 mm Analytical | |
| Mobile phase | 25 mM Methanesulfonic | |
| Injection volume | 25 | μL |
| Flow rate | 1.0 | mL/min |
| Cell temperature | 35° | C. |
| Column temperature | 35° | C. |
| Current | 80 | mA |

| | |
|---|---|
| Run time | 7.0 min (Na⁺) |

### VII. PLM (Polarized Light Microscopy)

Polarized light microscopic picture was captured on Axio Scope. A1 microscope from Carl Zeiss German Microscope.

### VIII. FTIR (Fourier Transform Infrared Spectroscopy)

FTIR data was collected using Nicolet Is 10 from Thermofisher.

### 6.2.4 Characterization of Polymorphic Forms

A total of 22 solid forms of Compound 1 were found during this polymorph screen study. The physical characteristics are summarized in Table 17.

TABLE 17
Characterization of crystal forms

| | TGA weight loss | DSC endotherm | Molar ratio | Speculated |
|---|---|---|---|---|
| Crystal form | (%) | (° C., peak) | (Na⁺/API) | form |
| Form D | 4.5 (to 100° C.) | 138.0, 145.0, | 0.9:1 | Hydrate |
| | 4.2 (100~220° C.) | 177.9* | | |
| Form E | 4.4 (to 120° C.) | 112.1, 183.2* | 1.0:1 | Hydrate |
| | 4.2 (120~220° C.) | | | |
| Form F | 7.0 (to 120° C.) | 110.4, 173.2, | 0.9:1 | Anhydrate/ |
| | 4.7 (120~220° C.) | 180.7* | | Hydrate |
| Form G | 4.3 (to 120° C.) | 60.5, 119.2, | 0.9:1 | Metastable |
| | 4.2 (120~220° C.) | 181.2* | | form |
| Form H | 5.5 (to 110° C.) | 46.0, 112.4, | 1.0:1 | 1,4-Dioxane |
| | 4.8 (110~220° C.) | 193.1* | | solvate |
| Form I | 11.5 (to 120° C.) | 71.7, 110.1, | 1.0:1 | Anhydrate/ |
| | 5.3 (120~220° C.) | 182.9* | | Hydrate |
| Form J | 5.4 (to 150° C.) | 86.0, 163.8* | 0.9:1 | Hydrate |
| | 4.6 (150~220° C.) | | | |
| Form K | NA | NA | NA | Metastable |
| | | | | form |
| Form L | 6.4 (to 130° C.) | 94.5, 134.0, | 1.1:1 | Hydrate |
| | 4.4 (130~250° C.) | 185.0* | | |
| Form M | 8.0 (to 120° C.) | 92.4, 152.4* | 0.9:1 | Anhydrate/ |
| | 4.5 (120~220° C.) | | | Hydrate |
| Form N | 8.0 (to 120° C.) | 87.9, 113.5#, | 1.1:1 | 1,4-Dioxane |
| | 4.5 (120~220° C.) | 190.0 | | solvate |
| Form O | NA | NA | NA | Anhydrate |
| Form P | NA | NA | NA | Anhydrate/ |
| | | | | Hydrate |
| Form Q | NA | NA | NA | Anhydrate |
| Form R | NA | NA | NA | Anhydrate |
| Form S | NA | NA | NA | Anhydrate/ |
| | | | | Hydrate |
| Form T | NA | NA | NA | Anhydrate |
| Form U | 6.6 (to 130° C.) | 66.6, 85.2, | NA | Hydrate |
| | 4.0 (130~230° C.) | 179.0* | | |
| Form V | NA | NA | NA | Anhydrate/ |
| | | | | Hydrate |
| Form W | 6.0 (to 130° C.) | 75.3, 180.2* | NA | Anhydrate |
| | 4.7 (130~230° C.) | | | |
| Form X | NA | NA | NA | Solvate |
| Form Y | NA | NA | NA | Anhydrate/ |
| | | | | Hydrate |

*Onset temperature.
NA: Not performed.

### Form D

Form D of Compound 1 was characterized by XRPD, TGA, DSC and ¹H NMR. The XRPD pattern of Form D showed characteristic peaks shown in FIG. 1. DSC curve showed three endotherms at 138.0° C., 145.0° C. (peak temperature) and 177.9° C. (onset temperature). The stoichiometric ratio of Na⁺/API was 0.9:1 by HPLC/IC.

FIG. 1 provides an XRPD pattern of Form D of Compound 1. A list of X-Ray Diffraction Peaks for Form D of Compound 1 is provided below in Table 18.

TABLE 18
X-Ray Diffraction Peaks for Form D of Compound 1

| #Peak | 2θ [°] | d-spacing [Å] | Rel [%] |
|---|---|---|---|
| 1 | 4.41 | 20.00 | 38.28 |
| 2 | 6.55 | 13.48 | 100.00 |
| 3 | 8.72 | 10.13 | 12.87 |
| 4 | 9.03 | 9.78 | 7.08 |
| 5 | 10.10 | 8.78 | 1.91 |
| 6 | 10.88 | 8.12 | 53.65 |
| 7 | 12.38 | 7.15 | 12.72 |
| 8 | 12.96 | 6.83 | 5.44 |
| 9 | 15.17 | 5.84 | 44.45 |
| 10 | 16.09 | 5.50 | 7.68 |
| 11 | 16.42 | 5.39 | 7.08 |
| 12 | 16.80 | 5.26 | 10.96 |
| 13 | 16.97 | 5.22 | 17.16 |
| 14 | 17.43 | 5.08 | 2.65 |
| 15 | 18.01 | 4.92 | 13.03 |
| 16 | 18.30 | 4.84 | 10.76 |
| 17 | 18.51 | 4.79 | 10.99 |
| 18 | 19.58 | 4.53 | 3.67 |
| 19 | 20.75 | 4.28 | 5.27 |
| 20 | 21.03 | 4.22 | 10.67 |
| 21 | 21.82 | 4.07 | 16.23 |
| 22 | 22.34 | 3.98 | 18.78 |
| 23 | 24.01 | 3.70 | 22.86 |
| 24 | 24.34 | 3.65 | 6.83 |
| 25 | 25.36 | 3.51 | 6.13 |
| 26 | 25.72 | 3.46 | 10.63 |
| 27 | 26.09 | 3.41 | 15.24 |
| 28 | 27.24 | 3.27 | 3.84 |
| 29 | 27.54 | 3.24 | 24.15 |
| 30 | 28.37 | 3.14 | 8.07 |
| 31 | 28.90 | 3.09 | 2.12 |
| 32 | 29.40 | 3.03 | 3.58 |
| 33 | 30.36 | 2.94 | 8.60 |
| 34 | 30.71 | 2.91 | 6.92 |
| 35 | 32.47 | 2.75 | 6.26 |
| 36 | 35.54 | 2.52 | 3.16 |
| 37 | 37.48 | 2.40 | 5.46 |

A TGA curve of Form D showed a weight loss of 4.5% up to 250° C. and 4.2% between 100° C. and 250° C. as depicted in FIG. 2.

A DSC plot for Form D showed three endotherms at 138.0° C., 145.0° C. (peak temperature) and 177.9° C. (onset temperature) as depicted in FIG. 2.

¹H NMR data in FIG. 3 was collected using DMSO-d₆ as solvent. The stoichiometric ratio of Na⁺/API was 0.9:1 by HPLC/IC.

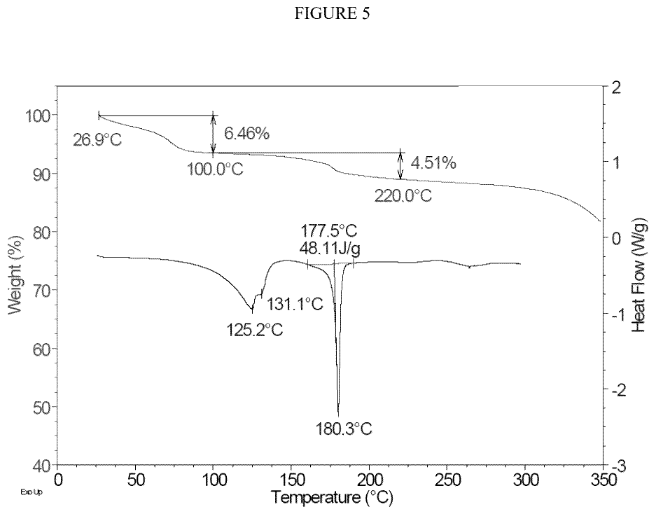

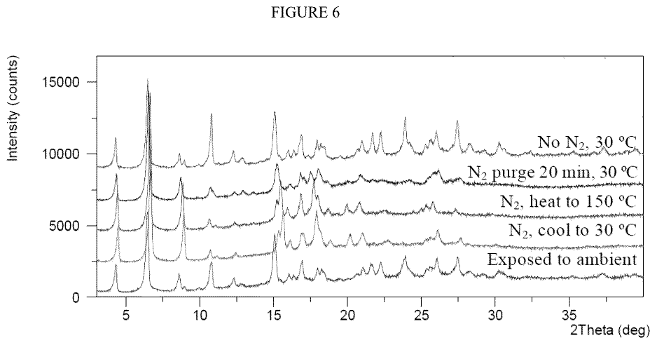

A heating experiment was performed for Form D of Compound 1. An XRPD pattern in FIG. 4 showed no form change after heating Form D to 150° C. and cooling to RT. As seen in FIG. 5, a TGA curve of the heated sample showed a two-step weight loss of 6.5% (up to 100° C.) and 4.5% (100° C.˜220° C.). A DSC curve of the heated curve in FIG. 5 showed three endotherms at 125.2° C., 131.1° C. (peak) and 177.5° C. (onset). A variable temperature XRPD (VT-XRPD) overlay of Form D is shown in FIG. 6. A form change to Form P was observed after N2 sweeping Form D for 20 min at 30° C. After heating to 150° C. and cooling to 30° C. with N₂ protection, another new form was observed, which was Form Q. After exposure to ambient conditions, Form D was re-obtained. Based on the above results, Form D was speculated to be a hydrate. The first step weight loss and two endotherms at 138.0° C., 145.0° C. were related to removal of crystal water.

As seen in a PLM image in FIG. 7, Form D was rod-like crystals with aggregation. An FTIR results are shown in FIG. 8 and Table 19.

TABLE 19
FTIR result of Form D

| IR Band (cm⁻¹) | Intensity | IR Band (cm⁻¹) | Intensity |
|---|---|---|---|
| 401.39 | 70.00 | 648.85 | 72.08 |
| 406.35 | 75.41 | 664.99 | 71.86 |
| 409.81 | 74.67 | 708.37 | 66.87 |
| 417.09 | 77.85 | 783.34 | 63.18 |
| 425.59 | 73.55 | 822.72 | 72.21 |
| 436.25 | 73.84 | 834.41 | 79.61 |
| 440.96 | 74.62 | 865.74 | 84.09 |
| 448.11 | 77.12 | 880.29 | 79.97 |
| 471.20 | 74.46 | 905.21 | 73.31 |
| 490.85 | 72.47 | 928.43 | 66.33 |
| 510.26 | 67.46 | 951.44 | 60.09 |
| 560.74 | 65.28 | 974.62 | 72.14 |
| 618.86 | 83.58 | 990.83 | 77.20 |
| 626.40 | 83.45 | 1039.10 | 68.19 |
| 1091.83 | 71.03 | 1447.14 | 86.906 |
| 1110.44 | 72.89 | 1487.15 | 76.921 |
| 1155.47 | 83.58 | 1514.29 | 87.32 |
| 1179.87 | 75.22 | 1551.01 | 74.121 |
| 1228.20 | 80.34 | 1591.32 | 81.87 |
| 1254.73 | 84.80 | 1614.99 | 83.029 |
| 1289.93 | 89.09 | 1657.17 | 64.094 |
| 1311.96 | 89.10 | 2321.84 | 93.367 |
| 1343.45 | 83.12 | 2863.68 | 90.953 |
| 1374.64 | 77.06 | 2939.15 | 90.414 |
| 1386.18 | 84.66 | 3091.76 | 92.846 |
| 1406.14 | 87.079 | 3142.46 | 92.676 |
| 1428.01 | 85.745 | 3302.05 | 87.906 |

### Form E

Form E was obtained via slurry of Form D in MIBK at 50° C. The XRPD pattern, TGA, DSC, FTIR and ¹H NMR of Form E of Compound 1 are shown in FIGS. 9-11 and 16.

FIG. 9 provides an XRPD pattern of Form E of Compound 1. A list of X-Ray Diffraction Peaks for Form E of Compound 1 is provided below in Table 20.

TABLE 20
X-Ray Diffraction Peaks for Form E of Compound 1

| | Relative |
|---|---|
| Angle/° 2θ | Intensity/% |
| 4.454 | 5.40 |
| 6.721 | 12.10 |
| 8.644 | 89.10 |
| 9.489 | 8.40 |
| 10.753 | 9.80 |
| 11.257 | 2.70 |
| 13.595 | 0.50 |
| 14.062 | 33.40 |
| 15.461 | 1.50 |
| 15.965 | 3.80 |
| 16.808 | 100.00 |
| 17.41 | 48.80 |
| 18.145 | 4.00 |
| 19.133 | 1.10 |
| 20.307 | 15.70 |
| 20.899 | 4.70 |
| 21.7 | 2.10 |
| 21.867 | 3.20 |
| 22.746 | 1.60 |
| 23.555 | 1.00 |
| 24.268 | 3.80 |
| 24.897 | 1.50 |
| 25.472 | 18.80 |
| 25.779 | 4.80 |
| 26.282 | 18.10 |
| 26.966 | 2.10 |
| 27.812 | 0.90 |
| 28.299 | 2.00 |
| 28.696 | 4.30 |
| 29.73 | 2.20 |
| 30.031 | 0.80 |
| 30.931 | 5.10 |
| 31.367 | 1.50 |
| 33.265 | 0.80 |
| 34.072 | 21.70 |
| 34.392 | 20.80 |
| 34.796 | 7.70 |
| 35.315 | 5.30 |
| 35.522 | 2.20 |
| 36.005 | 1.70 |
| 36.452 | 2.50 |
| 36.614 | 2.30 |
| 36.793 | 1.70 |
| 37.5 | 1.40 |
| 37.813 | 4.40 |
| 38.161 | 1.00 |
| 39.266 | 0.90 |
| 38.944 | 4.70 |
| 40.064 | 7.10 |
| 40.767 | 0.70 |
| 42.004 | 1.00 |
| 43.062 | 7.30 |
| 43.534 | 1.20 |
| 44.048 | 1.10 |
| 44.295 | 1.80 |
| 44.862 | 2.20 |
| 45.082 | 2.50 |
| 45.874 | 3.80 |
| 46.434 | 1.20 |
| 47.077 | 1.20 |
| 48.799 | 0.90 |
| 50.937 | 1.20 |
| 52.34 | 3.20 |
| 53.179 | 2.20 |
| 58.15 | 1.10 |

A two-step TGA weight loss of 4.4% up to 120° C. and 4.2% between 120° C. and 220° C. as depicted in FIG. 10.

A DSC plot for Form E showed two endotherms at 112.1° C. (peak) and 183.2° C. (onset) as depicted in FIG. 10.

No residual solvent (MIBK) was detected in Form E ¹H NMR as depicted in FIG. 11.

The stoichiometric ratio of Na⁺/API was 1:1 by HPLC/IC.

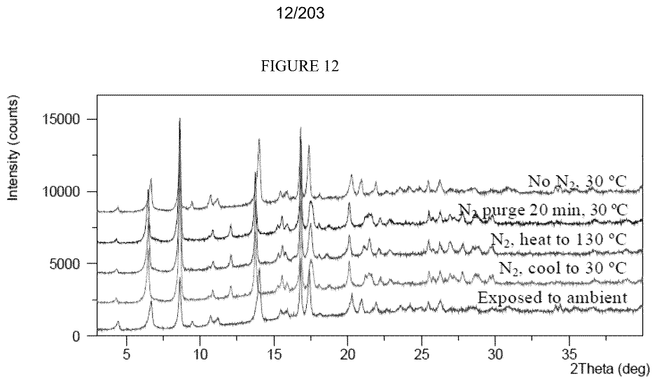

A VT-XRPD overlay of Compound 1 Form E is shown in FIG. 12.

A form change was observed after N₂ sweeping Compound 1 Form E for 20 min at 30° C., the new form was Form R. After heating to 130° C. and cooling to 30° C. with N₂ protection, no further form change was observed. After exposure to ambient conditions, Form E was re-obtained, indicating Form E was a hydrate.

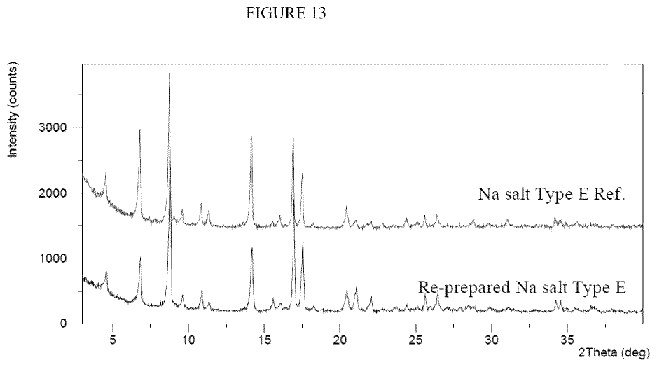

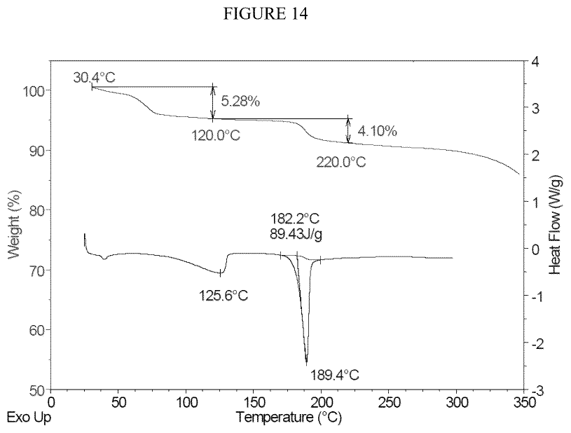

A second batch of Form E was obtained via slurry of another batch of Compound 1 Form D in MIBK at 50° C. An XRPD pattern for this second batch of Form E is shown in FIG. 13. TGA/DSC results of this second batch Form E are displayed in FIG. 14. The TGA result showed a two-step weight loss of 5.3% up to 120° C. and 4.1% between 120° C. and 220° C. The DSC result showed two endotherms at 125.6° C. (peak) and 182.2° C. (onset). The stoichiometric ratio of Na⁺/API was 0.9:1 by HPLC/IC. A PLM image in FIG. 15 showed Form E as rod-like crystals with aggregation, having particle size that is smaller than Form D. FTIR results are shown in FIG. 16 and Table 21.

TABLE 21
FTIR result of Na salt Form E

| IR Band (cm⁻¹) | Intensity | IR Band (cm⁻¹) | Intensity |
|---|---|---|---|
| 403.07 | 70.274 | 830.74 | 75.308 |
| 417.42 | 72.006 | 845.10 | 82.459 |
| 433.53 | 76.029 | 876.66 | 73.182 |
| 497.96 | 63.650 | 905.10 | 63.838 |
| 522.41 | 53.567 | 930.69 | 44.491 |
| 544.72 | 43.447 | 945.56 | 52.988 |
| 623.95 | 75.836 | 961.83 | 47.395 |
| 645.69 | 58.460 | 974.13 | 59.352 |
| 663.75 | 61.228 | 1017.05 | 39.540 |
| 712.01 | 54.597 | 1052.68 | 61.163 |
| 758.90 | 81.568 | 1062.93 | 71.590 |
| 783.71 | 50.450 | 1076.93 | 72.916 |
| 809.16 | 62.381 | 1091.45 | 57.332 |
| 822.09 | 61.456 | 1102.00 | 57.328 |
| 1138.34 | 81.354 | 1488.34 | 67.92 |
| 1187.66 | 61.949 | 1515.80 | 84.08 |
| 1227.40 | 68.026 | 1552.74 | 66.09 |
| 1254.59 | 81.765 | 1590.63 | 71.61 |
| 1332.16 | 72.968 | 1616.26 | 76.96 |
| 1354.16 | 81.780 | 1657.23 | 53.61 |
| 1372.62 | 71.762 | 2286.00 | 92.77 |
| 1384.72 | 71.621 | 2867.29 | 87.93 |
| 1405.61 | 84.411 | 2931.58 | 86.69 |
| 1423.53 | 81.226 | 3102.84 | 90.49 |
| 1441.80 | 82.124 | 3148.06 | 92.54 |
| 1454.69 | 80.25 | 3288.04 | 83.45 |
| 1481.19 | 67.40 | 3417.25 | 89.63 |

### Form J

Form J was obtained via slurry of Form D in MeOH at room temperature. The XRPD pattern, TGA, DSC, and ¹H NMR of Form J of Compound 1 are shown in FIGS. 17-19.

FIG. 17 provides an XRPD pattern of Form J of Compound 1. A list of X-Ray Diffraction Peaks for Form J of Compound 1 is provided below in Table 22.

TABLE 22
X-Ray Diffraction Peaks for Form J of Compound 1

| #Peak | 2θ [°] | d-spacing [Å] | Rel [%] |
|---|---|---|---|
| 1 | 4.64 | 19.02 | 12.60 |
| 2 | 4.88 | 18.08 | 12.42 |
| 3 | 5.49 | 16.07 | 11.54 |
| 4 | 5.87 | 15.05 | 20.18 |
| 5 | 6.42 | 13.76 | 14.52 |
| 6 | 7.89 | 11.19 | 24.08 |
| 7 | 8.26 | 10.70 | 6.72 |
| 8 | 8.57 | 10.31 | 4.47 |
| 9 | 9.26 | 9.54 | 100.00 |
| 10 | 9.75 | 9.06 | 5.05 |
| 11 | 10.29 | 8.59 | 4.75 |
| 12 | 11.03 | 8.02 | 8.29 |
| 13 | 11.73 | 7.54 | 7.76 |
| 14 | 12.83 | 6.89 | 7.86 |
| 15 | 13.91 | 6.36 | 3.90 |
| 16 | 14.73 | 6.01 | 4.87 |
| 17 | 15.82 | 5.60 | 33.04 |
| 18 | 16.53 | 5.36 | 2.44 |
| 19 | 17.64 | 5.02 | 4.88 |
| 20 | 18.21 | 4.87 | 11.29 |
| 21 | 18.68 | 4.75 | 15.79 |
| 22 | 19.37 | 4.58 | 76.60 |
| 23 | 20.65 | 4.30 | 6.51 |
| 24 | 21.94 | 4.05 | 6.66 |
| 25 | 23.20 | 3.83 | 2.35 |
| 26 | 24.00 | 3.70 | 1.75 |
| 27 | 27.40 | 3.25 | 1.37 |
| 28 | 28.04 | 3.18 | 8.64 |
| 29 | 32.02 | 2.79 | 2.94 |

A two-step TGA weight loss of 5.4% up to 150° C. and 4.6% between 150° C. and 220° C. as depicted in FIG. 18.

A DSC plot for Form E showed two endotherms at 86.0° C. (peak) and 163.8° C. (onset) as depicted in FIG. 18.

No residual solvent (MIBK) was detected in Form J ¹H NMR as depicted in FIG. 19.

The stoichiometric ratio of Na⁺/API was 1.0:1 by HPLC/IC.

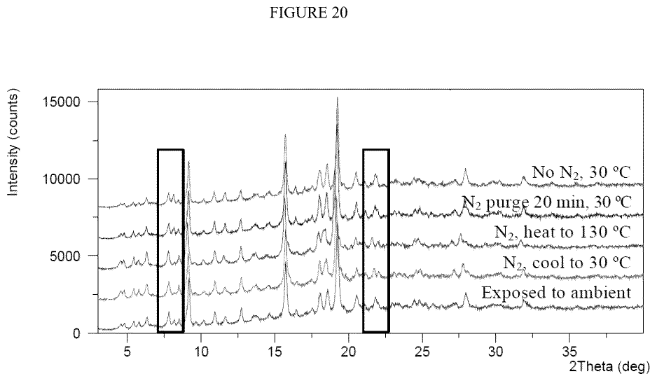

A VT-XRPD overlay of Compound 1 Form J is shown in FIG. 20.

A form change was observed after heating Form J to 130° C. and cooling to 30° C. with N₂ protection, the new form was Form O. After exposure to ambient conditions, Form J was re-obtained. Based on the VT-XRPD results, Form J was speculated to be a hydrate.

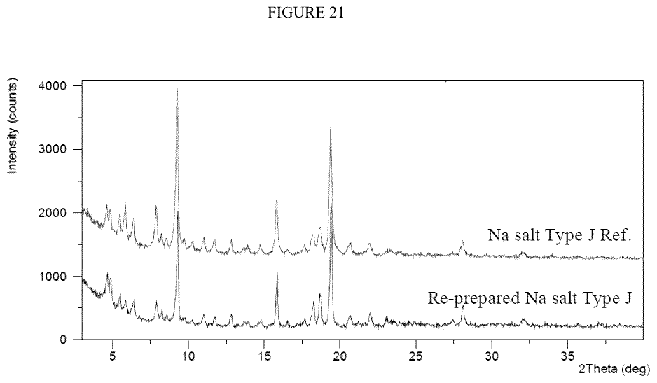

Another batch of Compound 1 Form J was obtained via slurry starting material Form D in MeOH at RT, an overlay of XRPD pattern is displayed in FIG. 21. This batch of Form J was used for slurry competition.

### Form L

Form L was obtained via adding anti-solvent ACN into THF/H₂O (1:1, v/v) solution of Form D. The XRPD pattern, TGA, DSC, ¹H NMR, and FTIR of Form L of Compound 1 are shown in FIGS. 22-24.

FIG. 22 provides an XRPD pattern of Form L of Compound 1. A list of X-Ray Diffraction Peaks for Form L of Compound 1 is provided below in Table 23.

TABLE 23
X-Ray Diffraction Peaks for Form L of Compound 1

| #Peak | 2θ [°] | d-spacing [Å] | Rel [%] |
|---|---|---|---|
| 1 | 6.45 | 13.69 | 24.78 |
| 2 | 7.16 | 12.33 | 40.10 |
| 3 | 11.97 | 7.39 | 100.00 |
| 4 | 12.31 | 7.18 | 27.64 |
| 5 | 13.87 | 6.38 | 62.02 |
| 6 | 14.35 | 6.17 | 29.94 |
| 7 | 16.79 | 5.28 | 28.42 |
| 8 | 18.51 | 4.79 | 12.89 |
| 9 | 19.20 | 4.62 | 18.40 |
| 10 | 20.32 | 4.37 | 14.18 |
| 11 | 20.62 | 4.30 | 36.03 |
| 12 | 21.71 | 4.09 | 17.24 |
| 13 | 22.86 | 3.89 | 17.34 |
| 14 | 26.75 | 3.33 | 24.63 |
| 15 | 27.25 | 3.27 | 21.71 |

A two-step TGA weight loss of 6.4% up to 130° C. and 4.4% between 130° C. and 250° C. as depicted in FIG. 23.

A DSC plot for Form L showed three endotherms at 94.5° C., 134.0° C. (peak) and 185.0° C. (onset) as depicted in FIG. 23.

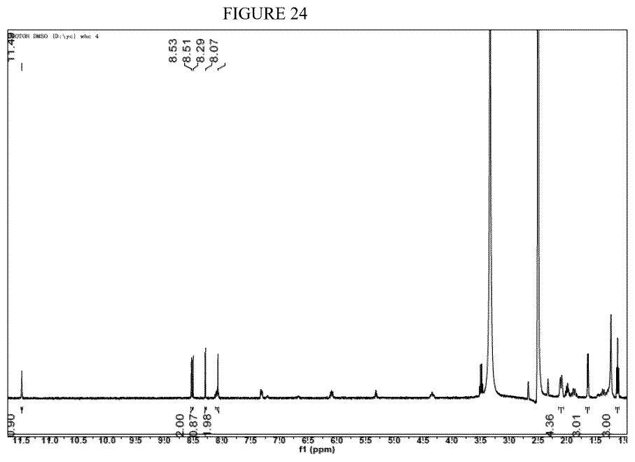

No residual solvent (ACN or THF) was detected in Form L ¹H NMR as depicted in FIG. 24.

The stoichiometric ratio of Na⁺/API was 1.1:1 by HPLC/IC.

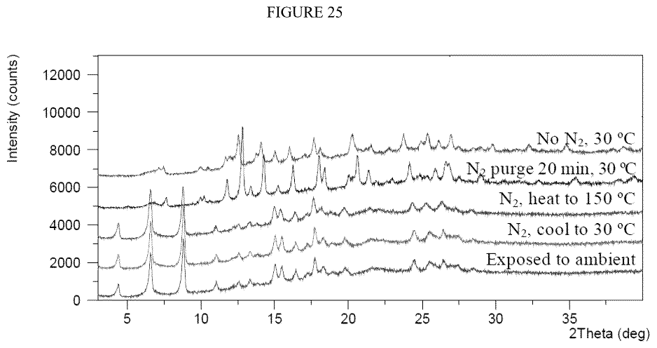

A VT-XRPD overlay of Compound 1 Form L is shown in FIG. 25.

A form change was observed after N₂ sweeping Form L for 20 minutes at 30° C., the new form was Form V. After heating to 150° C. and cooling to 30° C. with N₂ protection, followed by exposed to ambient condition for 30 min, a new form was observed, which was Form W. Combining the above data, Form L was speculated to be a hydrate. The crystal water was removed after N₂ sweeping, which resulted in the form conversion to Form V.

### Form U

Form U was obtained via heating Form N to 150° C. and cooling to 30° C. with N₂ protection, followed by exposure to ambient conditions for 30 min. The XRPD pattern, TGA and DSC of Form U of Compound 1 are shown in FIGS. 26-27.

FIG. 26 provides an XRPD pattern of Form U of Compound 1. A list of X-Ray Diffraction Peaks for Form U of Compound 1 is provided below in Table 24.

TABLE 24
X-Ray Diffraction Peaks for Form U of Compound 1

| #Peak | 2θ [°] | d-spacing [Å] | Rel [%] |
|---|---|---|---|
| 1 | 4.36 | 20.26 | 35.68 |
| 2 | 6.50 | 13.59 | 100.00 |
| 3 | 8.66 | 10.20 | 16.49 |
| 4 | 9.70 | 9.11 | 1.45 |
| 5 | 10.83 | 8.16 | 20.69 |
| 6 | 13.78 | 6.42 | 2.10 |
| 7 | 15.16 | 5.84 | 8.53 |
| 8 | 15.87 | 5.58 | 2.98 |
| 9 | 17.37 | 5.10 | 3.60 |
| 10 | 18.82 | 4.71 | 1.19 |
| 11 | 19.54 | 4.54 | 2.49 |
| 12 | 21.74 | 4.08 | 4.58 |
| 13 | 23.91 | 3.72 | 4.27 |

A two-step TGA weight loss of 5.1% up to 130° C. and 4.0% between 130° C. and 230° C. as depicted in FIG. 27.

A DSC plot for Form U showed three endotherms at 66.6° C., 85.2° C. (peak) and 179.0° C. (onset) as depicted in FIG. 27.

According to the stepwise weight loss and corresponding DSC signals, Form U was speculated to be a hydrate.

### Form O

Form O was obtained via heating Form J to 100° C. and cooling to 30° C. with N₂ protection. After exposure to ambient conditions Form O converted to Form J. The XRPD pattern of Form O of Compound 1 is shown in FIG. 28.

FIG. 28 provides an XRPD pattern of Form O of Compound 1. A list of X-Ray Diffraction Peaks for Form O of Compound 1 is provided below in Table 25.

TABLE 25
X-Ray Diffraction Peaks for Form O of Compound 1

| #Peak | 2θ [°] | d-spacing [Å] | Rel [%] |
|---|---|---|---|
| 1 | 4.54 | 19.43 | 7.71 |
| 2 | 4.77 | 18.52 | 8.22 |
| 3 | 5.44 | 16.24 | 9.71 |
| 4 | 5.75 | 15.35 | 7.28 |
| 5 | 6.30 | 14.03 | 14.14 |
| 6 | 7.81 | 11.32 | 15.62 |
| 7 | 8.17 | 10.81 | 2.84 |
| 8 | 8.50 | 10.40 | 10.33 |
| 9 | 9.12 | 9.69 | 42.92 |
| 10 | 9.63 | 9.18 | 1.89 |
| 11 | 10.20 | 8.66 | 4.37 |
| 12 | 10.94 | 8.08 | 15.09 |
| 13 | 11.59 | 7.63 | 7.27 |
| 14 | 12.71 | 6.96 | 16.65 |
| 15 | 13.54 | 6.54 | 5.37 |
| 16 | 13.71 | 6.45 | 7.47 |
| 17 | 14.57 | 6.08 | 4.22 |
| 18 | 15.72 | 5.63 | 59.55 |
| 19 | 16.53 | 5.36 | 3.69 |
| 20 | 17.51 | 5.06 | 5.18 |
| 21 | 18.04 | 4.91 | 25.11 |
| 22 | 18.40 | 4.82 | 20.35 |
| 23 | 18.47 | 4.80 | 17.46 |
| 24 | 19.17 | 4.63 | 100.00 |
| 25 | 19.47 | 4.56 | 11.53 |
| 26 | 19.83 | 4.47 | 7.41 |
| 27 | 20.32 | 4.37 | 6.68 |
| 28 | 20.56 | 4.32 | 17.33 |
| 29 | 20.88 | 4.25 | 9.35 |
| 30 | 21.16 | 4.19 | 10.04 |
| 31 | 21.75 | 4.08 | 14.75 |
| 32 | 22.05 | 4.03 | 8.21 |
| 33 | 22.80 | 3.89 | 4.02 |
| 34 | 23.09 | 3.85 | 8.52 |
| 35 | 23.40 | 3.80 | 6.28 |
| 36 | 23.76 | 3.74 | 4.94 |
| 37 | 24.63 | 3.61 | 8.82 |
| 38 | 24.84 | 3.58 | 11.83 |
| 39 | 25.288 | 3.52 | 9.43 |
| 40 | 27.19 | 3.28 | 9.81 |
| 41 | 27.79 | 3.21 | 16.98 |
| 42 | 28.02 | 3.18 | 6.36 |
| 43 | 30.23 | 2.95 | 4.71 |
| 44 | 31.81 | 2.81 | 9.32 |
| 45 | 33.78 | 2.65 | 2.75 |

As Form O could be obtained after heating to 130° C. and cooling to 30° C. with N₂ protection, it was speculated to be an anhydrate.

### Form Q

Form Q was obtained via heating Form D to 150° C. and cooling to 30° C. with N₂ protection. After exposure to ambient conditions Form Q converted to Form D. The XRPD pattern of Form Q of Compound 1 is shown in FIG. 29.

FIG. 29 provides an XRPD pattern of Form Q of Compound 1. A list of X-Ray Diffraction Peaks for Form Q of Compound 1 is provided below in Table 26.

TABLE 26
X-Ray Diffraction Peaks for Form Q of Compound 1

| #Peak | 2θ [°] | d-spacing [Å] | Rel [%] |
|---|---|---|---|
| 1 | 4.46 | 19.78 | 24.97 |
| 2 | 4.47 | 19.78 | 12.49 |
| 3 | 6.68 | 13.23 | 100.00 |
| 4 | 6.69 | 13.23 | 50.00 |
| 5 | 8.91 | 9.92 | 34.73 |
| 6 | 8.93 | 9.92 | 17.36 |
| 7 | 10.70 | 8.26 | 6.84 |
| 8 | 10.73 | 8.26 | 3.42 |
| 9 | 11.16 | 7.92 | 1.95 |
| 10 | 11.18 | 7.92 | 0.97 |
| 11 | 12.43 | 7.12 | 2.94 |
| 12 | 12.46 | 7.12 | 1.47 |
| 13 | 15.31 | 5.78 | 14.47 |
| 14 | 15.35 | 5.78 | 7.24 |
| 15 | 15.62 | 5.67 | 30.37 |
| 16 | 15.66 | 5.67 | 15.19 |
| 17 | 16.09 | 5.50 | 7.96 |
| 18 | 16.13 | 5.50 | 3.98 |
| 19 | 16.87 | 5.25 | 12.64 |
| 20 | 16.91 | 5.25 | 6.32 |
| 21 | 16.98 | 5.22 | 8.05 |
| 22 | 17.02 | 5.22 | 4.02 |
| 23 | 17.88 | 4.96 | 27.72 |
| 24 | 17.93 | 4.96 | 13.86 |
| 25 | 18.12 | 4.89 | 10.54 |
| 26 | 18.17 | 4.89 | 5.27 |
| 27 | 18.81 | 4.71 | 5.88 |
| 28 | 18.86 | 4.71 | 2.94 |
| 29 | 19.48 | 4.55 | 1.79 |
| 30 | 19.53 | 4.55 | 0.89 |
| 31 | 20.15 | 4.40 | 9.83 |
| 32 | 20.20 | 4.40 | 4.92 |
| 33 | 20.98 | 4.23 | 10.59 |
| 34 | 21.03 | 4.23 | 5.29 |
| 35 | 22.68 | 3.92 | 4.17 |
| 36 | 22.74 | 3.92 | 2.09 |
| 37 | 25.68 | 3.47 | 5.76 |
| 38 | 25.75 | 3.47 | 2.88 |
| 39 | 26.05 | 3.42 | 11.02 |
| 40 | 26.12 | 3.42 | 5.51 |
| 41 | 27.63 | 3.23 | 4.75 |
| 42 | 27.70 | 3.23 | 2.38 |

As Form Q could be obtained after heating to 150° C. and cooling to 30° C. with N₂ protection, it was speculated to be an anhydrate.

### Form R

Form R was obtained via N₂ sweeping Form E at 30° C. for 20 min. After exposure to ambient conditions Form Q converted to Form D. The XRPD pattern of Form R of Compound 1 is shown in FIG. 30.

FIG. 30 provides an XRPD pattern of Form R of Compound 1. A list of X-Ray Diffraction Peaks for Form R of Compound 1 is provided below in Table 27.

TABLE 27
X-Ray Diffraction Peaks for Form R of Compound 1

| #Peak | 2θ [°] | d-spacing [Å] | Rel [%] |
|---|---|---|---|
| 1 | 4.33 | 20.40 | 2.50 |
| 2 | 6.47 | 13.65 | 41.02 |
| 3 | 6.91 | 12.78 | 1.56 |
| 4 | 8.62 | 10.25 | 100.00 |
| 5 | 10.87 | 8.13 | 6.83 |
| 6 | 12.08 | 7.32 | 9.29 |
| 7 | 13.73 | 6.44 | 50.93 |
| 8 | 15.26 | 5.80 | 5.58 |
| 9 | 15.54 | 5.70 | 12.79 |
| 10 | 15.87 | 5.58 | 6.36 |
| 11 | 16.82 | 5.27 | 77.95 |
| 12 | 17.45 | 5.08 | 23.26 |
| 13 | 17.59 | 5.04 | 16.98 |
| 14 | 18.06 | 4.91 | 4.73 |
| 15 | 18.71 | 4.74 | 2.84 |
| 16 | 20.08 | 4.42 | 19.99 |
| 17 | 21.31 | 4.17 | 9.87 |
| 18 | 21.62 | 4.11 | 7.13 |
| 19 | 22.18 | 4.00 | 7.93 |
| 20 | 22.84 | 3.89 | 5.71 |
| 21 | 25.47 | 3.49 | 7.83 |
| 22 | 26.29 | 3.39 | 8.85 |
| 23 | 26.94 | 3.31 | 6.33 |
| 24 | 27.76 | 3.21 | 9.90 |
| 25 | 28.59 | 3.12 | 7.66 |
| 26 | 29.81 | 2.99 | 6.81 |
| 27 | 36.71 | 2.45 | 2.50 |
| 28 | 37.70 | 2.38 | 0.39 |

As Form R could be observed after heating to 130° C. and cooling to 30° C. with N₂ protection, it was speculated to be an anhydrate.

### Form T

Form T was obtained via heating Form N to 150° C. and cooling to 30° C. with N₂ protection. After exposure to ambient conditions, Form T converted to Form U. The XRPD pattern of Form T of Compound 1 is shown in FIG. 31.

FIG. 31 provides an XRPD pattern of Form T of Compound 1. A list of X-Ray Diffraction Peaks for Form T of Compound 1 is provided below in Table 28.

TABLE 28
X-Ray Diffraction Peaks for Form T of Compound 1

| #Peak | 2θ [°] | d-spacing [Å] | Rel [%] |
|---|---|---|---|
| 1 | 4.40 | 20.09 | 24.43 |
| 2 | 6.60 | 13.37 | 100.00 |
| 3 | 8.83 | 10.00 | 58.36 |
| 4 | 9.57 | 9.23 | 1.87 |
| 5 | 11.03 | 8.01 | 6.32 |
| 6 | 12.16 | 7.27 | 1.33 |
| 7 | 13.34 | 6.63 | 1.97 |
| 8 | 13.81 | 6.41 | 3.20 |
| 9 | 14.40 | 6.17 | 2.06 |
| 10 | 15.54 | 5.70 | 32.05 |
| 11 | 15.92 | 5.56 | 7.45 |
| 12 | 16.86 | 5.25 | 2.44 |
| 13 | 17.26 | 5.13 | 3.47 |
| 14 | 17.79 | 4.98 | 31.92 |
| 15 | 18.80 | 4.73 | 2.25 |
| 16 | 19.24 | 4.61 | 3.83 |
| 17 | 20.07 | 4.42 | 9.39 |
| 18 | 21.18 | 4.19 | 3.28 |
| 19 | 21.56 | 4.12 | 3.06 |
| 20 | 22.18 | 4.00 | 3.34 |
| 21 | 25.97 | 3.43 | 7.99 |
| 22 | 27.15 | 3.28 | 7.20 |

As Form T could be obtained after heating to 150° C. and cooling to 30° C. with N₂ protection, it was speculated to be an anhydrate.

### Form W

Form W was obtained via heating Form L to 150° C. and cooling to 30° C. with N₂ protection, followed by exposure to ambient conditions for 30 min. The XRPD pattern, TGA and DSC of Form W of Compound 1 are shown in FIGS. 32-33.

FIG. 32 provides an XRPD pattern of Form W of Compound 1. A list of X-Ray Diffraction Peaks for Form W of Compound 1 is provided below in Table 29.

TABLE 29
X-Ray Diffraction Peaks for Form W of Compound 1

| #Peak | 2θ [°] | d-spacing [Å] | Rel [%] |
|---|---|---|---|
| 1 | 4.30 | 20.65 | 19.10 |
| 2 | 4.47 | 19.75 | 34.93 |
| 3 | 6.33 | 13.95 | 23.93 |
| 4 | 6.70 | 13.18 | 82.94 |
| 5 | 8.42 | 10.50 | 21.55 |
| 6 | 8.92 | 9.91 | 100.00 |
| 7 | 10.52 | 8.40 | 12.34 |
| 8 | 11.14 | 7.94 | 14.46 |
| 9 | 12.20 | 7.22 | 5.12 |
| 10 | 12.67 | 6.98 | 13.13 |
| 11 | 13.42 | 6.59 | 10.93 |
| 12 | 15.14 | 5.85 | 33.28 |
| 13 | 15.56 | 5.69 | 17.35 |
| 14 | 16.58 | 5.34 | 12.36 |
| 15 | 17.86 | 4.96 | 20.75 |
| 16 | 18.40 | 4.82 | 12.67 |
| 17 | 19.00 | 4.67 | 10.43 |
| 18 | 19.91 | 4.46 | 10.35 |
| 19 | 21.80 | 4.08 | 8.88 |
| 20 | 23.30 | 3.82 | 8.83 |
| 21 | 24.58 | 3.62 | 14.35 |
| 22 | 25.70 | 3.47 | 13.79 |
| 23 | 26.60 | 3.35 | 9.46 |
| 24 | 27.51 | 3.24 | 10.95 |
| 25 | 28.70 | 3.11 | 5.02 |
| 26 | 29.70 | 3.01 | 6.55 |

A two-step TGA weight loss of 6.0% up to 130° C. and 4.7% between 130° C. and 230° C. as depicted in FIG. 33.

A DSC plot for Form W showed two endotherms at 75.3° C. (peak) and 180.2° C. (onset) as depicted in FIG. 33.

As Form W could be obtained after heating to 150° C. and cooling to 30° C. with N₂ protection, it was speculated to be an anhydrate. The first stepwise weight loss and endotherm might be caused by removal of the surface-adsorbed water.

### Form H

Form H was obtained via adding anti-solvent 1,4-dioxane into MeOH/DCM (1:1, v/v) solution of Form D. The XRPD pattern, TGA, DSC and ¹H NMR, of Form H of Compound 1 are shown in FIGS. 34-36 Form H of Compound 1.

FIG. 34 provides an XRPD pattern of Form H of Compound 1. A list of X-Ray Diffraction Peaks for Form H of Compound 1 is provided below in Table 30.

TABLE 30
X-Ray Diffraction Peaks for Form H of Compound 1

| #Peak | 2θ [°] | d-spacing [Å] | Rel [%] |
|---|---|---|---|
| 1 | 4.05 | 21.78 | 15.60 |
| 2 | 6.06 | 14.57 | 100.00 |
| 3 | 7.96 | 11.10 | 36.11 |
| 4 | 10.97 | 8.06 | 21.99 |
| 5 | 12.70 | 6.96 | 4.69 |
| 6 | 15.51 | 5.71 | 22.77 |
| 7 | 18.89 | 4.69 | 11.57 |
| 8 | 21.30 | 4.16 | 5.60 |
| 9 | 22.94 | 3.87 | 31.22 |
| 10 | 24.97 | 3.56 | 6.07 |
| 11 | 26.17 | 3.40 | 11.97 |
| 12 | 27.18 | 3.28 | 7.97 |
| 13 | 29.31 | 3.04 | 16.63 |
| 14 | 30.90 | 2.89 | 6.03 |

A two-step TGA weight loss of 5.5% up to 110° C. and 4.8% between 110° C. and 220° C. as depicted in FIG. 35.

A DSC plot for Form H showed three endotherms at 46.0° C., 112.4° C. (peak) and 193.1° C. (onset) as depicted in FIG. 35.

Form H ¹H NMR is depicted in FIG. 36. The molar ratio of residual 1,4-dioxane/API was about 0.3:1 (the corresponding TGA weight loss was 3.4%).

The stoichiometric ratio of Na⁺/API was 1.0:1 by HPLC/IC.

Form H was likely to be a solvate according to the stepwise weight loss, DSC endotherm before melting and ¹H NMR result.

### Form N

Form N was obtained via adding anti-solvent 1,4-dioxane into MeOH/DCM (1:1, v/v) solution of Form D. The XRPD pattern, TGA, DSC, and ¹H NMR of Form N of Compound 1 are shown in FIGS. 37-39.

FIG. 37 provides an XRPD pattern of Form N of Compound 1. A list of X-Ray Diffraction Peaks for Form N of Compound 1 is provided below in Table 31.

TABLE 31
X-Ray Diffraction Peaks for Form N of Compound 1

| #Peak | 2θ [°] | d-spacing [Å] | Rel [%] |
|---|---|---|---|
| 1 | 4.15 | 21.27 | 17.13 |
| 2 | 6.23 | 14.19 | 100.00 |
| 3 | 10.47 | 8.44 | 11.65 |
| 4 | 12.32 | 7.18 | 27.65 |
| 5 | 14.36 | 6.16 | 20.30 |
| 6 | 19.70 | 4.50 | 7.06 |
| 7 | 21.30 | 4.18 | 7.89 |
| 8 | 23.30 | 3.81 | 14.03 |
| 9 | 25.30 | 3.52 | 6.65 |
| 10 | 26.70 | 3.33 | 6.61 |

A two-step TGA weight loss of 7.7% up to 150° C. and 5.5% between 150° C. and 220° C. as depicted in FIG. 38.

A DSC plot for Form N showed two endotherms at 87.9° C. and 190.0° C. (peak), and an exotherm at 113.5° C. (peak) as depicted in FIG. 38.

A molar ratio of residual 1,4-dioxane/API was 0.2:1 (the corresponding TGA weight loss was 2.7%) as seen in Form N ¹H NMR as depicted in FIG. 39.

The stoichiometric ratio of Na⁺/API was 1.1:1 by HPLC/IC.

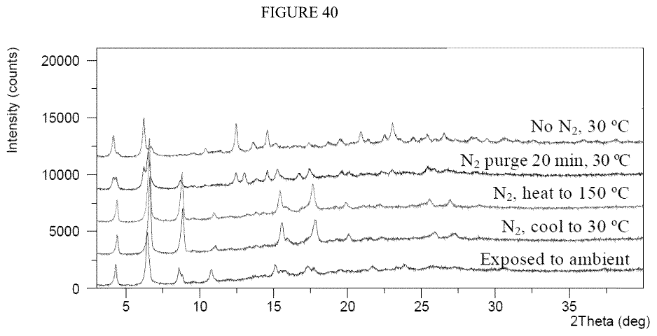

A VT-XRPD overlay of Compound 1 Form N is shown in FIG. 40.

A form change was observed after N₂ sweeping Form N for 20 min at 30° C., the new form was Form S. After heating to 150° C. and cooling to 30° C. with N₂ protection, Form T was obtained. After exposure to ambient conditions, Form U was obtained. Based on the above date, Form N was speculated to be a solvate.

### Form X

Form X was obtained after slurrying the mixture of Forms D/E/J in MeOH (aw˜0) for 3 days (wet sample). After exposure to ambient conditions, Form T converted to Form U. The XRPD pattern of Form X of Compound 1 is shown in FIG. 41.

A list of X-Ray Diffraction Peaks for Form X of Compound 1 is provided below in Table 32.

TABLE 32
X-Ray Diffraction Peaks for Form X of Compound 1

| #Peak | 2θ [°] | d-spacing [Å] | Rel [%] |
|---|---|---|---|
| 1 | 4.90 | 17.98 | 4.59 |
| 2 | 5.50 | 16.05 | 44.65 |
| 3 | 6.41 | 13.78 | 16.83 |
| 4 | 7.86 | 11.24 | 7.91 |
| 5 | 8.25 | 10.71 | 25.02 |
| 6 | 8.58 | 10.29 | 12.91 |
| 7 | 9.25 | 9.55 | 5.18 |
| 8 | 11.00 | 8.03 | 18.56 |
| 9 | 12.86 | 6.88 | 12.26 |
| 10 | 13.64 | 6.48 | 3.66 |
| 11 | 15.82 | 5.60 | 11.93 |
| 12 | 16.57 | 5.35 | 10.98 |
| 13 | 18.13 | 4.89 | 5.94 |
| 14 | 19.16 | 4.63 | 85.55 |
| 15 | 19.75 | 4.49 | 100.00 |
| 16 | 20.18 | 4.40 | 9.46 |
| 17 | 20.52 | 4.32 | 7.38 |
| 18 | 20.90 | 4.25 | 23.41 |
| 19 | 21.14 | 4.20 | 33.79 |
| 20 | 21.62 | 4.11 | 19.38 |
| 21 | 21.97 | 4.04 | 40.67 |
| 22 | 22.34 | 3.98 | 12.32 |
| 23 | 22.56 | 3.94 | 36.67 |
| 24 | 23.03 | 3.86 | 18.67 |
| 25 | 23.37 | 3.80 | 15.54 |
| 26 | 24.17 | 3.68 | 15.97 |
| 27 | 24.51 | 3.63 | 49.35 |
| 28 | 24.74 | 3.60 | 20.32 |
| 29 | 25.28 | 3.52 | 26.43 |
| 30 | 26.00 | 3.42 | 19.44 |
| 31 | 26.33 | 3.38 | 13.56 |
| 32 | 26.91 | 3.31 | 15.30 |
| 33 | 27.15 | 3.28 | 8.45 |
| 34 | 28.20 | 3.16 | 5.52 |
| 35 | 28.69 | 3.11 | 8.43 |
| 36 | 28.91 | 3.09 | 8.97 |
| 37 | 29.29 | 3.05 | 14.25 |
| 38 | 29.98 | 2.98 | 5.25 |
| 39 | 34.40 | 2.60 | 5.12 |

After drying at RT, Form X converted to a new form, Form Y.

Form X was likely to be a MeOH solvate.

### Form F

Form F was obtained via slurry of Form D in MeOH at RT. The XRPD pattern, TGA, DSC, and ¹H NMR of Form F of Compound 1 are shown in FIGS. 42-44.

FIG. 42 provides an XRPD pattern of Form F of Compound 1. A list of X-Ray Diffraction Peaks for Form F of Compound 1 is provided below in Table 33.

TABLE 33
X-Ray Diffraction Peaks for Form F of Compound 1

| #Peak | 2θ [°] | d-spacing [Å] | Rel [%] |
|---|---|---|---|
| 1 | 4.27 | 20.66 | 21.45 |
| 2 | 5.35 | 16.50 | 57.31 |
| 3 | 7.78 | 11.36 | 11.25 |
| 4 | 8.53 | 10.36 | 12.55 |
| 5 | 9.13 | 9.68 | 51.28 |
| 6 | 10.66 | 8.29 | 100.00 |
| 7 | 11.97 | 7.39 | 11.27 |
| 8 | 13.00 | 6.78 | 12.28 |
| 9 | 14.26 | 6.21 | 27.83 |
| 10 | 15.60 | 5.69 | 13.67 |
| 11 | 15.99 | 5.54 | 13.86 |
| 12 | 17.55 | 5.05 | 17.41 |
| 13 | 18.28 | 4.85 | 24.00 |
| 14 | 19.61 | 4.52 | 47.28 |
| 15 | 21.78 | 4.08 | 18.07 |

A two-step TGA weight loss of 7.0% up to 120° C. and 4.7% between 120° C. and 220° C. as depicted in FIG. 43.

A DSC plot for Form F showed three endotherms at 110.4° C., 173.2° C. and 180.7° C. (peak) as depicted in FIG. 43.

No solvent was detected in ¹H NMR of Form F as depicted in FIG. 44.

The stoichiometric ratio of Na⁺/API was 0.9:1 by HPLC/IC.

Based on the results, Form F was likely to be a hydrate or hygroscopic anhydrate.

### Form G

Form G was obtained via slurry of Form D in EtOH at 50° C. The XRPD pattern, TGA, DSC and ¹H NMR of Form G of Compound 1 are shown in FIGS. 45-47.

FIG. 45 provides an XRPD pattern of Form G of Compound 1. A list of X-Ray Diffraction Peaks for Form G of Compound 1 is provided below in Table 34.

TABLE 34
X-Ray Diffraction Peaks for Form G of Compound 1

| #Peak | 2θ [°] | d-spacing [Å] | Rel [%] |
|---|---|---|---|
| 1 | 6.95 | 12.71 | 26.88 |
| 2 | 10.08 | 8.77 | 46.75 |
| 3 | 12.39 | 7.14 | 48.94 |
| 4 | 13.89 | 6.37 | 100.00 |
| 5 | 15.40 | 5.75 | 26.55 |
| 6 | 20.50 | 4.32 | 21.51 |
| 7 | 22.10 | 4.02 | 24.32 |
| 8 | 24.10 | 3.69 | 13.74 |

A two-step TGA weight loss of 4.3% up to 120° C. and 4.2% between 120° C. and 220° C. as depicted in FIG. 46.

A DSC plot for Form G showed three endotherms at 60.5° C., 119.2° C. (peak) and 181.2° C. (onset) as depicted in FIG. 46.

No residual solvent (EtOH) was detected in Form G ¹H NMR as depicted in FIG. 47.

The stoichiometric ratio of Na⁺/API was 0.9:1 by HPLC/IC.

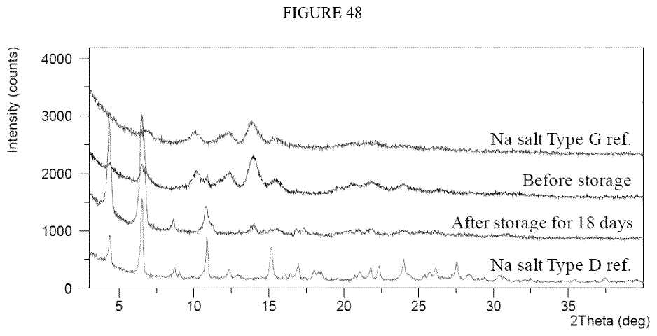

Another batch of Compound 1 Form G was obtained in a slurry of Form D in EtOH at RT, with addition of polymer mixture A (polyvinyl pyrrolidone (PVP), polyvinyl alcohol (PVA), polyvinylchloride (PVC), polyvinyl acetate (PVAC), hypromellose (HPMC), methyl cellulose (MC) (mass ratio of 1:1:1:1:1:1)). Peaks of Form D could be observed after storing Form G sample under ambient conditions for 17 days, and overlay XRPD of Forms G, before storage, after storage for 18 days and Form D is displayed in FIG. 48. As a result, Form G was a metastable form at ambient temperature.

### Form I

Form I was obtained via adding anti-solvent ACN into THF/H₂O (1:1, v/v) solution of Form D. The XRPD pattern, TGA, DSC and ¹H NMR of Form I of Compound 1 are shown in FIGS. 49-51.

FIG. 49 provides an XRPD pattern of Form I of Compound 1. A list of X-Ray Diffraction Peaks for Form I of Compound 1 is provided below in Table 35.

TABLE 35
X-Ray Diffraction Peaks for Form I of Compound 1

| #Peak | 2θ [°] | d-spacing [Å] | Rel [%] |
|---|---|---|---|
| 1 | 6.98 | 12.65 | 94.48 |
| 2 | 9.29 | 9.51 | 25.74 |
| 3 | 10.40 | 8.49 | 3.92 |
| 4 | 11.62 | 7.61 | 100.00 |
| 5 | 12.40 | 7.12 | 8.44 |
| 6 | 13.77 | 6.43 | 11.72 |
| 7 | 16.23 | 5.46 | 10.05 |
| 8 | 21.94 | 4.05 | 12.57 |
| 9 | 23.40 | 3.80 | 14.38 |
| 10 | 24.40 | 3.65 | 12.47 |

A two-step TGA weight loss of 11.5% up to 120° C. and 5.3% between 120° C. and 220° C. as depicted in FIG. 50.

A DSC plot for Form I showed three endotherms at 71.7° C., 110.1° C. (peak) and 182.9° C. (onset) as depicted in FIG. 50.

No residual solvent (ACN or THF) was detected in Form I ¹H NMR as depicted in FIG. 51.

The stoichiometric ratio of Na⁺/API was 1.0:1 by HPLC/IC.

Based on the results, Form I was likely to be a hydrate or hygroscopic anhydrate.

### Form K

Form K was obtained via solid vapor diffusion of Form D in IPA atmosphere. After storing under ambient conditions for 17 days, Form K converted to Form D. An overlay of XRPD patterns is displayed in FIG. 52. A list of X-Ray Diffraction Peaks for Form K of Compound 1 is provided below in Table 36.

TABLE 36
X-Ray Diffraction Peaks for Form K of Compound 1

| #Peak | 2θ [°] | d-spacing [Å] | Rel [%] |
|---|---|---|---|
| 1 | 4.56 | 19.38 | 100.00 |
| 2 | 5.61 | 15.74 | 13.38 |
| 3 | 9.09 | 9.72 | 12.56 |
| 4 | 13.73 | 6.44 | 23.44 |
| 5 | 18.23 | 4.86 | 21.81 |

### Form M

Form M was obtained via slow cooling of ACN/H₂O (1:1, v/v) solution from 50° C. to 5° C., followed by evaporation at RT. The XRPD pattern, TGA, DSC and ¹H NMR of Form I of Compound 1 are shown in FIGS. 53-55.

FIG. 53 provides an XRPD pattern of Form M of Compound 1. A list of X-Ray Diffraction Peaks for Form M of Compound 1 is provided below in

TABLE 37

| #Peak | 2θ [°] | d-spacing [Å] | Rel [%] |
|---|---|---|---|
| 1 | 5.16 | 17.13 | 100.00 |
| 2 | 6.49 | 13.61 | 11.40 |
| 3 | 7.76 | 11.39 | 56.45 |
| 4 | 10.34 | 8.55 | 13.59 |

A two-step TGA weight loss of 8.0% up to 120° C. and 4.5% between 120° C. and 220° C. as depicted in FIG. 54.

A DSC plot for Form M showed two endotherms at 92.4° C. (peak) and 152.4° C. (onset) as depicted in FIG. 54.

No residual solvent (ACN) was detected in Form M ¹H NMR as depicted in FIG. 55.

The stoichiometric ratio of Na⁺/API was 0.9:1 by HPLC/IC.

Based on the results, Form M was likely to be a hydrate or hygroscopic anhydrate.

### Form P

Form P was obtained via N₂ sweeping Form D at 30° C. for 20 min. An XRPD pattern for Form P is displayed in FIG. 56. A list of X-Ray Diffraction Peaks for Form P of Compound 1 is provided below in Table 38.

TABLE 38
X-Ray Diffraction Peaks for Form P of Compound 1

| #Peak | 2θ [°] | d-spacing [Å] | Rel [%] |
|---|---|---|---|
| 1 | 4.36 | 20.27 | 22.68 |
| 2 | 6.51 | 13.57 | 100.00 |
| 3 | 8.70 | 10.16 | 18.77 |
| 4 | 10.69 | 8.27 | 8.87 |
| 5 | 12.34 | 7.17 | 3.20 |
| 6 | 12.90 | 6.86 | 3.82 |
| 7 | 13.61 | 6.50 | 1.31 |
| 8 | 15.20 | 5.83 | 25.85 |
| 9 | 16.11 | 5.50 | 5.39 |
| 10 | 16.50 | 5.38 | 2.94 |
| 11 | 16.75 | 5.29 | 11.18 |
| 12 | 17.08 | 5.19 | 4.34 |
| 13 | 17.49 | 5.07 | 13.76 |
| 14 | 18.01 | 4.92 | 19.48 |
| 15 | 18.64 | 4.76 | 8.18 |
| 16 | 20.06 | 4.42 | 5.51 |
| 17 | 20.84 | 4.26 | 7.13 |
| 18 | 21.60 | 4.11 | 5.37 |
| 19 | 22.27 | 3.99 | 4.05 |
| 20 | 24.18 | 3.68 | 3.83 |
| 21 | 25.80 | 3.45 | 9.25 |
| 22 | 26.14 | 3.41 | 11.48 |
| 23 | 26.92 | 3.31 | 2.88 |
| 24 | 27.48 | 3.24 | 6.01 |

### Form S

Form S was obtained via N₂ sweeping Form N at 30° C. for 20 min. An XRPD pattern for Form S is displayed in FIG. 57. A list of X-Ray Diffraction Peaks for Form S of Compound 1 is provided below in Table 39.

TABLE 39
X-Ray Diffraction Peaks for Form S of Compound 1

| #Peak | 2θ [°] | d-spacing [Å] | Rel [%] |
|---|---|---|---|
| 1 | 4.13 | 21.39 | 28.89 |
| 2 | 4.32 | 20.44 | 28.25 |
| 3 | 6.19 | 14.26 | 54.20 |
| 4 | 6.48 | 13.63 | 100.00 |
| 5 | 8.66 | 10.20 | 20.41 |
| 6 | 9.42 | 9.38 | 4.15 |
| 7 | 9.62 | 9.19 | 4.02 |
| 8 | 10.36 | 8.54 | 3.68 |
| 9 | 11.07 | 7.98 | 5.16 |
| 10 | 12.44 | 7.11 | 30.71 |
| 11 | 13.02 | 6.79 | 30.26 |
| 12 | 13.79 | 6.41 | 9.95 |
| 13 | 14.52 | 6.09 | 28.48 |
| 14 | 15.19 | 5.83 | 29.50 |
| 15 | 16.70 | 5.30 | 17.49 |
| 16 | 17.38 | 5.10 | 26.54 |
| 17 | 18.30 | 4.85 | 2.86 |
| 18 | 18.70 | 4.74 | 5.91 |
| 19 | 19.59 | 4.53 | 15.39 |
| 20 | 20.05 | 4.43 | 11.68 |
| 21 | 20.86 | 4.26 | 6.78 |
| 22 | 21.40 | 4.15 | 6.72 |
| 23 | 22.23 | 4.00 | 9.98 |
| 24 | 22.88 | 3.88 | 7.95 |
| 25 | 24.04 | 3.70 | 6.00 |
| 26 | 25.41 | 3.50 | 21.69 |
| 27 | 25.82 | 3.45 | 14.77 |
| 28 | 26.74 | 3.33 | 12.70 |
| 29 | 28.66 | 3.11 | 6.73 |

### Form V

Form V was obtained via N₂ sweeping Form L at 30° C. for 20 min. An XRPD pattern for Form V is displayed in FIG. 58. A list of X-Ray Diffraction Peaks for Form V of Compound 1 is provided below in Table 40.

TABLE 40
X-Ray Diffraction Peaks for Form V of Compound 1

| #Peak | 2θ [°] | d-spacing [Å] | Rel [%] |
|---|---|---|---|
| 1 | 5.10 | 17.33 | 2.06 |
| 2 | 6.73 | 13.12 | 5.16 |
| 3 | 7.65 | 11.55 | 11.26 |
| 4 | 9.95 | 8.88 | 8.02 |
| 5 | 10.22 | 8.65 | 8.21 |
| 6 | 10.59 | 8.34 | 2.38 |
| 7 | 11.79 | 7.50 | 27.75 |
| 8 | 12.81 | 6.91 | 100.00 |
| 9 | 13.37 | 6.62 | 14.29 |
| 10 | 14.27 | 6.20 | 57.22 |
| 11 | 15.24 | 5.81 | 10.42 |
| 12 | 16.24 | 5.45 | 36.26 |
| 13 | 17.40 | 5.10 | 2.53 |
| 14 | 18.00 | 4.92 | 47.04 |
| 15 | 18.37 | 4.83 | 27.62 |
| 16 | 20.01 | 4.43 | 15.14 |
| 17 | 20.30 | 4.37 | 10.43 |
| 18 | 20.61 | 4.31 | 42.52 |
| 19 | 21.36 | 4.16 | 21.29 |
| 20 | 21.88 | 4.06 | 5.92 |
| 21 | 22.61 | 3.93 | 7.32 |
| 22 | 22.96 | 3.87 | 8.23 |
| 23 | 24.15 | 3.68 | 25.93 |
| 24 | 24.81 | 3.59 | 7.89 |
| 25 | 25.34 | 3.51 | 8.24 |
| 26 | 25.88 | 3.44 | 18.30 |
| 27 | 26.59 | 3.35 | 27.58 |
| 28 | 26.82 | 3.32 | 21.53 |
| 29 | 27.41 | 3.25 | 6.03 |
| 30 | 28.95 | 3.08 | 11.59 |
| 31 | 30.57 | 2.92 | 3.13 |
| 32 | 31.60 | 2.83 | 2.14 |
| 33 | 32.88 | 2.72 | 4.64 |
| 34 | 35.39 | 2.53 | 8.61 |
| 35 | 38.37 | 2.34 | 4.62 |
| 36 | 39.35 | 2.29 | 7.58 |

### Form Y

Form Y was obtained after slurry the mixture of Forms D/E/J in MeOH (aw˜0) for 3 days and drying at RT. after slurry the mixture of Forms D/E/J in MeOH (aw˜0) for 3 days and drying at RTAn XRPD pattern for Form Y is displayed in FIG. 59. A list of X-Ray Diffraction Peaks for Form Y of Compound 1 is provided below in Table 41.

TABLE 41
X-Ray Diffraction Peaks for Form Y of Compound 1

| #Peak | 2θ [°] | d-spacing [Å] | Rel [%] |
|---|---|---|---|
| 1 | 4.68 | 18.88 | 16.78 |
| 2 | 4.91 | 17.99 | 6.21 |
| 3 | 5.91 | 14.94 | 8.51 |
| 4 | 6.44 | 13.71 | 2.14 |
| 5 | 7.92 | 11.16 | 6.92 |
| 6 | 9.31 | 9.49 | 96.82 |
| 7 | 10.01 | 8.83 | 6.78 |
| 8 | 11.78 | 7.51 | 6.97 |
| 9 | 13.71 | 6.46 | 3.45 |
| 10 | 13.94 | 6.35 | 7.74 |
| 11 | 14.78 | 5.99 | 5.48 |
| 12 | 15.86 | 5.59 | 16.12 |
| 13 | 17.71 | 5.00 | 3.99 |
| 14 | 18.26 | 4.85 | 11.16 |
| 15 | 18.67 | 4.75 | 16.06 |
| 16 | 19.41 | 4.57 | 100.00 |
| 17 | 20.10 | 4.41 | 2.56 |
| 18 | 20.54 | 4.32 | 3.67 |
| 19 | 21.94 | 4.05 | 7.98 |
| 20 | 23.23 | 3.83 | 2.83 |
| 21 | 24.07 | 3.69 | 2.98 |
| 22 | 27.49 | 3.24 | 2.25 |
| 23 | 28.09 | 3.17 | 12.29 |
| 24 | 28.60 | 3.12 | 1.45 |
| 25 | 31.96 | 2.80 | 1.68 |

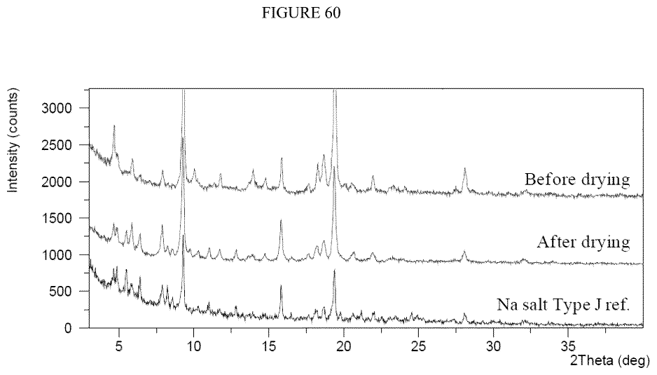

After drying at 50° C. under vacuum for about 4 hrs, Form J was obtained. An overlay of XRPD of Form Y of Compound 1 before and after drying, and reference Form J is shown in FIG. 60.

### 6.2.5 Inter-Conversion Relationship Studies

### Inter-Conversion Relationship Studies in Acetone/H₂O

Inter-conversion relationship study of forms D, E and J was performed in Acetone/H₂O systems with different water activity (aw=0, 0.2, 0.4, 0.6, 0.8 and 1.0). Detailed procedure are as follows.

1) Form D was used to saturate the corresponding solvent systems with different water activity (aw-0, 0.2, 0.4, 0.6, 0.8, 1.0) before filtration to obtain a near-saturated solution at RT.

2) Equal amounts (about 5 mg each) of Form D, Form E, and Form J were weighed and then added into 1 mL of the prepared solution to form a suspension.

3) Magnetically stir at RT. Isolate residual solids for XRPD analysis.

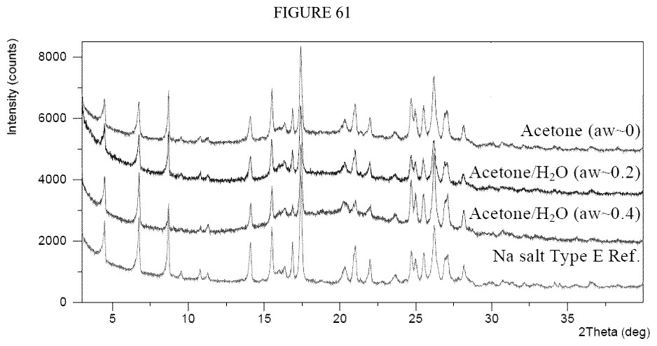

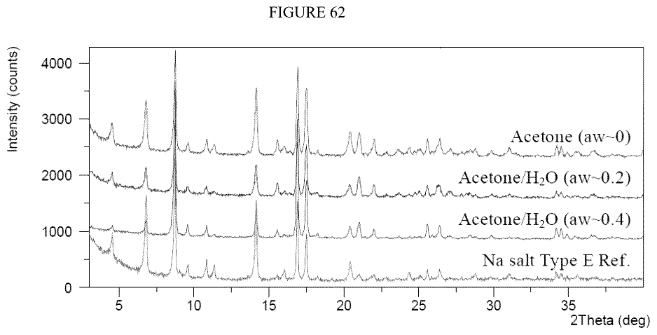

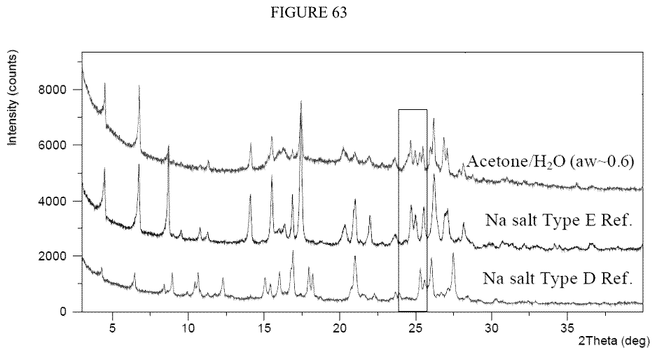

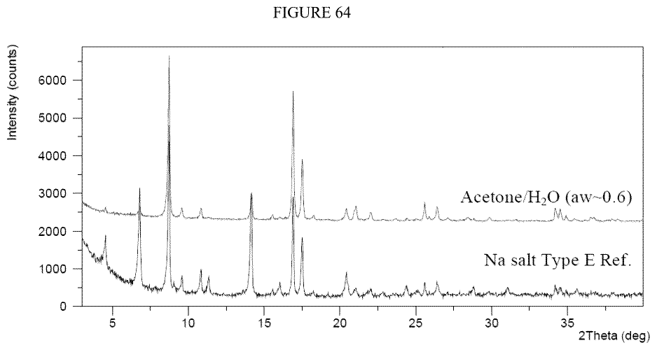

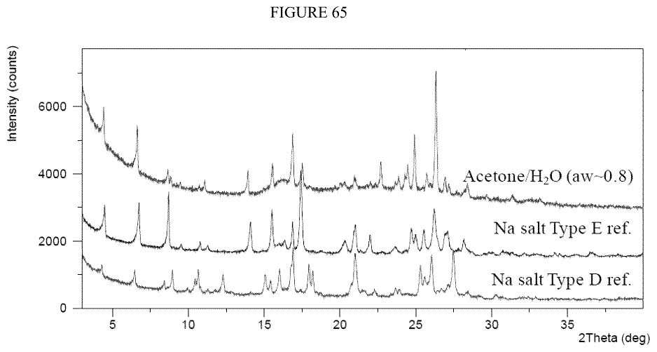

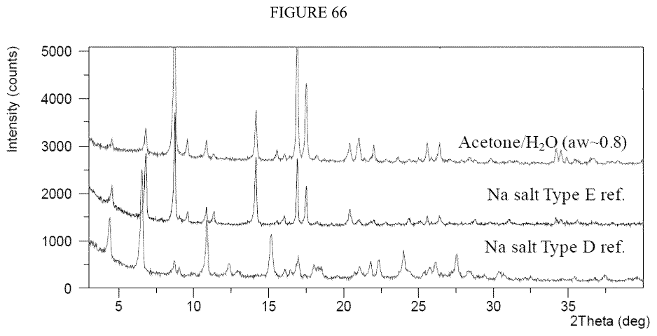

The results are summarized in Table 42. An overlay of XRPD comparison results are shown in FIGS. 61-67.

According to the results,

1) Form E was obtained after slurry a mixture of Forms D, E and J in Acetone/H₂O solvent systems with aw=0˜0.8 at RT for 6 days (dry sample) (FIGS. 61-66).

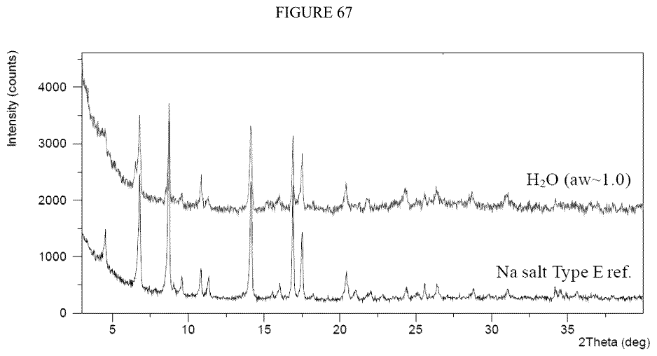

2) Form E was obtained after slurry Forms D, E and J in H₂O (aw=1.0) at RT for 36 days (dry sample) (FIG. 67).

TABLE 42
Results of slurry competition experiment among Na salt Hits

| | | | Result | |
|---|---|---|---|---|
| Experiment | | | Wet | Dry |
| ID | Solvent (aw) | Time | sample | sample |
| 40-A1 | Acetone (aw~0) | 6 days | Form E | Form E |
| 40-A2 | Acetone/H₂O | | Form E | Form E |
| | (aw~0.2) | | | |
| 40-A3 | Acetone/H₂O | | Form E | Form E |
| | (aw~0.4) | | | |
| 40-A4 | Acetone/H₂O | | Form D + E | Form E |
| | (aw~0.6) | | | |
| 40-A5 | Acetone/H₂O | | Form E* | Form E |
| | (aw~0.8) | | | |
| 35-A6 | H₂O (aw = 1) | 36 days | — | Form E |

*A form similar with Form E was observed.

### Inter-Conversion Relationship Study in MeOH/H₂O

Inter-conversion relationship study of Forms D, E and J was performed in MeOH/H₂O systems with different water activity at room temperature. Detailed procedure are as follows.

1) Form D was used to saturate the MeOH/H₂O solvent systems with different water activity (aw˜0, 0.2, 0.4, 0.6, 0.8 and 1.0) before filtration to obtain a near-saturated solution at RT.

2) Equal amounts (about 5 mg each) of Forms D, E and J were weighed and then added into 1 mL of the prepared solution to form a suspension.

3) Magnetically stir at RT for 4 days. Isolate residual solids for XRPD analysis.

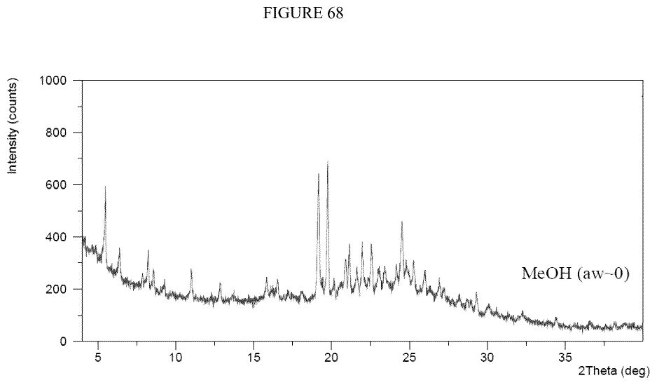

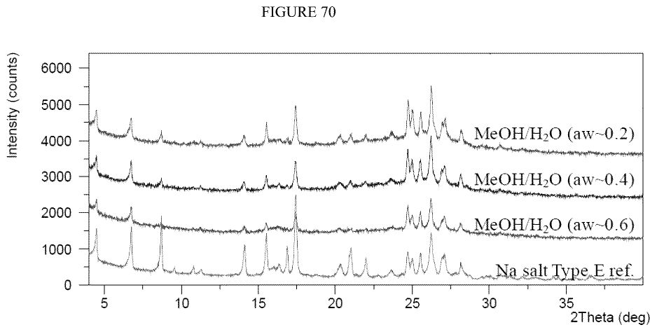

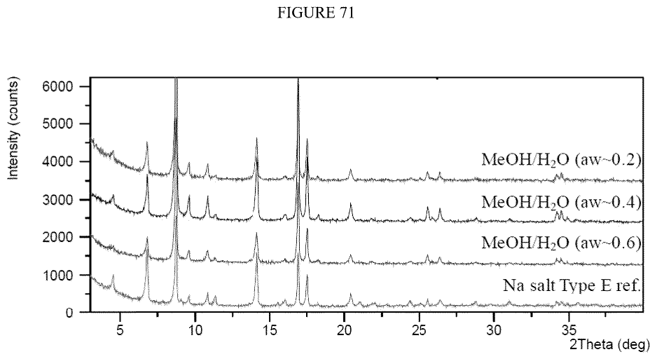

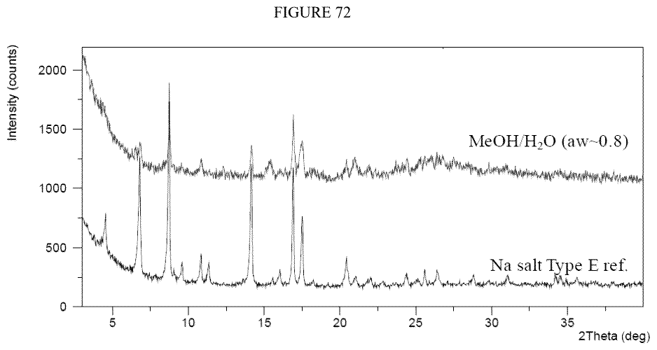

The results were summarized in Table 43. The XRPD comparison results are shown in FIGS. 68-72. According to the results,

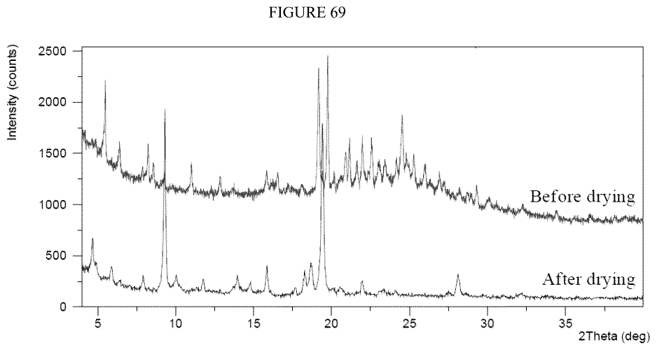

1) A new form, Form X, was obtained in MeOH (aw˜0) and converted to another new form, named as Form Y, after drying. An XRPD overlay is shown in FIG. 68 and FIG. 69. Based on the results, Form X, which might be a MeOH solvate, was obtained in MeOH (aw˜0), and converted to Form Y immediately after exposed to ambient condition.

2) Form E was obtained after slurry a mixture of Forms D, E and J in MeOH solvent systems with aw=0.2˜0.8 at RT, indicating Form E could be obtained when water activity aw≥0.2.

TABLE 43
Results of slurry competition experiment among Na salt forms

| | | | Result | |
|---|---|---|---|---|
| Experiment | | | Wet | Dry |
| ID | Solvent (aw) | Time | sample | sample |
| 35-A1 | MeOH (aw~0) | 3 days | Form X | Form Y |
| 35-A2 | MeOH/H₂O (aw~0.2) | 3 days | Form E | Form E |
| 35-A3 | MeOH/H₂O (aw~0.4) | 3 days | Form E | Form E |
| 35-A4 | MeOH/H₂O (aw~0.6) | 3 days | Form E | Form E |
| 35-A5 | MeOH/H₂O (aw~0.8) | 66 days | — | Form E |

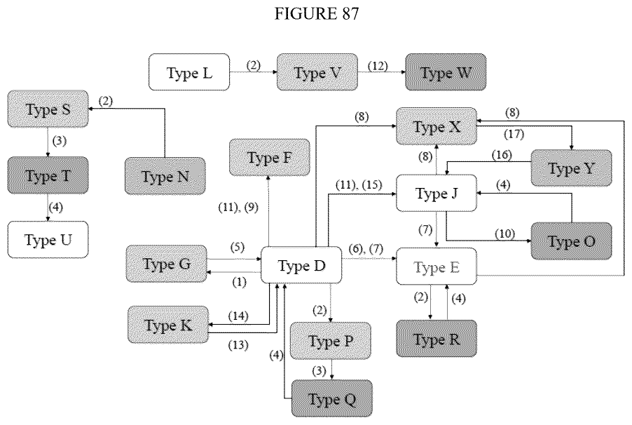

FIG. 87 provides an inter-conversion diagram of Compound 1 crystal forms, wherein steps (1)-(17) are as follows:
(1) Slurry in EtOH at 50° C.
(2) Sweeping N₂ at 30° C. for 20 min.
(3) Heating to 150° C. and cooling to 30° C. with N₂ protection.
(4) Exposed under ambient conditions.
(5) Stored under ambient conditions for 18 days.
(6) Slurry in MIBK at 50° C.
(7) Slurry competition in Acetone/H₂O (aw=0˜1) and MeOH/H₂O (aw=0.2˜0.8).
(8) Slurry competition in MeOH (aw=0) (wet sample).
(9) Slurry at MeOH at 50° C.
(10) Heating to 130° C. and cooling to 30° C. with N₂ protection.
(11) Slurry in MeOH at RT.
(12) Heating to 150° C. and cooling to 30° C. with N₂ protection, then exposed to ambient for 30 min.
(13) Stored under ambient conditions for 17 days.
(14) Solid vapor diffusion in IPA atmosphere.
(15) Solid vapor diffusion in MeOH atmosphere.
(16) Vacuum dry at 50° C. for 4 hrs.
(17) Dry under ambient conditions.

### 6.2.6 Evaluation of Na Salt Form D and Form E

According to the characterization and inter-conversion relationship study results of polymorphs of Compound 1, Form E was selected as the leading form for further evaluation, including kinetic solubility, hygroscopicity and solid state stability. In addition, Form D was also assessed for comparison.

### Kinetic Solubility

Kinetic solubility of Form D and Form E in water and bio-relevant media (SGF, FaSSIF and FeSSIF) at 37° C. was assessed. Detailed procedures are as follows.

1) Weigh approximate 80 mg of Form D and Form E into 3-mL glass vials. Add 1.6 mL of H₂O into each glass vial to form a suspension.

2) Weigh approximate 8 mg of Form D and Form E into 3-mL glass vials. Add 1.6 mL of the corresponding bio-relevant media (SGF, FaSSIF and FeSSIF) into each glass vial to form a suspension.

3) Cap the vials and keep the suspensions rolling at 37° C. (25 rpm). Sample at 1 and 24 hrs time point.

4) At each time point, about 0.8 mL of the suspension was extracted into a centrifugation tube, followed by centrifugation (˜10000 rpm, 37° C., 5 min) and filtration through PTFE membrane (0.45 μm pore size).

5) The supernatant was analyzed for HPLC solubility and pH, and the residual solids were used for XRPD analysis.

### Preparation of Bio-Relevant Media

### 1) SGF

a) Weigh 100 mg of NaCl and 50 mg of Triton X-100 into a 50-mL volumetric flask.

b) Add appropriate volume of purified water and sonicate until all solids are completely dissolved.

c) Add 68 μL of HCl (12 M) and sufficient purified water closely to the target volume and adjust to pH 1.8.

d) Dilute to volume with purified water.

### 2) FaSSIF

a) Weigh 170 mg of NaH₂PO₄, 21 mg of NaOH, 320 mg of NaCl and 110 mg of SIF powder into a 50-mL volumetric flask.

b) Add appropriate volume of purified water and sonicate until all solids are completely dissolved.

c) Add sufficient purified water closely to the target volume and adjust to pH 6.5.

d) Dilute to volume with purified water.

### 3) FeSSIF

a) Weigh 202 mg of NaOH, 594 mg of NaCl and 560 mg of SIF powder into a 50-mL volumetric flask.

b) Add 0.41 mL of glacial acetic acid.

c) Add appropriate volume of purified water and sonicate until all solids are completely dissolved.

d) Add sufficient purified water closely to the target volume and adjust to pH 5.0.

e) Dilute to volume with purified water.

Kinetic solubility results were summarized in Table 44.

TABLE 44
Results summary of kinetic solubility evaluation

| | | 1 hr | | | 24 hrs | | |
|---|---|---|---|---|---|---|---|
| | | Solubility | | Form | Solubility | | Form |
| Material | Media | (mg/mL) | pH | change | (mg/mL) | pH | change |
| Form D | H₂O | 35.44 | 4.9 | No | 35.91 | 5.1 | No |
| | SGF | 0.11 | 2.1 | Yes | 0.02 | 2.1 | Yes |
| | FaSSIF | 2.11 | 6.4 | No | 2.07 | 6.4 | No |
| | FeSSIF | 0.50 | 5.0 | No | 0.54 | 5.0 | No |
| Form E | H₂O | 45.34 | 4.8 | No | 44.53 | 5.0 | No |
| | SGF | 0.14 | 2.0 | No | 0.03 | 2.0 | No^{#} |
| | FaSSIF | 4.01 | 6.3 | No | 6.32* | 6.3 | No |
| | FeSSIF | 0.70 | 5.0 | No | 0.68 | 5.0 | No |

*Additional 8.4 mg of material was added after 1 hrs.
^{#}Additional 2 peaks were observed.

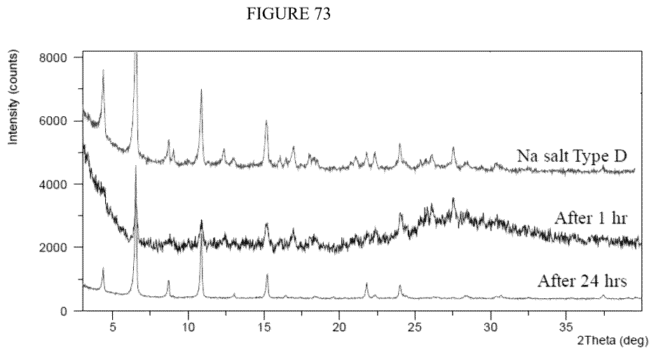

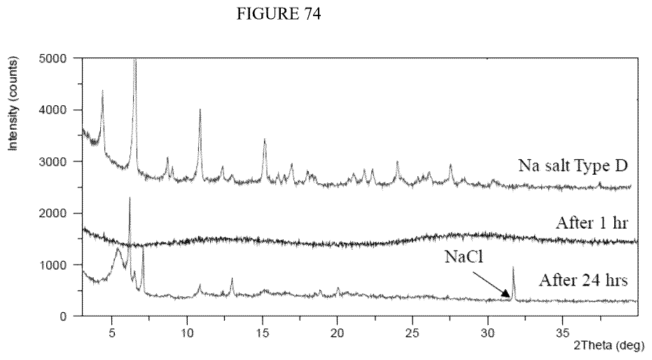

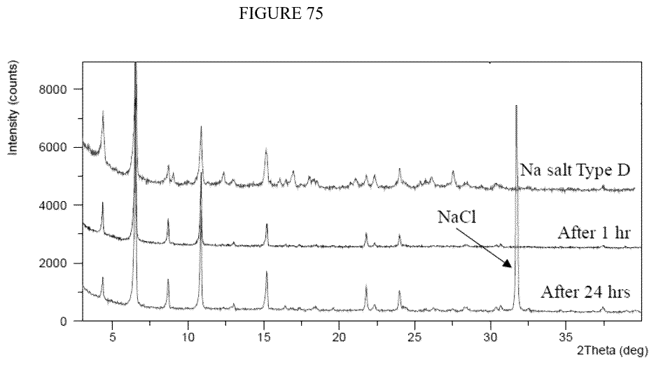

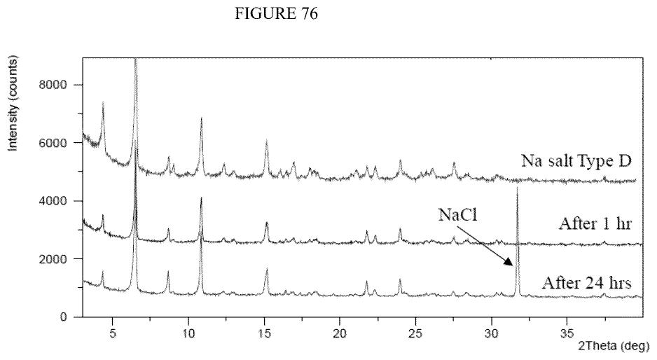

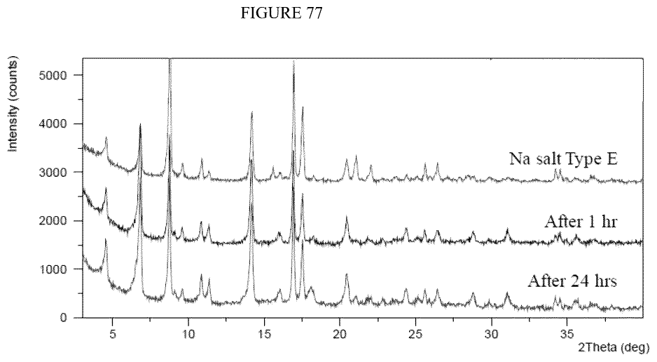

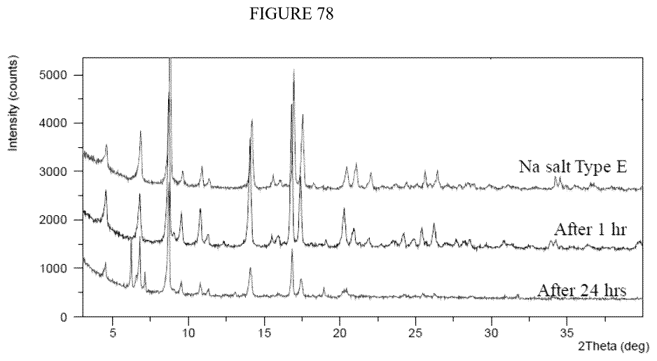

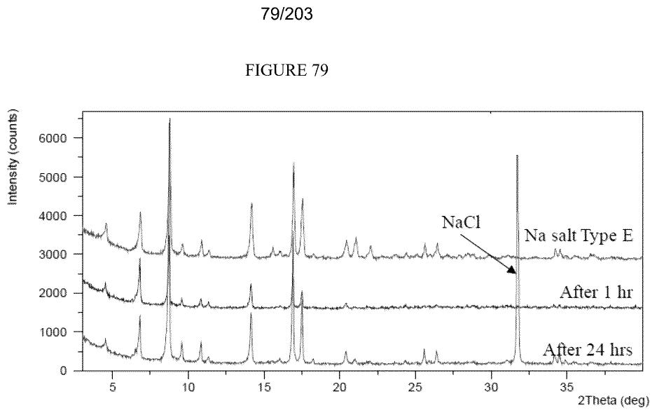

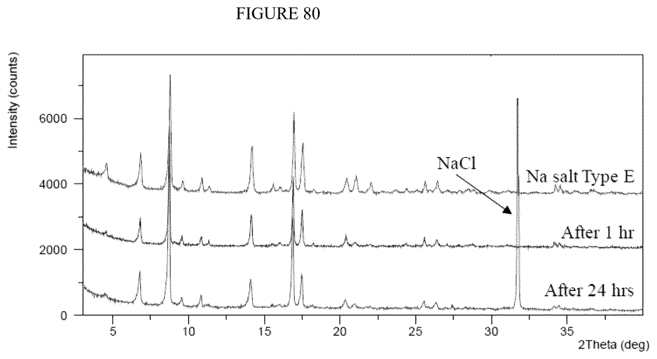

For both Form D and Form E, the highest solubility was observed in H₂O after 1 hr and 24 hrs. No form change was observed for Form D and Form E in all media, except Form D in SGF after 1 hr and 24 hrs. XRPD patterns of residual solids are displayed from FIGS. 73, 74, 75, 76, 77, 78, 79 and 80.

### Hygroscopicity

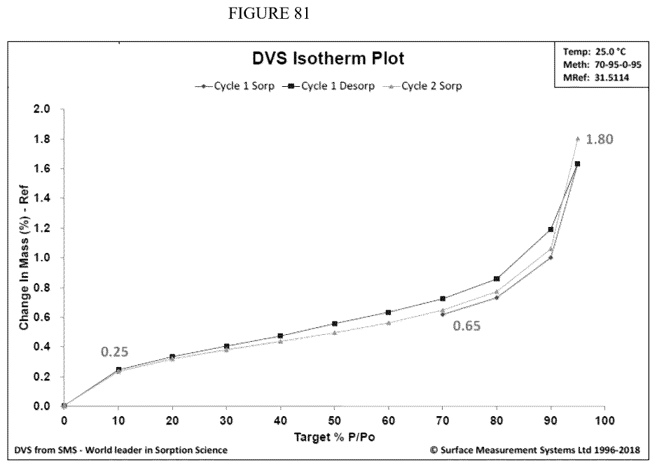

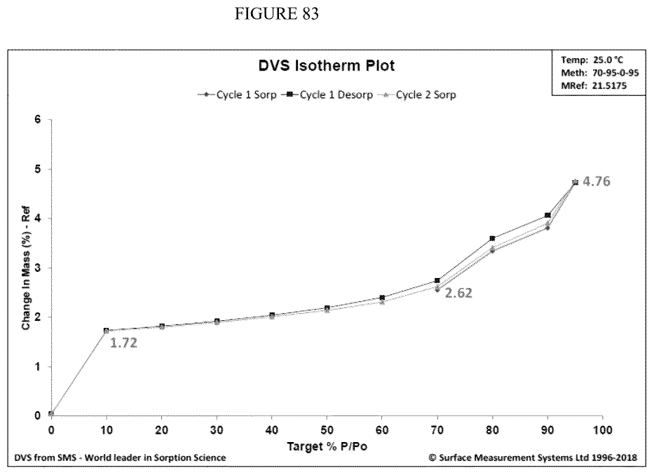

To investigate the solid form stability as a function of humidity, DVS isotherm plots of Form D and Form E were collected at 25° C. between 0% RH and 95% RH. The DVS plots and XRPD comparison are shown in FIG. 81 to FIG. 84.

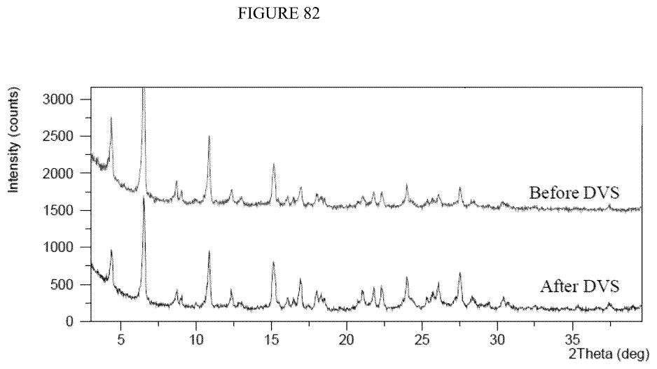

For Form D, the water uptake at 70% RH was 0.65%, and increased to 1.80% at 95% RH. In the desorption cycle, the water uptake decreased to 0.25% at 10% RH. The overlay of X-ray powder diffractograms for Form D before and after DVS test showed no form change, see FIG. 82.

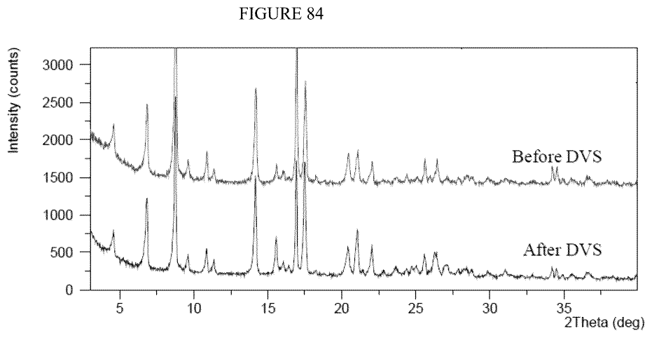

For Form E, the water uptake at 70% RH was 2.62%, and increased to 4.76% at 95% RH. In the desorption cycle, the water uptake in the humidity range of 10% RH˜0% RH decreased dramatically from 1.7% to ˜0%. The overlay of X-ray powder diffractograms for Form E before and after DVS test showed no form change, see FIG. 84.

TABLE 45
Water uptake of Form D and Form E

| Humidity | Water uptake of Form D (%) | | | Water uptake of Form E (%) | | |
|---|---|---|---|---|---|---|
| (% RH) | Sorption 1 | Desorption 1 | Sorption 2 | Sorption 1 | Desorption 1 | Sorption 2 |
| 0 | — | 0.006 | 0.006 | — | 0.036 | 0.036 |
| 10 | — | 0.246 | 0.234 | — | 1.734 | 1.717 |
| 20 | — | 0.335 | 0.319 | — | 1.817 | 1.796 |
| 30 | — | 0.406 | 0.380 | — | 1.919 | 1.892 |
| 40 | — | 0.474 | 0.437 | — | 2.041 | 2.005 |
| 50 | — | 0.557 | 0.496 | — | 2.191 | 2.138 |
| 60 | — | 0.634 | 0.562 | — | 2.400 | 2.307 |
| 70 | 0.617 | 0.724 | 0.649 | 2.548 | 2.740 | 2.618 |
| 80 | 0.730 | 0.857 | 0.772 | 3.335 | 3.599 | 3.411 |
| 90 | 1.000 | 1.192 | 1.061 | 3.804 | 4.058 | 3.903 |
| 95 | 1.633 | 1.633 | 1.804 | 4.725 | 4.725 | 4.763 |

—: The test was initiated from 70% RH, which was close to the room humidity.

### Solid State Stability

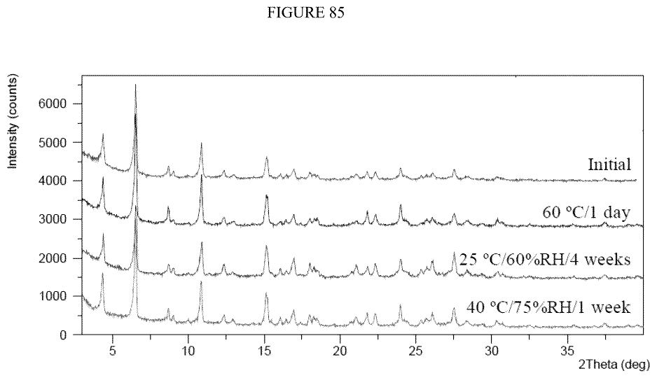

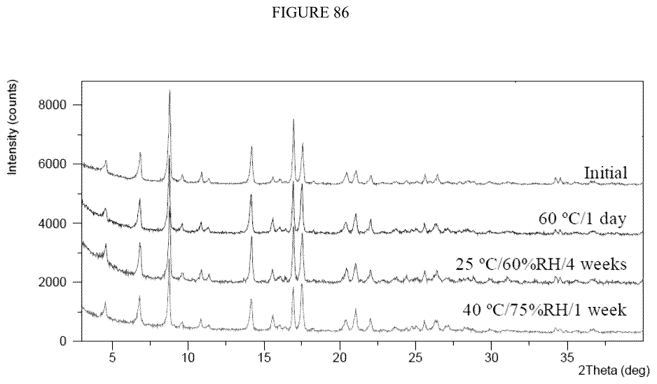

To evaluate the solid state stability of Form D and Form E, samples were stored under 60° C./closed for 1 day, 40° C./75% RH/open for 1 week and 25° C./60% RH/open for 4 weeks. All the stability samples were characterized by XRPD and HPLC purity, with the results summarized in Table 46. No form change or significant HPLC purity decrease was observed for Form D and Form E under all conditions, indicating good physical and chemical stability for both forms. XRPD results were shown in FIG. 85 and FIG. 86.

TABLE 46
Solid state stability evaluation results of Form D and Form E

| | | Initial | | | |
|---|---|---|---|---|---|
| | | Purity | Purity | Purity/ | |
| | | (area | (area | Initial | Form |
| Material | Condition | %) | %) | (%) | Change |
| Form D | 60° C./1 day | 99.54 | 99.43 | 99.9 | No |
| | 40° C./75% RH/1 week | | 99.43 | 99.9 | No |
| | 25° C./60% RH/4 weeks | | 99.44 | 99.9 | No |
| Form E | 60° C./1 day | 99.24 | 99.33 | 100.1 | No |
| | 40° C./75% RH/1 week | | 99.49 | 100.3 | No |
| | 25° C./60% RH/4 weeks | | 99.31 | 100.0 | No |

### 6.3 Example 3: Crystallization Process for Form E of Compound 1

This example describes a crystallization process of form E of Compound 1 for scale-up manufacturing.

### 6.3.1 Starting Material (SM)

The starting material used in this example is compound:

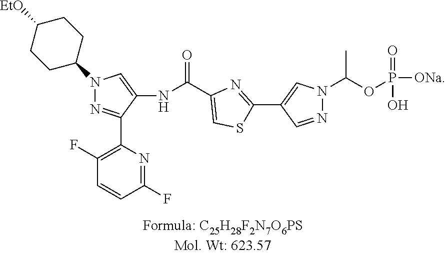

The characterization data for different batches of the starting materials used in the crystallization study and for solubility measurement of Form E are provided in Table 47.

TABLE 47
Characterization Data of Starting materials

| Starting | | | | |
|---|---|---|---|---|
| material | | | DSC | TGA |
| (SM) # | XRPD | PLM | Onset/peak (° C.), ΔH (J/g) | Wt. loss/T (° C.) |
| 001S1 | Form D | Needle-like crystal with | 88.3/115.2, 88.3 | 3.5%/30-120 |
| | | agglomerations | 179.2/182.6, 58.7 | 3.6%/130-210 |
| 004S1 | Form D + E | Fines (<10 μm) with | 70.4/91.6, 88.4 | 3.5%/30-110 |
| | | agglomerates | 113.3/131.4, 3.1 | 0.3%/110-145 |
| | | | 191.1/200.6, 93.9 | 4.7%/145-230 |
| 013S1 | NP1 | Fines (<10 μm) with | Multiple adjacent | 3.1%/35-130 |
| | | agglomerates | endotherms between 30 to | 2.6%/130-190 |
| | | | 140° C. | |
| | | | 165.9/174.1, 56.0 | |
| 038S1 | Form D | Needle-like crystal with | Two adjacent endotherms | 3.7%/35-130 |
| | | agglomerations | between 60 to 130° C. | 3.4%/130-200 |
| | | | 181.6/183.4, 47.6 | |

Starting material 004S1 was prepared using the following steps:
Charge THF (8.44 V) to the reactor.
Charge di-tert-butyl (1-(4-(4-((3-(3,6-difluoropyridin-2-yl)-1-((1s,4s)-4-ethoxycyclohexyl)-1H-pyrazol-4-yl)carbamoyl)thiazol-2-yl)-1H-pyrazol-1-yl)ethyl) phosphate to the reactor.
Charge H₂O (6.77 V) to the reactor.
Charge NaOAc (0.39 V) to the reactor.
Stir and heat to 55° C.
monitor pH value hourly and adjust to NLT PH=3.0 with 10% sodium acetate.
Take sample by HPLC until NLT 65% 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium.
Cool to 25° C., add 0.5 V THF, 0.5 V H₂O.
Adjust pH to 5.8 with 1 M NaOH aq.
Charge 12 V acetone to reaction.
Drop 25 V acetone for 30 min at 50° C., and lots of white solids appear.
Stir and cool to 10′C, take sample and test solid purity and mother liquors loss.
Filter and wash the cake with 3 V acetone.
Dry the white cake under N2.

Starting material 013S1 was prepared using the following steps:
Charge THF (9 V, 450 ml) to 2.0 L reactor, charge di-tert-butyl (1-(4-(4-((3-(3,6-difluoropyridin-2-yl)-1-((1s,4s)-4-ethoxycyclohexyl)-1H-pyrazol-4-yl)carbamoyl)thiazol-2-yl)-1H-pyrazol-1-yl)ethyl) phosphate (50.0 g, 1.0 eq.) to reactor, pH=6.82.
Charge H₂O (7 V, 350 ml) to reactor, pH=2.56.
Charge 10% NaOAc aq. (0.5 V, 25 ml) to reactor, pH=6.40.
Place 2.0 L reactor to oil bath, the temperature of reaction is 32° C.
Heat temperature to 57° C., pH=5.562, the reaction liquid gradually becomes clear.
Adjust pH to 2.8 by adding 10% NaOAc aq. and AcOH.
Cool temperature to 50° C., charge 1 M NaOH aq. (4.5 V, 225 ml) to reactor, pH=5.803, T=46° C.
Transfer reaction solution to 3 L reactor and charge acetone (12 V, 600 ml) to reactor, pH=6.528, T=39° C.
Dropwise acetone (25 V, 1250 ml) to reactor at least 1 h, when finished, pH=7.255, T=40° C.
Gradually cool temperature to 10° C.
Take sample to test solid purity and mother liquors loss.
Filter and wash cake with acetone (3 V, 150 ml).
A di-sodium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate was obtained, which was converted to 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate using the following steps:
Charge H₂O (10 V, 230 ml) to 1.0 L reactor, charge di-sodium salt (22.99 g, 1.0 eq., Q-NMR: 99.17%) to reactor.
Cool temperature to 5±5° C.
Dropwise concentrated hydrochloric acid (2.0 eq., 5.74 ml) to reactor.
Stir for 45 min at room temperature.
Cool temperature to 5±5° C.
Charge NaOH (1.0 eq., 1.3766 g) to reactor.
Stir for 20 min at room temperature.
Transfer reaction to 2 L plastic beaker.
Charge acetone (30 V, 690 ml) to plastic beaker.
Take sample to test solid purity and mother liquors loss.
Filter and wash cake with acetone (3 V, 69 ml).

Starting material 038S1 was prepared using the following steps:
Charge NMP (10 V), di-tert-butyl (1-(4-(4-((3-(3,6-difluoropyridin-2-yl)-1-((1s,4s)-4-ethoxycyclohexyl)-1H-pyrazol-4-yl)carbamoyl)thiazol-2-yl)-1H-pyrazol-1-yl)ethyl) phosphate (1.0 g, 1.0 eq.) to reactor.
Charge H₂O (10 V) to reactor.
Change 10% Sodium benzoate aq. (5 V) to reactor.
Heat temperature to 60° C., the reaction liquid gradually becomes clear when di-tert-butyl (1-(4-(4-((3-(3,6-difluoropyridin-2-yl)-1-((1s,4s)-4-ethoxycyclohexyl)-1H-pyrazol-4-yl)carbamoyl)thiazol-2-yl)-1H-pyrazol-1-yl)ethyl) phosphate is completed.
Take sample, cool temperature to 10˜20° C.
Adjust pH=5.751 to pH=3.241 with 2 M HCl aq. and 10% sodium benzoate aq.
Heat temperature to 48° C. and stir.
cool temperature to room temperature.
charge acetone (45 V) to reactor, white solid gradually appears.
Take sample to test solid purity and mother liquors loss.
Filter and wash cake with acetone (3 V).
Dry the cake under N2.

Starting materials 013S1 and 03851 were used in the crystallization study and starting materials 001S1 and 004S1 were used in the solubility measurement of Form E.

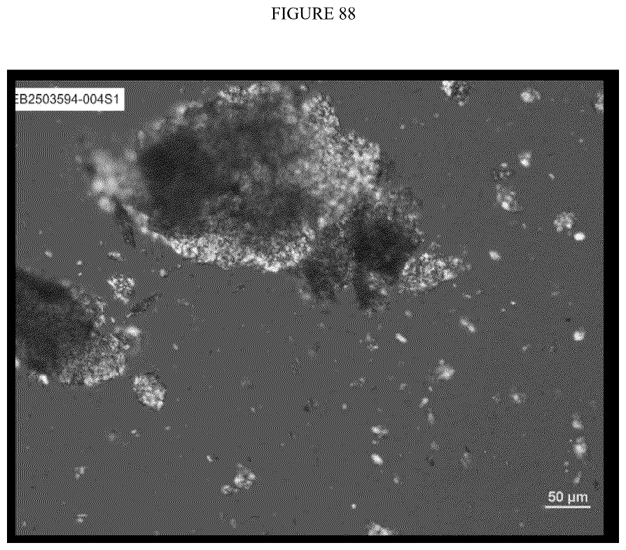

FIG. 7 provides a PLM image of Form D of Compound 1. FIG. 88 provides a PLM image of Form D+E of Compound 1. FIG. 89 provides a PLM image of Form NP1 of Compound 1.

FIG. 90 provides an X-ray powder diffraction pattern of Form NP1. A list of X-Ray Diffraction Peaks for Form NP1 of Compound 1 is provided below in Table N1.

TABLE N1

| | | | Relative | | Relative | |
|---|---|---|---|---|---|---|
| | d- | | Intensity | | Intensity | |
| Position | spacing | Height | (%) of | | (%) of | |
| (° 2θ) | (Å) | (cts) | Height | Area | Area | FWHM |
| 7.226 | 12.2238 | 91 | 27.2 | 2280 | 22.2 | 0.292 |
| 10.134 | 8.7215 | 132 | 39.4 | 4756 | 46.3 | 0.420 |
| 10.705 | 8.2577 | 36 | 10.7 | 683 | 6.6 | 0.221 |
| 11.674 | 7.5742 | 190 | 56.7 | 5841 | 56.8 | 0.359 |
| 11.974 | 7.3849 | 217 | 64.8 | 9604 | 93.4 | 0.516 |
| 12.358 | 7.1564 | 109 | 32.5 | 4576 | 44.5 | 0.490 |
| 13.935 | 6.3497 | 335 | 100.0 | 10279 | 100.0 | 0.358 |
| 14.759 | 5.9972 | 109 | 32.5 | 2144 | 20.9 | 0.229 |
| 15.689 | 5.6438 | 48 | 14.3 | 739 | 7.2 | 0.180 |
| 16.886 | 5.2462 | 34 | 10.1 | 694 | 6.8 | 0.238 |
| 19.494 | 4.5499 | 70 | 20.9 | 1842 | 17.9 | 0.307 |
| 20.166 | 4.3998 | 179 | 53.4 | 9622 | 93.6 | 0.627 |
| 20.522 | 4.3243 | 196 | 58.5 | 7876 | 76.6 | 0.469 |
| 21.386 | 4.1514 | 76 | 22.7 | 1169 | 11.4 | 0.179 |
| 22.003 | 4.0364 | 33 | 9.9 | 617 | 6.0 | 0.218 |
| 24.996 | 3.5594 | 50 | 14.9 | 1658 | 16.1 | 0.387 |
| 25.227 | 3.5273 | 65 | 19.4 | 1656 | 16.1 | 0.297 |
| 26.265 | 3.3902 | 36 | 10.7 | 744 | 7.2 | 0.241 |
| 26.768 | 3.3277 | 85 | 25.4 | 2912 | 28.3 | 0.400 |
| 27.302 | 3.2638 | 36 | 10.7 | 726 | 7.1 | 0.235 |
| 28.687 | 3.1093 | 59 | 17.6 | 1436 | 14.0 | 0.284 |
| 31.221 | 2.8625 | 32 | 9.6 | 1473 | 14.3 | 0.537 |
| 31.221 | 2.8625 | 32 | 9.6 | 1473 | 14.3 | 0.537 |
| 31.745 | 2.8164 | 110 | 32.8 | 2461 | 23.9 | 0.261 |

A TGA plot for Form NP1 showed TGA weight loss of 3.1% between 35° C. and 130° C. and 2.6% between 130° C. and 190° C. as depicted in FIG. 91.

A DSC plot for Form NP1 showed endotherms at 82.67° C. (peak) with an onset temperature of 54.18° C. with enthalpy of 131.77 J/g and 174.11° C. (peak) with an onset temperature of 165.86° C. (peak) and 174.11° C. (onset) with enthalpy of 55.95 J/g as depicted in FIG. 94.

### 6.3.2 Crystallization Process Condition Study

### 6.3.2.1 Preparation of Form E

Form E was initially prepared in Acetone/Water (1/1, v/v) solvent system at 25° C., and the product was used for solubility measurement. The starting materials, Form D or mixture of Form D and Form E, were suspended in 10 V of Acetone/Water (1/1, v/v) at 25° C., then magnetically stirred at 25° C. for 20 h. The solids were isolated by filtration and analyzed by XRPD.

TABLE 48
Preparation of Form E

| Input | | | | | | | |
|---|---|---|---|---|---|---|---|
| | | Crystal | | Temp. | Time | Product | |
| Amount | SM # | form | Solvent | (° C.) | point | PD # | XRPD |
| 0.5 g | 001S1 | Form D | 10 V | 25 | 20 h | 002P1 | Form E |
| 1.9 g | 004S1 | Form D + E | Acetone/Water | | | 005P1 | |
| | | | (1/1, v/v) | | | | |

### 6.3.2.2 Solubility of Form E in Single Solvent System

The solubility of Form E was measured in single solvents by visual observation with the method below: ˜20 mg material was weighed into a 2-mL vial and the solvent was added dropwise until the sample dissolved. The results are given in Table 49.

The results showed that Form E had extremely low solubility (<5 mg/mL) in the selected single solvent. In addition, the dissolution rate of Form E was very slow.

TABLE 49
Solubility Data of Form E in Single Solvent
Input: Form E at 20° C.

| | | Solubility | | | | Solubility | |
|---|---|---|---|---|---|---|---|
| Lot# | Solvent | (mg/mL) | XRPD | Lot# | Solvent | (mg/mL) | XRPD |
| 003A1 | MeOH | <3 | Form E | 003A10 | Hept. | <3 | Form E |
| 003A2 | EtOH | | | 003A11 | CAN | | |
| 003A3 | IPA | | | 003A12 | Water | | |
| 003A4 | EtOAc | | | 003A9 | MTBE | | |
| 003A5 | IPAc | | | 003A14 | DCM | | |
| 003A6 | Acetone | | | 003A15 | 2-Me—THF | | |
| 003A7 | MEK | | | 003A16 | Anisole | | |
| 003A8 | MIBK | | | 003A13 | DMSO | 3-5 | |

### 6.3.2.3 Solubility of Form E in Multiple Solvent Systems

The solubility of Form E was measured in multiple solvent systems by visual observation with the method below: ˜5 mg material was weighed into a 2-mL vial and the solvent was added dropwise until the sample dissolved. The results are given in Table 50. No synergistic effect was found in these multiple solvent systems based on the results.

TABLE 50
Solubility Data of Form E in Multiple Solvent Systems
Input: Form E

| | Vol | Temp | Solubility | | Vol | Temp | Solubility |
|---|---|---|---|---|---|---|---|
| Solvent | ratio | (° C.) | (mg/mL) | Solvent | ratio | (° C.) | (mg/mL) |
| Acetone/ | 95/5 | 50 | <3 | DMSO/2- | 8/2 | 50 | 3-5 |
| Water | 7/3 | | <3 | Me—THF | 7/3 | | 5-10 |
| | 5/5 | | <3 | | 5/5 | | <3 |
| | 3/7 | | <3 | | 3/7 | | <3 |
| EtOH/ | 7/3 | | <3 | MeOH/ | 8/2 | | 3-5 |
| Water | 5/5 | | <3 | Anisole | 7/3 | | 5-10 |
| | 3/7 | | <3 | | 5/5 | | 5-10 |
| MeOH/ | 7/3 | | <3 | | 3/7 | | <3 |
| Water | 5/5 | | <3 | EtOH/Anisole | 7/3 | | <3 |
| | 3/7 | | <3 | Acetone/ | 2/2/1 | | 3-4 |
| ACN/Water | 5/5 | 70 | <3 | 2-Me—THF/ | 2/2/2 | | 5-10 |
| Acetone/ | 1/1/1 | 50 | <3 | Water | 2/2/3 | | <3 |
| MEK/ | | | | | | | |
| Water | | | | | | | |

### 6.3.2.4 Solubility of Form E in THF/Water Systems

The solubility of Form E was measured in THF/Water with different volumetric ratios by HPLC using the method below: an appropriate amount of Form E was suspended in the solvent systems and stirred for ˜20 h. After that, the suspensions were filtered, then the filtrates were collected for solubility measurement by HPLC, and the residual solids were analyzed by XRPD. The results are given in Table 51.

The solubility was affected by the volumetric ratio of THF/Water, and significant synergistic effect was detected in THF/Water (7/3, v/v), and solubility was 102 mg/mL. However, there were significant differences in solubility and phase conversion among materials from different batches. In addition, a hazy solution was observed after adding 10 V of THF/Water (7/3, v/v) and it remained as hazy after addition of another 10 V solvent, likely due to other insoluble substances in the sample.

The results showed that the solubility decreased significantly with THF content increasing, indicating THF was a potent anti-solvent. Based on solubility data, the condition of THF/water (7/3, v/v, total 18V) at 50° C. and THF/water (27/3, v/v, total 30V) at 0° C. were selected as starting point and ending point of crystallization, respectively.

TABLE 51
Solubility Data of Form E in Multiple Solvent Systems

| | | | Temp. | Solubility | |
|---|---|---|---|---|---|
| Input | Solvent | Ratio | (° C.) | (mg/mL) | XRPD |
| Form E | THF/Water | 95/5 | 50 | 1 | Form E |
| 005P1 | | 9/1 | | 2 | |
| | | 8/2 | | 37 | |
| | | 7/3 | | 102 | |
| | | 6/4 | | 82 | |
| | | 5/5 | | 72 | |
| | | 3/7 | | 29 | |
| Form E | THF/Water | 7/3 | 45 | 51 | Form E + D |
| 012BP1 | | | 40 | 43 | |
| | | | 35 | 36 | |
| | | | 50 | 62 | |
| | A*/THF | 14/1 | 50 | 60 | Form E + D |
| | | 14/2 | | 52 | |
| | | 14/3 | | 44 | |
| | | 10/3 | | 42 | |
| | | 14/7 | | 31 | |
| | | 14/10 | | 22 | |
| | | 14/19 | | 10 | Form E |
| | | 14/28 | | 2 | |

A* represents to THF/Water (7/3, v/v).

### 63.2.5 Solution Stability Study

Based on the solubility and physical stability data, the solution stability of Form E was evaluated in THF/Water (7/3, v/v) at 50 TC. The purity of drug solution was monitored by HPLC at different time points. The purity decreased to 95.10% from 96.52% after stirring in at 50° C. for 15 h.

TABLE 52
Solution Stability Data

| | | Temp. | | Purity |
|---|---|---|---|---|
| Input | Solvent | (° C.) | Time/h | (%) |
| Compound 1, Form E | 40 V | 50° C. | 0 | 96.52 |
| (Purity: 96.48%) | THF/Water | | 6 | 96.11 |
| | (7/3, v/v) | | 15 | 95.10 |

### 6.3.2.6 Competitive Slurry Study

Crystal forms, NP3 and NP4, were identified in THF/Water at 25° C., using NP1 as the starting material. Since NP4 was metastable and converted to NP3 in THF/Water (7.3/1, v/v) at 25° C., NP3 was used for competitive slurry study with Form D and Form E.

FIG. 92 provides a PLM image of Form NP3 of Compound 1. FIG. 93 provides an X-ray powder diffraction pattern of NP3. A list of X-Ray Diffraction Peaks for Form NP3 of Compound 1 is provided below in Table N3.

TABLE N3

| | | | Relative | | Relative | |
|---|---|---|---|---|---|---|
| | d- | | Intensity | | Intensity | |
| Position | spacing | Height | (%) of | | (%) of | |
| (° 2θ) | (Å) | (cts) | Height | Area | Area | FWHM |
| 4.853 | 18.1933 | 58 | 5.2 | 498 | 3.6 | 0.150 |
| 6.414 | 13.7695 | 128 | 11.4 | 2380 | 17.0 | 0.325 |
| 6.705 | 13.1710 | 102 | 9.1 | 2132 | 15.3 | 0.366 |
| 7.175 | 12.3101 | 865 | 77.2 | 10063 | 72.0 | 0.204 |
| 8.620 | 10.2493 | 355 | 31.7 | 2240 | 16.0 | 0.110 |
| 9.605 | 9.2006 | 234 | 20.9 | 2564 | 18.3 | 0.192 |
| 10.739 | 8.2312 | 90 | 8.0 | 517 | 3.7 | 0.100 |
| 12.037 | 7.3464 | 1120 | 100.0 | 13974 | 100.0 | 0.218 |
| 13.895 | 6.3682 | 163 | 14.6 | 1417 | 10.1 | 0.152 |
| 14.524 | 6.0938 | 166 | 14.8 | 2741 | 19.6 | 0.289 |
| 14.770 | 5.9929 | 62 | 5.5 | 830 | 5.9 | 0.234 |
| 15.715 | 5.6343 | 26 | 2.3 | 102 | 0.7 | 0.069 |
| 16.812 | 5.2692 | 418 | 37.3 | 6088 | 43.6 | 0.255 |
| 17.407 | 5.0904 | 119 | 10.6 | 1671 | 12.0 | 0.246 |
| 19.403 | 4.5709 | 228 | 20.4 | 2744 | 19.6 | 0.211 |
| 20.841 | 4.2588 | 62 | 5.5 | 808 | 5.8 | 0.228 |
| 21.856 | 4.0632 | 234 | 20.9 | 3128 | 22.4 | 0.234 |
| 23.026 | 3.8593 | 125 | 11.2 | 1577 | 11.3 | 0.221 |
| 24.344 | 3.6532 | 289 | 25.8 | 4364 | 31.2 | 0.264 |
| 26.400 | 3.3733 | 61 | 5.4 | 684 | 4.9 | 0.196 |
| 28.726 | 3.1052 | 91 | 8.1 | 1349 | 9.7 | 0.259 |
| 31.175 | 2.8666 | 68 | 6.1 | 1072 | 7.7 | 0.276 |
| 31.855 | 2.8069 | 51 | 4.6 | 665 | 4.8 | 0.228 |
| 33.519 | 2.6713 | 52 | 4.6 | 564 | 4.0 | 0.190 |
| 34.101 | 2.6270 | 31 | 2.8 | 782 | 5.6 | 0.441 |
| 34.430 | 2.6027 | 21 | 1.9 | 457 | 3.3 | 0.381 |
| 39.511 | 2.2789 | 79 | 7.1 | 1252 | 9.0 | 0.277 |

A TGA plot for Form NP3 showed TGA weight loss of 5.1% between 28° C. and 120° C. and 3.45% between 120° C. and 210° C. as depicted in FIG. 94.

A DSC plot for Form NP3 showed endotherms at 73.31° C. (peak) with an onset temperature of 44.26° C. with enthalpy of 134.1 J/g and 73.31° C. (peak) with an onset temperature of 184.45° C. (peak) and 178.66° C. (onset) with enthalpy of 70.4 J/g as depicted in FIG. 94.

FIG. 95 provides an X-ray powder diffraction pattern of NP4. A list of X-Ray Diffraction Peaks for Form NP4 of Compound 1 is provided below in Table N4.

TABLE N4

| | | | Relative | | Relative | |
|---|---|---|---|---|---|---|
| | d- | | Intensity | | Intensity | |
| Position | spacing | Height | (%) of | | (%) of | |
| (° 2θ) | (Å) | (cts) | Height | Area | Area | FWHM |
| 3.906 | 22.6047 | 103 | 1.7 | 2256 | 3.2 | 0.255 |
| 4.234 | 20.8513 | 1090 | 17.5 | 12800 | 18.3 | 0.137 |
| 5.881 | 15.0151 | 108 | 1.7 | 4055 | 5.8 | 0.438 |
| 6.347 | 13.9132 | 6226 | 100.0 | 69932 | 100.0 | 0.131 |
| 6.718 | 13.1461 | 167 | 2.7 | 6481 | 9.3 | 0.453 |
| 8.449 | 10.4564 | 339 | 5.4 | 4007 | 5.7 | 0.138 |
| 8.669 | 10.1915 | 136 | 2.2 | 1734 | 2.5 | 0.149 |
| 10.276 | 8.6015 | 33 | 0.5 | 328 | 0.5 | 0.116 |
| 10.590 | 8.3471 | 422 | 6.8 | 4242 | 6.1 | 0.117 |
| 12.099 | 7.3090 | 71 | 1.1 | 1746 | 2.5 | 0.287 |
| 12.728 | 6.9493 | 1517 | 24.4 | 14943 | 21.4 | 0.115 |
| 14.046 | 6.2998 | 240 | 3.9 | 2090 | 3.0 | 0.102 |
| 14.249 | 6.2106 | 48 | 0.8 | 639 | 0.9 | 0.155 |
| 14.867 | 5.9537 | 1115 | 17.9 | 11504 | 16.5 | 0.120 |
| 15.572 | 5.6858 | 161 | 2.6 | 1143 | 1.6 | 0.083 |
| 16.843 | 5.2594 | 106 | 1.7 | 1616 | 2.3 | 0.178 |
| 16.997 | 5.2123 | 186 | 3.0 | 2874 | 4.1 | 0.180 |
| 17.460 | 5.0749 | 41 | 0.7 | 707 | 1.0 | 0.201 |
| 18.214 | 4.8666 | 44 | 0.7 | 445 | 0.6 | 0.118 |
| 19.138 | 4.6336 | 341 | 5.5 | 3773 | 5.4 | 0.129 |
| 19.932 | 4.4509 | 54 | 0.9 | 1216 | 1.7 | 0.263 |
| 20.851 | 4.2568 | 86 | 1.4 | 903 | 1.3 | 0.122 |
| 21.292 | 4.1695 | 238 | 3.8 | 2630 | 3.8 | 0.129 |
| 21.810 | 4.0717 | 254 | 4.1 | 2964 | 4.2 | 0.136 |
| 22.784 | 3.8998 | 68 | 1.1 | 652 | 0.9 | 0.112 |
| 23.447 | 3.7909 | 1239 | 19.9 | 12975 | 18.6 | 0.122 |
| 23.693 | 3.7521 | 232 | 3.7 | 4395 | 6.3 | 0.221 |
| 24.680 | 3.6043 | 56 | 0.9 | 605 | 0.9 | 0.126 |
| 25.639 | 3.4716 | 150 | 2.4 | 2183 | 3.1 | 0.170 |
| 26.671 | 3.3396 | 192 | 3.1 | 2790 | 4.0 | 0.169 |
| 26.890 | 3.3128 | 57 | 0.9 | 839 | 1.2 | 0.172 |
| 27.863 | 3.1994 | 63 | 1.0 | 877 | 1.3 | 0.162 |
| 28.383 | 3.1419 | 35 | 0.6 | 262 | 0.4 | 0.087 |
| 28.700 | 3.1079 | 249 | 4.0 | 3386 | 4.8 | 0.159 |
| 29.989 | 2.9772 | 135 | 2.2 | 1577 | 2.3 | 0.136 |
| 30.745 | 2.9057 | 181 | 2.9 | 2745 | 3.9 | 0.177 |
| 31.799 | 2.8117 | 36 | 0.6 | 626 | 0.9 | 0.203 |
| 32.224 | 2.7756 | 64 | 1.0 | 1062 | 1.5 | 0.194 |
| 32.832 | 2.7256 | 188 | 3.0 | 2081 | 3.0 | 0.129 |
| 34.985 | 2.5626 | 36 | 0.6 | 657 | 0.9 | 0.213 |
| 36.655 | 2.4496 | 44 | 0.7 | 1878 | 2.7 | 0.498 |
| 38.184 | 2.3550 | 33 | 0.5 | 433 | 0.6 | 0.153 |
| 38.881 | 2.3143 | 101 | 1.6 | 3384 | 4.8 | 0.391 |
| 39.239 | 2.2940 | 70 | 1.1 | 1844 | 2.6 | 0.307 |

Competitive slurry of Forms D, E and NP3 was conducted in pre-saturated THF/Water at different temperatures to investigate the phase conversion relationship among Forms D, E and NP3. The detailed procedure is shown Table 53. The result indicated that Form L was the intermediate phase, and the mixture converted to Form E finally, indicating Form E was more stable than Form D and NP3 at 0-50° C.

TABLE 53
Competitive Slurry Study of Form D, Form E and NP3 in THF/Water
Form D & Form E & NP3

| | Ratio | | | |
|---|---|---|---|---|
| Solvent | (v/v) | Temp./° C. | Time | XRPD |
| THF/Water | 7/3, 10 V | 50 | 20 h | Form E + Form L |
| | | | 3 d | Form E |
| | 27/3, 30 V | 50 | 20 h | Form E + Form L |
| | | | 3 d | Form E |
| | | 25 | 20 h | Form E + Form L |
| | | | 3 d | Form E |
| | | 0 | 20 h | Form E + Form L |
| | | | 3 d | Form E |

### 6.3.3 Crystallization Process Development and Optimization

According to the solubility data, one preliminary normal anti-solvent addition crystallization trial was carried out in THF/Water solvent system with the details below. 2 g of NP1 material was dissolved into 10 V of THF/Water (7/3, v/v) at 50° C., then 3 V of THF was added into the solution to generate supersaturation (1.8) for seeding. Afterwards, 2 wt. % Form E seeds were added, and the suspension was aged for further 2 h at 50° C. Then, the remaining 17 V of THF was added at 2.1 V/h (˜8 h), and the suspension was aged at 50° C. for 32 h. But the crystal form was determined to be a mixture of Form D and Form E, and it remained unchanged after heating-cooling for 2 cycles. The suspension was cooled to 0° C. and stirred for 3 days, it converted to Form E. After vacuum pump filtration and drying (50° C. under vacuum for 20 h), the product was analyzed by XRPD, PLM, 1H-NMR and HPLC. All the analytical data met the criteria (XRPD: Form E, purity >99%). The solvent residue was difficult to determine by ¹H-NMR, due to the overlapping peak positions of THF with the main peak of compound. Additionally, no suitable solvents available for gas chromatography for solvent residue determination, due to extremely low solubility.

According to the preliminary experimental data and behavior, multiple crystallization trials were performed to evaluate the effects of crystallization temperature (50° C. vs 25° C. vs 0° C.) and anti-solvent addition rate (2 V/h vs 3 V/h) on crystallization behavior. Different hydrate forms (Form D, Form L and for NP3) were identified, indicating that the compound has a very complicated crystallization kinetics.

The effect of type of agitation (overhead vs magnetic) was also investigated on phase conversion rate. One third of the suspension was filtered and solids were isolated and used for slurry in 30 V Acetone/Water (1/1, v/v) 25° C., but it remained unchanged after overhead stirring for 3 days. The residual suspension (Form D+trace E) was stirred using magnetic bar at 40° C. and 25° C., and it converted to Form E. Compared overhead stirring and magnetic stirring, the results indicated that magnetic stirring was beneficial to speed up the phase conversion rate from Form D+E to Form E, due to milling effect.

Hence, further crystallization trials were performed to evaluate the effects of wet milling at different temperature (0° C. and 50° C.) and using different crystal forms (Form D+E and Form L+E) as input on crystal form of products. The mixture of Form D and trace E was wet-milled at 0° C. for 150 cycles and stirred at 0° C. for 16 h, Form E was obtained. When the input was Form L, Form L remained unchanged after wet-milling at 0° C., but it converted to Form E with trace Form D after wet milling at 50° C. Finally, it converted to Form E after cooling to 0° C. and stirring at 0° C. for 20 h.

The experimental details and data were summarized in Table 54, including crystallization process parameters and the characterization results of all crystallized products.

TABLE 54
Results of Crystallization in THF/Water Solvent System.

| | | | | Seeding point | | | | Anti- | | | |
|---|---|---|---|---|---|---|---|---|---|---|---|
| | Objective/ | Temp | | Solvent | Temp | | | solvent | Additional | | |
| Input | scale | (° C.) | Solvent | (v/v) | (° C.) | Loading | Aging | addition | operation | XRPD | Results |
| NP1 | Preliminary | 50 | 10 V A* | A*/THF | 50 | 2% | 2 h | 17 V THF/ | Stirred at 50° | Form D + | PLM: Needle-like |
| Purity: | crystal- | | | 10 V/3 V | | Form E | | 8 h | C. for 32 h | E | crystal with |
| 98.9% | lization/2 g | | | | | | | | Heating- | Form D + | agglomeration |
| | | | | | | | | | cooling^{&} for | E | XRPD: Form E |
| | | | | | | | | | two cycles | | Purity: 99.79% |
| | | | | | | | | | Stirred at 0° | Form E | DSC: 40.8/42.8° |
| | | | | | | | | | C. for 3 d | | C., 6.0 J/g; |
| | | | | | | | | | | | 77.8/100.5° C., |
| | | | | | | | | | | | 59.4 J/g; |
| | | | | | | | | | | | 191.4/197.3° C., |
| | | | | | | | | | | | 98.7 J/g |
| | | | | | | | | | | | TGA: 0.1%/30-60° |
| | | | | | | | | | | | C.; 2.6%/60-120° |
| | | | | | | | | | | | C.; 3.5%/130-230° |
| | | | | | | | | | | | C. |
| | | | | | | | | | | | ML loss: 7% |
| | | | | | | | | | | | Solid yield: 90% |
| | Crystal- | 50 | 14 V A* | 14 V A* | 45 | 2% | 1 h | Cooled to | Stirred at 0° | Form L + | |
| | lization | | | | | Form E | | 0° C. at | C. for 3 d | trace E | |
| | at 0° C./2 g | | | | | | | 20° C./h; | Stirred at 25° | | |
| | | | | | | | | 21 V THF/ | C. for 24 h | | |
| | | | | | | | | 8 h | 5% Form E | | |
| | | | | | | | | | was added | | |
| | | | | | | | | | and stirred at | | |
| | | | | | | | | | 25° C. for 3 d | | |
| | Crystal- | 50 | 14 V A* | 14 V A* | 45 | 2% | 1 h | Cooled to | Stirred at 25° | NP3 | PLM: Fines with |
| | lization | | | | | Form E | | 25° C. at | C. for 5 d | | agglomeration |
| | at 25° C./2 g | | | | | | | 10° C./h; | | | XRPD: NP3 |
| | | | | | | | | 21 V THF/ | | | Purity: 99.88% |
| | | | | | | | | 8 h | | | DSC: 44.3/73.3° |
| | | | | | | | | | | | C., 134.1 J/g; |
| | | | | | | | | | | | 178.7/184.5° C., |
| | | | | | | | | | | | 70.4 J/g |
| | | | | | | | | | | | TGA: 5.1%/28- |
| | | | | | | | | | | | 120° C.; 2.6%/60- |
| | | | | | | | | | | | 120° C.; 3.4%/120- |
| | | | | | | | | | | | 210° C. |
| Compound | Effect of | 50 | 14 V A* | A*/THF | 50 | 5% | 2 h | 27 V THF/ | Stirred at 0° | Form D + | |
| 1 | slow | | | 14 V/1 V | | Form E | | 12 h | C. for 24 h | trace E | |
| NP1 | addition | | | | | | | | 1/3 of | Form E | |
| Purity: | rate (2 V/h | | | | | | | | suspension | | |
| 98.9% | vs 3 V/h)/ | | | | | | | | stirred at 40° | | |
| | 3 g | | | | | | | | C. for 3 d | | |
| | | | | | | | | | (magnetic) | | |
| | | | | | | | | | 1/3 of | Form E | |
| | | | | | | | | | suspension | | |
| | | | | | | | | | stirred at 25° | | |
| | | | | | | | | | C. for 3 d | | |
| | | | | | | | | | (magnetic) | | |
| | | | | | | | | | 1/3 of | Form D + | |
| | | | | | | | | | suspension | trace E | |
| | | | | | | | | | was filtered | | |
| | | | | | | | | | then slurry at | | |
| | | | | | | | | | 30 V | | |
| | | | | | | | | | Acetone/Water | | |
| | | | | | | | | | (1/1) at 25° | | |
| | | | | | | | | | C. for 3 d | | |
| | | | | | | | | | (overhead | | |
| | | | | | | | | | stirring) | | |
| | Effect of | 50° | 18 V A* | A*/THF | 50 | 2% | 2 h | 26 V THF/ | Stirred at 0° | Form D + | PLM: Needle-like |
| | wet | C. | | 18 V/10 V | | Form E | | 9 h | C. for 41 h | trace E | crystals with |
| | milling at | | | | | | | | Wet milling | Form E | agglomeration |
| | 0° C. on | | | | | | | | at 0° C. for | | XRPD: Form E |
| | phase | | | | | | | | 150 cycles | | Purity: 99.86% |
| | conversion | | | | | | | | and stirred at | | DSC: 41.2/47.1° |
| | rate of | | | | | | | | 0° C. for 16 h | | C., 10.8 J/g; |
| | type D | | | | | | | | | | 89.4/118.3° C., |
| | and type E/ | | | | | | | | | | 68.8 J/g; |
| | 5 g | | | | | | | | | | 197.6/201.9° C., |
| | | | | | | | | | | | 92.5 J/g |
| | | | | | | | | | | | TGA: 0.7%/28-65° |
| | | | | | | | | | | | C.; 2.7%/66-130° |
| | | | | | | | | | | | C.; 3.3%/130-220 |
| C. | | | | | | | | | | | C. |
| | | | | | | | | | | | Solid yield: 86% |
| Form E | Effect of | 50° | 16 V A* | 16 V A* | 40 | 2% | 2 h | Cooled to | Wet milling | Form L | PLM: Needle-like |
| Purity: | wet | C. | | | | Form L | | 0° C. at | at 0° C. for 80 | | crystal with |
| 99.83% | milling at | | | | | | | 10° C./h; | cycles and | | agglomeration |
| | 0° C. on | | | | | | | 32 V THF/ | stirred at 0° | | XRPD: Form E |
| | phase | | | | | | | 8 h | C. for 3 d | | Purity: 99.94% |
| | conversion | | | | | | | | Stirred at 50° | Form E + | DSC: 43.3/44.5° |
| | rate of | | | | | | | | C. for 20 h | trace D | C., 3.88 J/g; |
| | Form L | | | | | | | | Stirred at 0° | Form E | 70.3/97.3° C., 65.3 |
| | and Form | | | | | | | | C. for 20 h | | J/g; 195.1/200.5° |
| | E/4 g | | | | | | | | | | C., 102.9 J/g |
| | | | | | | | | | | | TGA: 0.1%/32-45° |
| | | | | | | | | | | | C.; 2.3%/45-110° |
| | | | | | | | | | | | C.; 2.6%/190-210° |
| | | | | | | | | | | | C. |
| | | | | | | | | | | | ML loss: 10.6% |
| | | | | | | | | | | | Solid yield: 86% |
| Form D | Effect of | 50° | 18 V A* | 18 V A* | 35 | 2% | 2 h | Cooled to | Stirred at 25° | Form L | PLM: Needle-like |
| Purity: | wet | C. | | | | Form E | | 25° C. at | C. for 8 h | | crystal with |
| 98.05% | milling at | | | | | | | 10° C./h; | Wet milling | Form E + | agglomeration |
| | 50° C. on | | | | | | | 25 V THF/ | for 50 cycles | trace D | XRPD: Form E |
| | phase | | | | | | | 8 h | and stirred at | | Purity: 99.40% |
| | conversion | | | | | | | | 50° C. for 20 | | DSC: 42.3/44.2° |
| | rate of | | | | | | | | h | | C., 2.8 J/g; |
| | Form L | | | | | | | | 11 V THF/ | / | 72.0/99.0° C., 72.3 |
| | and Form | | | | | | | | 4 h | | J/g; 191.6/197.2° |
| | E/2 g | | | | | | | | Stirred at 0° | Form E | C., 96.9 J/g |
| | | | | | | | | | C. for 20 h | | TGA: 0.1%/35-45° |
| | | | | | | | | | | | C.; 2.7%/45-110° |
| | | | | | | | | | | | C.; 2.8%/190-210 |
| | | | | | | | | | | | C. |
| | | | | | | | | | | | ML loss: 12% |
| | | | | | | | | | | | Solid yield: 85% |

A* represents THF/Water (7/3, v/v).
^{&}Heating-cooling for two cycles with the details as follows: cooled to 0° C. at 10° C./h and aged for 2 h, then heated to 50° C. at 33° C./h and aged for 1 h.
^{#}Wet-milling is conducted using IKA magic LAB setup equipped with 6F + 6F + 6F rotor/stator, and tip speed is set as 23 m/s (14600 rpm).

The below instrument and parameters were used in this example.

### PLM

Light microscopy analysis was performed using an ECLIPSE LV100POL (Nikon, JPN) microscope. Each sample was placed on a glass slide with a drop of immersion oil and covered with a glass slip. The sample was observed using a 10× objective with polarized light.

### XRPD

XRPD diffract grams were collected with an X-ray diffractometer. The sample was prepared on a zero-background silicon wafer by gently pressing onto the flat surface. The parameters of XRPD diffraction are given in Table 55.

TABLE 55
Parameters for XRPD Testing with Bruker D8 Advance

| Instrument | Bruker D8 Advance | |
|---|---|---|
| Radiation | Cu Kα (λ = 1.5418 Å) | |
| Detector | LynxEye | |
| Scan angle | 3-40° (2θ) | |
| Scan step | 0.013° (2θ) | |
| Scan speed | 0.10 | s/step |
| Tube | 40 kV/40 mA | |
| voltage/current | | |
| Divergence slit | 0.2 | mm |

| | |
|---|---|
| Rotation | On |
| Sample holder | Zero-background sample pan |

### TGA

TGA analysis was performed using a TA Instrument. About 1-3 mg of a sample was loaded onto a pre-tared aluminum pan and heated with the parameters in Table 56. The data was analyzed using TRIOS.

TABLE 56
Parameters of TGA Testing

| Instrument | TA, Discovery TGA 5500 | |
|---|---|---|
| Sample pan | Aluminum pan with lid with a pin- | |
| | hole | |
| Temperature range | RT-300° | C. |
| Heating rate | 10° | C./min |

| | |
|---|---|
| Purge gas | N₂ |
| Flow rate | Balance chamber: 40 mL/min |
| | Sample chamber: 60 mL/min |

### DSC

DSC analysis was performed with a TA Instrument. About 1-3 mg of a sample was placed into an aluminum pan with pin-hole cap and heated with the parameters shown in Table 57.

TABLE 57
Parameters of DSC Testing

| Instrument | TA, Discovery DSC 250 and 2500 | |
|---|---|---|
| Sample pan | Aluminum, pin-holed | |
| Temperature range | 25-300° | C. |
| Heating rate | 10° | C./min |
| Purge gas | N₂ | |
| Flow rate | 50 | mL/min |

### ¹H-NMR

¹H-NMR spectra were collected on a Bruker 400 MHz instrument. Unless specified, samples were prepared in DMSO solvent and measured with the parameters in Table 58. The data was analyzed using MestReNova.

TABLE 58
Parameters for ¹H-NMR Analysis

| Instrument | Bruker | |
|---|---|---|
| Frequency | 400 | mHz |
| Scan times | 16-32 | |
| Temperature | 295 | K |
| Relaxation delay | 1 | s |

### HPLC

HPLC analysis was performed with an Agilent HPLC 1260 series instrument. HPLC method for solubility and purity is presented in Table 59.

TABLE 59
HPLC Method for Purity and Solution Stability Test

| Instrument | Agilent 1260 series | | |
|---|---|---|---|
| Column | Waters Xbridge C18, 4.6*150 mm, 2.5 | | |
| | μm | | |
| Column Temperature | 40° C. | | |
| Mobile Phase | A: 10 mM NH₄OAc, pH 6.8 | | |
| | B: ACN | | |
| Flow Rate | 1.0 mL/min | | |
| Injection Volume | 5 μL | | |
| Detector | DAD | | |
| Wavelength | 275 nm | | |
| Run Time | 15.0 minutes | | |
| Diluent | THF/Water (7/3, v/v) | | |
| Gradient | Time (min) | % A | % B |
| | 0.0 | 95 | 5 |
| | 0.7 | 95 | 5 |
| | 7.0 | 5 | 95 |
| | 11.7 | 5 | 95 |
| | 11.8 | 95 | 5 |
| | 15.0 | 95 | 5 |

### Wet-Milling

The wet-milling was performed with an IKA Magic Lab instrument. The details are presented in Table 60.

TABLE 60
Parameters of Wet-milling

| Instrument | IKA Magic Lab | |
|---|---|---|
| Stator and rotor | 6F + 6F + 6F | |
| Tip speed | 23 m/s (14600 rpm) | |
| Temperature | 0° | C. |
| Milling cycles | 50-100 | cycles |

### 6.4 Example 4: Salt Screening

### Characterization of Starting Material

The starting material compound 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate was prepared as follows:

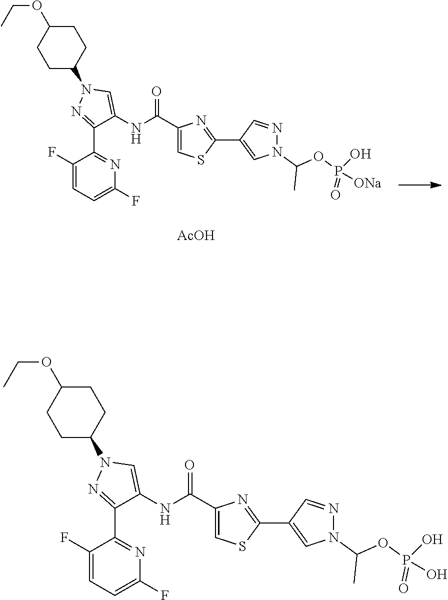

To a sample of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt acetic acid adduct (2.82 g, 4.0 mmol, 1.0 eq) was added deionized water (20 mL) and the mixture stirred for 2 minutes to form a heterogeneous suspension. Formic acid (10 mL) was added in one portion and the mixture sonicated for 5 minutes and stirred for a further 5 minutes. A thick white slurry formed which was diluted with deionized water (20 mL). After stirring for 1 hour, the mixture was further diluted with deionized water (30 mL), stirred for 10 minutes and filtered (filtration slow). The wet solid was washed with water (50 mL and 25 mL). The solid was suction dried on the filter for 16 hours to obtain the free acid as a white solid (2.14 g, 86%). The solid was further dried under vacuum to remove all water. Analysis of solid showed high purity by LC-MS and NMR.

1-(4-(4-((3-(3,6-Difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate obtained in this process was characterized as freeform Form A by XRPD, TGA, DSC and ¹H NMR. The characterization data are provided elsewhere herein.

### Approximate Solubility

Approximate solubility of the starting material was determined in 10 solvent systems at RT. Approximately 2 mg of the sample was added into a 3-mL glass vial. Solvents in Table 61 were then added stepwise into the vials until the solids were dissolved visually or a total volume of 2 mL was reached. Solubility results summarized in Table 61 were used to guide the solvent selection in screening design.

TABLE 61
Approximate solubility of starting material at RT

| | Solubility | | |
|---|---|---|---|
| Solvent | (mg/mL) | Solvent | Solubility (mg/mL) |
| MeOH | S < 1.1 | CHCl₃ | S < 1.0 |
| Acetone | S < 1.1 | 1,4-Dioxane | S < 1.3 |
| EtOAc | S < 1.0 | DMSO/Acetone (1:4) | 2.1 < S < 7.0 |
| THF | S < 1.2 | THF/H₂O (9:1) | 7.0 < S < 21.0 |
| ACN | S < 1.1 | ACN/H₂O (9:1) | S < 1.1 |

### Summary of Salt Screening

According to the approximate solubility of compound 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate at room temperature (RT, 24 f 2° C.), a total of 48 salt screening experiments were performed using 10 bases (two charge ratios for NaOH and KOH) in four solvent systems via solvent-assisted reaction crystallization. In details, about 20 mg of Freeform Form A and corresponding base were mixed into each HPLC vial with a charge ratio of 1:1 or 2:1 (base/freeform). 0.5 mL of corresponding solvent was then added to form a suspension, which was magnetically stirred (˜1000 rpm) at RT for about three days. Solids were isolated for XRPD analysis. As summarized in Table 62, a total of 16 crystalline salt hits and 4 crystal forms of freeform were obtained during screening and identification process based on the XRPD comparison.

TABLE 62

| | | | Solvent (v/v) | | | |
|---|---|---|---|---|---|---|
| | Base | | | B | | |
| | (base/ | Safety | A | DMSO/Acetone | C | D |
| # | freeform) | Class | MeOH | (1:4) | EtOAc | THF/H₂O (9:1) |
| 0 | Blank | — | Freeform Type | Freeform Type | Freeform Type | Freeform Type |
| | | | B | C | A | B |
| 1 | NaOH (1:1) | I | Freeform Type | Freeform Type | Freeform Type | Freeform Type |
| | | | D | D | D | D |
| 2 | KOH (1:1) | I | K Salt Type A | Freeform Type | K Salt Type B | K Salt Type C |
| | | | | C + K salt Type | | |
| | | | | A | | |
| 3 | Mg(OH)₂ (1:1) | I | Mg Salt Type A | Freeform Type | Freeform Type | Low crystalline |
| | | | | C + Mg(OH)₂ | A + Mg(OH)₂ | |
| 4 | Ca(OH)₂ (1:1) | I | Freeform Type | Freeform Type | Freeform Type | Ca Salt Type A |
| | | | B + Ca(OH)₂ | C + Ca(OH)₂ | A + CH(OH)₂ | |
| 5 | Ammonia | I | Freeform Type | Freeform Type | Freeform Type | Ammonium Salt |
| | (1:1) | | B + Peaks | C + Peaks | A + Peaks | Type A |
| 6 | Meglumine | I | Amorphous | Amorphous | Amorphous | Amorphous |
| | (1:1) | | | | | |
| 7 | L-Arginine | I | Arginine Salt | Freeform Type | Freeform Type | Arginine Salt |
| | (1:1) | | Type A | C + Peaks | A + Peaks | Type B |
| 8 | Lysine (1:1) | I | Lysine Salt | Freeform Type | Freeform Type | Amorphous |
| | | | Type A | C | A | |
| 9 | Choline (1:1) | I | Freeform Type | Choline Salt | Choline Salt | Amorphous |
| | | | B | Type A | Type A | |
| 10 | Tromethamine | II | Tris salt Type A | Tris salt Type B | Amorphous | Amorphous |
| | (1:1) | | | | | |
| 11 | NaOH (2:1) | I | Na Salt Type A | Na Salt Type B | Na Salt Type C | Na Salt Type B |
| 12 | KOH (2:1) | I | K Salt Type B | K Salt Type D | Freeform Type | K Salt Type C |
| | | | | | A | |

Arginine salt Form C and Choline salt Form B were observed during VT-XRPD and storage, respectively.

All salt hits were characterized by XRPD, TGA and DSC. The stoichiometric ratio was determined by ¹H NMR or HPLC/IC.

Characterization results of salt hits and freeform forms were listed in Table 63.

TABLE 63

| | | | Molar | |
|---|---|---|---|---|
| Salt Hits | | DSC | ratio | |
| (Sample | Weight loss | endotherm | (base/free | Speculated |
| ID) | (%, temp.) | (peak, ° C.) | acid) | form |
| K Salt | 3.1 (to 150° C.) | 170.3, 248.1 | 0.7:1 | Anhydrate/ |
| Type A | | | | Hydrate |
| K Salt | 5.3 (to 140° C.) | 94.6*, 174.0* | 1.1:1 | Hydrate |
| Type B | 6.7 (140° C.~240° C.) | | | |
| K Salt | 4.0 (to 130° C.) | 101.7*, 168.5* | 1.0:1 | Hydrate |
| Type C | 4.7 (130° C.~230° C.) | | | |
| K Salt | 5.9 (to 125° C.) | 100.6, 149.0 | 1.4:1 | Anhydrate |
| Type D | | | | |
| Arginine Salt | 2.1 (to 190° C.) | 130.7, 216.1 | 1.2:1 | Anhydrate |
| Type A | | | | |
| Choline Salt | 5.1 (to 160° C.) | 67.7, 158.7, | 0.8:1 | Anhydrate |
| Type A | | 195.0 | | |
| Choline Salt | 3.3 (to 160° C.) | 67.2, 159.4, | NA | Anhydrate/ |
| Type B | | 195.7 | | Hydrate |
| Tris Salt | 1.2 (to 150° C.) | 61.3, 174.3 | 1.1:1 | Channel |
| Type A | | | | hydrate |
| Tris Salt | 2.4 (to 140° C.) | 63.0, 135.2, | 0.9:1 | Channel |
| Type B | | 175.6 | | hydrate |
| Na Salt | 5.5 (to 240° C.) | 97.6, 176.4, | 1.5:1 | Anhydrate/ |
| Type A | 6.0 (110° C.~240° C.) | 195.0 | | Hydrate |
| Na Salt | 13.5 (to 250° C.) | 109.9, | 1.6:1 | Anhydrate/ |
| Type B | | 183.1, | | Hydrate |
| | | 226.0 | | |
| Na Salt | 6.1 (to 150° C.) | 66.6, 110.7, | 1.6:1 | Anhydrate/ |
| Type C | | 200.7 | | Hydrate |
| Ammonium | 3.0 (to 115° C.) | 97.9, 160.2, | 0.6:1^{#} | Anhydrate/ |
| Salt Type A | 2.6 (115° C.~200° C.) | 192.9, 238.8 | | Hydrate |
| Arginine | 4.0 (to 160° C.) | 80.8, 119.4, | 1.0:1 | Anhydrate/ |
| Salt Type B | | 145.1, 177.1 | | Hydrate |
| Lysine Salt | 5.0 (to 140° C.) | 69.3, 175.4, | 0.7:1 | Anhydrate/ |
| Type A | | 227.3 | | Hydrate |
| Mg Salt | 11.7 (to 230° C.) | 69.4, 116.4, | 1.0:1^{#} | Anhydrate/ |
| Type A | | 183.2 | | Hydrate |
| Ca Salt | 6.9 (to 180° C.) | 114.0*, 190.5* | 0.8:1^{#} | Anhydrate/ |
| Type A | | | | Hydrate |

### Detailed Characterization of Salt Hits

### Na Salt Form A

Na salt Form A sample was obtained via slurry of freeform and NaOH (the charge ratio of base/freeform was 2:1) in MeOH at RT.

FIG. 96 provides an XRPD pattern of Form A of Compound 1. A list of X-Ray Diffraction Peaks for Form A of Compound 1 is provided below in Table 64.

TABLE 64
X-Ray Diffraction Peaks for Form A of Compound 1

| #Peak | 2θ [°] | d-spacing [Å] | Rel [%] |
|---|---|---|---|
| 1 | 4.41 | 20.04 | 14.56 |
| 2 | 6.56 | 13.46 | 100.00 |
| 3 | 7.10 | 12.43 | 65.39 |
| 4 | 8.56 | 10.32 | 12.27 |
| 5 | 9.46 | 9.34 | 21.22 |
| 6 | 10.88 | 8.12 | 7.22 |
| 7 | 11.83 | 7.48 | 4.75 |
| 8 | 13.18 | 6.71 | 4.34 |
| 9 | 15.67 | 5.65 | 10.09 |
| 10 | 16.90 | 5.24 | 7.06 |
| 11 | 17.58 | 5.04 | 5.64 |
| 12 | 18.88 | 4.70 | 1.89 |
| 13 | 19.74 | 4.49 | 2.33 |
| 14 | 21.90 | 4.06 | 4.65 |
| 15 | 23.71 | 3.75 | 9.60 |
| 16 | 26.20 | 3.40 | 4.36 |
| 17 | 28.53 | 3.13 | 3.49 |
| 18 | 30.85 | 2.90 | 2.98 |

A two-step TGA weight loss of 5.5% (to 110° C.) and 6.0% (110° C. 240° C.) was observed on TGA curve as depicted in FIG. 97. A DSC plot for Form A showed three endotherms at 97.6° C., 176.4° C. and 195.0° C. (peak) on DSC curve as depicted in FIG. 97.

No residual solvent (methanol) was detected in Form A ¹H NMR as depicted in FIG. 98. The stoichiometric ratio of Na⁺/freeform was 1.5:1 by HPLC combined with IC.

### Na Salt Form B

Na salt Form B was obtained via slurry of freeform and NaOH (the charge ratio of base/freeform was 2:1) in DMSO/Acetone (1:4, v/v) at RT.

FIG. 99 provides an XRPD pattern of Form B of Compound 1. A list of X-Ray Diffraction Peaks for Form B of Compound 1 is provided below in Table 65.

TABLE 65
X-Ray Diffraction Peaks for Form B of Compound 1

| #Peak | 2θ [°] | d-spacing [Å] | Rel [%] |
|---|---|---|---|
| 1 | 6.48 | 13.63 | 100.00 |
| 2 | 8.59 | 10.29 | 13.57 |
| 3 | 17.60 | 5.04 | 22.27 |

A TGA weight loss of 13.5% up to 250° C. was observed on TGA curve as depicted in FIG. 100. A DSC plot for Form B showed three endotherms at 109.9° C., 183.1° C. and 226.0° C. (peak) on DSC curve as depicted in FIG. 100.

No residual solvent (DMSO or Acetone) was detected in Form B ¹H NMR as depicted in FIG. 101. The stoichiometric ratio of Na⁺/freeform was 1.5:1 by HPLC combined with IC.

### Na Salt Form C

Na salt Form C was obtained via slurry of freeform and NaOH (the charge ratio of base/freeform was 2:1) in EtOAc at RT.

FIG. 102 provides an XRPD pattern of Form C of Compound 1. A list of X-Ray Diffraction Peaks for Form C of Compound 1 is provided below in Table 66.

TABLE 66
X-Ray Diffraction Peaks for Form C of Compound 1

| #Peak | 2θ [°] | d-spacing [Å] | Rel [%] |
|---|---|---|---|
| 1 | 7.62 | 11.60 | 36.80 |
| 2 | 8.93 | 9.89 | 100.00 |
| 3 | 10.00 | 8.84 | 49.75 |
| 4 | 10.62 | 8.32 | 29.08 |
| 5 | 11.77 | 7.51 | 92.40 |
| 6 | 12.70 | 6.96 | 84.46 |
| 7 | 14.20 | 6.23 | 81.66 |
| 8 | 15.14 | 5.85 | 37.51 |
| 9 | 16.12 | 5.49 | 37.89 |
| 10 | 17.80 | 4.98 | 44.82 |
| 11 | 18.22 | 4.86 | 19.08 |
| 12 | 20.24 | 4.38 | 71.46 |
| 13 | 21.30 | 4.17 | 29.01 |
| 14 | 21.70 | 4.09 | 23.30 |
| 15 | 23.87 | 3.72 | 20.60 |
| 16 | 25.54 | 3.49 | 24.24 |
| 17 | 27.10 | 3.29 | 38.64 |

A TGA weight loss of 6.1% up to 150° C. was observed on TGA curve as depicted in FIG. 103. A DSC plot for Form C showed three endotherms at 66.6° C., 110.7° C. and 200.7° C. (peak) on DSC curve as depicted in FIG. 104.

No residual solvent EtOAc was detected in Form C ¹H NMR as depicted in FIG. 105. The stoichiometric ratio of Na⁺/freeform was 1.5:1 by HPLC combined with IC.

### K Salt Form A

K salt Form A was obtained via slurry of freeform and equimolar KOH in methanol at RT.

FIG. 105 provides an XRPD pattern of Form A of Compound 1A. A list of X-Ray Diffraction Peaks for Form A of Compound 1A is provided below in Table 67.

TABLE 67
X-Ray Diffraction Peaks for Form A of Compound 1A

| #Peak | 2θ [°] | d-spacing [Å] | Rel [%] |
|---|---|---|---|
| 1 | 4.30 | 20.54 | 2.40 |
| 2 | 5.56 | 15.87 | 100.00 |
| 3 | 6.45 | 13.70 | 7.97 |
| 4 | 8.59 | 10.29 | 6.91 |
| 5 | 10.72 | 8.24 | 2.65 |
| 6 | 11.10 | 7.96 | 15.30 |
| 7 | 13.02 | 6.79 | 2.45 |
| 8 | 14.99 | 5.91 | 1.96 |
| 9 | 16.66 | 5.32 | 2.88 |
| 10 | 17.17 | 5.16 | 1.21 |
| 11 | 18.03 | 4.91 | 1.52 |
| 12 | 20.65 | 4.30 | 1.45 |
| 13 | 23.58 | 3.77 | 0.83 |
| 14 | 30.27 | 2.95 | 0.65 |

A TGA weight loss of 3.1% up to 150° C. was observed on TGA curve as depicted in FIG. 106. A DSC plot for Form A showed two endotherms at 170.3° C. and 248.1° C. (peak) as depicted in FIG. 106.

No residual solvent methanol was detected in Form A ¹H NMR as depicted in FIG. 107. The stoichiometric ratio of Na⁺/freeform was 0.7:1 by HPLC combined with IC.

### K Salt Form B

K salt Form B was obtained via slurry of freeform and equimolar KOH in EtOAc at RT.

FIG. 108 provides an XRPD pattern of Form B of Compound 1A. A list of X-Ray Diffraction Peaks for Form B of Compound 1A is provided below in Table 68.

TABLE 68
X-Ray Diffraction Peaks for Form B of Compound 1A

| #Peak | 2θ [°] | d-spacing [Å] | Rel [%] |
|---|---|---|---|
| 1 | 6.41 | 13.78 | 100.00 |
| 2 | 8.56 | 10.33 | 6.90 |
| 3 | 10.67 | 8.29 | 24.10 |
| 4 | 14.94 | 5.92 | 15.68 |
| 5 | 21.37 | 4.15 | 15.34 |
| 6 | 23.67 | 3.76 | 8.55 |
| 7 | 26.02 | 3.42 | 14.68 |

A two-step TGA weight loss of 5.3% (to 140° C.) and 6.7% (140° C. ˜240° C.) was observed on TGA curve as depicted in FIG. 109. A DSC plot for Form B showed two endotherms at 119.1° C. and 187.0° C. (peak) as depicted in FIG. 109.

No residual solvent EtOAc was detected in Form C ¹H NMR as depicted in FIG. 110. The stoichiometric ratio of K⁺/freeform was 1.1:1 by HPLC combined with IC.

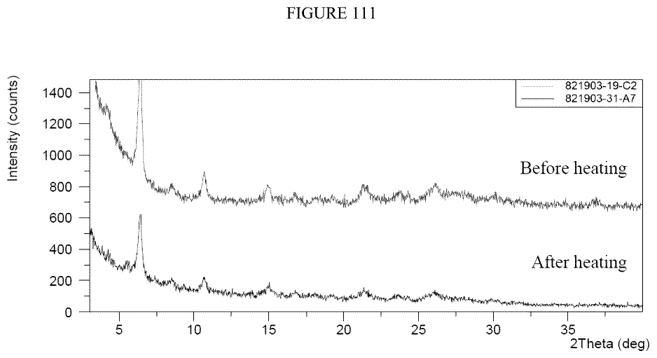

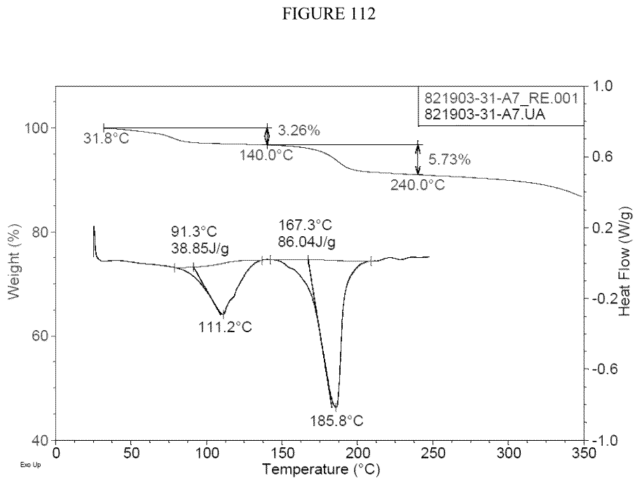

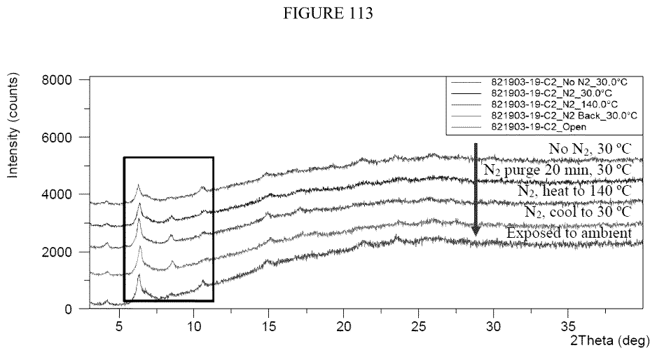

After heating K salt Form B to 130° C. and cooling to RT, no form change was observed. XRPD comparison results were shown in FIG. 111. TGA/DSC curves of the heated sample was displayed in FIG. 112. A two-step weight loss of 3.3% (to 140° C.) and 5.7% (140° C.˜240° C.) and two endotherms at 111.2° C. and 185.8° C. (peak) were observed. VT-XRPD was performed for identification of K salt Form B, and the results were shown in FIG. 113. Slight peak shift was observed after heating K salt Form B to 130° C. and cooling to 30° C. After exposed to ambient conditions, K salt Form B was re-obtained. Based on data above, K salt Form B was designated as a hydrate.

### K Salt Form C

K salt Form C was obtained via slurry of freeform and equimolar KOH in THF/H₂O (9:1, v/v) at RT.

FIG. 114 provides an XRPD pattern of Form C of Compound 1A. A list of X-Ray Diffraction Peaks for Form C of Compound 1A is provided below in Table 69.

TABLE 69
X-Ray Diffraction Peaks for Form C of Compound 1A

| #Peak | 2θ [°] | d-spacing [Å] | Rel [%] |
|---|---|---|---|
| 1 | 4.43 | 19.95 | 12.31 |
| 2 | 6.67 | 13.23 | 53.12 |
| 3 | 8.69 | 10.16 | 100.00 |
| 4 | 9.51 | 9.29 | 12.93 |
| 5 | 10.72 | 8.24 | 18.42 |
| 6 | 13.91 | 6.36 | 49.42 |
| 7 | 15.74 | 5.62 | 7.31 |
| 8 | 16.82 | 5.27 | 80.75 |
| 9 | 17.41 | 5.09 | 16.52 |
| 10 | 20.22 | 4.39 | 15.10 |
| 11 | 25.41 | 3.50 | 9.80 |
| 12 | 36.56 | 2.46 | 4.60 |

A two-step TGA weight loss of 4.0% (to 130° C.) and 4.7% (130° C. 230° C.) was observed on TGA curve as depicted in FIG. 115. A DSC plot for Form C showed two endotherms at 125.9° C. and 182.0° C. (peak) as depicted in FIG. 115.

No residual solvent THF was detected in Form C ¹H NMR as depicted in FIG. 116. The stoichiometric ratio of K⁺/freeform was 1.0:1 by HPLC combined with IC.

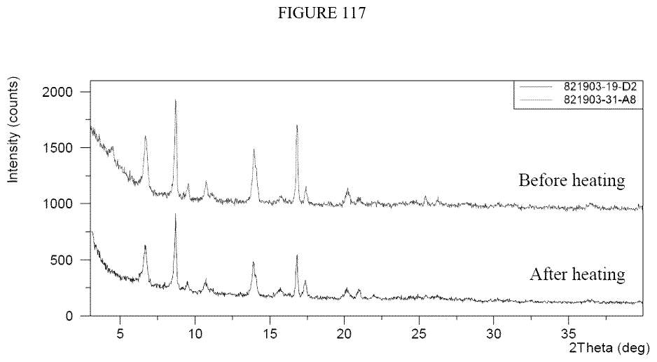

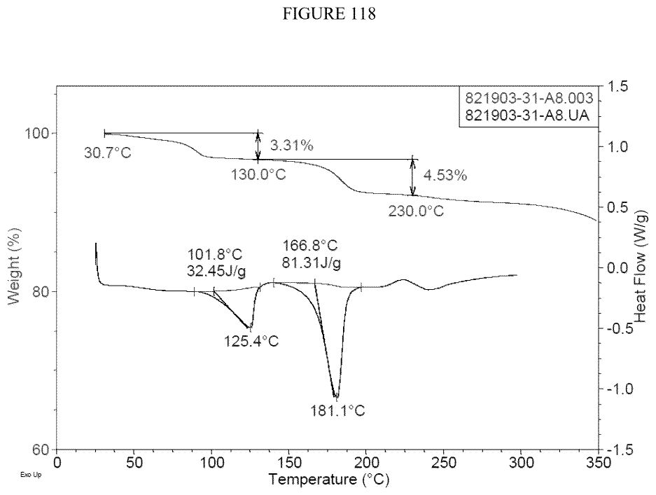

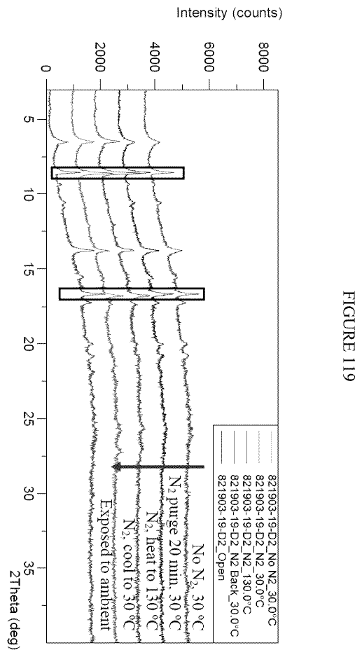

After heating K salt Form C to 130° C. and cooling to RT, no form change was observed. XRPD comparison results are shown in FIG. 117. TGA/DSC curves of the heated sample is displayed in FIG. 118. A two-step weight loss of 3.3% (to 130° C.) and 4.5% (130° C.˜230° C.) and two endotherms at 125.4° C. and 181.1° C. (peak) were observed. VT-XRPD was performed for identification of K salt Form C, and the results are shown in FIG. 119. Slight peak shift was observed after heating K salt Form C to 130° C. and cooling to 30° C. After exposed to ambient conditions, K salt Form C was re-obtained. Based on data above, K salt Form C was designated as a hydrate.

### K Salt Form D

K salt Form D was obtained via slurry of freeform and KOH (the charge ratio of base/freeform was 2:1) in DMSO/Acetone (1:4, v/v) at RT.

FIG. 120 provides an XRPD pattern of Form D of Compound 1A. A list of X-Ray Diffraction Peaks for Form D of Compound 1A is provided below in Table 70.

TABLE 70
X-Ray Diffraction Peaks for Form D of Compound 1A

| #Peak | 2θ [°] | d-spacing [Å] | Rel [%] |
|---|---|---|---|
| 1 | 5.20 | 16.99 | 100.00 |
| 2 | 10.37 | 8.52 | 6.43 |
| 3 | 12.43 | 7.11 | 5.74 |
| 4 | 15.59 | 5.68 | 8.36 |
| 5 | 17.01 | 5.21 | 13.00 |
| 6 | 19.96 | 4.44 | 1.61 |
| 7 | 20.77 | 4.27 | 2.69 |
| 8 | 21.92 | 4.05 | 5.19 |
| 9 | 24.30 | 3.66 | 1.64 |
| 10 | 24.96 | 3.56 | 2.40 |
| 11 | 29.57 | 3.02 | 1.57 |

A stepwise TGA weigh loss of 5.9% up to 125° C. was observed on TGA curve as depicted in FIG. 121. A DSC plot for Form C showed a weak endotherm at 100.6° C. (peak) and a sharp endotherm at 149.0° C. (peak) as depicted in FIG. 121.

The molar ratio of residual solvent DMSO/freeform was 0.07:1 (the corresponding TGA weight loss was 0.8%) as seen in ¹H NMR provided in FIG. 122. The stoichiometric ratio of K⁺/freeform was 1.4:1 by HPLC combined with IC.

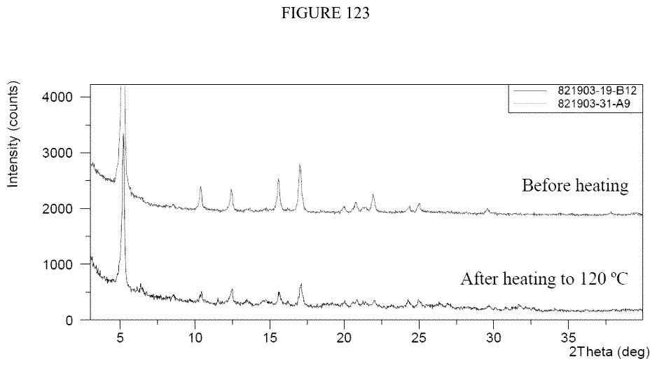

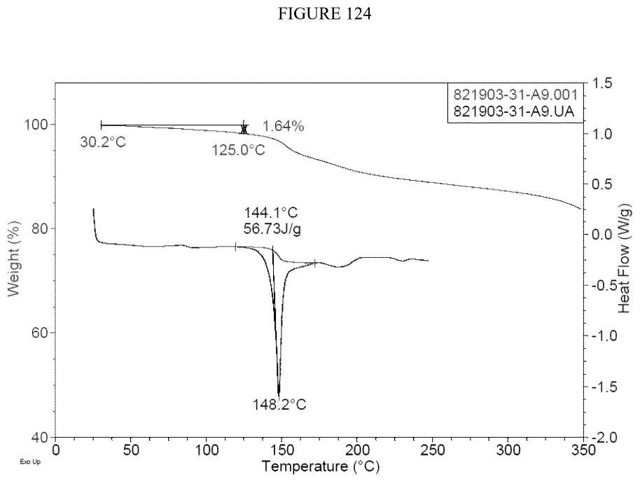

No form change was observed after heating K salt Form D to 120° C. and cooling to RT, XRPD results are shown in FIG. 123. TGA/DSC curves of the heated sample are displayed in FIG. 124, a weight loss of 1.6% up to 125° C. and a sharp endotherm at 148.2° C. (peak) were observed.

### Mg Salt Form A

Mg salt Form A was obtained via slurry of freeform and equimolar Mg(OH)₂ in MeOH at RT.

FIG. 125 provides an XRPD pattern of Form A of Compound 1B. A list of X-Ray Diffraction Peaks for Form A of Compound 1B is provided below in Table 71.

TABLE 71
X-Ray Diffraction Peaks for Form A of Compound 1B

| #Peak | 2θ [°] | d-spacing [Å] | Rel [%] |
|---|---|---|---|
| 1 | 5.44 | 16.23 | 71.61 |
| 2 | 6.77 | 13.04 | 22.50 |
| 3 | 8.16 | 10.82 | 100.00 |
| 4 | 8.77 | 10.07 | 18.76 |
| 5 | 9.92 | 8.91 | 39.72 |
| 6 | 10.90 | 8.11 | 75.26 |
| 7 | 13.64 | 6.49 | 35.99 |
| 8 | 16.35 | 5.42 | 30.94 |
| 9 | 18.60 | 4.77 | 41.06 |
| 10 | 27.39 | 3.25 | 15.99 |

A TGA weigh loss of 11.7% up to 230° C. was observed on TGA curve as depicted in FIG. 126. A DSC plot for Form A showed three endotherms at 69.4° C., 116.4° C. and 183.2° C. (peak) as depicted in FIG. 126.

No residual solvent EtOAc was detected in Form C ¹H NMR as depicted in FIG. 127. The stoichiometric ratio of Mg⁺⁺/freeform was 1.0:1 by HPLC combined with IC.

### Ca Salt Form A

Ca salt Form A was obtained via slurry of freeform and equimolar Ca(OH)₂ in THF/H₂O (9:1, v/v) at RT.

FIG. 128 provides an XRPD pattern of Form A of Compound 1C. A list of X-Ray Diffraction Peaks for Form A of Compound 1C is provided below in Table 72.

TABLE 72
X-Ray Diffraction Peaks for Form A of Compound 1C

| #Peak | 2θ [°] | d-spacing [Å] | Rel [%] |
|---|---|---|---|
| 1 | 4.86 | 18.18 | 100.00 |
| 2 | 6.55 | 13.49 | 5.01 |
| 3 | 7.62 | 11.60 | 6.51 |
| 4 | 9.39 | 9.41 | 8.17 |
| 5 | 11.41 | 7.75 | 10.09 |
| 6 | 13.57 | 6.52 | 9.22 |
| 7 | 14.56 | 6.08 | 13.54 |
| 8 | 15.73 | 5.63 | 12.55 |
| 9 | 16.97 | 5.22 | 9.94 |
| 10 | 18.11 | 4.89 | 4.44 |
| 11 | 19.47 | 4.56 | 12.03 |
| 12 | 22.90 | 3.88 | 11.48 |
| 13 | 29.56 | 3.02 | 2.62 |
| 14 | 34.37 | 2.61 | 1.96 |

A stepwise TGA weigh loss of 6.9 up to 180° C. was observed on TGA curve as depicted in FIG. 129. A DSC plot for Form A showed two endotherms at 142.9° C. and 195.0° C. (peak) as depicted in FIG. 129.

No residual solvent THF was detected in Form A ¹H NMR as depicted in FIG. 130. The stoichiometric ratio of Ca⁺⁺/freeform was 0.8:1 by HPLC combined with IC.

### Ammonium Salt Form A

Ammonium salt Form A was obtained via slurry of freeform and equimolar NH₃·H₂O in THF/H₂O (9:1, v/v) at room temperature.

FIG. 131 provides an XRPD pattern of Form A of Compound 1D. A list of X-Ray Diffraction Peaks for Form A of Compound 1D is provided below in Table 73.

TABLE 73
X-Ray Diffraction Peaks for Form A of Compound 1D

| #Peak | 2θ [°] | d-spacing [Å] | Rel [%] |
|---|---|---|---|
| 1 | 4.52 | 19.52 | 31.58 |
| 2 | 5.52 | 16.00 | 27.89 |
| 3 | 6.80 | 13.00 | 18.04 |
| 4 | 8.70 | 10.15 | 100.00 |
| 5 | 9.51 | 9.29 | 11.90 |
| 6 | 10.80 | 8.18 | 21.48 |
| 7 | 14.12 | 6.27 | 51.54 |
| 8 | 16.80 | 5.27 | 68.63 |
| 9 | 17.41 | 5.09 | 29.27 |
| 10 | 20.55 | 4.32 | 9.69 |
| 11 | 25.45 | 3.50 | 13.38 |
| 12 | 26.22 | 3.40 | 12.27 |

A two-step TGA weigh loss of 3.0% (to 115° C.) and 2.6% (115° C.˜200° C.) was observed on TGA curve as depicted in FIG. 132. A DSC plot for Form A showed four endotherms at 97.9° C., 160.2° C., 192.9° C. and 238.8° C. (peak) as depicted in FIG. 132.

No residual solvent THF was detected in Form A ¹H NMR as depicted in FIG. 133. The stoichiometric ratio of NH₄⁺/freeform was 0.6:1 by HPLC combined with IC.

### Arginine Salt Form A

Arginine salt Form A was obtained via slurry of freeform and equimolar Arginine in methanol at room temperature.

FIG. 134 provides an XRPD pattern of Form A of Compound 1E. A list of X-Ray Diffraction Peaks for Form A of Compound 1E is provided below in Table 74.

TABLE 74
X-Ray Diffraction Peaks for Form A of Compound 1E

| #Peak | 2θ [°] | d-spacing [Å] | Rel [%] |
|---|---|---|---|
| 1 | 4.65 | 19.00 | 100.00 |
| 2 | 9.32 | 9.48 | 12.36 |
| 3 | 12.25 | 7.22 | 33.83 |
| 4 | 13.91 | 6.36 | 94.68 |
| 5 | 15.73 | 5.63 | 26.55 |
| 6 | 16.69 | 5.31 | 13.99 |
| 7 | 18.59 | 4.77 | 19.22 |
| 8 | 21.76 | 4.08 | 14.69 |
| 9 | 22.87 | 3.89 | 15.11 |
| 10 | 25.05 | 3.55 | 16.56 |

A TGA weigh loss of 2.1% up to 190° C. was observed on TGA curve as depicted in FIG. 135. A DSC plot for Form A showed a weak endotherm at 130.7° C. (peak) and a sharp endotherm at 216.2° C. (peak) as depicted in FIG. 135.

No residual solvent methanol was detected in Form A ¹H NMR as depicted in FIG. 136. The stoichiometric ratio of arginine/freeform was 1.2:1 by HPLC combined with IC.

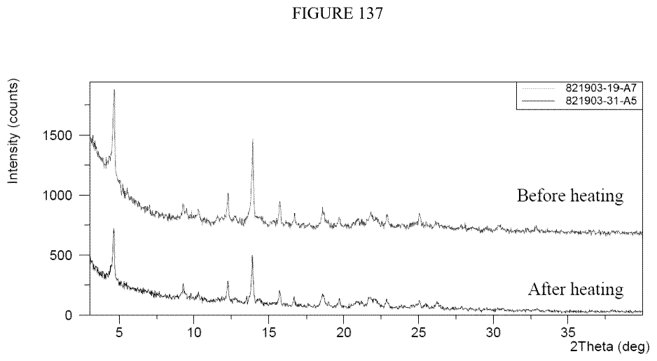

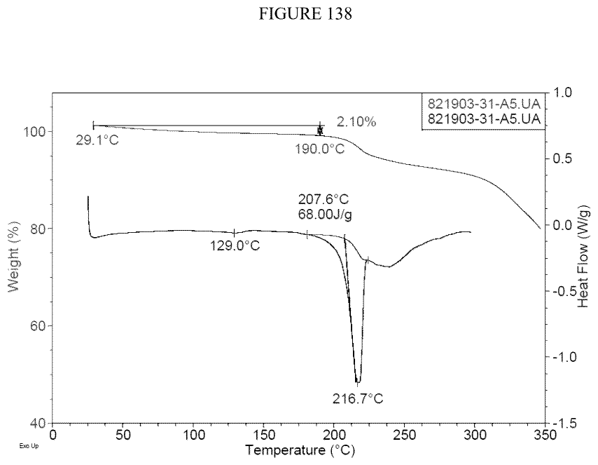

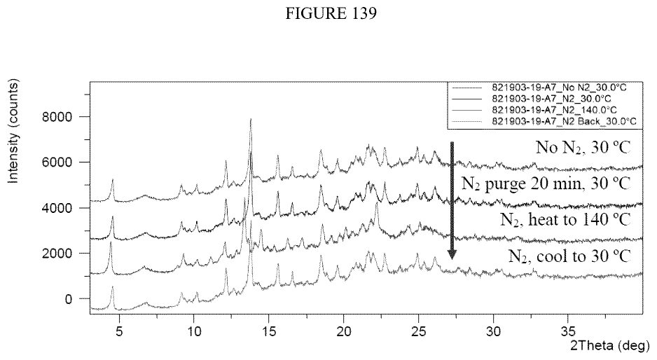

As XRPD comparison results in FIG. 137 shown, no form change was observed after heating Arginine salt Form A to 140° C. and cooling to RT. TGA/DSC curves of the heated sample are displayed in FIG. 138, which was consistent with the sample before heating. A weight loss of 2.1% up to 190° C. and two endotherms at 129.0° C. and 216.7° C. (peak) were observed. VT-XRPD was performed for identification of Arginine salt Form A, and the results are shown in FIG. 139. A new form was observed after heating Arginine salt Form A to 140° C. with N2 protection, which was named as Arginine salt Form C. After cooling to 30° C. with N2 protection, Arginine salt Form A was re-obtained. Based on data above, Arginine salt Type A was designated as an anhydrate.

### Arginine Salt Form B

Arginine salt Form B was obtained via slurry of freeform and Arginine in THF/H₂O (9:1, v/v) at room temperature.

FIG. 140 provides an XRPD pattern of Form B of Compound 1E. A list of X-Ray Diffraction Peaks for Form B of Compound 1E is provided below in Table 75.

TABLE 75
X-Ray Diffraction Peaks for Form B of Compound 1E

| #Peak | 2θ [°] | d-spacing [Å] | Rel [%] |
|---|---|---|---|
| 1 | 4.07 | 21.68 | 24.31 |
| 2 | 6.10 | 14.49 | 26.74 |
| 3 | 8.16 | 10.83 | 46.57 |
| 4 | 9.01 | 9.81 | 100.00 |
| 5 | 14.06 | 6.30 | 33.79 |
| 6 | 16.94 | 5.23 | 29.22 |
| 7 | 17.43 | 5.08 | 77.30 |
| 8 | 21.29 | 4.17 | 35.49 |
| 9 | 24.28 | 3.66 | 20.20 |
| 10 | 26.34 | 3.38 | 32.62 |

A TGA weigh loss of 4.0% up to 160° C. was observed on TGA curve as depicted in FIG. 141. A DSC plot for Form B showed four endotherms at 80.8 #C, 119.4° C., 145.1° C. and 177.1° C. (peak) as depicted in FIG. 141.

No residual solvent THF was detected in Form B ¹H NMR as depicted in FIG. 142. The stoichiometric ratio of arginine/freeform was 1:1 by HPLC combined with IC.

### Arginine Salt Form C

Arginine salt Form C was obtained by heating Arginine salt Form A to 140° C. with N₂ protection.

FIG. 143 provides an XRPD pattern of Form C of Compound 1E. A list of X-Ray Diffraction Peaks for Form C of Compound 1E is provided below in Table 76.

TABLE 76
X-Ray Diffraction Peaks for Form C of Compound 1E

| #Peak | 2θ [°] | d-spacing [Å] | Rel [%] |
|---|---|---|---|
| 1 | 4.42 | 19.96 | 54.41 |
| 2 | 6.61 | 13.37 | 10.85 |
| 3 | 9.26 | 9.55 | 25.00 |
| 4 | 10.19 | 8.67 | 11.69 |
| 5 | 11.09 | 7.97 | 12.33 |
| 6 | 12.06 | 7.33 | 33.34 |
| 7 | 12.81 | 6.90 | 15.32 |
| 8 | 13.36 | 6.62 | 100.00 |
| 9 | 14.05 | 6.30 | 20.27 |
| 10 | 14.46 | 6.12 | 44.27 |
| 11 | 15.33 | 5.77 | 11.67 |
| 12 | 16.26 | 5.45 | 21.35 |
| 13 | 17.21 | 5.15 | 18.65 |
| 14 | 18.54 | 4.78 | 34.37 |
| 15 | 19.16 | 4.63 | 15.16 |
| 16 | 19.67 | 4.51 | 14.14 |
| 17 | 20.12 | 4.41 | 27.31 |
| 18 | 20.57 | 4.32 | 19.30 |
| 19 | 21.25 | 4.18 | 31.17 |
| 20 | 21.80 | 4.07 | 38.58 |
| 21 | 22.21 | 4.00 | 66.89 |
| 22 | 24.27 | 3.66 | 24.48 |
| 23 | 25.07 | 3.55 | 30.40 |
| 24 | 27.22 | 3.27 | 13.01 |
| 25 | 31.61 | 2.83 | 7.44 |

After cooling to 30° C. with N₂ protection, Arginine salt Form C converted to Arginine salt Form A.

### Lysine Salt Form A

Lysine salt Form A was obtained via slurry of freeform and lysine in methanol at room temperature.

FIG. 144 provides an XRPD pattern of Form A of Compound 1F. A list of X-Ray Diffraction Peaks for Form A of Compound 1F is provided below in Table 77.

TABLE 77
X-Ray Diffraction Peaks for Form A of Compound 1F

| #Peak | 2θ [°] | d-spacing [Å] | Rel [%] |
|---|---|---|---|
| 1 | 4.27 | 20.68 | 63.51 |
| 2 | 6.39 | 13.82 | 92.14 |
| 3 | 10.60 | 8.34 | 100.00 |

A TGA weigh loss of 5.0% up to 140° C. was observed on TGA curve as depicted in FIG. 145. A DSC plot for Form A showed three endotherms at 69.3° C., 175.4° C. and 227.3° C. (peak) as depicted in FIG. 145.

No residual solvent methanol was detected in Form A ¹H NMR as depicted in FIG. 146. The stoichiometric ratio of lysine/freeform was 0.7:1 by HPLC combined with IC.

### Choline Salt Form A

Choline salt Form A was obtained via slurry of freeform and equimolar choline in EtOAc at room temperature.

FIG. 147 provides an XRPD pattern of Form A of Compound 1G. A list of X-Ray Diffraction Peaks for Form A of Compound 1G is provided below in Table 78.

TABLE 78
X-Ray Diffraction Peaks for Form A of Compound 1G

| #Peak | 2θ [°] | d-spacing [Å] | Rel [%] |
|---|---|---|---|
| 1 | 4.05 | 21.81 | 48.20 |
| 2 | 5.22 | 16.92 | 100.00 |
| 3 | 10.07 | 8.77 | 51.44 |
| 4 | 13.03 | 6.79 | 49.87 |
| 5 | 14.60 | 6.06 | 13.02 |
| 6 | 17.18 | 5.16 | 17.82 |
| 7 | 18.18 | 4.88 | 17.60 |
| 8 | 20.89 | 4.25 | 24.95 |
| 9 | 22.58 | 3.93 | 16.38 |
| 10 | 24.23 | 3.67 | 21.27 |
| 11 | 26.05 | 3.42 | 22.21 |

A TGA weigh loss of 5.1% up to 160° C. was observed on TGA curve as depicted in FIG. 148. A DSC plot for Form A showed two weak endotherms at 67.7° C. and 158.7° C. (peak), and a sharp endotherm at 195.0° C. (peak) as depicted in FIG. 148.

No residual solvent EtOAc was detected in Form A ¹H NMR as depicted in FIG. 149. The stoichiometric ratio of choline/freeform was 0.8:1 by HPLC combined with IC.

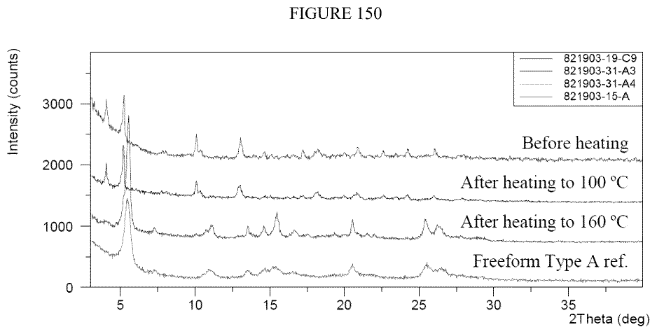

Heating experiments were performed for identification of choline salt Form A, and XRPD patterns are provided in FIG. 150. After heating to 100° C. and cooling to RT, no form change was observed. Choline salt Form A was an anhydrate as described in the form conversion study of Form B of Compound IG. As a result, the first endotherm was caused by removal of residual moisture, and the second one was the signal of form change to freeform.

### Choline Salt Form B

Choline salt Form B was obtained by storing choline salt Form A at room temperature for 23 days.

FIG. 151 provides an XRPD pattern of Form B of Compound 1G. A list of X-Ray Diffraction Peaks for Form B of Compound 1G is provided below in Table 79.

TABLE 79
X-Ray Diffraction Peaks for Form B of Compound 1G

| #Peak | 2θ [°] | d-spacing [Å] | Rel [%] |
|---|---|---|---|
| 1 | 4.07 | 21.68 | 50.31 |
| 2 | 5.18 | 17.05 | 100.00 |
| 3 | 7.71 | 11.45 | 7.39 |
| 4 | 10.10 | 8.75 | 27.58 |
| 5 | 12.89 | 6.86 | 41.66 |
| 6 | 13.61 | 6.50 | 17.26 |
| 7 | 13.99 | 6.33 | 12.94 |
| 8 | 15.23 | 5.81 | 8.74 |
| 9 | 16.60 | 5.34 | 4.40 |
| 10 | 17.67 | 5.01 | 11.21 |
| 11 | 18.07 | 4.91 | 23.06 |
| 12 | 20.67 | 4.29 | 23.22 |
| 13 | 22.20 | 4.00 | 15.09 |
| 14 | 23.32 | 3.81 | 13.89 |
| 15 | 23.80 | 3.74 | 15.09 |
| 16 | 25.61 | 3.48 | 8.03 |
| 17 | 27.45 | 3.25 | 17.13 |
| 18 | 27.88 | 3.20 | 2.53 |
| 19 | 28.57 | 3.12 | 6.47 |

A TGA weigh loss of 3.3% up to 160° C. was observed on TGA curve as depicted in FIG. 152. A DSC plot for Form B showed three endotherms at 67.2° C., 159.4° C. and 195.7° C. (peak) as depicted in FIG. 152.

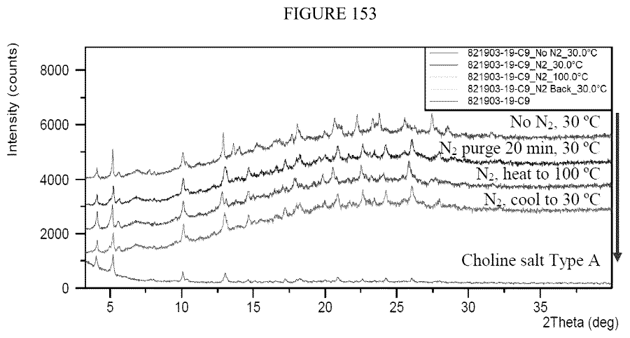

VT-XRPD results are depicted in FIG. 153. Form conversion to choline salt Form A was observed after N₂ purging choline salt Form B for 20 min at 30° C. After further heating to 100° C. and cooling to 30° C. with N₂ protection, choline salt Form A was observed. As a result, choline salt Form A was designated as an anhydrate.

### Tris Salt Form A

Tris salt Form A was obtained from a slurry of freeform and equimolar tromethamine in methanol at room temperature.

FIG. 154 provides an XRPD pattern of Form A of Compound 1H. A list of X-Ray Diffraction Peaks for Form A of Compound 1H is provided below in Table 80.

TABLE 80
X-Ray Diffraction Peaks for Form A of Compound 1H

| #Peak | 2θ [°] | d-spacing [Å] | Rel [%] |
|---|---|---|---|
| 1 | 4.86 | 18.16 | 83.85 |
| 2 | 8.00 | 11.04 | 100.00 |
| 3 | 8.57 | 10.30 | 81.10 |
| 4 | 9.84 | 8.98 | 20.73 |
| 5 | 11.10 | 7.97 | 15.53 |
| 6 | 12.22 | 7.24 | 13.72 |
| 7 | 13.24 | 6.68 | 24.35 |
| 8 | 16.04 | 5.52 | 33.40 |
| 9 | 16.55 | 5.35 | 38.87 |
| 10 | 17.48 | 5.07 | 38.90 |
| 11 | 19.76 | 4.49 | 21.42 |
| 12 | 21.72 | 4.09 | 20.53 |
| 13 | 25.54 | 3.49 | 16.80 |

A TGA weigh loss of 1.2% up to 150° C. was observed on TGA curve as depicted in FIG. 155. A DSC plot for Form A showed a broad endotherm at 61.3° C. and a sharp endotherm at 174.3° C. (peak) as depicted in FIG. 155.

No residual solvent methanol was detected in Form A ¹H NMR as depicted in FIG. 156. The molar ratio of Tromethamine/freeform was 1:1 by HPLC combined with IC.

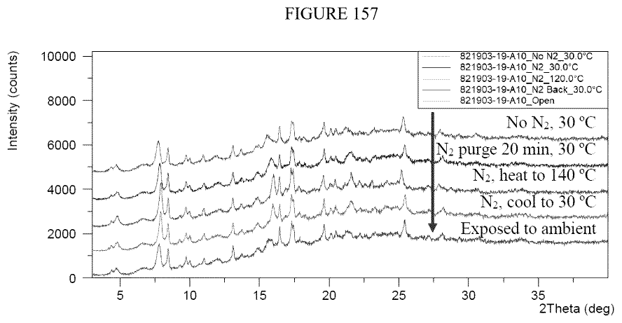

VT-XRPD results are displayed in FIG. 157. A slight peak shift was observed after N₂ sweeping for 20 min. After heating to 120° C. and cooling to 30° C. with N₂ protection, XRPD pattern was consistent with that before heating under N₂ protection. Tris salt Form A was re-obtained after exposing to ambient conditions for ˜1 hr. Based on VT-XRPD results, Tris salt Form A was depicted to be a channel hydrate, which could accommodate water molecule in the channel or cavity. The removal or adsorption caused the expansion or contraction of lattice and peaks shift of XRPD pattern.

### Tris Salt Form B

Tris salt Form B was obtained from a slurry of freeform and equimolar tromethamine in DMSO/acetone (4:1, v/v) at room temperature.

FIG. 158 provides an XRPD pattern of Form B of Compound 1H. A list of X-Ray Diffraction Peaks for Form B of Compound 1H is provided below in Table 81.

TABLE 81
X-Ray Diffraction Peaks for Form B of Compound 1H

| | 2θ | d-spacing | Rel |
|---|---|---|---|
| #Peak | [°] | [Å] | [%] |
| 1 | 4.49 | 19.67 | 79.68 |
| 2 | 6.67 | 13.24 | 19.52 |
| 3 | 11.16 | 7.92 | 83.83 |
| 4 | 13.24 | 6.68 | 32.96 |
| 5 | 15.05 | 5.88 | 23.21 |
| 6 | 16.45 | 5.39 | 9.18 |
| 7 | 17.92 | 4.95 | 14.80 |
| 8 | 20.60 | 4.31 | 35.85 |
| 9 | 23.44 | 3.79 | 33.35 |
| 10 | 25.55 | 3.48 | 100.00 |
| 11 | 28.24 | 3.16 | 43.10 |

A TGA weigh loss of 2.4% up to 140° C. was observed on TGA curve as depicted in FIG. 159. A DSC plot for Form B showed three endotherms at 63.0° C., 135.2° C. and 175.6° C. (peak) as depicted in FIG. 158.

No residual solvent DMSO or acetone was detected in Form A ¹H NMR as depicted in FIG. 160. The molar ratio of Tromethamine/freeform was 0.9:1 by HPLC combined with IC.

### Freeform Isolation

Freeform of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate (Compound 1I) were isolated using the below procedure starting from 50 mg of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt as the starting material.

1) Add 49.9 mg of the starting material and 1 mL of H₂O into a 5-mL glass vial.

2) Add 0.1 mL HCl (1 N) dropwise when stirring. Magnetically stir at RT for 0.5 hr.

3) Add 3 mL DCM dropwise when stirring. Magnetically stir at RT for 0.5 hr. Keep the sample stand at RT for ˜2 hrs.

4) Suspension could be observed in the upper layer (H₂O). Collect suspension in water layer and isolate sample by centrifugation (10000 rpm, 2 min).

5) Dry solids at 50° C. under vacuum overnight. Solid was 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate, which was characterized by XRPD, TGA and DSC.

6) IC result showed the Na⁺ content was 0.25%, indicating sample was freeform.

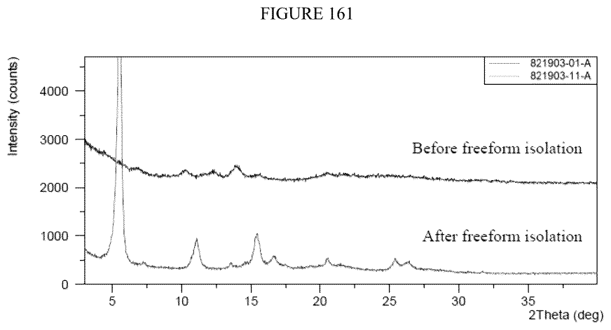

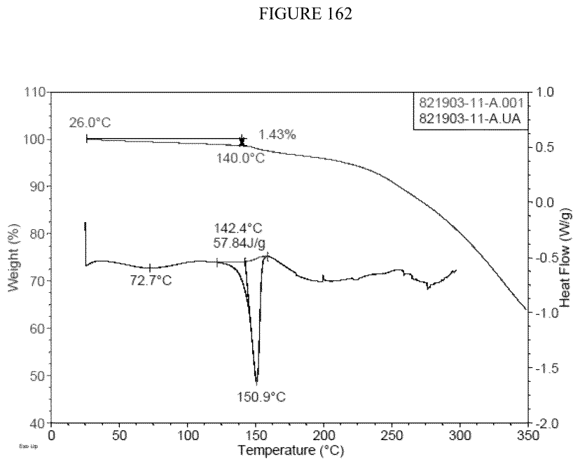

XRPD, TGA and DSC characterization results of freeform, 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate, are provided in FIG. 161 and FIG. 162. The isolated freeform was crystalline.

A list of X-Ray Diffraction Peaks for freeform is provided below in Table 82.

TABLE 82
X-Ray Diffraction Peaks for freeform

| | 2θ | d-spacing | Rel |
|---|---|---|---|
| #Peak | [°] | [Å] | [%] |
| 1 | 5.51 | 16.03 | 100.00 |
| 2 | 10.98 | 8.05 | 11.71 |
| 3 | 13.51 | 6.55 | 10.88 |
| 4 | 15.29 | 5.79 | 15.81 |
| 5 | 20.54 | 4.32 | 20.75 |
| 6 | 25.48 | 3.49 | 21.23 |
| 7 | 26.56 | 3.35 | 15.13 |

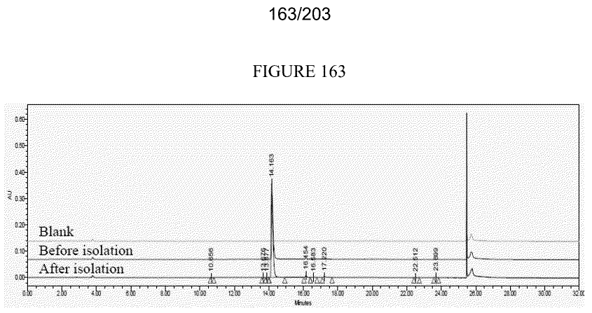

A weight loss of 1.4% up to 140° C. was observed on TGA curve. A broad endotherm at 72.7° C. (peak) and a sharp endotherm at 142.4° C. (onset) were observed on DSC curves. HPLC result showed that the purity of sample was 96.80 area % (Purity/initial purity was 100.3%). HPLC chromatogram and individual impurities were summarized in FIG. 163 and Table 83.

TABLE 83

| | | 821903-01-A | 821903-11-A |
|---|---|---|---|
| #Peak | RRT | (area %) | (area %) |
| 1 | 0.75 | 0.07 | 0.09 |
| 2 | 0.96 | 0.05 | <0.05 |
| 3 | 0.98 | 0.04 | <0.05 |
| 4 | 1.00 | 96.48 | 96.80 |
| 5 | 1.14 | 1.35 | 2.07 |
| 6 | 1.17 | 0.15 | 0.12 |
| 7 | 1.22 | 1.04 | 0.22 |
| 8 | 1.30 | <0.05 | 0.07 |
| 9 | 1.41 | <0.05 | 0.15 |
| 10 | 1.59 | 0.23 | 0.25 |
| 11 | 1.67 | 0.60 | 0.23 |

### Form A Compound 1I

FIG. 164 provides an XRPD pattern of Form A of Compound 1I. A list of X-Ray Diffraction Peaks for Form A of Compound 1I is provided below in Table 84.

TABLE 84
X-Ray Diffraction Peaks for Form A of Compound 1I

| | 2θ | d-spacing | Rel |
|---|---|---|---|
| #Peak | [°] | [Å] | [%] |
| 1 | 5.51 | 16.03 | 100.00 |
| 2 | 10.98 | 8.05 | 11.71 |
| 3 | 13.51 | 6.55 | 10.88 |
| 4 | 15.29 | 5.79 | 15.81 |
| 5 | 20.54 | 4.32 | 20.75 |
| 6 | 25.48 | 3.49 | 21.23 |
| 7 | 26.56 | 3.35 | 15.13 |

A TGA weigh loss of 1.6% up to 150° C. was observed on TGA curve as depicted in FIG. 165. A DSC plot for Form A showed broad endotherm at 82.3° C. (peak temperature) and a sharp endotherm at 146.2° C. (onset temperature), which was speculated to be caused by melting as depicted in FIG. 165.

¹H NMR data in FIG. 166 was collected using DMSO-d₆ as solvent.

### Form B Compound 1I

Form B of Compound 1I was obtained via slurry of freeform starting material in methanol at room temperature.

FIG. 167 provides an XRPD pattern of Form B of Compound 1I. A list of X-Ray Diffraction Peaks for Form B of Compound 1I is provided below in Table 85.

TABLE 85
X-Ray Diffraction Peaks for Form B of Compound 1I

| | 2θ | d-spacing | Rel |
|---|---|---|---|
| #Peak | [°] | [Å] | [%] |
| 1 | 5.53 | 15.95 | 100.00 |
| 2 | 11.06 | 7.99 | 15.81 |
| 3 | 12.99 | 6.81 | 17.03 |
| 4 | 13.87 | 6.38 | 0.75 |
| 5 | 16.59 | 5.34 | 3.46 |
| 6 | 17.95 | 4.94 | 6.12 |
| 7 | 20.69 | 4.29 | 4.31 |
| 8 | 21.53 | 4.12 | 2.04 |
| 9 | 23.24 | 3.82 | 1.63 |
| 10 | 23.79 | 3.74 | 1.85 |
| 11 | 26.11 | 3.41 | 2.53 |
| 12 | 37.22 | 2.41 | 0.27 |

A TGA weigh loss of 4.2% up to 140° C. was observed on TGA curve as depicted in FIG. 168. A DSC plot for Form A showed three endotherms at 53.8° C., 167.1° C. and 220.3° C. (peak), as depicted in FIG. 168.

¹H NMR data in FIG. 169 indicated no residual solvent MeOH.

### Form C Compound 1I

Form C of Compound 1I was obtained via slurry of freeform starting material in DMSO/Acetone (1:4, v/v) at room temperature.

FIG. 170 provides an XRPD pattern of Form C of Compound 1I. A list of X-Ray Diffraction Peaks for Form C of Compound 1I is provided below in Table 86.

TABLE 86
X-Ray Diffraction Peaks for Form C of Compound 1I

| | 2θ | d-spacing | Rel |
|---|---|---|---|
| #Peak | [°] | [Å] | [%] |
| 1 | 5.35 | 16.50 | 100.00 |
| 2 | 10.70 | 8.26 | 8.47 |
| 3 | 12.68 | 6.98 | 12.66 |
| 4 | 13.59 | 6.51 | 1.69 |
| 5 | 14.66 | 6.04 | 1.57 |
| 6 | 16.05 | 5.52 | 6.87 |
| 7 | 17.43 | 5.08 | 11.16 |
| 8 | 20.43 | 4.34 | 1.66 |
| 9 | 21.19 | 4.19 | 3.59 |
| 10 | 21.74 | 4.08 | 2.20 |
| 11 | 22.50 | 3.95 | 3.24 |
| 12 | 24.91 | 3.57 | 2.51 |
| 13 | 25.50 | 3.49 | 3.30 |

A TGA weigh loss of 7.8% up to 120° C. was observed on TGA curve as depicted in FIG. 171. A DSC plot for Form A showed three endotherms at 131.4° C. (peak) as depicted in FIG. 171.

¹H NMR data in FIG. 172 indicated no residual solvent DMSO or acetone.

### Freeform Form D

Form D of Compound 1I was obtained via slurry of equimolar starting material freeform and NaOH in DMSO/acetone (4:1, v/v).

FIG. 173 provides an XRPD pattern of Form D of Compound 1I. A list of X-Ray Diffraction Peaks for Form D of Compound 1I is provided below in Table 87.

TABLE 87
X-Ray Diffraction Peaks for Form D of Compound 1I

| | 2θ | d-spacing | Rel |
|---|---|---|---|
| #Peak | [°] | [Å] | [%] |
| 1 | 6.70 | 13.18 | 17.56 |
| 2 | 8.73 | 10.13 | 100.00 |
| 3 | 9.52 | 9.28 | 6.99 |
| 4 | 10.76 | 8.21 | 9.26 |
| 5 | 13.99 | 6.33 | 19.16 |
| 6 | 15.63 | 5.67 | 7.89 |
| 7 | 16.90 | 5.24 | 58.38 |
| 8 | 17.47 | 5.07 | 34.81 |
| 9 | 20.31 | 4.37 | 6.77 |
| 10 | 21.05 | 4.22 | 12.80 |
| 11 | 22.04 | 4.03 | 9.26 |
| 12 | 26.38 | 3.38 | 7.22 |
| 13 | 34.38 | 2.61 | 3.46 |

A TGA stepwise weight loss of 5.6% up to 160° C. was observed on TGA curve as depicted in FIG. 174. A DSC plot for Form D showed two endotherms at 109.6° C. and 194.3° C. (peak) as depicted in FIG. 171.

¹H NMR data in FIG. 175 indicated no residual solvent DMSO or acetone.

### Preparation and Baseline Characterization of Starting Sodium Salt

The starting material used to prepare the freeforms was 1-(4-(4-((3-(3,6-difluoropyridin-2-yl)-1-((1 r,4r)-4-ethoxycyclohexyl)-1H-pyrazol-4-yl)carbamoyl)thiazol-2-yl)-1H-pyrazol-1-yl)ethyl phosphate monosodium salt, which was prepared from monosodium salt acetic acid adduct as follows using procedure 1) or 2):

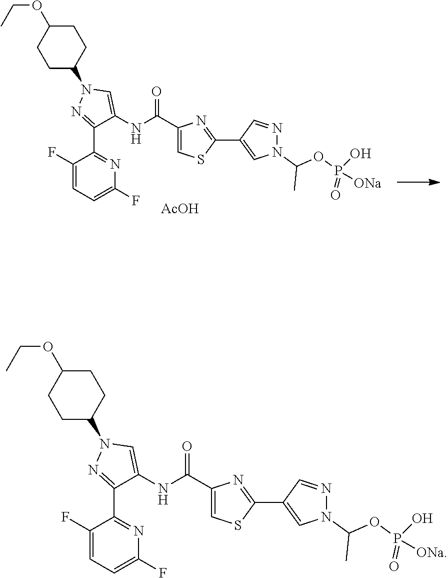

### 1) Stirring in Isopropanol-Water:

A suspension of the monosodium salt acetic acid adduct in 2-propanol-water (1:1, 0.1M) was stirred at room temperature for 3 hours. The solid was isolated by filtration washing with acetone (2×) to obtain the monosodium salt.

### 2) Alternative Using Formic Acid in Isopropanol-Water:

To a suspension of monosodium salt acetic acid adduct (0.150 g, 0.213 mmol, 1.0 eq) in isopropanol-water (2 mL, 1:1) was added formic acid (0.08 mL, 2.13 mmol, 10.0 eq). The reaction mixture was stirred at room temperature for 2 hours and the resulting suspension diluted with isopropanol-acetone (12 mL, 5:1). The solid was isolated by filtration and dried under vacuum to obtain the 1-(4-(4-((3-(3,6-difluoropyridin-2-yl)-1-((1 r,4r)-4-ethoxycyclohexyl)-1H-pyrazol-4-yl)carbamoyl)thiazol-2-yl)-1H-pyrazol-1-yl)ethyl phosphate monosodium salt.

3) from Di-Tert-Butyl Phosphate:

Another batch of the starting material 1-(4-(4-((3-(3,6-difluoropyridin-2-yl)-1-((I r,4r)-4-ethoxycyclohexyl)-1H-pyrazol-4-yl)carbamoyl)thiazol-2-yl)-1H-pyrazol-1-yl)ethyl phosphate monosodium salt was prepared from di-tert-butyl phosphate as follows:

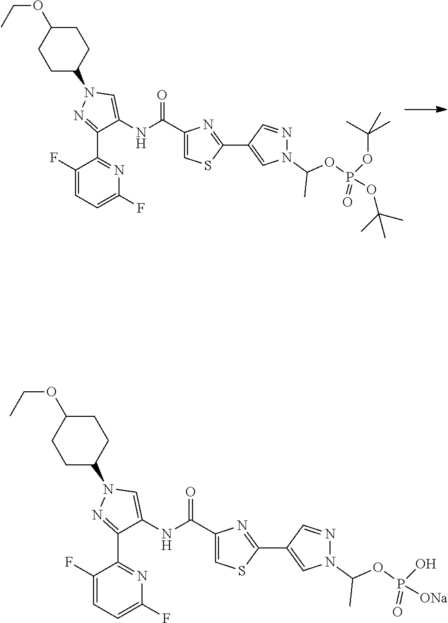

Sodium acetate (0.08 g, 1.00 mmol, 0.75 eq) was added to a solution of the di-tert-butyl phosphate (1.47 g, 2.00 mmol, 1.0 eq) in tetrahydrofuran (11 mL). Water (11 mL, miliQ 18Ω) was added and the reaction heated to 70° C. for 6 hours. The reaction was cooled and added into acetone (75 mL) forming a white solid, which was isolated by filtration to obtain the monosodium salt (0.51 g, 40%) as a white solid.

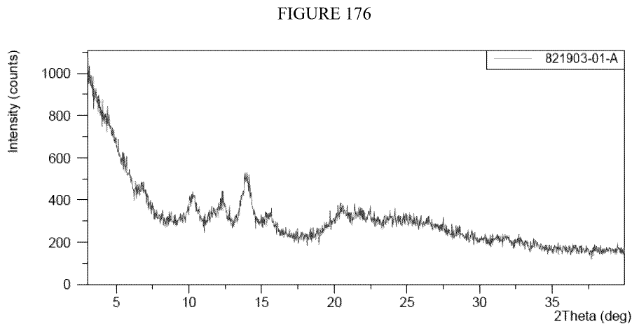

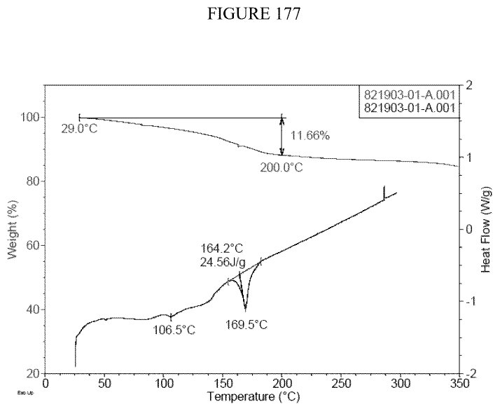

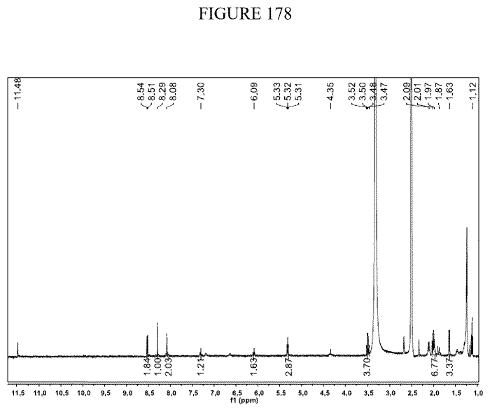

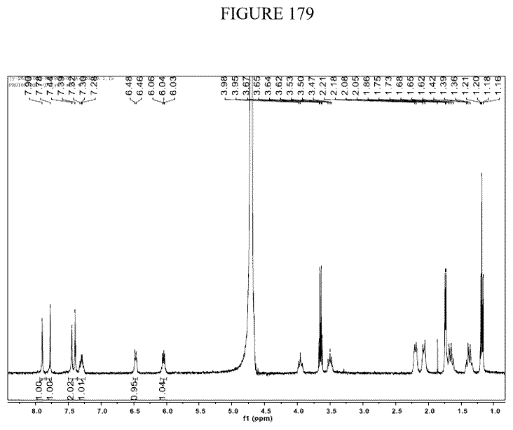

1-(4-(4-((3-(3,6-Difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium salt obtained by the above methods was characterized by XRPD, TGA and DSC. The results are displayed in FIG. 176 and FIG. 177. A weight loss of 11.7% up to 200° C. and two endotherms at 106.5° C. and 169.5° C. were observed on TGA/DSC curve. IC result confirmed the content of Na⁺ was 4.2%, indicating the material to be sodium salt. ¹H NMR results were shown in FIG. 178 and FIG. 179, using DMSO-d6 and D₂O as solvents respectively.

Two additional batches of materials were also characterized by IC for Na⁺ content confirmation and ¹H NMR. The Na⁺ content for sample and was 5.5% and 4.1%, respectively.

### 6.5 Example 5: Scale-Up and Characterization of Salt Leads

Based on the solid-state characterization and form identification results, K salt Form D, Arginine salt Form A, Choline salt Form A and Tris salt Form A were selected as salt leads for scale up and further evaluation. The selection criteria included but were not limited to: 1) anhydrate (preferentially), 2) low safety risk of base (safety risk, class 1<class 2<class 3), 3) sharp XRPD peaks without apparent amorphous halo, 4) negligible weight loss in TGA, 5) neat DSC endotherm at high temperature. Detailed procedures used to scale-up the salt leads are described below:

### K Salt Form E

1. Weigh 200.2 mg of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and equimolar KOH (18.1 mg) into a 20-mL glass vial.

2. Add 6.0 mL of DMSO/acetone (1:4, v/v) to form a suspension. Magnetically stir at RT for 2 days.

3. Isolate suspension by centrifugation (10000 rpm, 2 min). Dry solid at RT under vacuum for 1 day.

4. Test solid by XRPD. K salt Type E was obtained, the stoichiometric ratio of K+/freeform is 0.9:1.

### Arginine Salt Form A

1. Weigh 200.2 mg of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and 55.9 mg of L-Arginine into a 20-mL glass vial.

2. Add 6.0 mL of MeOH to form a suspension. Magnetically stir at RT for 2 days.

3. Isolate suspension by centrifugation (10000 rpm, 2 min). Dry solid at RT under vacuum for 1 day.

4. Test solid by XRPD. A total of 215.0 mg of solid was obtained (Yield: ˜84.0%).

### Choline Salt Form A

1. Weigh 200 mg of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and 70.8 mg of choline (50% aqueous solution) into a 20-mL glass vial.

2. Add 6.0 mL of EtOAc to form a suspension. Magnetically stir at RT for 2 days.

3. Isolate suspension by centrifugation (10000 rpm, 2 min). Dry solid at RT under vacuum for 1 day.

4. Test solid by XRPD. A total of 199.0 mg of solid was obtained (Yield: ˜84.5%).

### Tris Salt Form C

1. Weigh 200.2 mg of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate and 47.9 mg of Tromethamine into a 20-mL glass vial.

2. Add 6.0 mL of MeOH to form a suspension. Magnetically stir at RT for 2 days.

3. Isolate suspension by centrifugation (10000 rpm, 2 min). Dry solid at RT under vacuum for 1 day.

4. Test solid by XRPD. A total of 186.3 mg of solid was obtained (Yield: ˜75.1%).

XRPD comparison results confirmed Arginine salt Type A and Choline salt Type A were generated.

A new form of K salt was obtained, which was named as K salt Form E. XRPD pattern of re-prepared Tris salt was similar with both Tris salt Form A and Tris salt Form B and not classified as either, which was named as Tris salt Form C. Characterization results of re-prepared salt leads were summarized in Table 88.

TABLE 88
Characterization results of re-prepared salt leads

| | TGA weight | DSC | |
|---|---|---|---|
| Salt form | loss | endotherm | Molar ratio |
| (Sample ID) | (%, temp.) | (° C., peak) | (base/API) |
| K Salt | 6.6 | 199.8 | 1:1 |
| Form E | (to 220° C.) | | |
| Arginine Salt | 3.3 | 131.6, | 1:1 |
| Form A | (to 190° C.) | 217.1 | |
| Choline Salt | 2.3 | 64.3, | 0.9:1 |
| Form A | (to 160° C.) | 186.7 | |
| Tris Salt | 5.8 | 156.5, | 1.1:1 |
| Form C | (to 150° C.) | 176.2 | |

### K Salt Form E

XRPD pattern of K salt Form E is shown in FIG. 180. A list of X-Ray Diffraction Peaks for Form E of Compound 1A is provided below in Table 89.

TABLE 89
X-Ray Diffraction Peaks for Form E of Compound 1A

| | 2θ | d-spacing | Rel |
|---|---|---|---|
| #Peak | [°] | [Å] | [%] |
| 1 | 4.28 | 20.64 | 34.49 |
| 2 | 6.41 | 13.79 | 94.62 |
| 3 | 8.55 | 10.33 | 100.00 |
| 4 | 10.67 | 8.28 | 17.82 |
| 5 | 12.32 | 7.18 | 10.53 |
| 6 | 13.33 | 6.63 | 5.28 |
| 7 | 14.47 | 6.12 | 19.46 |
| 8 | 14.98 | 5.91 | 32.23 |
| 9 | 15.73 | 5.63 | 12.83 |
| 10 | 17.14 | 5.17 | 18.57 |
| 11 | 19.21 | 4.62 | 6.77 |
| 12 | 22.39 | 3.97 | 7.67 |
| 13 | 23.62 | 3.76 | 12.92 |
| 14 | 25.26 | 3.52 | 6.09 |
| 15 | 26.01 | 3.42 | 7.69 |
| 16 | 27.13 | 3.28 | 5.88 |
| 17 | 30.23 | 2.95 | 5.42 |
| 18 | 32.23 | 2.78 | 2.56 |
| 19 | 36.86 | 2.44 | 3.36 |
| 20 | 39.14 | 2.30 | 7.16 |

The stoichiometric ratio of K⁺/API was determined as 1:1 by HPLC and IC. TGA/DSC results are displayed in FIG. 181. TGA result showed a weight loss of 6.6% up to 220° C. DSC result showed one endotherm at 199.8° C. (onset). The ¹H NMR result in FIG. 182 showed the molar ratio of DMSO/API was 0.9:1 (the corresponding TGA weight loss was 9.6%).

### Arginine Salt Form A

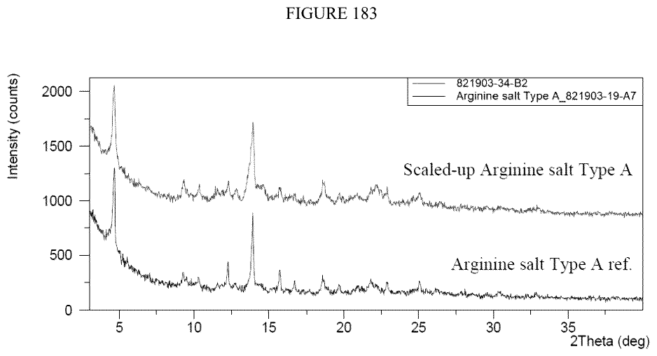

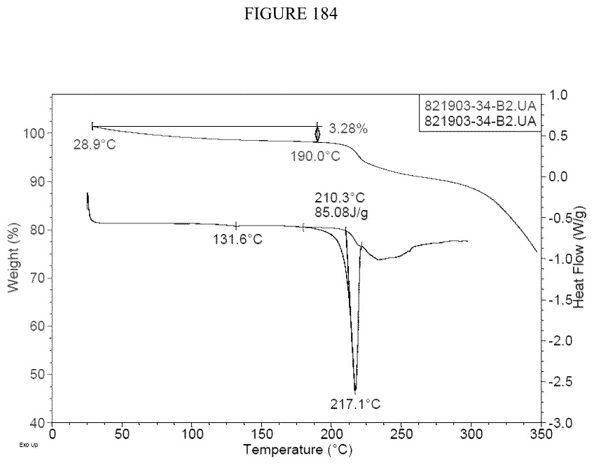

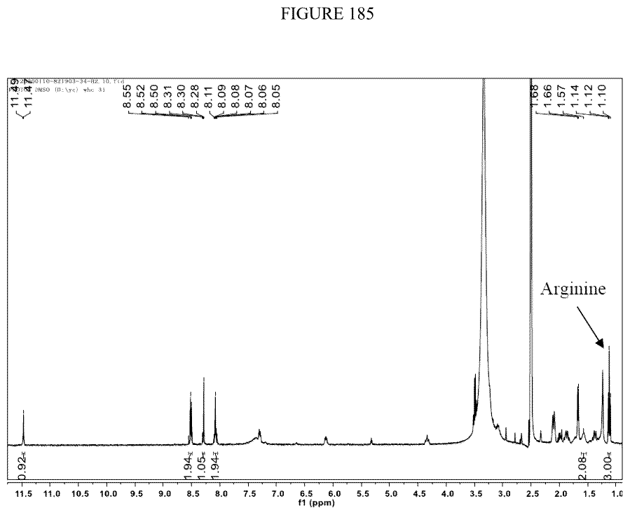

XRPD pattern of Arginine salt Form A is shown in FIG. 183. TGA/DSC results are displayed in FIG. 184. TGA result in FIG. 184 showed a weight loss of 3.3% up to 190° C. DSC result in FIG. 184 showed two endotherms at 131.6° C. and 217.1° C. (peak). The ¹H NMR result in FIG. 185 showed the molar ratio of base/freeform was 1:1 and negligible solvent MeOH was detected.

### Choline Salt Form A

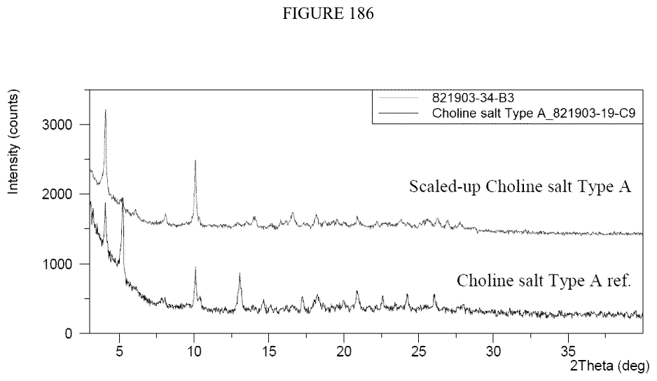

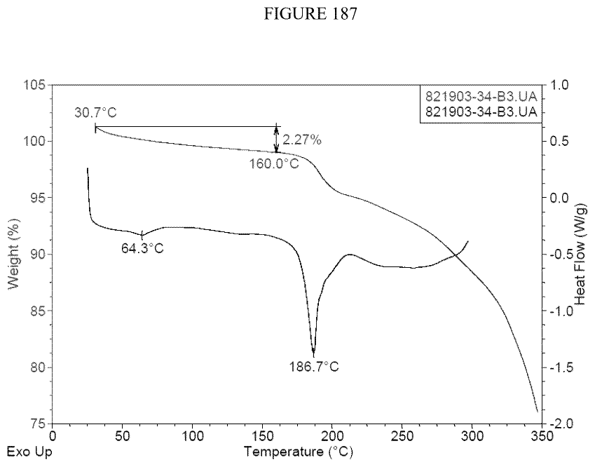

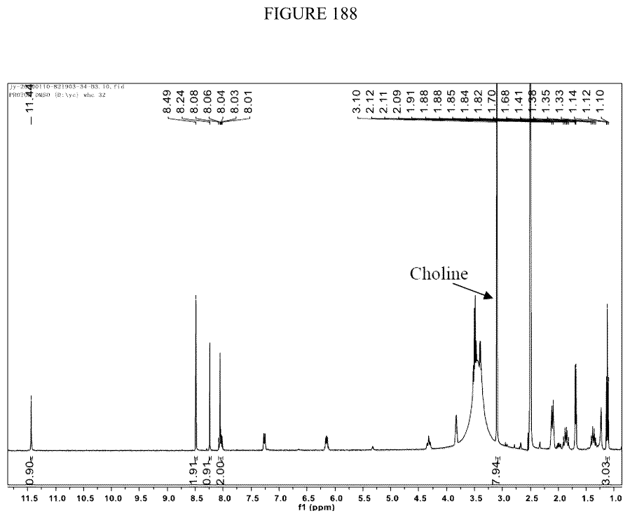

XRPD pattern of Choline salt Form A is shown in FIG. 186. TGA/DSC results are displayed in FIG. 187. TGA result showed a weight loss of 2.3% up to 160° C. DSC result showed two endotherms at 64.3° C. and 186.7° C. (peak). The 1H NMR result in FIG. 188 showed the molar ratio of base/freeform was 0.9:1 and negligible residual solvent EtOAc was detected.

### Tris Salt Form C

XRPD pattern of Tris salt was shown in FIG. 189, which was similar with both Tris salt Type A and B, which was named as Tris salt Type C. A list of X-Ray Diffraction Peaks for Form C of Compound 1H is provided below in Table 90.

TABLE 90
X-Ray Diffraction Peaks for Form C of Compound 1H

| | 2θ | d-spacing | Rel |
|---|---|---|---|
| #Peak | [°] | [Å] | [%] |
| 1 | 4.46 | 19.80 | 45.12 |
| 2 | 6.46 | 13.67 | 32.91 |
| 3 | 7.09 | 12.46 | 18.12 |
| 4 | 8.56 | 10.33 | 100.00 |
| 5 | 9.38 | 9.42 | 13.11 |
| 6 | 9.85 | 8.97 | 21.14 |
| 7 | 11.11 | 7.96 | 32.27 |
| 8 | 12.16 | 7.27 | 3.93 |
| 9 | 13.23 | 6.69 | 32.93 |
| 10 | 13.84 | 6.39 | 20.44 |
| 11 | 14.28 | 6.20 | 6.77 |
| 12 | 14.88 | 5.95 | 11.48 |
| 13 | 15.65 | 5.66 | 6.68 |
| 14 | 16.54 | 5.35 | 59.52 |
| 15 | 17.39 | 5.10 | 50.23 |
| 16 | 17.56 | 5.05 | 54.11 |
| 17 | 18.00 | 4.92 | 13.65 |
| 18 | 19.75 | 4.49 | 28.86 |
| 19 | 20.57 | 4.31 | 24.24 |
| 20 | 23.04 | 3.86 | 6.82 |
| 21 | 25.01 | 3.56 | 17.65 |
| 22 | 25.53 | 3.49 | 18.76 |
| 23 | 25.85 | 3.44 | 11.73 |
| 24 | 28.24 | 3.16 | 5.92 |
| 25 | 28.85 | 3.09 | 5.16 |
| 26 | 29.47 | 3.03 | 3.72 |
| 27 | 30.78 | 2.90 | 5.96 |
| 28 | 33.38 | 2.68 | 7.19 |
| 29 | 33.97 | 2.64 | 5.17 |
| 30 | 35.55 | 2.52 | 2.87 |

TGA/DSC results were displayed in FIG. 190. TGA result showed a weight loss of 5.8% up to 150 TC. DSC result showed two endotherms at 156.5° C. and 176.2° C. (peak). The ¹H NMR result in FIG. 191 showed the molar ratio of base/freeform was around 1.1:1 (the peak of Tromethamine is overlapped with H₂O) and negligible MeOH was detected.

### 6.6 Example 6: Evaluation

Based on the results of salt screening and scale-up, potassium salt Form E, arginine salt Form A, choline salt Form A and tris salt Form C were selected for further evaluation, including hygroscopicity and solid state stability.

### Hygroscopicity Evaluation

To investigate the solid form stability as a function of humidity, DVS isotherm plot of K salt Form E, Arginine salt Form A, Choline salt Form A and Tris salt Form C were collected at 25° C. between 0 and 95% RH.

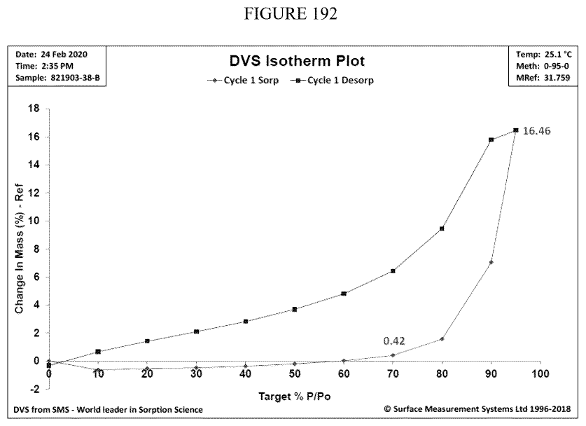

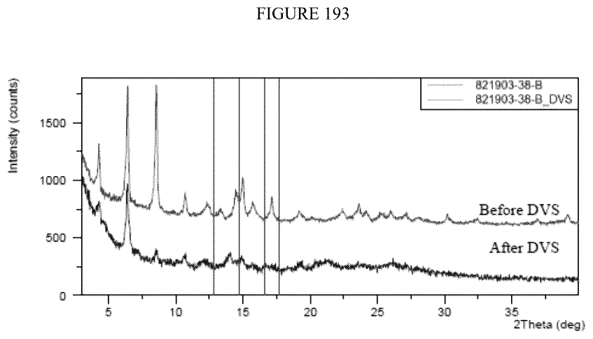

The DVS plot of K salt Form E is shown in FIG. 192. The water uptake at 70% RH was 0.42%, and increased dramatically to 16.5% at 95% RH. XRPD comparison in FIG. 193 shows form change for K salt Form E after DVS test.

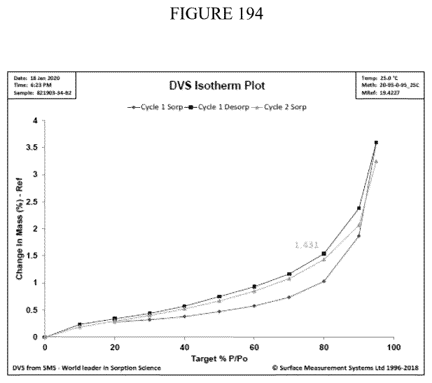

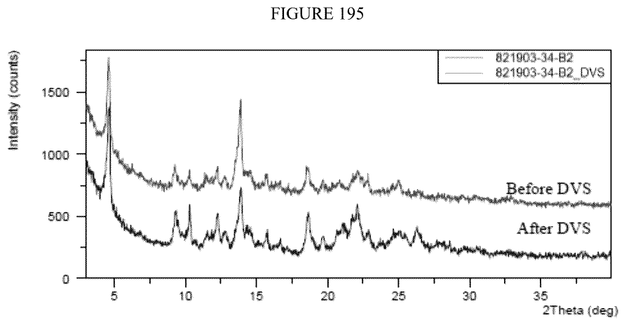

The DVS plot of Arginine salt Form A is shown in FIG. 194. A water uptake of 1.43% was observed at 80% RH, indicating Arginine salt Form A was slight hygroscopic. XRPD comparison in FIG. 195 showed no form change before and after DVS test.

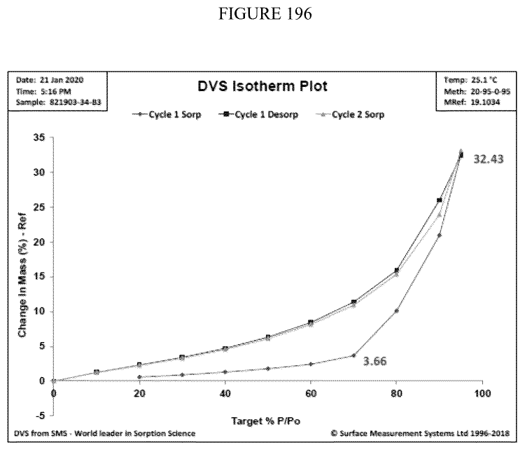

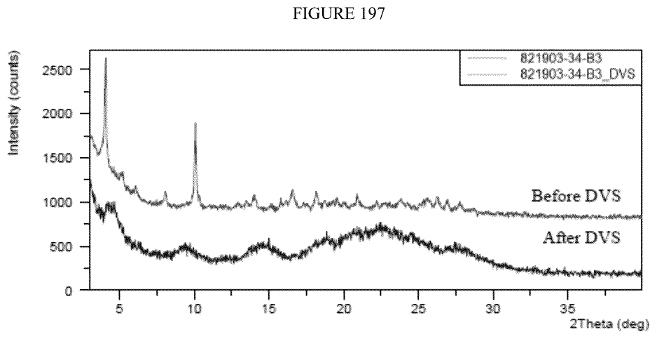

The DVS plot of Choline salt Form A is shown in FIG. 196. The water uptake at 70% RH was 3.66%, and increased dramatically to 32.4% at 95% RH. XRPD comparison in FIG. 197 showed amorphous sample with halo peak was observed after DVS test.

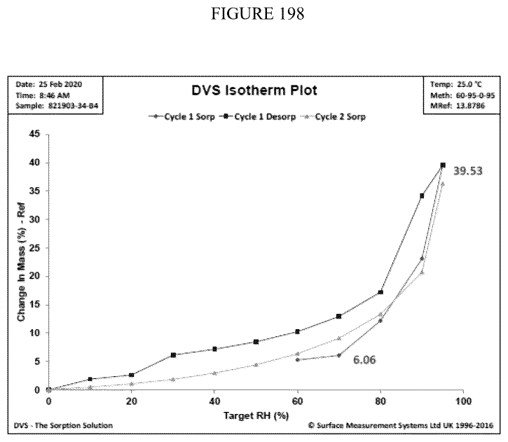

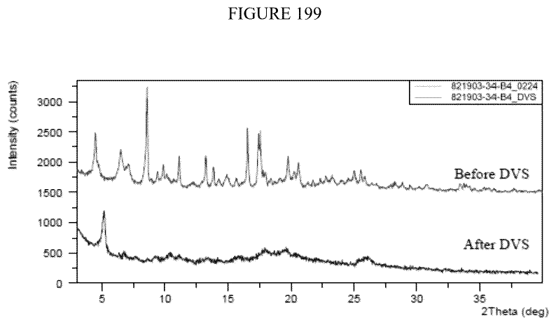

The DVS plot of Tris salt Form C is shown in FIG. 198. The water uptake at 70% RH was 6.06%, and increased dramatically to 39.5% at 95% RH. XRPD comparison in FIG. 199 showed form change for Tris salt Form C after DVS test.

### Physical and Chemical Stability

The physical and chemical stability of K salt Form E, Arginine salt Form A, Choline salt Form A and Tris salt Form C were evaluated under conditions of 25° C./60% RH and 40° C./75% RH for 1 week. Each sample was added into 3-mL glass vials, sealed by parafilm with several holes, and kept under tested condition. After one week, samples was taken for XRPD and HPLC purity test. All the characterization data are summarized in Table 91.

TABLE 91

| | | 25° C./ | | 40° C./ | |
|---|---|---|---|---|---|
| | | 60% RH/1 week | | 75% RH/1 week | |
| | Initial | Purity/ | | Purity/ | |
| | purity | Initial | Form | Initial | Form |
| Salt leads | (area %) | purity (%) | change | purity (%) | change |
| K salt | 97.27 | 99.0 | No | 99.1 | Yes |
| Form E | | | | | |
| Arginine | 95.91 | 99.4 | No | 99.6 | No |
| salt Form A | | | | | |
| Choline salt | 98.70 | 100.0 | No | 99.1 | No |
| Form A | | | | | |
| Tris salt | 96.06 | 100.6 | No | 98.9 | No |
| Form C | | | | | |

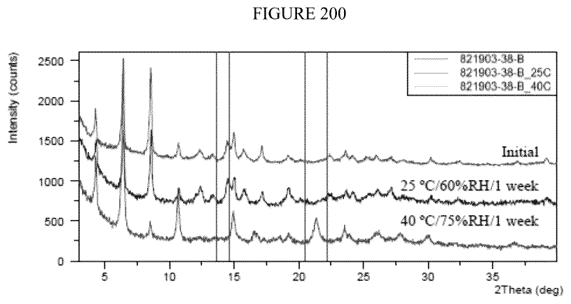

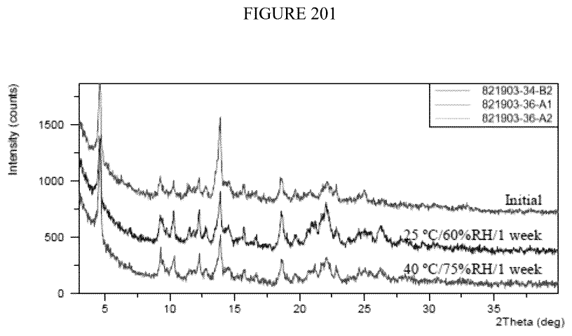

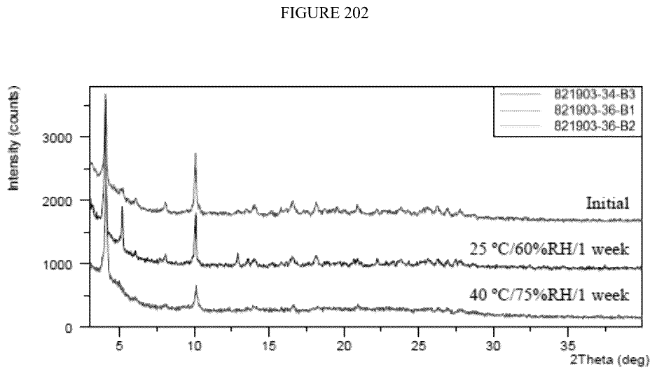

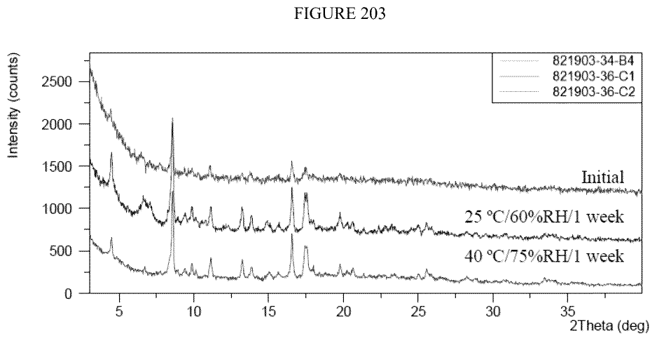

As the XRPD patterns showed from FIG. 200 to FIG. 203, no form change was observed after storage under the two conditions for Arginine salt Form A, Choline salt Form A and Tris salt Form C. For K salt Form E, no form change was observed under 25° C./60% RH while form change under 40° C./75% RH. For K salt Form E and Arginine salt Form A, slight purity decrease was observed under both conditions after 1 week. For Choline salt Form A and Tris salt Form C, no HPLC purity decrease was observed under 25° C./60% RH while purity decrease under 40° C./75% RH. Impurities summary for all salt hits are shown form Table 92 to Table 95. The peak at RRT=1.17 corresponds to N-(3-(3,6-difluoropyridin-2-yl)-1-((1r,4r)-4-ethoxycyclohexyl)-1H-pyrazol-4-yl)-2-(1H-pyrazol-4-yl)thiazole-4-carboxamide, the parent compound of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate that is formed by hydrolysis. Decrease in purity of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate salt is typically correlated with a corresponding increase in N-(3-(3,6-difluoropyridin-2-yl)-1-((1r,4r)-4-ethoxycyclohexyl)-1H-pyrazol-4-yl)-2-(1H-pyrazol-4-yl)thiazole-4-carboxamide parent impurity level.

TABLE 92
Impurity summary of Form E Compound 1A

Area (%)

| | | | 25° C./ | 40° C./ |
|---|---|---|---|---|
| #Peak | RRT | Initial | 60% RH | 75% RH |
| 1 | 1.00 | 97.27 | 96.26 | 96.40 |
| 2 | 1.14 | <0.04 | <0.04 | 0.05 |
| 3 | 1.17 | 1.33 | 2.14 | 1.80 |
| 4 | 1.40 | 0.23 | 0.25 | 0.39 |
| 5 | 1.44 | 0.21 | 0.30 | 0.24 |
| 6 | 1.70 | 0.18 | 0.27 | 0.24 |
| 7 | 1.72 | 0.77 | 0.78 | 0.83 |
| 8 | 1.81 | <0.04 | <0.04 | 0.04 |

TABLE 93
Impurity summary of Form A Compound 1E

Area (%)

| | | | 25° C./ | 40° C./ |
|---|---|---|---|---|
| #Peak | RRT | Initial | 60% RH | 75% RH |
| 1 | 0.77 | <0.03 | 0.03 | 0.04 |
| 2 | 1.00 | 95.91 | 95.31 | 95.50 |
| 3 | 1.13 | <0.03 | 0.06 | 0.06 |
| 4 | 1.17 | 2.39 | 2.68 | 2.48 |
| 5 | 1.35 | <0.03 | 0.06 | 0.11 |
| 6 | 1.45 | 0.44 | 0.50 | 0.47 |
| 7 | 1.71 | 0.73 | 0.74 | 0.73 |
| 8 | 1.73 | <0.53 | 0.61 | 0.60 |

TABLE 94
Impurity summary of Form A Compound 1G

Area (%)

| | | | 25° C./ | 40° C./ |
|---|---|---|---|---|
| #Peak | RRT | Initial | 60% RH | 75% RH |
| 1 | 0.77 | 0.03 | 0.04 | 0.04 |
| 2 | 1.00 | 98.70 | 98.66 | 97.81 |
| 3 | 1.13 | 0.06 | 0.06 | 0.06 |
| 4 | 1.17 | 0.75 | 0.58 | 1.31 |
| 5 | 1.35 | <0.03 | 0.10 | 0.14 |
| 6 | 1.45 | 0.06 | 0.07 | 0.11 |
| 7 | 1.71 | 0.06 | 0.05 | 0.08 |
| 8 | 1.73 | 0.33 | 0.46 | 0.46 |

TABLE 95
Impurity summary of Form C Compound 1H

Area (%)

| | | | 25° C./ | 40° C./ |
|---|---|---|---|---|
| #Peak | RRT | Initial | 60% RH | 75% RH |
| 1 | 0.77 | <0.03 | <0.03 | 0.03 |
| 2 | 1.00 | 96.06 | 96.61 | 95.03 |
| 3 | 1.13 | 0.07 | 0.06 | 0.06 |
| 4 | 1.17 | 1.87 | 1.63 | 2.69 |
| 5 | 1.45 | 0.37 | 0.35 | 0.47 |
| 6 | 1.71 | 0.86 | 0.80 | 0.88 |
| 7 | 1.73 | 0.76 | 0.55 | 0.84 |

While the disclosure has been described with respect to the particular embodiments, it will be apparent to those skilled in the art that various changes and modifications may be made without departing from the spirit and scope of the disclosure as defined in the claims. Such modifications are also intended to fall within the scope of the appended claims.

All of the patents, patent applications and publications referred to herein are incorporated herein in their entireties. Citation or identification of any reference in this application is not an admission that such reference is available as prior art to this disclosure. The full scope of the disclosure is better understood with reference to the appended claims.

What is claimed is:

1. A solid form of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate monosodium: 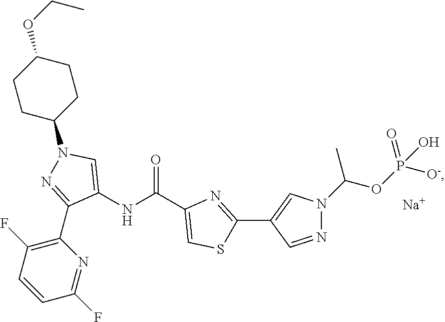
wherein the solid form is selected from:
Form E having an X-ray powder diffraction pattern comprising one or more peaks at approximately 8.64, 16.81 or 17.41 degrees 2θ;
Form D having an X-ray powder diffraction pattern comprising one or more peaks at approximately 6.55, 10.88 or 15.17 degrees 2θ;
Form J having an X-ray powder diffraction pattern comprising one or more peaks at approximately 9.26, 15.82 or 19.37 degrees 2θ;
Form L having an X-ray powder diffraction pattern comprising one or more peaks at approximately 7.16, 11.97 or 13.87 degrees 2θ;
Form U having an X-ray powder diffraction pattern comprising one or more peaks at approximately 4.36, 6.50 or 10.83 degrees 2θ;
Form O having an X-ray powder diffraction pattern comprising one or more peaks at approximately 9.12, 15.72 or 19.17 degrees 2θ;
Form Q having an X-ray powder diffraction pattern comprising one or more peaks at approximately 6.68, 6.69 or 8.91 degrees 2θ;
Form R having an X-ray powder diffraction pattern comprising one or more peaks at approximately 8.62, 13.73 or 16.82 degrees 2θ;
Form T having an X-ray powder diffraction pattern comprising one or more peaks at approximately 6.60, 8.83 or 15.54 degrees 2θ;
Form W having an X-ray powder diffraction pattern comprising one or more peaks at approximately 6.70, 4.47 or 8.92 degrees 2θ;
Form H having an X-ray powder diffraction pattern comprising one or more peaks at approximately 6.06, 7.96 or 22.94 degrees 2θ;
Form N having an X-ray powder diffraction pattern comprising one or more peaks at approximately 6.23, 12.32 or 14.36 degrees 2θ;
Form X having an X-ray powder diffraction pattern comprising one or more peaks at approximately 19.16, 19.75 or 24.51 degrees 2θ;
Form F having an X-ray powder diffraction pattern comprising one or more peaks at approximately 5.35, 9.13 or 10.66 degrees 2θ;
Form G having an X-ray powder diffraction pattern comprising one or more peaks at approximately 10.08, 12.39 or 13.89 degrees 2θ;
Form I having an X-ray powder diffraction pattern comprising one or more peaks at approximately 6.98, 9.20 or 11.62 degrees 2θ;
Form K having an X-ray powder diffraction pattern comprising one or more peaks at approximately 4.56, 13.73 or 18.23 degrees 2θ;
Form M having an X-ray powder diffraction pattern comprising one or more peaks at approximately 5.16, 7.76 or 10.34 degrees 2θ;
Form P having an X-ray powder diffraction pattern comprising one or more peaks at approximately 4.36, 6.51 or 15.20 or degrees 2θ;
Form S having an X-ray powder diffraction pattern comprising one or more peaks at approximately 6.19, 6.48 or 12.44 degrees 2θ;
Form V having an X-ray powder diffraction pattern comprising one or more peaks at approximately 12.81, 14.27 or 18.00 degrees 2θ;
Form Y having an X-ray powder diffraction pattern comprising one or more peaks at approximately 4.68, 9.31 or 19.41 degrees 2θ;
Form A having an X-ray powder diffraction pattern comprising one or more peaks at approximately 6.56, 7.10 and 9.46 degrees 2θ;
Form B having an X-ray powder diffraction pattern comprising one or more peaks at approximately 6.48, 8.59 and 17.60 degrees 2θ;
Form C having an X-ray powder diffraction pattern comprising one or more peaks at approximately 8.93, 11.77 or 12.70 degrees 2θ;
Form NP1 having an X-ray powder diffraction pattern comprising one or more peaks at approximately 11.97, 13.94 or 20.52 degrees 2θ;
Form NP3 having an X-ray powder diffraction pattern comprising one or more peaks at approximately 7.18, 8.62 or 16.82 degrees 2θ; and
Form NP4 having an X-ray powder diffraction pattern comprising one or more peaks at approximately 6.35, 12.73 or 23.45 degrees 2θ.

2. The solid form of claim 1, which is Form E having an X-ray powder diffraction pattern comprising one or more peaks at approximately 8.64, 16.81 or 17.41 degrees 2θ.

3. The solid form of claim 2, having an X-ray powder diffraction pattern comprising one or more peaks at approximately 8.64, 14.06, 16.81, 17.41 or 34.07 degrees 2θ.

4. The solid form of claim 2, having an X-ray powder diffraction pattern substantially as shown in FIG. 9.

5. The solid form of claim 2, having a thermal gravimetric analysis plot comprising a two step weight loss of about 4.4% up to about 120° C., and about 4.2% between about 120° C. and 220° C.

6. The solid form of claim 2, having a thermal gravimetric analysis plot substantially as shown in FIG. 10.

7. The solid form of claim 2, having a differential scanning calorimetry plot comprising two endotherms at about 112.1° C. and about 183.2° C.

8. The solid form of claim 2, having a differential scanning calorimetry plot substantially as shown in FIG. 10.

9. The solid form of claim 2 which is substantially pure.

10. The solid form of claim 2, which is a hydrate.

11. A solid form selected from:
Form A of potassium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 8.64, 16.81 or 17.41 degrees 2θ;
Form B of potassium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 6.41, 10.67 or 14.94 degrees 2θ;
Form C of potassium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 6.67, 8.69 or 16.82 degrees 2θ;
Form D of potassium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 5.20, 15.57 or 17.01 degrees 2θ;
Form E of potassium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 4.28, 6.41 or 8.55 degrees 2θ;
Form A of magnesium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 5.44, 8.16 or 10.90 degrees 2θ;
Form A of calcium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 4.86, 14.56 or 15.73 degrees 2θ;
Form A of ammonium salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 8.70, 14.12 or 16.80 degrees 2θ;
Form A of arginine salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 4.65, 12.25 or 13.91 degrees 2θ;
Form B of arginine salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 8.16, 9.01 or 17.43 degrees 2θ;
Form C of arginine salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 4.42, 13.36 or 22.21 degrees 2θ;
Form A of lysine salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 4.27, 6.39 or 10.60 degrees 2θ;
Form A of choline salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 4.05, 5.22 or 10.07 degrees 2θ;
Form B of choline salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 4.07, 5.18 or 12.89 degrees 2θ;
Form A of tris salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 4.86, 8.00 or 8.57 degrees 2θ;
Form B of tris salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 4.49, 11.16 or 25.55 degrees 2θ;
Form C of tris salt of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 8.56, 16.54 or 17.56 degrees 2θ;
Form A of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 5.51, 20.54 or 25.48 degrees 2θ;
Form B of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 5.53, 11.06 or 12.99 degrees 2θ;
Form C of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 5.35, 12.68 or 17.43 degrees 2θ; and
Form D of 1-(4-(4-((3-(3,6-difluoropyridin-2-yl)-1-((1r,4r)-4-ethoxycyclohexyl)-1H-pyrazol-4-yl)carbamoyl)thiazol-2-yl)-1H-pyrazol-1-yl)ethyl phosphate having an X-ray powder diffraction pattern comprising one or more peaks at approximately 8.73, 16.90 or 17.47 degrees 2θ.

12. A pharmaceutical composition comprising the solid form of claim 1 and a pharmaceutically acceptable carrier, diluent or excipient.

13. The pharmaceutical composition of claim 12, wherein the composition is formulated for oral administration.

14. A method of treating a disease comprising administering to a subject in need thereof the solid form of claim 1, wherein the disease is an auto-immune disease, an inflammatory disorder, a cardiovascular disease, a nerve disorder, a neurodegenerative disorder, an allergic disorder, asthma, pancreatitis, multi-organ failure, a kidney disease, platelet aggregation, cancer, transplantation, sperm motility, erythrocyte deficiency, graft rejection, a lung injury, a respiratory disease, an ischemic condition, bacterial infection or a viral infection.

15. The method of claim 14, wherein disease is an allergic disease, amyotrophic lateral sclerosis (ALS), systemic lupus erythematosus, rheumatoid arthritis, type I diabetes mellitus, inflammatory bowel disease, biliary cirrhosis, uveitis, multiple sclerosis, Crohn's disease, ulcerative colitis, bullous pemphigoid, sarcoidosis, psoriasis, autoimmune myositis, Wegener's granulomatosis, ichthyosis, Graves ophthalmopathy, or asthma.

16. The method of claim 14, wherein disease is transplantation of organs or tissue, graft-versus-host diseases brought about by transplantation, autoimmune syndromes including arthralgia, arthritis, rheumatoid arthritis, lupus, including systemic lupus erythematosus, Hashimoto's thyroiditis, multiple sclerosis, systemic sclerosis, myasthenia gravis, type I diabetes, uveitis, posterior uveitis, allergic encephalomyelitis, glomerulonephritis, postinfectious autoimmune diseases including rheumatic fever and post-infectious glomerulonephritis, inflammatory and hyperproliferative skin diseases, psoriasis, atopic dermatitis, contact dermatitis, eczematous dermatitis, seborrhoeic dermatitis, lichen planus, pemphigus, bullous pemphigoid, epidermolysis bullosa, urticaria, angioedemas, vasculitis, erythema, cutaneous eosinophilia, lupus erythematosus, acne, alopecia areata, keratoconjunctivitis, vernal conjunctivitis, uveitis associated with Behcet's disease, keratitis, herpetic keratitis, conical cornea, dystrophia epithelialis corneae, corneal leukoma, ocular pemphigus, Mooren's ulcer, scleritis, Graves' opthalmopathy, Vogt-Koyanagi-Harada syndrome, sarcoidosis, pollen allergies, reversible obstructive airway disease, bronchial asthma, allergic asthma, intrinsic asthma, extrinsic asthma, dust asthma, chronic or inveterate asthma, late asthma and airway hyper-responsiveness, bronchitis, gastric ulcers, vascular damage caused by ischemic diseases and thrombosis, ischemic bowel diseases, inflammatory bowel diseases, necrotizing enterocolitis, intestinal lesions associated with thermal burns, celiac diseases, proctitis, eosinophilic gastroenteritis, mastocytosis, Crohn's disease, ulcerative colitis, migraine, rhinitis, eczema, interstitial nephritis, Goodpasture's syndrome, hemolytic-uremic syndrome, diabetic nephropathy, multiple myositis, Guillain-Barre syndrome, Meniere's disease, polyneuritis, multiple neuritis, mononeuritis, radiculopathy, hyperthyroidism, Basedow's disease, pure red cell aplasia, aplastic anemia, hypoplastic anemia, idiopathic thrombocytopenic purpura, autoimmune hemolytic anemia, agranulocytosis, pernicious anemia, megaloblastic anemia, erythroplasia, osteoporosis, sarcoidosis, fibroid lung, idiopathic interstitial pneumonia, dermatomyositis, leukoderma vulgaris, ichthyosis vulgaris, photoallergic sensitivity, cutaneous T cell lymphoma, chronic lymphocytic leukemia, arteriosclerosis, atherosclerosis, aortitis syndrome, polyarteritis nodosa, myocardosis, scleroderma, Wegener's granuloma, Sjögren's syndrome, adiposis, eosinophilic fascitis, lesions of gingiva, periodontium, alveolar bone, substantia ossea dentis, glomerulonephritis, male pattern alopecia or alopecia senilis by preventing epilation or providing hair germination and/or promoting hair generation and hair growth, muscular dystrophy, pyoderma and Sezary's syndrome, Addison's disease, ischemia-reperfusion injury of organs which occurs upon preservation, transplantation or ischemic disease, endotoxin-shock, pseudomembranous colitis, colitis caused by drug or radiation, ischemic acute renal insufficiency, chronic renal insufficiency, toxinosis caused by lung-oxygen or drugs, lung cancer, pulmonary emphysema, cataracta, siderosis, retinitis pigmentosa, senile macular degeneration, vitreal scarring, corneal alkali burn, dermatitis erythema multiforme, linear IgA bullous dermatitis and cement dermatitis, gingivitis, periodontitis, sepsis, pancreatitis, diseases caused by environmental pollution, aging, carcinogenesis, metastasis of carcinoma and hypobaropathy, disease caused by histamine or leukotriene-C4 release, Behcet's disease, autoimmune hepatitis, primary biliary cirrhosis, sclerosing cholangitis, partial liver resection, acute liver necrosis, necrosis caused by toxin, viral hepatitis, shock, or anoxia, B-virus hepatitis, non-A/non-B hepatitis, cirrhosis, alcoholic liver disease, including alcoholic cirrhosis, non-alcoholic steatohepatitis, hepatic failure, fulminant hepatic failure, late-onset hepatic failure, “acute-on-chronic” liver failure, augmentation of chemotherapeutic effect, cytomegalovirus infection, HCMV infection, AIDS, cancer, senile dementia, Parkinson's disease, trauma, chronic bacterial infection, palmoplantar pustulosis, hidradenitis suppurativa, cytokine release syndrome, acute respiratory distress syndrome, acute kidney injury, kidney malfunction, or thrombosis.

17. The method of claim 14, wherein disease is hidradenitis suppurativa, or a lymphoid neoplasm selected from myeloproliferative neoplasms, myeloid/lymphoid neoplasms with PDGFRA rearrangement, myeloid/lymphoid neoplasms with PDGFRB rearrangement, myeloid/lymphoid neoplasms with FGFR1 rearrangement, myeloid/lymphoid neoplasms with PCM1-JAK2, myelodysplastic/myeloproliferative neoplasms, myeloid sarcoma, myeloid proliferations related to Down syndrome, blastic plasmacytoid dendritic cell neoplasm, B-lymphoblastic leukemia/lymphoma; and/or T-lymphoblastic leukemia/lymphoma.

18. The method of claim 14, wherein disease is a myeloproliferative neoplasm selected from chronic myeloid leukemia, chronic neutrophilic leukemia, primary myelofibrosis, essential thrombocythemia, chronic eosinophilic leukemia, or a combination thereof.

19. The method of claim 14, wherein disease is a myelodysplastic/myeloproliferative neoplasm selected from chronic myelomonocytic leukemia, atypical chronic myeloid leukemia, juvenile myelomonocytic leukemia, MDS/MPN with ring sideroblasts and thrombocytosis, or a combination thereof.

20. The method of claim 14, wherein disease is rheumatoid arthritis, psoriatic arthritis, osteoarthritis, systemic lupus erythematosus, lupus nephritis, ankylosing spondylitis, osteoporosis, systemic sclerosis, multiple sclerosis, psoriasis, in particular pustular psoriasis, type I diabetes, type II diabetes, inflammatory bowel disease, hyperimmunoglobulinemia d and periodic fever syndrome, cryopyrin-associated periodic syndromes, Schnitzler's syndrome, systemic juvenile idiopathic arthritis, adult's onset Still's disease, gout, gout flares, pseudogout, SAPHO syndrome, Castleman's disease, sepsis, stroke, atherosclerosis, celiac disease, deficiency of Il-1 receptor antagonist, Alzheimer's disease, or Parkinson's disease.

21. The method of claim 14, wherein disease is a solid tumor, carcinoma of the brain, kidney, liver, adrenal gland, bladder, breast, stomach, gastric tumors, ovaries, colon, rectum, prostate, pancreas, lung, vagina, cervix, testis, genitourinary tract, esophagus, larynx, skin, bone or thyroid, sarcoma, glioblastomas, neuroblastomas, multiple myeloma, gastrointestinal cancer, especially colon carcinoma or colorectal adenoma, a tumor of the neck and head, an epidermal hyperproliferation, psoriasis, prostate hyperplasia, a neoplasia, a neoplasia of epithelial character, adenoma, adenocarcinoma, keratoacanthoma, epidermoid carcinoma, large cell carcinoma, non-small-cell lung carcinoma, lymphomas, Hodgkins and Non-Hodgkins, a mammary carcinoma, follicular carcinoma, undifferentiated carcinoma, papillary carcinoma, seminoma, melanoma, IL-1 driven disorders, a MyD88 driven disorder, primary cutaneous T-cell lymphoma, chronic lymphocytic leukemia, smoldering or indolent multiple myeloma, leukemia, acute myeloid leukemia, DLBCL, ABC DLBCL, chronic lymphocytic leukemia, chronic lymphocytic lymphoma, primary effusion lymphoma, Burkitt lymphoma/leukemia, acute lymphocytic leukemia, B-cell prolymphocytic leukemia, lymphoplasmacytic lymphoma, myelodysplastic syndrome, clonal cytopenia of undetermined significance, myelofibrosis, polycythemia vera, Kaposi's sarcoma, Waldenstrom's macroglobulinemia, splenic marginal zone lymphoma, multiple myeloma, plasmacytoma or intravascular large B-cell lymphoma.

22. The method of claim 21, wherein disease is a myelodysplastic syndrome.

23. The method of claim 22, wherein the myelodysplastic syndrome is a higher-risk myelodysplastic or a lower-risk myelodysplastic syndrome.

24. The method of claim 22, wherein the myelodysplastic syndrome is refractory or relapsed myelodysplastic syndrome.

25. The method of claim 14, wherein the method further comprises administering a second therapeutic agent.
